(19) United States
(12) Patent Application Publication
(10) Pub. No.: US 2015/0356243 A1
(43) Pub. Date: Dec. 10, 2015

(54) SYSTEMS AND METHODS FOR IDENTIFYING POLYMORPHISMS

(71) Applicants: OSLO UNIVERSITETSSYKEHUS HF, Oslo (NO); THE REGENTS OF THE UNIVERSTY OF CALIFORNIA, Oakland, CA (US)

(72) Inventors: Ole A. Andreassen, Blommenholm (NO); Anders M. Dale, La Jolla, CA (US); Wesley Kurt Thompson, San Diego, CA (US); Andrew Schork, San Diego, CA (US)

(21) Appl. No.: 14/759,738

(22) PCT Filed: Jan. 10, 2014
(86) PCT No.: PCT/US2014/011014

§ 371 Date: Jul. 8, 2015

Related U.S. Application Data
(60) Provisional application No. 61/751,420, filed on Jan. 11, 2013.

(51) Int. Cl. G06F 19/22; G06F 19/00

(52) U.S. Cl. CPC G06F 19/22; G06F 19/3431

(57) ABSTRACT

The present invention relates to processes, systems and methods for estimating the effects of genetic polymorphisms associated with traits and diseases, based on distributions of observed effects across multiple loci. In particular, the present invention provides systems and methods for analyzing genetic variant data including estimating the proportion of polymorphisms truly associated with the phenotypes of interest, the probability that a given polymorphism has a true association with the phenotypes of interest, and the predicted effect size of a given genetic variant in independent de novo samples given effect size distributions in observed samples. The present invention also relates to using the described systems and methods and use of genetic polymorphisms across a plurality of loci and a plurality of phenotypes to diagnose, characterize, optimize treatment and predict diseases and traits.

### FIELD OF THE INVENTION

The present invention relates to processes, systems and methods for estimating the effects of genetic polymorphisms associated with traits and diseases, based on distributions of observed effects across multiple loci. In particular, the present invention provides systems and methods for analyzing genetic variant data including estimating the proportion of polymorphisms truly associated with the phenotypes of interest, the probability that a given polymorphism has a true association with the phenotypes of interest, and the predicted effect size of a given genetic variant in independent de novo samples given effect size distributions in observed samples. The present invention also relates to using the described systems and methods and use of genetic polymorphisms across a plurality of loci and a plurality of phenotypes to diagnose, characterize, optimize treatment and predict diseases and traits.

### BACKGROUND OF THE INVENTION

Many devastating human diseases are heritable, including many of the largest health care burden today, including cardiovascular diseases, brain disorders, rheumatologic and immunological disorders. However, only a small fraction of genetic variance has been identified, even after using large genome-wide association studies (GWAS). Several lines of evidence support the existence of numerous small genetic effects that cannot be detected with traditional GWAS analyses.

Converging evidence suggest that complex human phenotypes are influenced by numerous genes each with small effects. Though thousands of single nucleotide polymorphisms (SNPs) have been identified by genome-wide association studies (GWAS), these SNPs fail to explain a large proportion of the heritability of most complex phenotypes studied, often referred to as the “missing heritability” problem. Recent findings indicate that GWAS have the potential to explain a greater proportion of the heritability of common complex phenotypes, and more SNPs are likely to be identified in larger samples. Due to the polygenic architecture of most complex traits and disorders, a large number of SNPs are likely to have associations too weak to be identified with the currently available sample sizes.

New analytical methods are needed to reliably identify a larger proportion of SNPs associated with complex diseases and phenotypes, since recruitment and genotyping of new samples are expensive.

### SUMMARY OF THE INVENTION

The present invention relates to processes, systems and methods for estimating the effects of genetic polymorphisms associated with traits and diseases, based on distributions of observed effects across multiple loci. In particular, the present invention provides systems and methods for analyzing genetic variant data including estimating the proportion of polymorphisms truly associated with the phenotypes of interest, the probability that a given polymorphism has a true association with the phenotypes of interest, and the predicted effect size of a given genetic variant in independent de novo samples given effect, size distributions in observed samples. The present invention also relates to using the described systems and methods and use of genetic polymorphisms across a plurality of loci and a plurality of phenotypes to diagnose, characterize, optimize treatment and predict diseases and traits.

For example, in some embodiments the present invention provides a computer implemented process of identifying polymorphisms associated with a specific condition, comprising at least one of: a) inputting polymorphism information for a plurality of gene variants (e.g., single nucleotide polymorphisms (SNP)); b) assigning a linkage disequilibrium (LD) score to each SNP; c) testing each gene variant for enrichment using scores derived from conditional distribution analysis (e.g., Q-Q plots); d) assigning a ranking (e.g., false discovery rate (FDR) or local false discovery rate) to each gene variant using unconditional and conditional distributions; e) performing a Bayesian, resampling, or likelihood-based analysis on a combination of all or some enriching factors; f) applying a regression model to combine information; and g) identifying or quantifying the probability that the gene variants are associated with the condition. In some embodiments, identifying comprises listing identified gene variants in a priority order. In some embodiments, the LD assigns each of the gene variants to a functional category. In some embodiments, the Q-Q score provides a true discovery rate and a FDR for each SNP. In some embodiments, the FDR for a specific gene variant is defined as the nominal p-value divided by the empirical quantile. In some embodiments, gene variants with FDRs less than a threshold value (e.g., 0.01) are defined as associated with the condition. In some embodiments, empirical quantiles are plotted as Q-Q plots. In some embodiments, Q-Q plots identify pleiotropic enrichment. In some embodiments, polymorphism information is obtained from at least 2 subjects. In some embodiments, polymorphism information comprises at least 1000, 5000, or 10000 or more individual gene variants. In some embodiments, gene variants are intergenic. In some embodiments, the method further comprises the step of plotting FDRs within an LD block in relation to their chromosomal location. In some embodiments, the condition is, for example, a disease, a trait, a response to a particular therapeutic agent, or a prognosis, although other conditions are specifically contemplated.

In some embodiments, distributions of gene variant, effect sizes for a given trait or disease are used to determine Bayesian posterior effect sizes across a plurality of polymorphisms. In some embodiments, Bayesian posterior effect sizes are computed across a plurality of diseases or traits simultaneously. In some embodiments, prior information regarding genes, functional roles of SNPs, LD scores, or other covariates is used to improve estimates of Bayesian posterior effect sizes. In some embodiments, distributions of Bayesian posterior effect size for one or more diseases or traits is used to identify genetic loci associated with a disease or trait. In some embodiments, Bayesian posterior effect sizes in one or more diseases or traits is used to explain observed variance in a disease or trait. In some embodiments, Bayesian posterior effect size distributions for one or more diseases or traits is used to compute a polygenic risk score for the a disease or trait. In some embodiments, the polygenic risk score for a disease or trait is used to predict the risk of an individual having a disease or trait. In further embodiments, the predicted risk of an individual have the disease or trait includes confidence intervals indicating the degree of precision of the estimated risk. In some embodiments, distributions of Bayesian posterior effect sizes is used to produce estimates of power for identifying polymorphisms associated with a disease or trait in genetic studies for a given study sample size.

In further embodiments, the present provides a plurality of gene variants identified by the process described herein, wherein the plurality of gene variants are associated with a specific condition.

In yet other embodiments, the present invention provides a method, comprising: a) identifying a plurality of gene variants from a subject associated with a given condition using the process described herein; and b) characterizing one or more conditions in the subject based on the plurality of gene variants. In some embodiments, the method further comprises the step of providing a diagnosis or a prognosis to the subject. In some embodiments, the method further comprises the step of determining a treatment course of action based on the characterizing (e.g., choosing a therapeutic agent and/or choosing a dosage of a therapeutic agent.

In some embodiments, the present invention provides computer implemented processes and methods calculating polygenic personalized risk scores associated with a specific condition, comprising: computing gene variant, (e.g., single nucleotide polymorphisms (SNP)) posterior effect sizes (e.g. by randomly dividing subjects from a given group into disjoint training and replication subsamples); calculating sample mean replication effect sizes conditional on training effect sizes; and determining a polygenic risk score based on the effect sizes. In some embodiments, the polygenic risk score is computed as a linear or nonlinear function of the estimated statistical parameters. In some embodiments, the linear or nonlinear function of the estimated statistical parameters includes per gene variant allele effect size mean and/or estimates of variability. In some embodiments, computing comprises linear weighting of each gene variant by its estimated posterior effect size divided by its estimated posterior variance. In some embodiments, the process further comprises the step of obtaining maximal correlation of genetic risk scores with phenotypes in de novo subject samples by obtaining posterior effect size estimates for each SNP modulated by genie annotations and/or strength of association with pleiotropic phenotypes. In some embodiments, the posterior effect sizes for each gene variant are multiplied by the corresponding gene variant values for a de novo subject and added together to calculate an overall risk score for the condition or the posterior effect sizes for each SNP are scaled by dividing by a measure of its variability before computing the polygenic risk score. In some embodiments, gene variant effect sizes below a given threshold are deleted before computing polygenic risk scores. In some embodiments, the comprises subjects from a single study or collection of studies. In some embodiments, the polygenic personalized risk scores summarize patient-level genomic variation as a single score per subject, summed over assayed gene variants. In some embodiments, the polygenic personalized risk score includes other biomarkers of the condition, for example, including but not limited to, age, gender, family history, or results of diagnostic testing. In some embodiments, the process further comprises the step of predicting the likelihood of an offprising of two parents developing the condition. In some embodiments, predicting comprises the step of randomly simulating multiple offspring and estimating polygenic risk scores for each simulated offspring and using the scores across offspring to predict the likelihood of said offspring developing the condition.

Additional embodiments will be apparent to persons skilled in the relevant art based on the teachings contained herein.

### DESCRIPTION OF THE DRAWINGS

FIG. 1 shows stratified Q-Q plots for schizophrenia conditioned on nominal p-values of association with bipolar disorder.

FIG. 2 shows a conditional Manhattan plot for schizophrenia showing the FDR conditional on bipolar disorder.

FIG. 3 shows a conditional Manhattan plot for bipolar disorder showing the FDR conditional on schizophrenia.

FIG. 4 shows a conjunction Manhattan plot.

FIG. 5 shows stratified Q-Q plots of nominal versus empirical −log 10 p-values of genie vs. intergenic regions, controlling for genomic inflation in schizophrenia (p<5×10-8).

FIG. 6 shows conditional FDR look-up tables.

FIG. 7 shows a) conjunction FDR look-up tables. FIG. 7 b shows Marginal QQ-plot for Schizophrenia (SCZ) and the QQ-plot based on ML estimates for the two-groups mixture model (χ21 null and Weibull non-null for z2). FIG. 7c shows Marginal QQ-plot for BD and the QQ-plot based on ML estimates for the two-groups mixture model (χ21 null and Weibull non-null for z2). FIG. 7d shows Marginal QQ-plot for T2D and the QQ-plot based on ML estimates for the two-groups mixture model (χ21 null and Weibull non-null for z2). FIG. 7e shows Conditional local FDR 2-D look-up table based on ML-estimates of the four-group mixture model (χ21 null and Weibull non-null for z2) for SCZ conditional on BD tail probability thresholds. FIG. 7f shows Conditional local FDR 2-D look-up table based on ML-estimates of the four-group mixture model (χ21 null and Weibull non-null for z2) for BD conditional on SCZ tail probability thresholds. FIG. 7g shows Conditional local FDR 2-D look-up table based on ML-estimates of the four-group mixture model (χ21 null and Weibull non-null for z2) for SCZ conditional on T2D tail probability thresholds. FIG. 7h Conjunction local FDR based on ML-estimates of the four-group mixture model (χ21 null and Weibull non-null for z2) for SCZ and BD. FIG. 7i shows ROC curves for power diagnostics of FDR for SCZ and fdr for SCZ|BD. The x-axis is the estimated local FDR and the y-axis is the estimated proportion of nun-null SNPs exceeding the given fdr or conditional fdr threshold. FIG. 7j shows ROC curves for power diagnostics of FDR for BD and fdr for BD|SCZ. The x-axis is the estimated local FDR and the y-axis is the estimated proportion of nun-null SNPs exceeding the given FDR or conditional fdr threshold. FIG. 7k shows ROC curves for power diagnostics of FDR for SCZ and fdr for SCZ|T2D. The x-axis is the estimated local FDR and the y-axis is the estimated proportion of nun-null SNPs exceeding the given FDR or conditional FDR threshold. FIG. 7l shows ROC curves for power diagnostics of FDR for SCZ and FDR for SCZ|SCZ, using independent split-half samples for cases and controls. The x-axis is the estimated local FDR and the y-axis is the estimated proportion of nun-null SNPs exceeding the given FDR or conditional FDR threshold.

FIG. 8 shows stratified Q-Q plot for height shows enrichment by annotation categories using Linkage-Disequilibrium (LD) weighted scores.

FIG. 9 shows stratified Q-Q plots and true discovery rates show consistency of enrichment. Upper panel: Stratified Q-Q) plots illustrating consistent enrichment of genie annotation categories across diverse phenotypes. (A) Height, (B) Schizophrenia (SCZ), and (C) Cigarettes per Day (CPD). Lower panel: Stratified True Discovery Rate (TDR) plots illustrating the increase in TDR associated with increased enrichment in (D) Height, (E) SCZ and (F) CPD.

FIG. 10 shows categorical enrichment for seven diverse phenotypes.

FIG. 11 shows that independent study replication confirms enrichment in Crohn's disease. (A). Stratified True Discovery Rate (TDR) plots illustrating the increase in TDR associated with increased enrichment. (B) Cumulative replication plot showing the average rate of replication (p<0.05) within sub-studies for a given p-value threshold shows enriched categories replicate at a higher rate in independent samples.

FIG. 12 shows that enrichment improves discovery through stratified false discovery rates (sFDR). Among three phenotypes, (A) Height, (B) Crohn's Disease, (C) and Schizophrenia.

FIG. 13 shows A-F. Enrichment and replication. Upper panel: Stratified Q-Q plot of nominal versus empirical −log 10 p-values (corrected for inflation) in schizophrenia (SCZ) below the standard GWAS threshold of p<5×10-8 as a function of significance of association with A) triglycerides (TG) and B) Waist Hip Ratio (WHR) at the level of −log 10(p)>0, −log 10(p)>1, −log 10(p)>2, −log 10(p)>3 corresponding to p<1, p<0.1, p<0.01, p<0.005, respectively. Dotted lines indicate the nullhypothesis. Middle panel: Stratified True Discovery Rate (TDR) plots illustrating the increase in TDR associated with increased pleiotropic enrichment in C) SCZ conditioned on TG (SCZ|TG), and D) SCZ conditioned on WHR (SCZ|WHR). Lower panel: Cumulative replication plot showing the average rate of replication (p<0.05) within SCZ sub-studies for a given p-value threshold shows that pleiotropic enriched SNP categories replicate at a higher rate in independent SCZ samples, for E) SCZ conditioned on TG (SCZ|TG), and F) SCZ conditioned on WHR (SCZ|WHR). The vertical intercept is the overall replication rate per category.

FIG. 14 shows a conditional Manhattan plot of conditional −log 10 (FDR) values for schizophrenia (SCZ) alone (grey) and SCZ given the cardiovascular disease risk factors triglycerides (TG: SCZ|TG, red), Low density Lipoprotein cholesterol (LDL; SCZ|LDL, yellow), High density Lipoprotein cholesterol (HDL, SCZ|HDL blue), systolic blood pressure (SCZ|SBP, green), body mass index (SCZ|BMI, purple), waist hip ratio (SCZ|WHR, mustard), type 2 diabetes (SCZ|T2D, blue).

FIG. 15 shows stratified Q-Q plots of nominal versus empirical −log 10 p-values of genie vs. intergenic regions, controlling for genomic inflation in schizophrenia (p<5×10⁻⁸).

FIG. 16 shows that Z-score-z-score plot in schizophrenia (SCZ) demonstrate that the empirical replication z-scores closely match the expected a posteriori effect sizes and are strongly dependent upon pleiotropy with triglycerides (TG).

FIG. 17 shows conditional FDR look-up tables.

FIG. 18 shows conjunction FDR look-up tables.

FIG. 19 shows a conjunction Manhattan plot of conjunction −log 10 (FDR) values for schizophrenia (SCZ) and the cardiovascular disease (CVD) risk factors triglycerides (TG; SCZ&TG, red), Low density Lipoprotein cholesterol (LDL; SCZ&LDL, yellow), High density Lipoprotein cholesterol (HDL, SCZ&HDL blue), systolic blood pressure (SCZ&SBP, green), body mass index (SCZ&BMI, purple), waist hip ratio (SCZ&WHR, mustard), type 2 diabetes (SCZ&T2D, blue).

FIG. 20 shows an overview of exemplary systems and methods of the present disclosure.

FIG. 21 shows improved prediction of phenotypic variance SCZ using systems of embodiments of the present disclosure.

FIG. 22 shows estimated r2 LD for all GWAS tag SNP in the 1KGP with all SNPs within 1 megabase.

FIG. 23 shows (A) Heat map displaying the Spearman's correlation coefficients among continuous valued LD-weighted annotation scores. (B) Heat map displaying the Spearman's correlation coefficients among thresholded and binarized annotation categories presented in Q-Q plots.

FIG. 24 shows Q-Q plot showing enrichment of genie annotation categories using positional scores (non LD-weighted)

FIG. 25 shows (A) Q-Q plot of height without correction for genomic inflation. (B) Q-Q plot of height after correction for genomic inflation using the ‘intergenic inflation control’.

FIG. 26 shows that the mean(z-score2 −1) for each category of SNPs per phenotype reveals consistent enrichment across fourteen phenotypes. BD, Bipolar Disorder; BMI, Body Mass Index; CD, Crohn's disease; CPD, Cigarettes per Day; DBP, Diastolic blood pressure; HDL, High density lipoprotein; LDL, Low density lipoprotein; SBP, systolic blood pressure; SCZ, Schizophrenia; TC, total Cholesterol; TG, triglycerides; UC, Ulcerative Colitis; WHR, Waist-hip-ratio.

FIG. 27 shows mixture model fits for all SNPs for Crohn's disease.

FIG. 28 shows mixture model fits for each annotation category for Crohn's disease.

FIG. 29 shows (A) Expected a posteriori estimates of effect size for a given observed z-score. (B) Z-score-z-score plot demonstrates the empirical replication z-scores closely match the expected a posteriori effect sizes and are strongly dependent upon genie annotation category.

FIG. 30 shows Q-Q plot enrichment for the regression based strata for (A) Height, (B) Crohn's Disease (CD), and (C) Schizophrenia (SCZ).

FIG. 31 shows that for a given SNP rank threshold (i.e., top 500 SNPs), those ranked by the genie annotation category-informed stratified FDR show a greater absolute number of replications, and thus a greater rate of replication, when compared to the annotation un-informed standard FDR.

FIG. 32 shows the original stratified QQ-plots for height (A), Schizophrenia (B), and Cigarettes per day (C) using LD-weighted annotation categories created from an LD matrix describing the pairwise correlation between each GWAS SNP and all 1000 SNPs (described above) including r2 values greater than 0.2 and within 1 of the target GWAS SNP show a qualitatively similar pattern of enrichment when the scoring parameters are changed to include all pairwise r2 values greater than 0.05 and within 2 megabases (Height, D; Schizophrenia, E; Cigarettes per day, F).

FIG. 33 shows the patterns among the mean(z-score2 −1) for each category of SNPs per phenotype is robust to LD-weighted annotation scoring parameters.

FIG. 34 shows a regenerated the cumulative replication plot showing the average rate of replication (p<0.05) within independent sub-studies for a given p-value.

FIG. 35 shows for height the mean (z2) of each category as the threshold for inclusion for both the original (A; including r2>0.2 and within 1 megabases), and alternate (B; r2>0.05 and within 2 megabases) parameters for LD weighted scoring.

FIG. 36 shows a Q-Q Plot for Height (left panel) and Crohn's Disease (right panel).

FIG. 37 shows a predicted Q-Q Plot, for Crohn's Disease (CD; solid black line) from parametric Weibull mixture model fit.

FIG. 38 shows a predicted Q-Q Plot for Crohn's Disease (CD; solid black line) from parametric Weibull mixture model fit.

FIG. 39 shows a cumulative replication plot, showing the average replication rate (y-axis), defined as P<0.05 in the replication sample and the same sign in both discovery and replication samples, for schizophrenia (SCZ) substudies, for a range of discovery P value thresholds (x-axis).

FIG. 40 shows a Q-Q plot of enrichment by functional annotation category for Crohn's Disease.

FIG. 41 shows null and non-null distributions.

FIG. 42 shows a histogram of Crohn's disease absolute z-scores.

FIG. 43 shows power of fdr vs. cmfdr.

FIG. 44 shows genetic pleiotropy enrichment of SCZ conditional on MS. (a) Conditional Q-Q plot of nominal versus empirical −log 10 p-values (corrected for inflation) in schizophrenia (SCZ) below the standard GWAS threshold of p<5×10-8 as a function of significance of association with multiple sclerosis (MS) at the level of −log 10(p)≧0, −log 10(p)≧1, −log 10(p)≧2, −log 10(p)≧3 corresponding to p≦1, p≦0.1, p≦0.01, p≦0.001, respectively, (b) Conditional True Discovery Rate (TDR) plots illustrating the increase in TDR associated with increased pleiotropic enrichment in SCZ conditioned on MS (SCZ|MS). (c) Cumulative replication plot showing the average rate of replication (p<0.05) within SCZ sub-studies for a given pvalue threshold shows that pleiotropic enriched SNP categories replicate at a higher rate in independent SCZ samples, for SCZ conditioned on MS (SCZ|MS). (d) Z-score-z-score plot demonstrates that the empirical replication z-scores closely match the expected a posteriori effect sizes of schizophrenia (SCZ) and are strongly dependent upon pleiotropy with multiple sclerosis (MS).

FIG. 45 shows genetic pleiotropy enrichment, of BD conditional on MS. (a) Conditional Q-Q plot of nominal versus empirical −log 10 p-values (corrected for inflation) in bipolar disorder (BD) below the standard GWAS threshold of p<5×10-8 as a function of significance of association with multiple sclerosis (MS) at the level of −log 10(p)≧0, −log 10(p)≧1, −log 10(p)≧2, −log 10(p)≧3 corresponding to p≦5, p≦0.1, p≦0.01, p≦0.001, respectively, (b) Conditional True Discovery Rate (TDR) plots illustrating the increase in TDR associated with increased pleiotropic enrichment in BD conditioned on MS (BD|MS).

FIG. 46 shows a ‘Conditional FDR Manhattan plot’.

FIG. 47 shows a conditional Q-Q plot with 95% confidence interval of expected versus observed −log 10(p)-values in schizophrenia (SCZ) as a function of significance of association with multiple sclerosis (MS) at the level of: −log 10(p)≧1, −log 10(p)≧2, −log 10(p)≧3 and −log 10(p)≧4 compared with −log 10(p)≧0.

FIG. 48 shows a censored conditional Q-Q plot with 95% confidence interval of expected versus observed −log 10(p)-values in schizophrenia (SCZ) as a function of significance of association with multiple sclerosis (MS) at the level of: −log 10(p)>1, −log 10(p)>2, −log 10(p)>3, and −log 10(p)>4 compared with −log 10(p)>0.

FIG. 49 shows a.) Conditional Q-Q plot of nominal versus empirical −log 10 p-values (corrected for inflation) in schizophrenia (SCZ) below the standard GWAS threshold of p<5×10-8 as a function of significance of association with multiple sclerosis (MS) at the level of −log 10(p)≧0, −log 10(p)≧1, −log 10(p)≧2, −log 10(p)≧3, −log 10(p)≧4, −log 10(p)≧5 and −log 10(p)≧6 corresponding to p≦1, p≦0.1, p≦0.01, p≦0.001, p≦0.0001, p≦0.00001, p≦0.000001, respectively, b.) Conditional True Discovery Rate (TDR) plots illustrating the increase in TDR associated with increased pleiotropic enrichment in SCZ conditioned on MS (SCZ|MS). c.) Cumulative replication plot showing the average rate of replication (p<0.05) within SCZ sub-studies for a given p-value threshold shows that pleiotropic enriched SNP categories replicate at a higher rate in independent SCZ samples, for SCZ conditioned on MS (SCZ|MS). d.) Z-score-z-score plot, demonstrates that the empirical replication z-scores closely match the expected a posteriori effect sizes of schizophrenia (SCZ) and are strongly dependent upon pleiotropy with multiple sclerosis (MS).

FIG. 50 shows a.) The SNPs from 1000 Genome data which correspond to the common SNPs between SCZ and MS in the current study were extracted and stratified by the significant level of MS (x axis), b.) The 1000 Genome SNPs which corresponds to the common SNPs between SCZ and T2D were extracted and stratified by the significant level of T2D (x axis), c.) The conditional Q-Q plots of SCZ conditioning on T2D.

FIG. 51 shows the association of the SNPs (y axis) with SCZ as investigated by logistic regression with study indicator variables and the first 5 principal components as covariate, without conditioning (Un-conditioned) and conditioning on each HLA allele (x axis) separately.

FIG. 52 shows a conditional Q-Q plot of nominal versus empirical −log 10 p-values (corrected for inflation) in Schizophrenia (SCZ) and Bipolar disorder (BD) below the standard GWAS threshold of p<5×10-8 as a function of significance of association with multiple sclerosis (MS) at the level of −log 10(p)≧0, −log 10(p)≧1, −log 10(p)≧2, −log 10(p)≧3 corresponding to p≦1, p≦0.1, p≦0.01, p≦0.001, respectively, after removing a.) SCZ SNPs located within the MHC region and other SNPs in LD (r2>0.2) with such SNPs, b.) SCZ SNPs located within MHC region genes whose alleles are studied in the current study and other SNPs in LD (r2>0.2) with such SNPs, c.) BD SNPs located within the MHC region and other SNPs in LD (r2>0.2) with such SNPs, d.) BD SNPs located within MHC region genes whose alleles are studied in the current study and other SNPs in LD (r2>0.2) with such SNPs, Dotted lines indicate the null-hypothesis.

FIG. 53 shows conditional Q-Q plots of nominal versus empirical −log 10 p-values (corrected for inflation) in a.) Autism spectrum disorder (AUT), b.) Major depressive disorder (MDD) and c.) Attention-deficit/hyperactivity disorder (ADHD) below the standard GWAS threshold of p<5×10-8 as a function of significance of association with multiple sclerosis (MS) at the level of −log 10(p)≧0, −log 10(p)≧1, −log 10(p)≧2, −log 10(p)≧3 corresponding to p≦1, p≦0.1, p≦0.01, p≦0.001, respectively.

FIG. 54 shows a conditional Q-Q plot of nominal versus empirical −log 10 p-values (corrected for inflation) in Bipolar disorder (BD) below the standard GWAS threshold of p<5×10-8 as a function of significance of association with schizophrenia (SCZ) at the level of −log 10(p)≧0, −log 10(p)≧1, −log 10(p)≧2, −log 10(p)≧3 corresponding to p≦1, p≦0.1, p≦0.01, p≦0.001, respectively.

FIG. 55 shows Q-Q plots of pleiotropic enrichment in SBP conditioned on associated phenotypes. Conditional Q-Q plot of nominal versus empirical −log 10 p-values (corrected for inflation) in systolic blood pressure (SBP) below the standard GWAS threshold of p<5×10-8 as a function of significance of association with A) Low density lipoprotein cholesterol (LDL), B) body mass index (BMI), C) bone mineral density (BMD), D) type 1 diabetes (T1D), E) schizophrenia (SCZ) and F) celiac disease (CeD)

FIG. 56 shows a ‘Conditional FDR Manhattan plot’ of conditional −log 10 values for Systolic Blood Pressure (SBP) alone and SBP given the associated phenotypes low density lipoprotein cholesterol (LDL; SBP|LDL), body mass index (BMI; SBP|BMI, orange), bone mineral density (BMD; SBP|BMD), type 1 diabetes (T1D; SBP|T1D), schizophrenia (SCZ; SBP|SCZ) and celiac disease (CeD; SBP|CeD).

### DEFINITIONS

To facilitate an understanding of the present invention, a number of terms and phrases are defined below:

As used herein, the term “sensitivity” is defined as a statistical measure of performance of an assay (e.g., method, test), calculated by dividing the number of true positives by the sum of the true positives and the false negatives.

As used herein, the term “specificity” is defined as a statistical measure of performance of an assay (e.g., method, test), calculated by dividing the number of true negatives by the sum of true negatives and false positives.

As used herein, the term “informative” or “informativeness” refers to a quality of a marker or panel of markers, and specifically to the likelihood of finding a marker (or panel of markers) in a positive sample.

As used herein, the term “amplicon” refers to a nucleic acid generated using one or more primers (e.g., two primers). The amplicon is typically single-stranded DNA (e.g., the result of asymmetric amplification), however, it may be RNA or dsDNA.

The term “amplifying” or “amplification” in the context of nucleic acids refers to the production of multiple copies of a polynucleotide, or a portion of the polynucleotide, typically starting from a small amount of the polynucleotide (e.g., a single polynucleotide molecule), where the amplification products or amplicons are generally detectable.

As used herein, the term “primer” refers to an oligonucleotide, whether occurring naturally as in a purified restriction digest or produced synthetically, that is capable of acting as a point of initiation of synthesis when placed under conditions in which synthesis of a primer extension product that is complementary to a nucleic acid strand is induced (e.g., in the presence of nucleotides and an inducing agent such as a biocatalyst (e.g., a DNA polymerase or the like) and at a suitable temperature and pH). The primer is typically single stranded for maximum efficiency in amplification, but may alternatively be double stranded. If double stranded, the primer is generally first treated to separate its strands before being used to prepare extension products, in some embodiments, the primer is an oligodeoxyribonucleotide. The primer is sufficiently long to prime the synthesis of extension products in the presence of the inducing agent. The exact lengths of the primers will depend on many factors, including temperature, source of primer and the use of the method. In certain embodiments, the primer is a capture primer.

A “sequence” of a biopolymer refers to the order and identity of monomer units (e.g., nucleotides, etc.) in the biopolymer. The sequence (e.g., base sequence) of a nucleic acid is typically read in the 5′ to 3′ direction.

As used herein, the term “subject” refers to any animal (e.g., a mammal), including, but not limited to, humans, non-human primates, rodents, and the like, which is to be the recipient of a particular treatment. Typically, the terms “subject” and “patient” are used interchangeably herein in reference to a human subject.

As used herein, the term “non-human animals” refers to all non-human animals including, but are not limited to, vertebrates such as rodents, non-human primates, ovines, bovines, ruminants, lagomorphs, porcines, caprines, equines, canines, felines, aves, etc.

The term “locus” as used herein refers to a nucleic acid sequence on a chromosome or on a linkage map and includes the coding sequence as well as 5′ and 3′ sequences involved in regulation of the gene.

In the present context the term “psychiatric disease” refers to brain disorders with a psychological or behavioral pattern that occurs in an individual and cause distress or disability that is not expected as part of normal development or culture, including symptoms related to behavior, emotion, cognition, perception, thought disorder. Non-limiting examples of psychiatric diseases are schizophrenia, other psychotic disorders, depression, bipolar disorder, depression, anxiety, OCD, Personality disorders, PTSD, Alzheimer's disease, eating disorders, child psychiatry disorders.

In the present context the term “neurological disease” refers to brain disorders involving the central, peripheral, and autonomic nervous systems, including their coverings, blood vessels, and all effector tissue, such as muscle, with primarily symptoms related to movement, but often other symptoms in addition, such as memory impairment, fatigue, pain, sensitivity abnormalities. Non-limiting examples of neurological diseases are stroke, epilepsy, neurodegenerative disorders, headache, multiple sclerosis.

As used herein, the term “gene variant” refers to any change in nucleotide sequence or dosage within a gene relative to the native or wild type sequences or copy number. Examples include, but are not limited to, mutations, single nucleotide polymorphisms (SNPs), copy number variants, deletions, inversions, duplications, splice variants, or haplotypes.

In the present, context the term “genotype information” refers information which can be obtained from the genome of an individual. Thus, genotype information may only be information from, part of the whole genome of the person. Non-limiting examples of genotype information which can be used in the present methods include SNPs (single-nucleotide polymorphisms), copy number variants (CNV), deletions, inversions, duplications, sequence variants, haplotypes. Preferably the genotype information obtained from a person are SNP's. Thus, in the present description, genotype information is used as a generic term for various genetic polymorphisms.

In the present context the phrase “SNP dose” refers to the number of times a specific SNP is present. Thus, for an individual the SNP dose can be 0, 1 or 2, meaning that a SNP dose of 0 means the specific SNP is not present in any of the two alleles, whereas a SNP dose of 1 means the SNP is present in one of the two alleles and a SNP dose of 2 means that the SNP is present on both alleles.

### DETAILED DESCRIPTION OF THE INVENTION

The present invention relates to processes, systems and methods for estimating the effects of genetic polymorphisms associated with traits and diseases, based on distributions of observed effects across multiple loci. In particular, the present invention provides systems and methods for analyzing genetic variant data including estimating the proportion of polymorphisms truly associated with the phenotypes of interest, the probability that a given polymorphism has a true association with the phenotypes of interest, and the predicted effect size of a given genetic variant in independent de novo samples given effect size distributions in observed samples. The present invention also relates to using the described systems and methods and use of genetic polymorphisms across a plurality of loci and a plurality of phenotypes to diagnose, characterize, optimize treatment and predict diseases and traits.

### I. Analysis Systems and Methods

Embodiments of the present invention provide processes, systems, and methods (e.g., computer implemented) for analysis of gene variant data and characterization of conditions. The below description is exemplified with SNPs. However, the systems and methods described herein find use in the analysis of any type of gene variant. Examples of gene variants include, but are not limited to, mutations, single nucleotide polymorphisms (SNPs), copy number variants, deletions, inversions, duplications, splice variants, or haplotypes.

In the present study the power of GWAS data was leveraged to demonstrate how GWAS from disorders can improve discovery of novel susceptibility loci. Using standard GWAS analytical methods, only one significant locus was identified. By applying the stratified FDR method (Yoo et al, (2009) BMC Proc 3 Suppl 7: S103; Sun et al., (2006) Genet Epidemiol 30:519-530), an additional 7 loci (2 in bipolar disorder, 5 in schizophrenia) were found. Combining the independent schizophrenia and bipolar disorder GWAS samples, a total of 58 loci were identified in schizophrenia and 35 in bipolar disorders, with FDR<0.05 as a threshold. These results demonstrate the feasibility of using a cost-effective, pleiotropy-informed stratified FDR approach to discover common variants in schizophrenia and bipolar disorders.

The current statistical framework is based on the fact that SNPs are not interchangeable. Rather, a SNP with effects in two associated phenotypes has a higher probability of being true nonnulls, and hence also a higher probability of being replicated in independent studies. A conditional FDR approach was developed for GWAS summary statistics, adapting stratification methods originally used for linkage analysis and microarray expression data (Yoo et al, (2009) BMC Proc 3 Suppl 7: S103; Sun et al., (2006) Genet Epidemiol 30:519-530). Decreased conditional FDR (equivalently, increased conditional TDR) for a given nominal p-value increases power to detect true non-null effects. Increased conditional TDR is directly related to increased replication effect sizes and replication rates in de novo samples. Using this stratified approach, it was possible to increase power to detect true non-null signals in independent studies for given nominal p-values cut-offs. Equivalently, in the stratified approach the FDR can be used to control FDR at a given level while increasing power to discover non-null SNPs over approaches that treat all SNPs as interchangeable (Craiu R V, Sun L (2008) Statistica Sinica 18: 861-879). A conjunction FDR approach was developed to investigate which SNPs are pleiotropic. SNPs that exceed a stringent, conjunction FDR threshold are highly likely to be non-null in two phenotypes simultaneously.

The current findings of polygenic enrichment indicate that genetic pleiotropy is important in severe mental disorders. However, the datasets utilized herein are exemplary. The present disclosure is not limited to a particular condition or disorder. By using a stratified FDR approach, it was possible to leverage the overlapping polygenetic architecture to identify more of the specific SNPs involved. The current approach identified 58 loci in schizophrenia compared to 7 in the original publication. In bipolar disorder, the added power from schizophrenia GWAS identified 35 loci compared to two loci in the original study. It is important to note that this improvement in gene discovery was obtained despite the much smaller number of controls in the current analyses because the original analyses of the two disorders used largely overlapping control samples. Since 1KGP data was used to calculate LD structure, the number of loci can vary somewhat compared to the original analysis. For both disorders, most of the current findings were borderline significant in the original GWAS mega-analysis, or identified in other GWAS of partly overlapping samples, such as TRANK1 and SYNE1.

The current findings provide genes and polymorphisms related to bipolar disorder and schizophrenia. However, the processes, systems, and methods described herein find use in the characterization of a variety of disorder and conditions.

In some embodiments, the present invention provides processes, systems, and methods for analyzing gene variant data, identifying gene variants useful for characterizing and diagnosing conditions and diseases. In some embodiments, the process comprises, a computer implemented process, system, or method of identifying polymorphisms associated with a specific condition, comprising at least one of: a) inputting polymorphism information for a plurality of gene variants (e.g., single nucleotide polymorphisms (SNPs)0: b) assigning a linkage disequilibrium (LD) score to each gene variant; c) testing each SNP for enrichment using a Q-Q score; d) assigning a FDR to each gene variant using a look up table; e) performing a baysesian analysis on a combination all enriching factors; f) applying a regression model to combine information; and g) identifying gene variants associated with the condition. In some embodiments, identifying comprises listing identified SNPs in a priority order. In some embodiments, the LD assigns each of the gene variants to a functional category. In some embodiments, the Q-Q score provides a true discovery rate and a FDR for each gene variant. In some embodiments, the FDR for a specific gene variant is defined as the nominal p-value divided by the empirical quantile. In some embodiments, gene variants with false discovery rates less than 0.01 are defined as associated with the condition. In some embodiments, Q-Q scores are plotted as Q-Q plots. In some embodiments, Q-Q plots identify pleiotropic enrichment. In some embodiments, polymorphism information is obtained from at least 2 subjects. In some embodiments, polymorphism information comprises at least 1000, 5000, or 10,000 or more individual SNPs. In some embodiments, gene variants are intergenic. In some embodiments, the method further comprises the step of plotting false discovery rates within a LD block in relation of their chromosomal location. In some embodiments, the condition is, for example, a disease, a trait, a response to a particular therapeutic agent, or a prognosis, although other conditions are specifically contemplated.

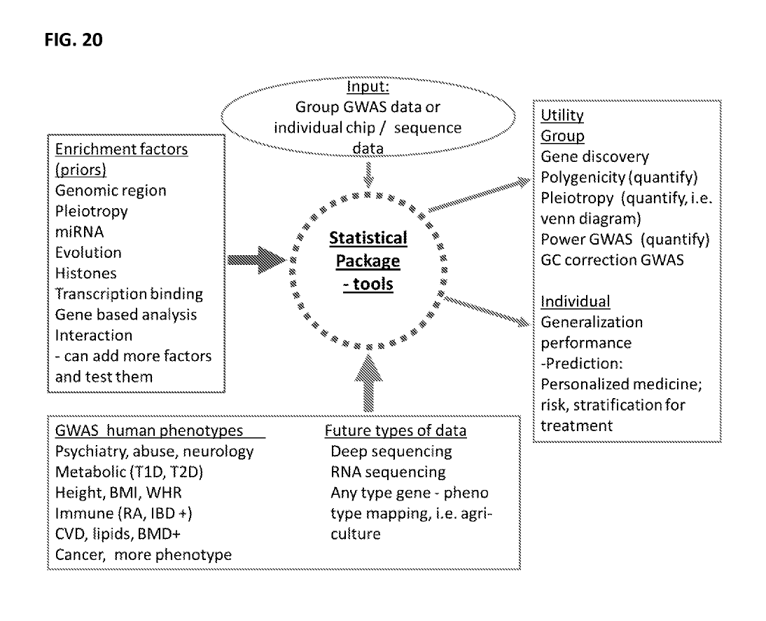

FIG. 20 shows a general overview of the systems and methods of embodiments of the present invention. The systems and methods provide the advantages of treating the genome as one functional unit (e.g. to use unthresholded information about all SNPs), and placing SNPs into categories that are enriched (e.g., more likely to be true), and quickly and reliably analyze large amounts of data (e.g., millions of SNPs) and provide knowledge about genotype-phenotype associations (e.g., gene effects) both in groups and individuals.

In some embodiments, systems and methods utilize the following steps as illustrated in FIG. 20. Embodiments of the present invention are illustrated using schizophrenia. However, the present invention is not limited to the identification of polymorphisms in schizophrenia. The systems and methods described herein find use in the analysis of a variety of diseases and traits. Below is an exemplary description of methods and systems of embodiments of the present disclosure.

1) The first step is to input the GWAS data of a particular train or disease as one data file or individual chip/sequence data. The data file includes the p-values (the significance of association with disease) for each SNPs from the GWAS (this can be original chipped SNPs or imputed SNPs). In some embodiments, raw data (e.g., unthresholded SNP list) is used.

2) Each SNPs is then annotated to the most recent catalogue of the human genome, such as 1000 genomes project (1KGP) for the ethnic group in question—so far most data are from Caucasians. In some embodiments, more detailed human genome variation maps for specific populations are used. In some embodiments, Linkage disequilibrium based annotation is used.

3) Obtain information about the enrichment factor (prior) from the literature or public databases, such as location of the SNP within a region of the genome. Several enrichment factors, such as, for example, regulatory regions of a gene, exons (coding region of the gene), microRNA binding sites and evolutionary measures, are used, although others may be utilized. Some of these are general for most phenotypes, while some vary between phenotypes. Another enrichment factor is associated or co-morbid phenotypes. For example, it was shown how SNPs associated with bipolar disorder greatly increase the signal in schizophrenia.

4) The statistical package includes tools according to the utility. In some embodiments, model-free methods or model-based analysis is used. The model-based tool is useful for quantification. In short, Q-Q plots were used to visualize enrichment, and to aid in obtaining TDR values for the SNPs and increase replication rate. One can then calculate a FDR value for each SNP, after using a look-up table. The FDR value for each SNP is the output of the package, and a much improved tool for gene discovery is provided (very strong improvement in schizophrenia, 4-5 times more genes), discovery of overlapping genes (pleiotropy, e.g., between CVD risk and schizophrenia) etc.

5) In some embodiments, the model-based tools are used for improving technical calculations of the GWAS, such as correcting for inflation (Genomic Control), for calculating power, and for quantification of overlap between phenotypes (and identification of the SNPs involved in the overlap), and for estimating the polygenicity of a trait (how many genes have an effect, 1000-10000).

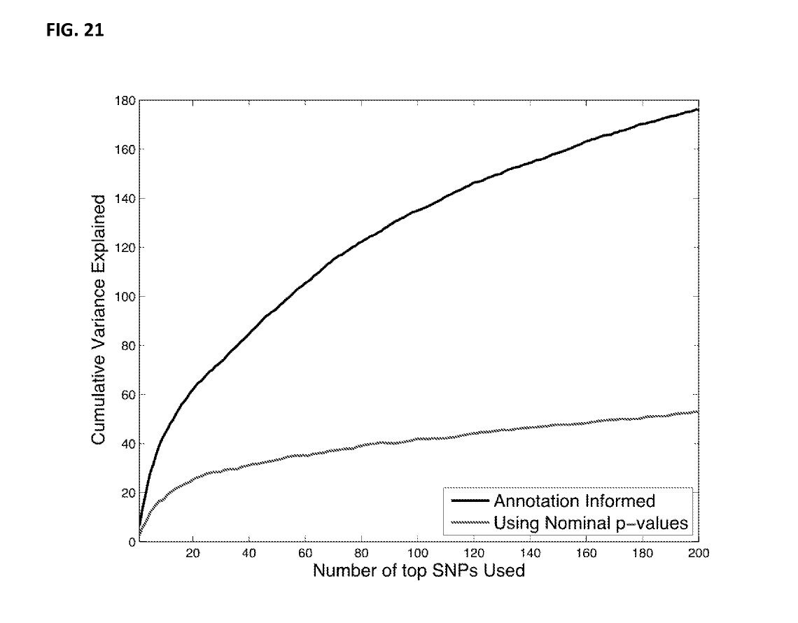

6) In some embodiments, a regression tool it used to combine all the enrichment factors including pleiotropic enrichment. This tool produces a FDR value for each SNP for the phenotype in question. In some embodiments, this forms the basis of the tool used for generalization performance (e.g., prediction of individuals based on their GWAS or deep sequencing profile). It was shown that the generalization performance increase 3-4 times compared to standard tools (See e.g., FIG. 21).

7) In some embodiments, systems and methods include updates on gene function (e.g., enrichment factors, system for continuous updates when new information becomes available), and all available GWAS studies (e.g., human traits of disorders, anonymous summary statistics, new GWAS as they become available), and a script for each utility. For example, some exemplary applications include: i) providing FDR values to new GWAS to improve discovery, and all the technical information needed (e.g., GC correction, power, etc) and providing pleiotropy information with all available phenotypes; ii) taking two new GWAS from two phenotypes and providing information about pleiotropy measures between the new phenotypes in addition; iii) taking deep sequencing data and providing information; and iv) providing an estimate of risk for specific phenotypes using a GWAS from an individual person.

The present invention also provides a variety of computer-related embodiments. Specifically, in some embodiments the invention provides computer programming for analyzing and comparing polymorphism to identify and characterize conditions.

The methods and systems described herein can be implemented in numerous ways. In one embodiment, the methods involve use of a communications infrastructure, for example the internet. Several embodiments of the invention are discussed below. It is also to be understood that the present invention may be implemented in various forms of hardware, software, firmware, processors, distributed servers (e.g., as used in cloud computing) or a combination thereof. The methods and systems described herein can be implemented as a combination of hardware and software. The software can be implemented as an application program tangibly embodied on a program storage device, or different portions of the software implemented in the user's computing environment (e.g., as an applet) and on the reviewer's computing environment, where the reviewer may be located at a remote site (e.g., at a service provider's facility).

For example, during or after data input by the user, portions of the data processing can be performed in the user-side computing environment. For example, the user-side computing environment can be programmed to provide for defined test codes to denote platform, carrier/diagnostic test, or both; processing of data using defined flags, and/or generation of flag configurations, where the responses are transmitted as processed or partially processed responses to the reviewer's computing environment in the form of test code and flag configurations for subsequent execution of one or more algorithms to provide a results and/or generate a report in the reviewer's computing environment.

The application program for executing the algorithms described herein may be uploaded to, and executed by, a machine comprising any suitable architecture. In general, the machine involves a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

As a computer system, the system generally includes a processor unit. The processor unit operates to receive information, which generally includes test data (e.g., specific gene products assayed), and test result data, (e.g., the pattern of gastrointestinal neoplasm-specific marker detection results from a sample). This information received can be stored at least temporarily in a database, and data analyzed in comparison to a library of marker patterns known to be indicative of the presence or absence of a condition.

Part or all of the input and output data can also be sent electronically; certain output data (e.g., reports) can be sent electronically or telephonically (e.g., by facsimile, e.g., using devices such as fax back). Exemplary output receiving devices can include a display element, a printer, a facsimile device and the like. Electronic forms of transmission and/or display can include email, interactive television, and the like. In some embodiments, all or a portion of the input data and/or all or a portion of the output data (e.g., diagnosis or characterization of a condition) are maintained on a server for access, e.g., confidential access. The results may be accessed or sent to professionals as desired.

A system for use in the methods described herein generally includes at least one computer processor (e.g., where the method is carried out in its entirety at a single site) or at least two networked computer processors (e.g., where detected marker data for a sample obtained from a subject is to be input by a user (e.g., a technician or someone performing the assays)) and transmitted to a remote site to a second computer processor for analysis detection results is compared to a library of patterns known to be indicative of the presence or absence of a disease or condition, where the first and second computer processors are connected by a network, e.g., via an intranet or internet). The system can also include a user component(s) for input; and a reviewer component(s) for review of data, and generation of reports. Additional components of the system can include a server component(s); and a database(s) for storing data (e.g., as in a database or report), or a relational database (RDB) which can include data input by the user and data output. The computer processors can be processors that are typically found in personal desktop computers (e.g., IBM, Dell, Macintosh), portable computers, mainframes, minicomputers, tablet computer, smart phone, or other computing devices.

The input components can be complete, stand-alone personal computers offering a full range of power and features to ran applications. The user component usually operates under any desired operating system and includes a communication element (e.g., a modem or other hardware for connecting to a network using a cellular phone network, Wi-Fi, Bluetooth, Ethernet, etc.), one or more input devices (e.g., a keyboard, mouse, keypad, or other device used to transfer information or commands), a storage element (e.g., a hard drive or other computer-readable, computer-writable storage medium), and a display element (e.g., a monitor, television, LCD, LED, or other display device that conveys information to the user). The user enters input commands into the computer processor through an input device. Generally, the user interface is a graphical user interface (GUI) written for web browser applications.

The server component(s) can be a personal computer, a minicomputer, or a mainframe, or distributed across multiple servers (e.g., as in cloud computing applications) and offers data management, information sharing between clients, network administration and security. The application and any databases used can be on the same or different servers. Other computing arrangements for the user and server(s), including processing on a single machine such as a mainframe, a collection of machines, or other suitable configuration are contemplated. In general, the user and server machines work together to accomplish the processing of the present invention.

Where used, the database(s) is usually connected to the database server component and can be any device which will hold data. For example, the database can be any magnetic or optical storing device for a computer (e.g., CDROM, internal hard drive, tape drive). The database can be located remote to the server component (with access via a network, modem, etc.) or locally to the server component.

Where used in the system and methods, the database can be a relational database that is organized and accessed according to relationships between data items. The relational database is generally composed of a plurality of tables (entities). The rows of a table represent records (collections of information about separate items) and the columns represent fields (particular attributes of a record). In its simplest conception, the relational database is a collection of data entries that “relate” to each other through at least one common field.

Additional workstations equipped with computers and printers may be used at point of service to enter data and, in some embodiments, generate appropriate reports, if desired. The computers) can have a shortcut (e.g., on the desktop) to launch the application to facilitate initiation of data entry, transmission, analysis, report receipt, etc. as desired.

### II. Diagnostic and Screening Applications

Embodiments of the present invention provide diagnostic, prognostic, and screening compositions, kits, and methods. In some embodiments, compositions, kits, and methods characterize and diagnose diseases and traits using one or more polymorphisms identified using the systems and methods described herein.

Embodiments of the present invention provide compositions and methods for detecting polymorphisms in one or more genes (e.g., to identity or diagnose diseases and traits). The present invention is not limited to particular variants. Exemplary variants for several traits are described in Examples 1-3, although the systems and methods described herein find use in the identification of polymorphisms in additional diseases and traits.

In some embodiments, 1 or more (e.g., 2, 3, 4, 5, 6, 7, 8, 9, 10, 15, 20, 30, 40, 50, 100, 1000, 5000, or more) gene variants associated with a given disease or trait are utilized to diagnose or characterize a condition. The specific number of necessary, useful, or sufficient to diagnose or characterize a given trait can vary based on posterior effect sizes of the gene variants or the pleiotropy of the condition being diagnosed and characterized. The system and methods described herein find use in identifying the number of polymorphisms necessary, useful, or sufficient for diagnosing or characterizing a given condition.

In some embodiments, the systems and method described herein identify particular combinations of markers that show optimal function with different ethnic groups or sex, different geographic distributions, different stages of disease, different degrees of specificity or different degrees of sensitivity. Particular combinations may also be developed which are particularly sensitive to the effect of therapeutic regimens on disease progression (e.g., to customize treatment). Subjects may be monitored after a therapy and/or course of action to determine the effectiveness of that specific therapy and/or course of action.

In some embodiments, the present, invention provides information that indicates if a particular individual is predisposed to a particular disease or trait. In some embodiments, the present invention provides information useful in determining a treatment course of action (e.g., determining a particular drug or treatment regimen that is customized to the individual).

In some embodiments, the systems and methods described herein find use in research applications (e.g., in the analysis of polymorphism information to identify markers or identify pleiotropy information).

In some embodiments, the present invention provides systems and method for computation of polygenic personalized risk scores leveraging linkage disequilibrium (LD) genie annotation scores employing the statistical methodology described herein. In some embodiments, gene variant (e.g., single nucleotide polymorphisms (SNP)) posterior effect sizes are computed by repeatedly and randomly dividing subjects from a given study or collection of studies into disjoint training and replication subsamples and computing sample mean replication effect sizes conditional on training effect sizes. In some embodiments, computation of polygenic risk scores leverages pleiotropic effects with other traits. In some embodiments, computation of polygenic risk scores leverages LD genie annotation scores and pleiotropy simultaneously. In some embodiments, computation of polygenic risk scores leverages other types of prior information.

In some embodiments, genetic personalized risk scores summarize patient-level genomic variation as a single score per subject, summed over assayed gene variants. The polygenic risk score is computed as a linear or nonlinear function of the estimated statistical parameters, including per SNP allele effect size mean and/or estimates of variability. In some embodiments, linear weighting of each gene variant by its estimated posterior effect size optionally divided by its estimated posterior variance, given the observed association statistics with a given complex phenotype or disease diagnosis is utilized. In some embodiments, statistical methods are utilized to obtain maximal correlation of genetic risk scores with phenotypes in de novo subject samples, by obtaining posterior effect size estimates for each gene variant modulated by genie annotations and/or strength of association with pleiotropic phenotypes. In some embodiments, posterior effect sizes for each gene variant are multiplied by the corresponding gene variant values for a de novo subject and added together to calculate an overall risk score for a given trait or illness. In other embodiments, the posterior effect size for each gene variant are scaled by dividing by a measure of its variability before computing the polygenic risk score. In some embodiments, gene variant effect sizes below a given threshold are deleted before computing polygenic risk scores.

In some embodiments, polygenic risk scores also include other biomarkers of complex phenotypes or disease diagnosis. Other biomarkers of risk include, but are not limited to, age, gender, family history of illness, brain imaging phenotypes, etc.

In some embodiments, the statistical methodology leverages LD-weighted annotation scores and pleiotropic associations to compute polygenic normative variation scores, accounting for non-risk related genetic variation in complex phenotypes. Non-risk related variation in genotypes is genotypic variation correlated with (and hence predictive of) normal phenotypic variation in a complex phenotype. Variation in non-risk related genotypic variation is used to compute a single personalized non-risk genetic score per subject, summed over assayed non-risk gene variants. Each gene variant is weighted by its estimated posterior effect size and divided by its estimated posterior variance, given the observed association statistics with a given complex phenotype. In some embodiments, non-risk related genetic scores are used to determine phenotypic and/or developmental norms for subjects with specific genetic backgrounds.

In some embodiments, the statistical methodology is used to assist in the development of specialized genotyping chips that enable computation of genetic personalized risk scores and polygenic normative variation scores with maximal power to predict normative and non-normative variation in complex phenotypes and diseases in de novo samples. For example, in some embodiments, arrays that focus on a specific disease or population group are developed.

In some embodiments, the statistical methodology is used to predict complex phenotypes and disease diagnosis of offspring of two parents, given the parents' genotypes. In some embodiments, this is accomplished by randomly simulating multiple offspring and estimating polygenic risk scores for each simulated offspring. The distribution of polygenic risk scores across offspring is used to determine a distribution of polygenetic risk for a given complex phenotype or disease.

### EXPERIMENTAL

The following examples are provided in order to demonstrate and further illustrate certain preferred embodiments and aspects of the present invention and are not to be construed as limiting the scope thereof.

### Example 1

### Materials and Methods

Ethics Statement

The relevant institutional review boards or ethics committees approved the research protocol of the individual GWAS used in the current analysis and all human participants gave written informed consent.

Participant Samples

GWAS results were obtained in the form of summary statistics p-values from the Psychiatric GWAS Consortium (PGC)—Schizophrenia and Bipolar Disorder Working Groups. The schizophrenia (SCZ) GWAS summary statistics results were obtained from the PGC Schizophrenia Work Group[12], which consisted of 9,394 cases with schizophrenia or schizoaffective disorder and 12,462 controls (52% screened) from a total of 17 samples from 11 countries. Semi-structured interviews were used by trained interviewers to collect clinical information, and operational criteria were used to establish diagnosis. The quality of phenotypic data was verified by a systematic review of data collection methods and procedures at each site, and only studies that fulfilled these criteria were included. Controls were selected from the same geographical and ethnic populations as cases. For further details on sample characteristics and quality control procedures applied, please see Ripke et al[12].

The bipolar disorder (BD) GWAS summary statistics results were obtained from, the PGC Bipolar Disorder Working Group[13], which consisted of n=16,731 including 7481 cases and 9250 controls, from 11 studies from 7 countries. Standardized semi-structured interviews were used by trained interviewers to collect clinical information about lifetime history of psychiatric illness and operational criteria applied to make lifetime diagnosis according to recognized classifications. All cases have experienced pathologically relevant episodes of elevated mood (mania or hypomania) and meet operational criteria for a BD diagnosis. The sample consisted of BD I (84%), BD II (11%), schizoaffective disorder bipolar type (4%), and BD NOS (1%). Controls were selected from the same geographical and ethnic populations as cases. For further details on sample characteristics and quality control procedures applied, please see Sklar et al[13].

Due to overlapping control samples in these studies, the common controls were split randomly, and divided between the two case-control analyses. All results presented here are based on these nonoverlapping control samples, with n=9379 cases and n=7736 samples in schizophrenia, and n=6990 cases and n=4820 controls in bipolar disorder analyses.

Statistical Analyses

Analyses implemented here were motivated by previously published stratified FDR methods[5,33]. However, it was found that stratified empirical cdfs exhibited a high degree of variability. Instead, empirical cdfs were obtained for the first phenotype conditional on nominal p-values of the second being at or below a given threshold. These conditional empirical cdfs vary more smoothly as a function of pvalue thresholds in the second (associated) phenotype than do empirical cdfs employing disjoint strata. Conditional FDR estimates derived from the conditional empirical cdfs are a simple extension of Efron's Empirical Bayes FDR methods[40].

One advantage of the model-free empirical cdf approach is the avoidance of bias in conditional FDR estimates from model misspecification. However, there are inherent, limitations to model-free approaches, especially with respect to inferring properties of the non-null distribution and, consequently, estimating power to detect non-null effects. Complementary model-based analyses are provided that estimate conditional and conjunctional local false discovery rate (fdr)[27].

Stratified Q-Q Plots

Q-Q plots compare a nominal probability distribution against an empirical distribution. In the presence of all null relationships, nominal p-values form a straight line on a Q-Q) plot when plotted against the empirical distribution. For each phenotype, for all SNPs and for each categorical subset (strata), −log₁₀ nominal p-values were plotted against −log₁₀ empirical p-values (stratified Q-Q plots). Leftward deflections of the observed distribution from the projected null line reflect increased tail probabilities in the distribution of test statistics (z-scores) and consequently an over-abundance of low p-values compared to that expected by chance, also termed “enrichment”.

Genomic Control

The empirical null distribution in GWAS is affected by global variance inflation due to population stratification and cryptic relatedness[39] and deflation due to over-correction of test statistics for polygenic traits by standard genomic control methods[40]. A control method leveraging only intergenic SNPs which are likely depleted for true associations (Schork et al., under review) was applied. First, the SNPs was annotated to genie (5″UTR, exon, intron, 3″UTR) and intergenic regions using information from the 1000 Genomes Project (1KGP). As illustrated in FIG. 5, there is an enrichment of functional genie regions in schizophrenia compared to the intergenic SNP category. Intergenic SNPs were used because their relative depletion of associations indicates that they provide a robust estimate of true null effects and thus seem a better category for genomic control than all SNPs. All p-values were converted to z-scores and for each phenotype the genomic inflation factor λGC for intergenic SNPs was estimated. The inflation factor, λGC, was computed as the median z-score squared divided by the expected median of a chi-square distribution with one degree of freedom and divided all test statistics by λGC. The stratified Q-Q plot, for schizophrenia after control for genomic inflation is shown in FIG. 5.

Q-Q Plots for Pleiotropic Enrichment

To assess pleiotropic enrichment, a Q-Q plot conditioned by “pleiotropic” effects was used. For a given associated phenotype, enrichment for pleiotropic signals is present if the degree of deflection from the expected null line is dependent on SNP associations with the second phenotype. Conditional Q-Q plots were constructed of empirical quantiles of nominal −log 10(p) values for SNP association with schizophrenia for all SNPs, and for subsets (strata) of SNPs determined by the nominal p-values of their association with bipolar disorder. Specifically, the empirical cumulative distribution of nominal p-values for a given phenotype for all SNPs and for SNPs with significance levels below the indicated cut-offs for the other phenotype (−log₁₀(p)≧0, −log₁₀(p)≧1, −log₁₀(p)≧2, −log₁₀(p)≧3 corresponding to p<1, p<0.1, p<0.01, p<0.001, respectively) was computed. The nominal p-values (−log₁₀(p)) are plotted on the y-axis, and the empirical quantiles (−log₁₀(q), where q=1−cdf(p)) are plotted on the x-axis. To assess for polygenic effects below the standard GWAS significance threshold, the conditional Q-Q plots were focused on SNPs with nominal −log 10(p)<7.3 corresponding to p>5×10⁻⁸).

Conditional FDR

Enrichment seen in conditional Q-Q plots can be directly interpreted in terms of FDR [29]), The stratified FDR method[26], previously used for enrichment of GWAS based on linkage information[5] was applied. Specifically, for a given p-value cutoff, the FDR is defined as

FDR(p)=π₀F₀(p)/F(p), [1]

where π₀ is the proportion of null SNPs, F₀ is the null cumulative distribution function (cdf), and F is the cdf of all SNPs, both null and non-null; see below for details on this simple mixture model formulation[41]. Under the null hypothesis, F0 is the cdf of the uniform distribution on the unit interval [0,1], so that Eq. [1] reduces to

FDR(p)=π₀p/F(p), [2]

The cdf F can be estimated by the empirical cdf q=Np/N, where Np is the number of SNPs with pvalues

less than or equal to p, and N is the total number of SNPs. Replacing F by q in Eq. [2], one gets

FDR(p)≈p/q, [3]

which is biased upwards as an estimate of the FDR[41]. Replacing π₀ in Equation [3] with unity gives an estimated FDR that is further biased upward. If π₀ is close to one, as is likely true for most GWAS, the increase in bias from Eq. [3] is minimal. The quantity 1−p/q, is therefore biased downward, and hence is a conservative estimate of the TDR. Note, Eq. [3] is the Empirical Bayes estimate of the Bayesian FDR described by Efron[40]. Referring to the formulation of the Q-Q plots, that Eq. [3] is equivalent to the nominal p-value divided by the empirical quantile, as defined earlier. Given the −log 10 of the Q-Q plots one obtains:

−log 10(FDR(p))≈log₁₀(q)−log₁₀(p) [4]

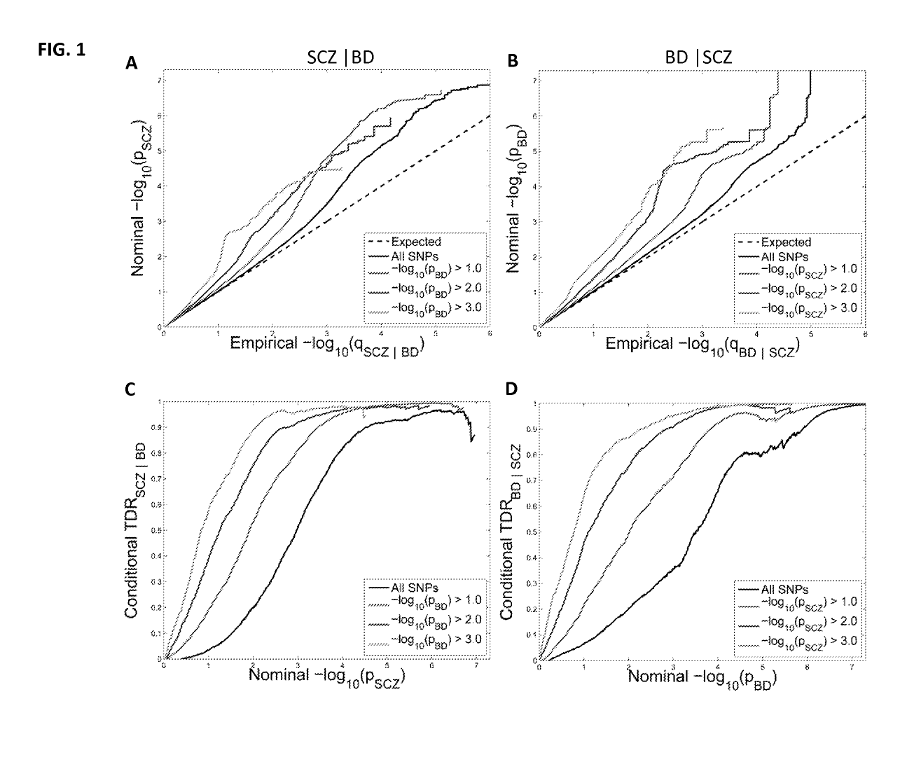

demonstrating that the (conservatively) estimated FDR is directly related to the horizontal shift of the curves in the conditional Q-Q plots from the expected line x=y, with a larger shift corresponding to a smaller FDR. This is illustrated in FIG. 1. For each p-value threshold in the associated trait (e.g. bipolar disorder), the conditional TDR is calculated as a function of p-value in the primary trait (e.g. schizophrenia, indicated by different colored curves) in FIG. 1 according to Eq. [4].
Conditional Statistics—Probability of Association with One Disorder

The conditional FDR is defined as the posterior probability that a given SNP is null for the first phenotype given that the p-values for both phenotypes are as small or smaller as the observed p-values. Formally, this is given by

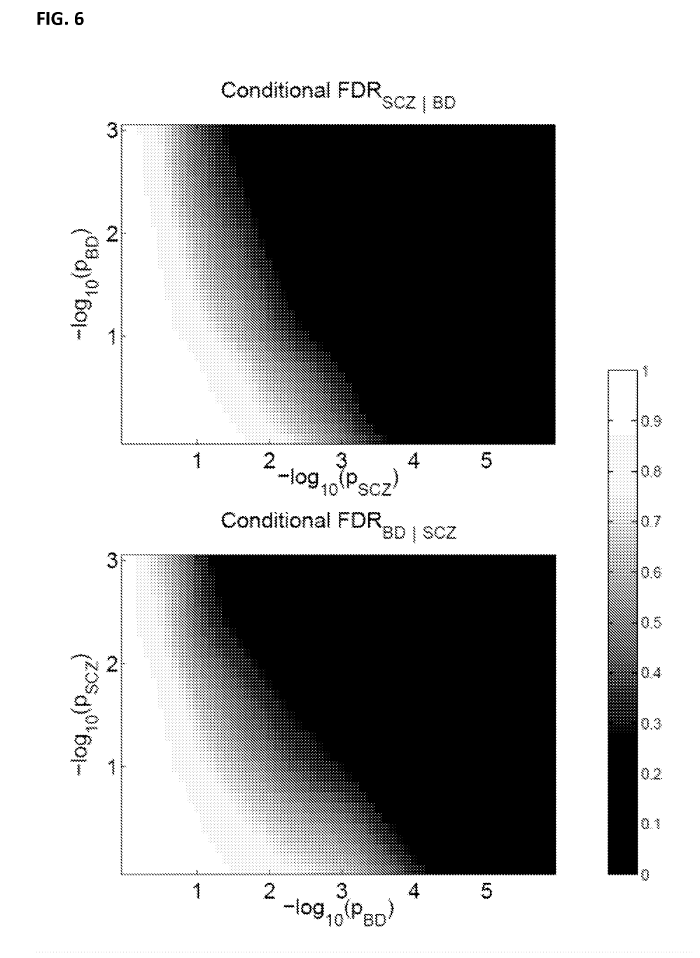

FDR(p₁|p₂)=π₀(p₂)p₁/F(p₁|p₂), [5]

where p1 is the p-value for the first phenotype, p2 is the p-value for the second, and F(p1|p2) is the conditional cdf and π0(p2) the conditional proportion of null SNPs for the first phenotype given that pvalues for the second phenotype are p2 or smaller. Eq. [5] makes the assumption, reasonable for independent GWAS, that summary statistics are independent across phenotypes if they are null for at least one phenotype. A conservative estimate of FDR(p1|p2) is produced by setting π0(p2)=1 and using the empirical conditional cdf in place of F(p1|p2) in Eq. [5]. This is a straightforward generalization of the Empirical Bayes approach developed by Efron[40]. A conditional FDR value for schizophrenia given bipolar disorder p-values (denoted by FDR SCZ BD) is assigned to each SNP by computing conditional FDR estimates on a grid and interpolating these estimates into a twodimensional look-up table (FIG. 6). All SNPs with conditional FDR<0.05 (−log 10(FDR)>1.3) in schizophrenia given association with bipolar disorder are listed in Table 1 after ‘pruning’ (removing all SNPs with r2>0.2 based on 1KGP LD structure). The same procedure, in the opposite direction, was used to assign a conditional FDR value (denoted as FDR BD|SCZ) for bipolar disorder given schizophrenia p-values to each SNP. All SNPs with FDR<0.05 (−log 10(FDR)>1.3) in bipolar disorder given schizophrenia are listed in Table 2 after pruning. A significance threshold of FDR<0.05 nominally corresponds to 5 false positives per 100 reported associations.

Conjunction Statistics—Test of Association with Both Phenotypes

In order to identify which of the SNPs associated with schizophrenia and bipolar disorder, a conjunction testing procedure as outlined for p-value statistics in Nichols et al.[42], adopted to FDR statistics based on the stratified FDR approach[5,26], was used. Conjunction FDR is defined as the posterior probability that a given SNP is null for both phenotypes simultaneously when the p-values for both phenotypes are as small or smaller than the observed p-values. Formally, conjunction FDR is given by

FDR(p₁,p₂)=π₀(p₁,p₂)F₀(p₁,p₂)/F(p₁,p₂), [6]

where π0(p1, p2) is the proportion of SNPs null for both phenotypes simultaneously, F0(p1, p2)=p1 p2 is the joint null cdf, and F(p1, p2) is the joint overall cdf.

Conditional empirical cdfs provide a model-free method to obtain conservative estimates of Eq. [6]. This can be seen as follows. Estimate the conjunction FDR by

FDR_{SCZ&BD}=max{FDR_{SCZ|BD}FDR_{BD|SCZ}} [7]

where FDR SCZ|BD and FDR BD|SCZ (the estimated conditional FDRs described above) are conservative (upwardly biased) estimates of Eq. [5]. Thus, Eq. [7] is a conservative estimate of max {p1/F(p1|p2), p2/F(p2|p1)}=max{p1 F2(p2)/F(p1, p2), p2 F1(p1)/F(p1, p2)}. For enriched samples, pvalues will tend to be smaller than predicted from the uniform distribution, so that F1(p1)≧p1 and F2(p2)≧p2. Hence, max{p1 F2(p2)/F(p1, p2), p2 F2(p1)/F(p1, p2)}≧max{p1 p2/F(p1, p2), p2 p1/F(p1, p2)}=p1 p2/F(p1, p2)≧π0(p1, p2) p1 p2/F(p1, p2). The last quantity is precisely the conjunction FDR defined by Eq. [6]. Thus, Eq. [7] is a conservative model-free estimate of the conjunction FDR.

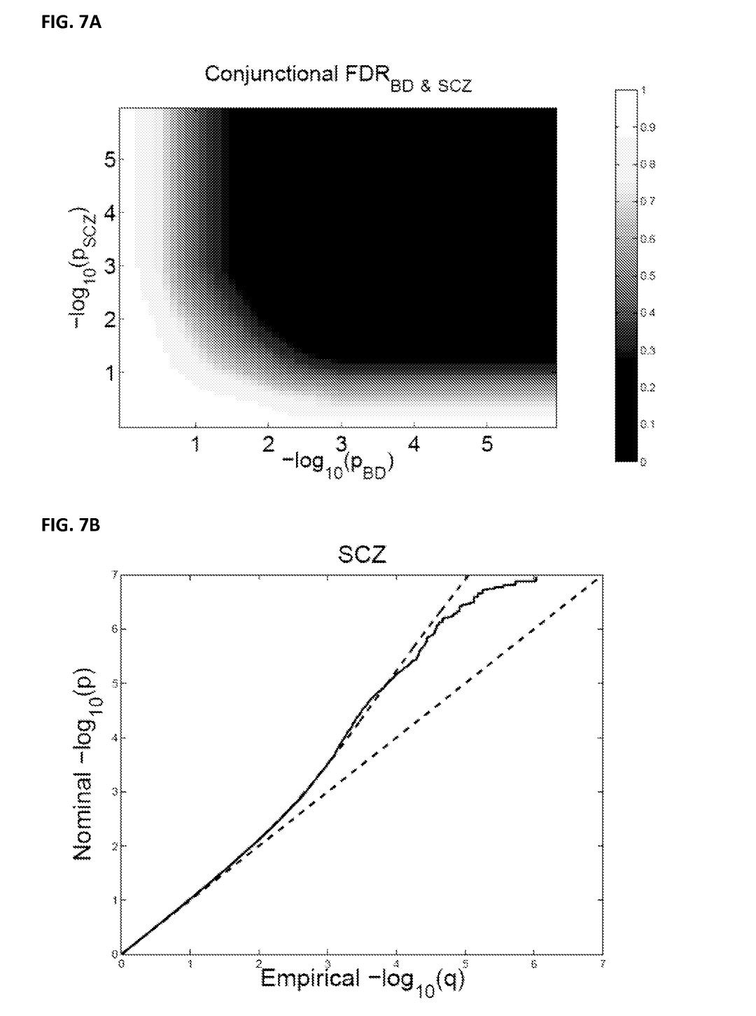

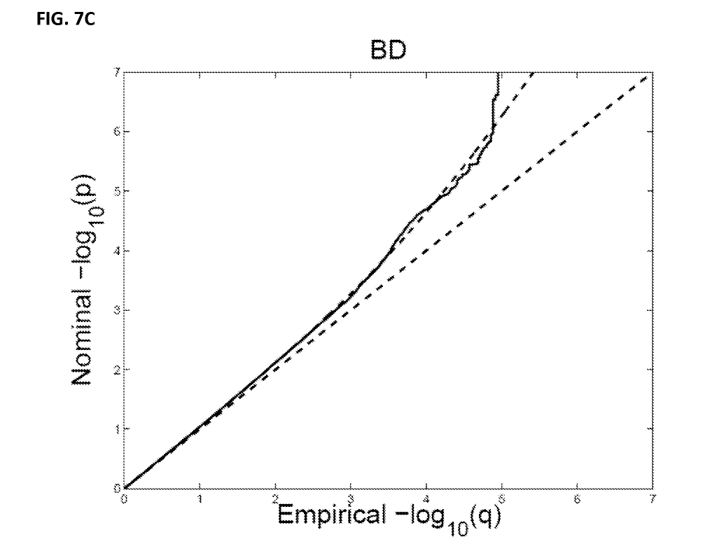

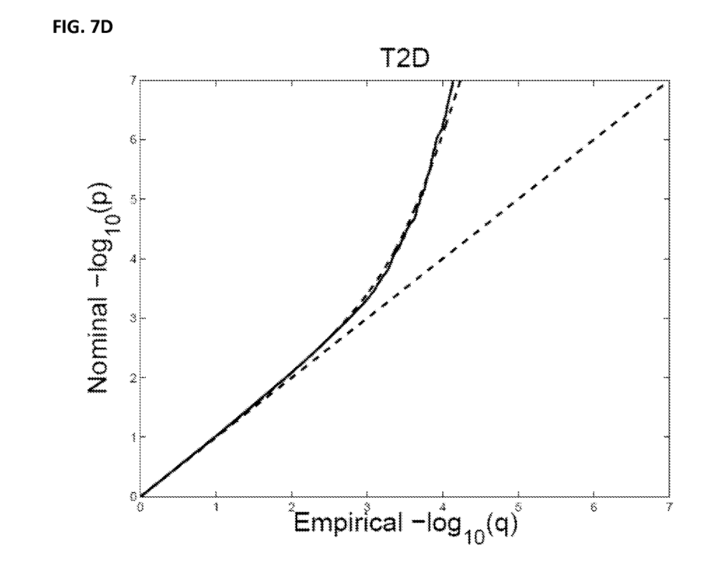

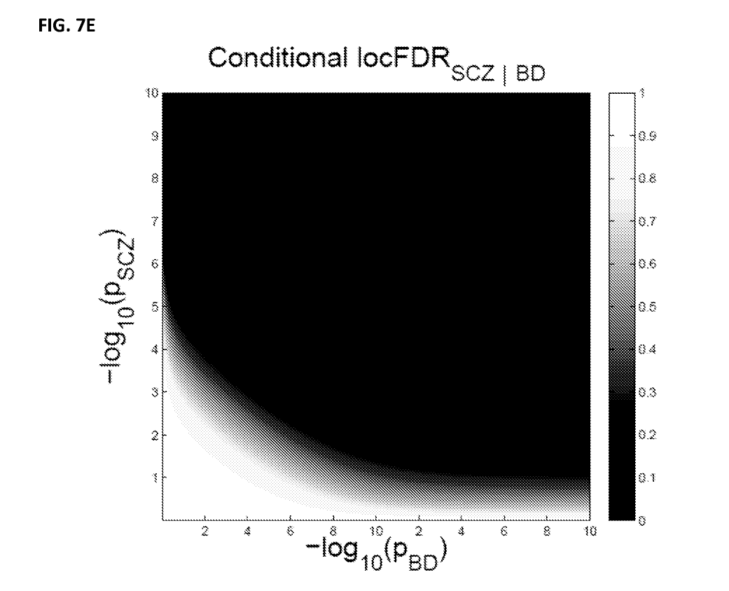

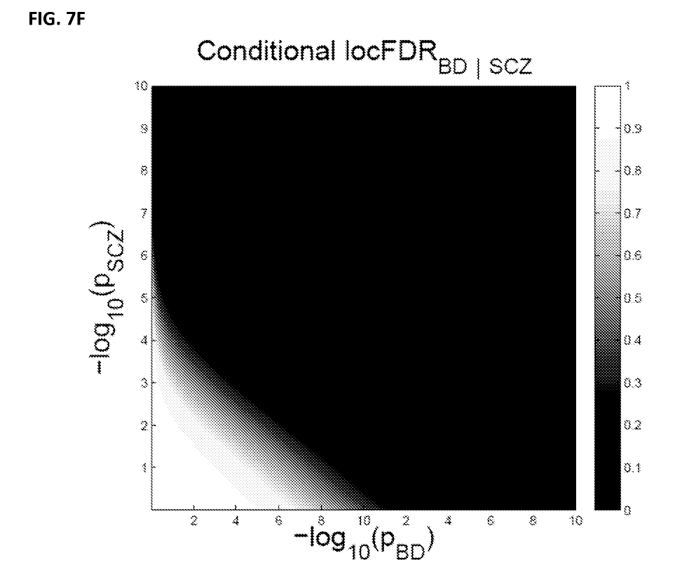

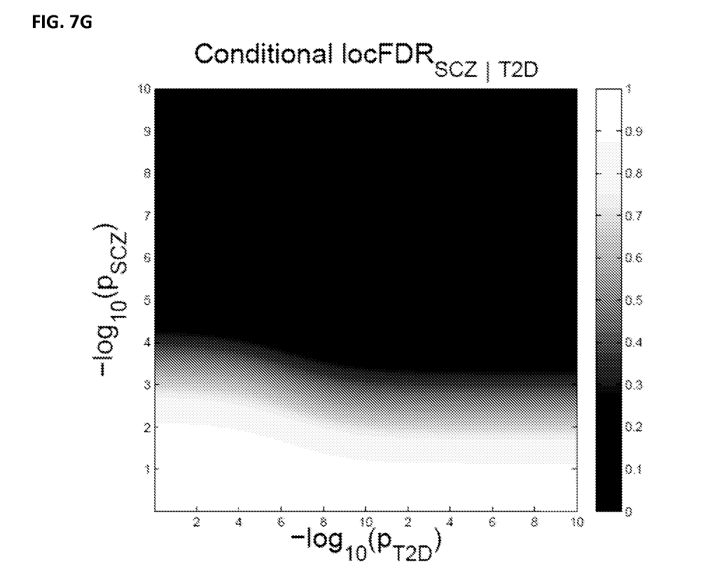

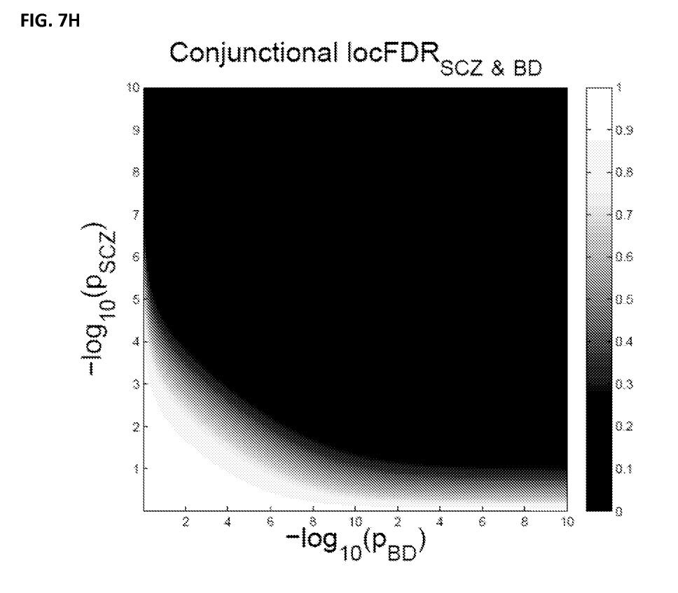

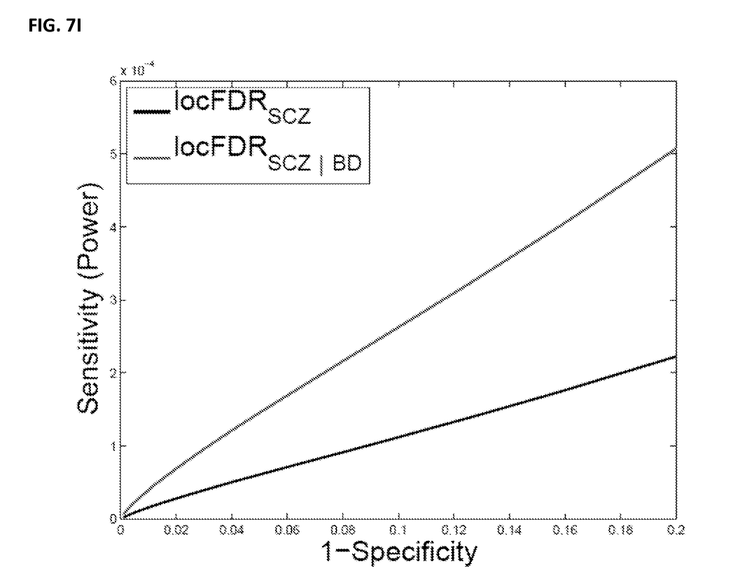

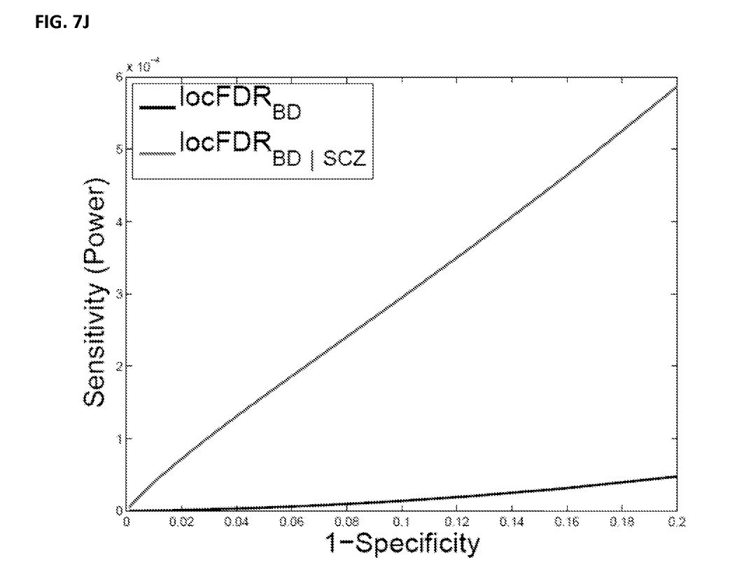

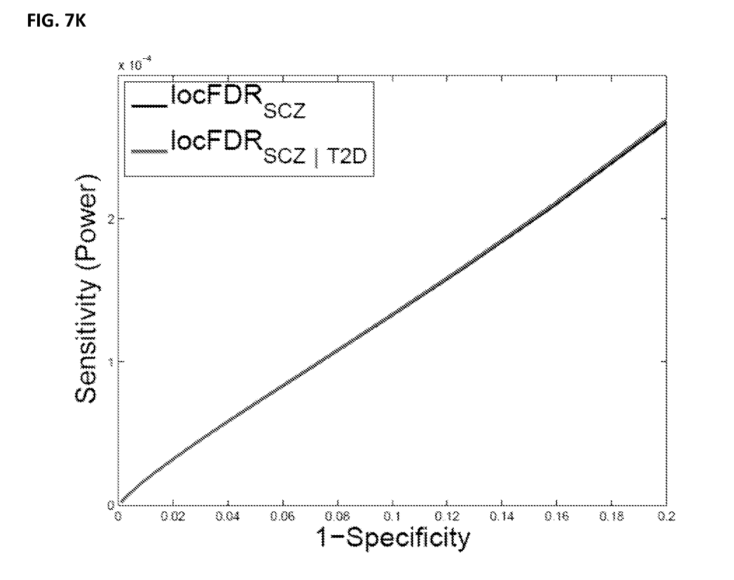

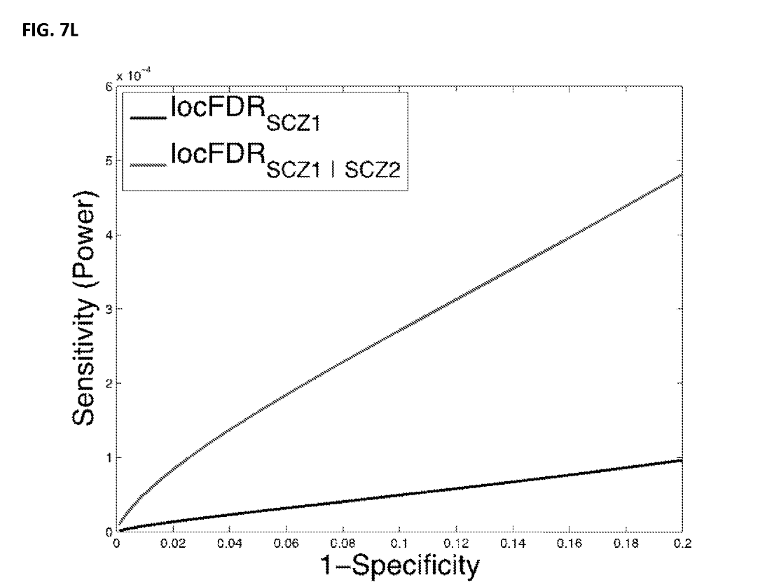

The conjunction FDR values were assigned by interpolation into a bi-directional two-dimensional look-up table (FIG. 7). All SNPs with conjunction FDR<0.05 (−log 10(FDR)>1.3) with schizophrenia and bipolar disorder considered jointly are listed in Table 3 (after pruning), together with the corresponding z-scores and minor alleles. The z-scores were calculated from the p-values and the direction of effect was determined by the risk allele.

Conditional Manhattan Plots

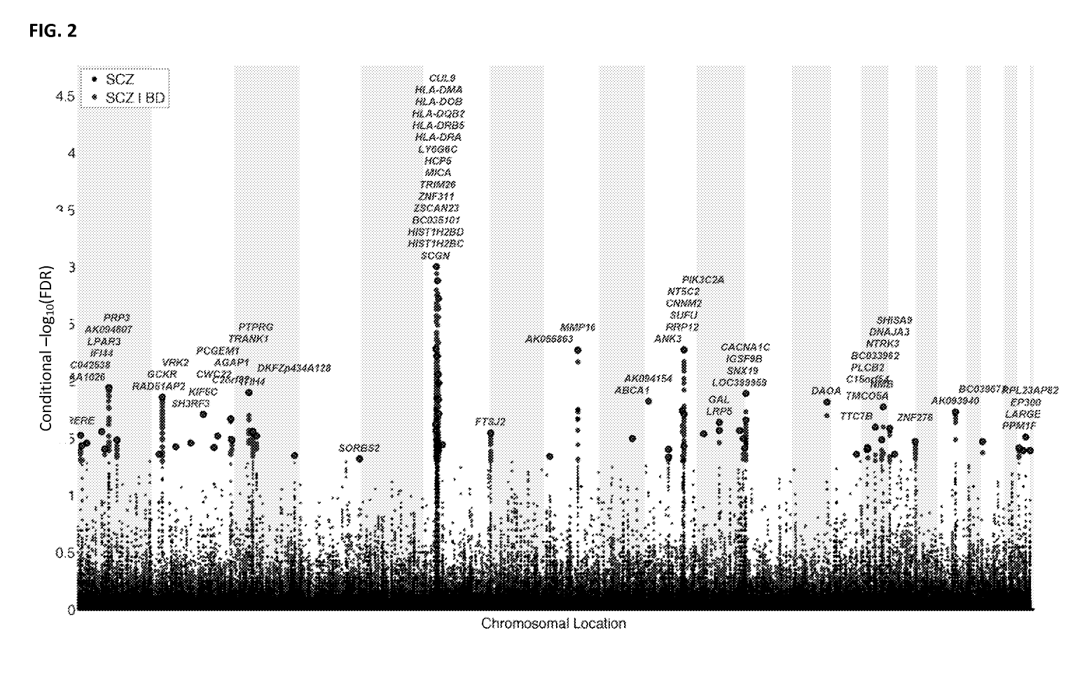

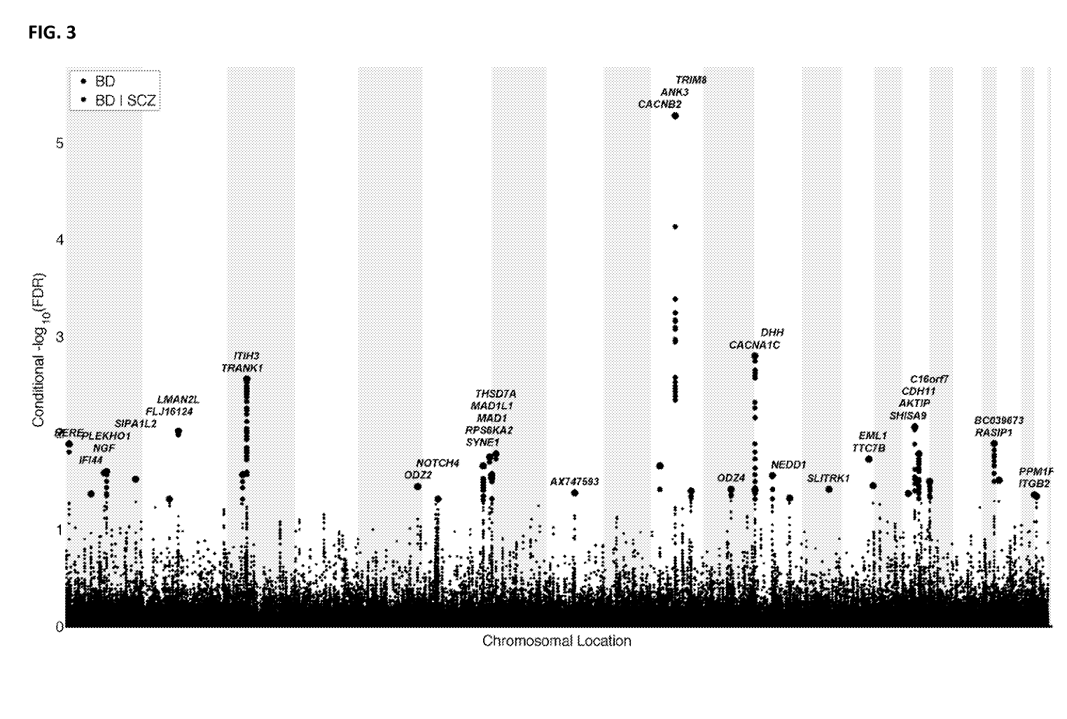

To illustrate the localization of the genetic markers associated with schizophrenia given bipolar disorder effect, and vice versa, a “Conditional Manhattan plot”, plotting all SNPs within an LD block in relation to their chromosomal location was used. As illustrated in FIG. 2 for schizophrenia, the large points represent the SNPs with FDR<0.05, whereas the small points represent the non-significant SNPs. All SNPs without “pruning” (removing all SNPs with r2>0.2 based on 1KGP LD structure) are shown. The strongest signal in each LD block is illustrated with a black line around the circles. This was identified by ranking all SNPs in increasing order, based on the conditional FDR value for schizophrenia, and then removing SNPs in LD r2>0.2 with any higher ranked SNP. Thus, the selected locus was the most significantly associated with schizophrenia in each LD block (FIG. 2). A similar procedure was used in the conditional Manhattan plot for bipolar disorder (FIG. 3).

Conjunction Manhattan Plots

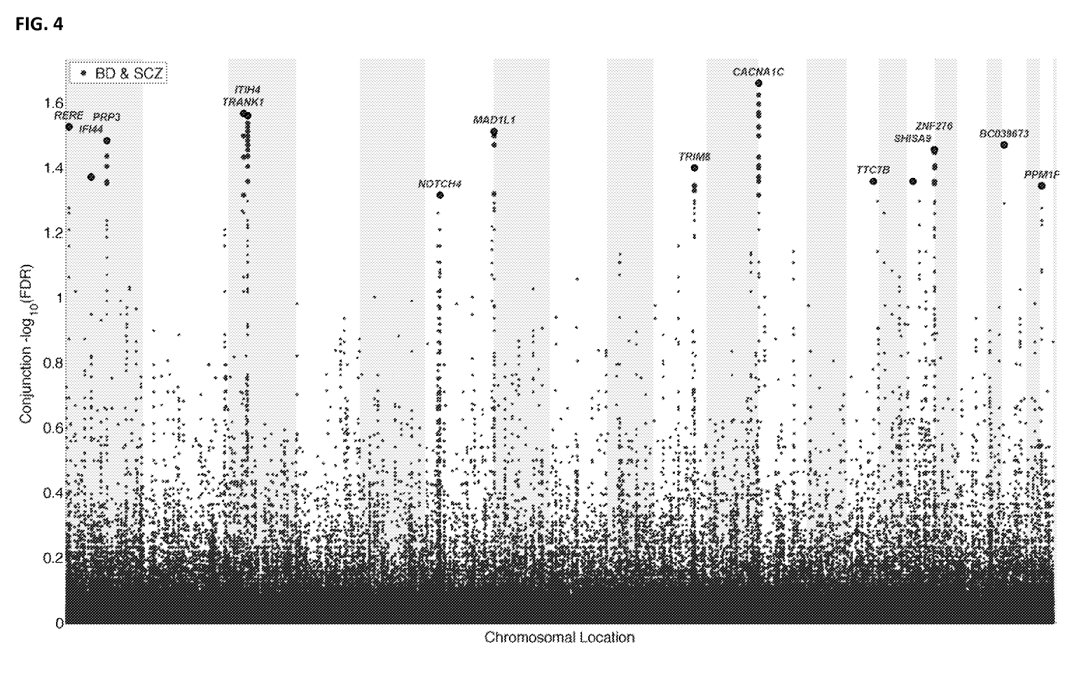

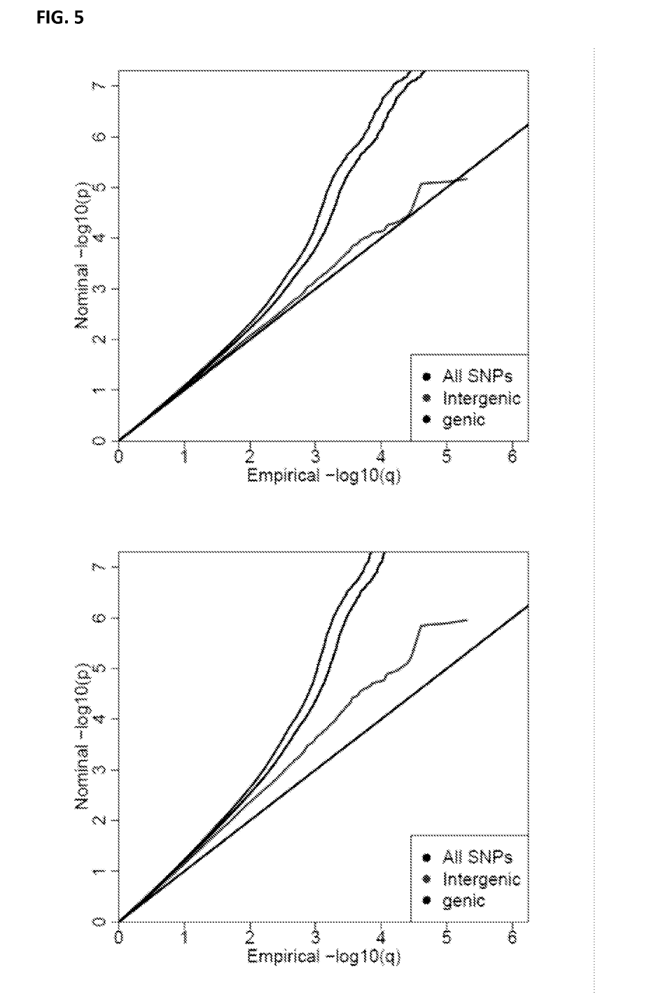

To illustrate the localization of the pleiotropic genetic markers association with both schizophrenia and bipolar disorder, a “Conjunction Manhattan plot”, plotting all SNPs with a significant conjunction FDR within an LD block in relation to their chromosomal location was used. As illustrated in FIG. 4, the large points represent the significant SNPs (FDR<0.05), whereas the small points represent the non-significant SNPs. All SNPs without “pruning” (removing all SNPs with r2>0.2 based on 1KGP LD structure are shown, and the strongest signal in each LD block is illustrated with a black line around the circles. First, all SNPs were ranked based on the conjunction FDR and removed SNPs in LD r²>0.2 with any higher ranked SNP.

Four-Groups Mixture Model

Here, a model-based methodology for computing pleitropy-informed conditional and conjunction analyses, complementary to the model-free approach presented in the main text is described. Let z be the GWAS test statistic (z-score) with corresponding nominal significance p (two-tailed probability of observed z-score under the null hypothesis of no effect). A standard Bayesian two-groups mixture model [Efron B (2010) Large-scale inference: empirical Bayes methods for estimation, testing, and prediction. Cambridge; New York: Cambridge University Press. xii, 263] is given by

f(z)=π₀f₀(z)+(1−π₀)f₁(z) [S1]

where f0 is the null distribution (e.g., standard normal after appropriate genomic control), f1 is the non-null distribution (which may be estimated parametrically or non-parametrically, and π0 is the proportion of null SNPs. From model [S1] the Bayesian False Discovery Rate (denoted as FDR) and the local False Discovery Rate (denoted as fdr) for a given effect size z are

FDR(z)=π₀F₀(z)/F(z) [S2]

fdr(z)=π₀f₀(z)/f(z) [S3]

where F0(z) and F(z) are the cumulative distribution functions (cdfs) corresponding to f0(z) and f(z), respectively. Following is an extension to conditional and conjunctional fdr (Eq. [S3]); it is straightforward to extend this to include conditional and conjunction FDR (Eq. [S2]). Eq. [S1] is generalized to bivariate z-scores from two phenotypes (z1 for phenotype 1 and z2 for phenotype 2) using a bivariate density from a four-groups mixture model

f(z₁,z₂)=π₀f₀(z₁,z₂)+π₁f₁(z₁,z₂)+π₂f₂(z₁,z₂)+π₃f₃(z₁,z₂) [S4]

where π0 is the proportion of SNPs for which both phenotypes are null, π1 is the proportion of SNPs where phenotype 1 is non-null and phenotype 2 is null, π2 is the proportion of SNPs where phenotype 1 is null and phenotype 2 is non-null, and 3 is the proportion of SNPs where both phenotypes are non-null (i.e., the pleiotropic SNPs). The mixture densities in [S4] are given by

f₀(z₁,z₂)=φ(z₁)φ(z₂)

f₁(z₁,z₂)=g₁(z₁)φ(z₂)

f₂(z₁,z₂)=φ(z₁)g₂(z₂)

f₃(z₁,z₂)=g₁(z₁)g₂(z₂) [S5]

where φ( ) denotes the theoretical null density and g1 and g2 denote the non-null marginal densities of z1 and z2, respectively. Modeling the φ with the standard normal and g1 and g2 with Normal-Laplace densities fits the empirical z-scores well. Another parametric model providing a very good fit to the squared z-scores (z2) sets φ to a central chi-squared density with one degree of freedom (χ21) and g1 and g2 to Weibull densities with scale parameters α1 and α2 and shape parameters β1 and β2 for g1 and g2, respectively. More generally f3 is modeled with marginal densities as above but allowing for dependence between pleiotropic (jointly non-null) SNPS using, for example, a copula formulation [Joe H (1997) Multivariate models and multivariate dependence concepts: Chapman & Hall/CRC]. The proportions π=(π0,π1,π2,π3) and the parameters of the non-null distributions can be estimated using Bayesian methods such as Markov Chain Monte Carlo (MCMC) algorithms or maximum likelihood (ML) estimation. FIGS. 7b and 7c present the ML-estimated marginal cdfs for SCZ and BD, respectively, indicating very good fit of marginal densities. To provide a comparison of a trait only weakly pleiotropic with SCZ and BD, the marginal fit to Type 2 Diabetes (T2D) GWAS data [Voight B F, Scott L J, Steinthorsdottir V, Morris A P, Dina C, et al. (2010) Twelve type 2 diabetes susceptibility loci identified through large-scale association analysis is shown. Nat Genet 42: 579-589] in FIG. 7d. Here, marginal distributions were modeled parametrically using the χ21-Weibull model for z2.

The estimated vector of probabilities π=(π0,π1,π2,π3) from these fits can be used to test whether the degree of pleiotropy is significantly higher than expected by chance if both phenotypes were independent. Independence implies that the joint pdf of both phenotype summary scores is a product of two two-group mixture models (two independent versions of Eq. [S1]). It is easy to show that testing for excess pleiotropy over that predicted by independence is equivalent to showing that π3>π1π2/π0 in Eq. [S4] or equivalently that the log-odds ratio

LOR(Phen. 1. Phen. 2)=log {π₃/1−π₃}−log {(π₁π₂/π₀)/(1−π₁π₂/π₀)} [S6]

is greater than zero. Using a multivariate normal approximation to the ML estimates with covariance obtained from the inverse Fisher information matrix, estimates of LOR with 95% confidence intervals are: LOR(SCZ,BD)=10.3 [4.1, 16.4], LOR(SCZ,T2D)=1.3 [0.2, 2.5], and LOR(BD,T2D)=1.5 [0.6, 2.4]. In particular, the departure from independence of SCZ and BD is highly significant, with a 95% CI bounded well above zero. ML estimates and 95% CIs were produced using the SCZ/BD data z2 values estimated using non-overlapping controls, and include an adjustment to account for correlation of SNPs (e.g., LD) that assumes an effective degree of freedom of 500,000 independent SNPs.

The proportion of pleiotropic SNPs is estimated for each phenotype. For example, π3/(π1+π3) is the proportion of pleiotropic SNPs for phenotype 1 (e.g., the proportion of non-null SNPs for phenotype 1 that are also non-null for phenotype 2). Again using the ML estimates from the χ21-Weibull model, the proportion of pleiotropic SNPs for BD with SCZ was 0.56 (95% CI: [0.48, 0.64]), the proportion for SCZ with BD was 0.94 [0.37, 1.00], the proportion for SCZ with T2D was 0.04 [0.01, 0.10], the proportion for BD with T2D was 0.05 [0.02, 0.09]. ML estimates and 95% CIs were again produced using the SCZ/BD data z-score estimates with non-overlapping controls, and include an adjustment to account for correlation of SNPs. The huge increase in power for BD|SCZ noted below is due to high proportion of non-null SCZ SNPs that are also non-null BD SNPs. As a point of comparison, two split-half samples are produced using the SCZ data, showing a pleiotropic overlap of 0.992 [0.988, 0.996] of SCZ with itself.

Conditional and Conjunction Local False Discovery Rate

From the ML-estimates of the four-groups mixture pdf (Eq. [S4]) one can compute ML estimates of the conditional pdf of z1 given z2 and hence the conditional fdr of the first phenotype given the second

fdr(z₁|z₂)=f(z₁|z₁null,z₂)Pr(z₁null|z₂)/f(z₁|z₂) [S6]

where f(z1|z1 null, z2) is the null density of z1 conditional on z2, Pr(z1 null|z2) is the probability that z1 is null given z2, and f(z1|z2) is the mixture density of z1 conditional on z2. With component densities as given in Eq. [S5], this becomes

fdr(z₁|z₂)=φ(z₁)[π₀φ(z₂)+π₂(z₂)]/f(z₁,z₂), [S7]

where f(z1, z2) is the joint density given in Eq. [S4]. Look-up tables were produced using Eq. [S7], with ML estimates of unknown parameters, again assuming the χ21-Weibiull model for z2.

The conjunctional fdr of both phenotypes is computed as

fdr(z₁,z₂)=f(z₁,z₂|z₁null,z₂null)Pr(z₁null,z₂null)/f(z₁,z₂) [S8]

where f(z1, z2|z1 null, z2 null)=φ(z1) φ(z2) is the joint null density of z1 and z2, Pr(z1 null, z2 null) is the probability that both z1 and z2 are null, and f(z1, z2) is the joint pdf of z1 and z2. With densities given in Eq. [S5], this becomes

fdr(z₁,z₂)=π₀φ(z₁)φ(z₂)/f(z₁,z₂) [9]

A joint fdr look-up table for SCZ & BD is presented in FIG. 7h.

Conditional Local False Discovery Rate and Power

Conditional local false discovery rates fdr(z1|z2) can lead to significant increases in power when two phenotypes are genuinely pleiotropic (i.e., when LOR(Phen. 1, Phen. 2) is significantly larger than zero). Here, power is defined in terms of the probability of rejecting the null hypothesis for SNPs that are in fact non-null for a given fdr threshold α. In this sense power corresponds to sensitivity to detect non-null SNPs and power diagnostics correspond can be presented as ROC-type curves as detailed in Efron [Efron B (2007) Size, power and false discovery rates. The Annals of Statistics 35: 1351-1377]. In FIGS. 7i-k the power diagnostic plots for conditional fdr estimated using the ML estimates from the χ21-Weibiull model are shown. The x-axis is the fdr (1-specificity) whereas the y-axis is the proportion of non-null SNPs (sensitivity, or power). ROC curves include marginal fdrs and conditional fdrs of phenotype 1 given phenotype 2. In particular these plots demonstrate a very large increase in power for using fdr of BD|SCZ. For comparison, an ROC plot for a split half sample of the SCZ data, also showing a very large improvement in power for SCZ using the GWAS data from an independent SCZ sample as the “pleiotropic” trait is included.

Note, estimates of power in the sense described above are sensitive to assumptions about the shape of the non-null distribution near zero. However, relative power (the ratio of sensitivity of conditional fdr with marginal fdr for a given threshold α) is well identified. For example, using the fdr cut-off α≦0.05, the ratio of power for conditional fdr of BD|SCZ vs. marginal fdr of BD is 44.4. The ratio of power for unconditional vs. conditional fdr for SCZ|BD is 2.4, indicating improvement of power but to a much lesser degree. In contrast, the ratio of power for unconditional vs. conditional fdr for SCZ|T2D is 1.00, indicating no improvement whatsoever.

Results

Q-Q plots of schizophrenia SNPs stratified by association with bipolar disorder and vice versa Under large-scale testing paradigms, such as GWAS, quantitative estimates of likely true associations can be estimated from the distributions of summary statistics[27,28]. A common method for visualizing the “enrichment” of statistical association relative to that expected under the global null hypothesis is through Q-Q plots of nominal p-values obtained from GWAS summary statistics. The usual Q-Q curve has as the y-ordinate the nominal p-value, denoted by “p”, and the x-ordinate the corresponding value of the empirical cdf, denoted by “q”. Under the global null hypothesis the theoretical distribution is uniform on the interval [0,1]. As is common in GWAS, one instead plots −log₁₀ p against −log₁₀ q to emphasize tail probabilities of the theoretical and empirical distributions. Thus, enrichment results in a leftward shift in the Q-Q curve, corresponding to a larger fraction of SNPs with nominal −log₁₀ p-value greater than or equal to a given threshold. Conditional Q-Q plots are formed by creating subsets of SNPs based on levels of an auxiliary measure for each SNP, and computing Q-Q plots separately for each level. If SNP enrichment is captured by variation in the auxiliary measure, this is expressed as successive leftward deflections in a conditional Q-Q plot as levels of the auxiliary measure increase.

Conditional Q-Q plots for schizophrenia conditioned on nominal p-values of association with bipolar disorder (SCZ|BD; FIG. 1A) show enrichment across different levels of significance for bipolar disorder. The earlier departure from the null line (leftward shift) indicates a greater proportion of true associations for a given nominal schizophrenia p-value. Successive leftward shifts for decreasing nominal bipolar disorder p-values indicate that the proportion of non-null effects in schizophrenia varies considerably across different levels of association with bipolar disorder. For example, the proportion of SNPs in the −log_{10(pBD)}≧3 category reaching a given significance level (e.g., −log_{10(pSCZ)}>4) is roughly 50 times greater than for the −log_{10(pBD)}≧0 category (all SNPs), indicating a high level of enrichment. An even stronger pleiotropic enrichment was seen for bipolar disorder conditioned on nominal p-values of association with schizophrenia (BD|SCZ; FIG. 1B), Here, the proportion of SNPs in the −log_{10(pSCZ)}>3 category reaching a given significance level (e.g., −log_{10(pBD)}>4) is roughly 500 times greater than for the −log 10(pSCZ)≧0 category (all SNPs), indicating a very high level of enrichment.

Conditional True Discovery Rate (TDR) in schizophrenia is increased by bipolar disorder, and vice versa.

Since categories of SNPs with stronger pleiotropic enrichment are more likely to be associated with schizophrenia, to maximize power for discovery all tag SNPs should not be treated interchangeably. Specifically, variation in enrichment across pleiotropic categories is expected to be associated with corresponding variation in the TDR (equivalent to 1-FDR)[29] for association of SNPs with schizophrenia. A conservative estimate of the TDR for each nominal p-value is equivalent to 1−(p/q), easily read from the stratified Q-Q plots (see Material and Methods). This relationship is shown for schizophrenia conditioned on nominal bipolar disorder p-values (SCZ|BD; FIG. 1C) and bipolar disorder conditioned on nominal schizophrenia p-values (BD|SCZ; FIG. 1D). For a given conditional TDR the corresponding estimated nominal p-value threshold varies with a factor of 100 from the most to the least enriched SNP category (strata) for schizophrenia conditioned on bipolar disorder (SCZ|BD), and approximately a factor of 500 for bipolar disorder conditioned on schizophrenia (BD|SCZ).

Schizophrenia Gene Loci Identified with Conditional FDR

A “conditional” Manhattan plot for schizophrenia showing the FDR conditional on bipolar disorder (FIG. 2) was constructed and used to identify significant loci on a total of 18 chromosomes (1-4, 6-16, 18, 20 and 22) associated with schizophrenia leveraging the reduced FDR obtained by the associated bipolar disorder phenotype. To estimate the number of independent loci, the associated SNPs were pruned (removed SNP with LD>0.2), and a total of 58 independent loci with a significance threshold of conditional FDR<0.05 (Table 1) were identified. Using the more conservative conditional FDR threshold of 0.01, 9 independent loci remained significant. One locus was located in the HLA region on chromosome 6. Of note, using a standard Bonferroni-corrected approach, no loci would have been discovered. Using the FDR method in schizophrenia alone, 4 loci were identified. Of these, the regions close to TRIM26 (6p21.3), MMP16 (8q21.3) and NT5C2 (10q24.32) have been identified in earlier GWAS studies after including large replication samples[12]. The remaining loci would not have been identified in the current sample without using the pleiotropy-informed stratified FDR method. Of interest, the VRK2 region (2p16.1) was identified in the previous sample after including a large schizophrenia replication sample[30], and the ITIH4 region (3p21.1), ANK3 (10q21) and CACNA1C (12p13.3) were discovered previously in the same, combined schizophrenia and bipolar disorder sample[12,13]. Thus, the current pleiotropy-informed FDR method validated 7 loci discovered in considerably larger samples, and discovered 52 new loci.

Bipolar Disorder Gene Loci Identified with Conditional FDR

A “conditional” Manhattan plot for bipolar disorder showing the FDR conditional on schizophrenia (FIG. 3) was used to identify significant loci on a total of 16 chromosomes (1-3, 5-8, 10-14, 16 and 19-22) associated with bipolar disorder leveraging the reduced FDR obtained by the associated schizophrenia phenotype. To estimate the number of independent loci, the associated SNPs were pruned (removed SNP with LD>0.2), and identified a total of 35 independent loci with a significance threshold of conditional FDR<0.05 (Table 2), of which one was complex and the rest were single gene loci. Using the more conservative conditional FDR threshold of 0.01, 5 independent loci remained significant. The most significant locus was close to ANK3 on chromosome (10q21). This is the only locus that would have been discovered using standard methods based on p-values (Bonferroni correction). Using the FDR method in bipolar disorder alone, an additional locus was identified, close to CACNA1C (12p13.3) [13,31]. The regions close to SYNE1 (6q25) and ODZ4 (11q14.1) have been identified in earlier GWAS after including large replication samples [13,32]. Of interest, the ITIH3 region (3p21.1). ANK3 (10q21) and CACNA1C (12p13.3) were discovered previously in the same, combined schizophrenia and bipolar disorder sample[12,13]. Thus, the current pleiotropy-informed FDR method validated 5 loci discovered in considerably larger samples, and discovered 30 new loci.

Pleiotropic Gene Loci in Both Schizophrenia and Bipolar Disorder Identified with Conjunctional FDR

To identify pleiotropic loci in schizophrenia and bipolar disorder, a conjunctional FDR analysis was performed and used to construct a “conjunction” Manhattan plot (FIG. 4). 14 independent pleiotropic loci were identified (pruned based on LD>0.2, black line around large circles) with a significance threshold of conjunctional FDR<0.05, all single gene loci, located on a total of 10 chromosomes (chr. 1, 3, 6, 7, 10, 12, 14, 16, 20, 22). See Table 3 for details. Of these loci, 3 have been implicated in bipolar disorder and schizophrenia earlier: NOTCH4 (6p21.2) with schizophrenia using a larger replication sample[12,16], and the ITIH4 (3p21.1), and CACNA1C (12p13.3) regions, both discovered previously in the same, combined schizophrenia and bipolar disorder sample[12,13]. Only one conjunctional locus was found on chromosome 6, indicating that there are several schizophrenia loci on this chromosome not overlapping with bipolar disorder. The ANK3 locus was not significant in the conjunctional FDR analysis, which indicates that the overlap is mostly driven by the association in bipolar disorder (Table 2). The direction of the effect (z-scores) across all the pleiotropic SNPs was the same for bipolar disorder and schizophrenia, except for locus 33 (BC039673, 20p13), which could be due to differences in LD structure in this region. The current findings describe overlapping genetic pathways in schizophrenia and bipolar disorders.

The model-based analysis using a bivariate mixture model showed that a very high proportion of the non-null schizophrenia SNPs are also non-null for bipolar disorder, leading to large increases in power (FIGS. 7i-j). The strong increase in power, especially for bipolar disorder, is also due to the large number of SNPs with p-values just below the Bonferroni threshold. To test for enrichment when there is little shared polygenic pleiotropy, pleiotropy analysis was performed using type 2 diabetes (T2D) GWAS. There was a very small level of pleiotropic enrichment between schizophrenia and T2D, leading to little if any improvement in statistical power (See FIG. 7k). Two full independent case-control datasets on the same disorder were analyzed, using split-half samples from the schizophrenia GWAS data. As shown in FIG. 7l, the same disorder case-control dataset for schizophrenia show almost complete overlap of non-null SNPs (greater than 99%), and, hence, a large increase in power even in much smaller samples as expected. The increase was larger than that obtained using the similar size bipolar disorder sample.

TABLE 1
Conditional FDR; SCZ loci given BD (SCZ|BD).

| locus | SNP | neighbor gene | chr | pval SCZ | fdr SCZ | fdr SCZ\|BD |
|---|---|---|---|---|---|---|
| 1 | rs2252865 | RERE | 1p36.23 | 4.76E−04 | 0.377 | 0.030 |
| 2 | rs11579756 | KIAA1026 | 1p36.21 | 1.17E−04 | 0.203 | 0.037 |
| 3 | rs4949526 | BC042538 | 1p35.2 | 1.11E−04 | 0.181 | 0.035 |
| 4 | rs4650608 | IFI44 | 1p31.1 | 2.06E−04 | 0.257 | 0.028 |
| 5 | rs4907103 | LPAR3 | 1p22.3 | 9.77E−05 | 0.181 | 0.039 |
| 6 | rs1625579 | AK094607 | 1p21.3 | 3.76E−06 | 0.065 | 0.011 |
| 7 | rs11205362 | PRP3 | 1q21.1 | 1.11E−03 | 0.489 | 0.033 |
| 8 | rs10495658 | RAD51AP2 | 2p24.2 | 3.99E−05 | 0.115 | 0.044 |
| 9 | rs813592 | GCKR | 2p23 | 2.71E−05 | 0.095 | 0.014 |
| 10 | rs10189138 | VRK2† | 2p16.1 | 1.42E−04 | 0.229 | 0.038 |
| 11 | rs11692886 | SH3RF3 | 2q13 | 1.05E−04 | 0.181 | 0.035 |
| 12 | rs6435387 | KIF5C | 2q23.1 | 4.28E−05 | 0.115 | 0.020 |
| 13 | rs17180327 | CWC22 | 2q31.3 | 1.29E−05 | 0.080 | 0.038 |
| 14 | rs17662626 | PCGEM1 | 2q32 | 7.79E−05 | 0.161 | 0.030 |
| 15 | rs2675968 | C2orf82 | 2q37.1 | 5.64E−05 | 0.143 | 0.021 |
| 16 | rs4663627 | AGAP1 | 2q37 | 1.31E−04 | 0.203 | 0.033 |
| 17 | rs13072940 | TRANK1 | 3p22.2 | 1.27E−05 | 0.080 | 0.013 |
| 18 | rs4687657 | ITIH4† | 3p21.1 | 1.56E−04 | 0.229 | 0.028 |
| 19 | rs11130874 | PTPRG | 3p21-p14 | 9.45E−06 | 0.077 | 0.030 |
| 20 | rs9838229 | DKFZp434A128 | 3q26.33 | 2.89E−05 | 0.104 | 0.045 |
| 21 | rs13150700 | SORBS2 | 4q35.1 | 2.77E−04 | 0.286 | 0.048 |
| 22 | rs9379780 | SCGN | 6p22.3-p22.1 | 3.78E−06 | 0.065 | 0.024 |
| | rs198829 | HIST1H2BC | 6p22.1 | 2.18E−05 | 0.088 | 0.027 |
| 23 | rs7749823 | HIST1H2BD | 6p21.3 | 1.32E−07 | 0.014 | 0.005 |
| | rs17693963 | BC035101 | 6p22.1 | 1.87E−07 | 0.022 | 0.001 |
| | rs13190937 | ZSCAN23 | 6p22.1 | 1.23E−04 | 0.203 | 0.033 |
| | rs3130893 | ZNF311 | 6p22.1 | 3.83E−06 | 0.065 | 0.006 |
| | rs2523722 | TRIM26† | 6p21.32-p22.1 | 2.54E−07 | 0.025 | 0.001 |
| | rs2596565 | MICA | 6p21.33 | 9.33E−06 | 0.077 | 0.009 |
| | rs2284178 | HCP5 | 6p21.3 | 3.31E−04 | 0.316 | 0.036 |
| | rs805294 | LY6G6C | 6p21.33 | 1.11E−04 | 0.181 | 0.039 |
| | rs9268858 | HLA-DRA | 6p21.3 | 1.66E−05 | 0.084 | 0.041 |
| | rs9268862 | HLA-DRA | 6p21.3 | 6.21E−07 | 0.037 | 0.002 |
| | rs502771 | HLA-DRB5 | 6p21.3 | 2.97E−05 | 0.104 | 0.039 |
| | rs9276601 | HLA-DQB2 | 6p21 | 3.07E−05 | 0.104 | 0.015 |
| | rs7383287 | HLA-DOB | 6p21.3 | 2.71E−05 | 0.095 | 0.019 |
| | rs1480380 | HLA-DMA | 6p21.3 | 1.06E−05 | 0.077 | 0.010 |
| 24 | rs9462875 | CUL9 | 6p21.1 | 1.61E−04 | 0.229 | 0.036 |
| 25 | rs7787274 | FTSJ2 | 7p22 | 3.27E−04 | 0.316 | 0.028 |
| 26 | rs12543276 | AK055863 | 8p23.1 | 1.38E−04 | 0.203 | 0.046 |
| 27 | rs7004633 | MMP16† | 8q21.3 | 1.70E−07 | 0.018 | 0.005 |
| 28 | rs2254884 | ABCA1 | 9q31.1 | 1.17E−04 | 0.203 | 0.032 |
| 29 | rs6602217 | AK094154 | 10p14 | 2.29E−05 | 0.095 | 0.015 |
| 30 | rs7084499 | ANK3† | 10q21 | 1.74E−04 | 0.229 | 0.040 |
| 31 | rs2153522 | ANK3† | 10q21 | 7.92E−04 | 0.449 | 0.046 |
| 32 | rs7895695 | RRP12 | 10q24.1 | 3.57E−05 | 0.115 | 0.018 |
| 33 | rs2298278 | SUFU | 10q24.32 | 1.24E−03 | 0.527 | 0.037 |
| | rs10883817 | CNNM2 | 10q24.32 | 1.13E−05 | 0.080 | 0.020 |
| | rs11191580 | NT5C2† | 10q24.32 | 1.71E−06 | 0.049 | 0.005 |
| 34 | rs4356203 | PIK3C2A | 11p15.5-p14 | 5.48E−05 | 0.128 | 0.029 |
| 35 | rs676318 | LRP5 | 11q13.4 | 1.41E−05 | 0.080 | 0.023 |
| 36 | rs6591348 | GAL | 11q13.3 | 1.16E−05 | 0.080 | 0.027 |
| 37 | rs17126243 | LOC399959 | 11q24.1 | 1.29E−05 | 0.080 | 0.027 |
| 38 | rs11222395 | SNX19 | 11q25 | 1.36E−04 | 0.203 | 0.032 |
| 39 | rs7106715 | IGSF9B | 11q25 | 6.52E−05 | 0.143 | 0.039 |
| 40 | rs7972947 | CACNA1C† | 12p13.3 | 5.32E−07 | 0.035 | 0.013 |
| 41 | rs1006737 | CACNA1C | 12p13.3 | 3.52E−05 | 0.104 | 0.022 |
| 42 | rs4517638 | DAOA | 13q34 | 1.10E−05 | 0.077 | 0.015 |
| 43 | rs961196 | TTC7B | 14q32.11 | 3.07E−03 | 0.662 | 0.044 |
| 44 | rs1502404 | TMCO5A | 15q14 | 1.04E−03 | 0.489 | 0.040 |
| 45 | rs724729 | C15orf54 | 15q14 | 4.70E−05 | 0.228 | 0.038 |
| 46 | rs1869901 | PLCB2 | 15q15 | 2.03E−04 | 0.257 | 0.039 |
| 47 | rs2414718 | BC033962 | 15q22.2 | 4.59E−05 | 0.128 | 0.025 |
| 48 | rs1051168 | NMB | 15q22 | 1.27E−04 | 0.203 | 0.033 |
| 49 | rs1078163 | NTRK3 | 15q25 | 2.67E−05 | 0.095 | 0.017 |
| 50 | rs2304634 | DNAJA3 | 16p13.3 | 7.90E−05 | 0.161 | 0.026 |
| 51 | rs12708772 | SHISA9 | 16p13.12 | 3.12E−03 | 0.662 | 0.044 |
| 52 | rs4785714 | ZNF276 | 16q24.3 | 1.34E−03 | 0.527 | 0.034 |
| 53 | rs12966547 | AK093940 | 18q21.2 | 6.23E−06 | 0.071 | 0.019 |
| 54 | rs159788 | BC039673 | 20p13 | 1.23E−03 | 0.527 | 0.034 |
| 55 | rs381523 | PPM1F | 22q11.22 | 1.55E−03 | 0.560 | 0.038 |
| 56 | rs9621735 | LARGE | 22q12.3 | 1.66E−05 | 0.084 | 0.041 |
| 57 | rs5758209 | EP300 | 22q13.2 | 5.06E−06 | 0.068 | 0.031 |
| 58 | rs28729663 | RPL23AP82 | 22q13.33 | 1.82E−04 | 0.257 | 0.041 |

Independent complex or single gene loci (r² < 0.2) with SNP(s) with a conditional FDR (condFDR) < 0.05 in schizophrenia (SCZ) given the association in bipolar disorder (BD). We defined the most significant SCZ SNP in each LD block based on the minimum condFDR for BD. The most significant SNPs in each LD block are listed. All loci with SNPs with condFDR < 0.05 were used to define the number of the loci. Chromosome location (Chr). SCZ FDR values < 0.05 are in bold.
†Same locus identified in previous SCZ genome-wide association studies. All data were first corrected for genomic inflation.

TABLE 2
Conditional FDR; BD loci given SCZ (BD|SCZ).

| locus | SNP | neighbor gene | Chr | pval BD | fdr BD | fdr BD\|SCZ |
|---|---|---|---|---|---|---|
| 1 | rs2252865 | RERE | 1p36.23 | 2.19E−04 | 0.44657 | 0.01306 |
| 2 | rs4650608 | IFI44 | 1p31.1 | 1.00E−03 | 0.64629 | 0.04250 |
| 3 | rs10776799 | NGF | 1p13.1 | 9.68E−06 | 0.17368 | 0.02579 |
| 4 | rs7521783 | PLEKHO1 | 1q21.2 | 5.58E−04 | 0.57626 | 0.02503 |
| 5 | rs573140 | SIPA1L2 | 1q42.2 | 6.58E−06 | 0.15946 | 0.03009 |
| 6 | rs3911862 | FLJ16124 | 2p14 | 5.65E−05 | 0.26909 | 0.04864 |
| 7 | rs2271893 | LMAN2L | 2q11.2 | 1.85E−05 | 0.18928 | 0.00960 |
| 8 | rs9834970 | TRANK1 | 3p22.2 | 5.20E−04 | 0.57626 | 0.02711 |
| 9 | rs2535629 | ITIH3† | 3p21.1 | 1.29E−05 | 0.17896 | 0.00279 |
| 10 | rs2902101 | ODZ2 | 5q34 | 1.04E−04 | 0.33589 | 0.03570 |
| 11 | rs3134942 | NOTCH4 | 6p21.3 | 1.15E−03 | 0.66028 | 0.04844 |
| 12 | rs9371601 | SYNE1† | 6q25 | 1.10E−06 | 0.06351 | 0.02196 |
| 13 | rs3823198 | RPS6KA2 | 6q27 | 4.16E−05 | 0.22281 | 0.01779 |
| 14 | rs4332037 | MAD1 | 7p22 | 3.97E−05 | 0.22281 | 0.02918 |
| 15 | rs6461233 | MAD1L1 | 7p22 | 5.19E−04 | 0.57626 | 0.02711 |
| 16 | rs10277665 | THSD7A | 7p21.3 | 5.42E−05 | 0.24328 | 0.01641 |
| 17 | rs6982836 | AX747593 | 8q13.2 | 5.64E−05 | 0.26909 | 0.04168 |
| 18 | rs7083127 | CACNB2 | 10p12 | 1.40E−04 | 0.37364 | 0.02191 |
| 19 | rs10994359 | ANK3† | 10q21 | 8.12E−10 | 0.00115 | 0.00001 |
| 20 | rs10883757 | TRIM8 | 10q24.3 | 1.11E−03 | 0.64629 | 0.03991 |
| 21 | rs17138230 | ODZ4† | 11q14.1 | 1.43E−05 | 0.18382 | 0.03822 |
| 22 | rs2239037 | CACNA1C | 12p13.3 | 9.06E−04 | 0.64629 | 0.03928 |
| | rs10774037 | CACNA1C† | 12p13.3 | 2.42E−07 | 0.01859 | 0.00161 |
| 23 | rs7296288 | DHH | 12q13.1 | 2.88E−05 | 0.20749 | 0.02777 |
| 24 | rs12427050 | NEDD1 | 12q23.1 | 5.00E−04 | 0.57626 | 0.04728 |
| 25 | rs4390476 | SLITRK1 | 13q31.1 | 2.03E−04 | 0.44657 | 0.03843 |
| 26 | rs961196 | TTC7B | 14q32.11 | 2.96E−04 | 0.50926 | 0.01872 |
| 27 | rs11160562 | EML1 | 14q32 | 6.93E−04 | 0.60769 | 0.03496 |
| 28 | rs12708772 | SHISA9 | 16p13.12 | 9.89E−04 | 0.64629 | 0.04219 |
| 29 | rs11863156 | AKTIP | 16q12.2 | 7.86E−05 | 0.30029 | 0.00865 |
| 30 | rs1424003 | CDH11 | 16q21 | 5.54E−05 | 0.24328 | 0.01641 |
| 31 | rs3809646 | C16orf7 | 16q24 | 5.76E−04 | 0.60769 | 0.03171 |
| 32 | rs281393 | RASIP1 | 19q13.33 | 5.99E−05 | 0.26909 | 0.01293 |
| 33 | rs159788 | BC039673 | 20p13 | 6.48E−04 | 0.60769 | 0.03080 |
| 34 | rs3746972 | ITGB2 | 21q22.3 | 1.42E−04 | 0.41109 | 0.04369 |
| 35 | rs381523 | PPM1F | 22q11.22 | 1.28E−03 | 0.66028 | 0.04536 |

For the independent complex or single gene loci (r² < 0.2) with SNP(s) with a conditional FDR (condFDR) < 0.05 in bipolar disorder (BD) given association with schizophrenia (SCZ). All independent loci are listed consecutively. Chromosome location (Chr). All data were first corrected for genomic inflation. BD FDR values < 0.05 are in bold.
†Same locus identified in previous BD genome-wide association studies.

TABLE 3
Conjunction FDR; pleiotropic loci in SCZ and BD (SCZ&BD).

| locus | SNP | neighbor gene | Chr | A1 | A2 | conjfdr BD&SCZ | z-score BD | z-score SCZ |
|---|---|---|---|---|---|---|---|---|
| 1 | rs2252865 | RERE | 1p36.23 | T | C | 0.030 | 3.696 | 3.494 |
| 2 | rs4650608 | IFI44 | 1p31.1 | T | C | 0.043 | 3.289 | 3.711 |
| 4 | rs11205362 | PRP3 | 1q21.1 | G | A | 0.033 | 3.404 | 3.262 |
| 8 | rs9834970 | TRANK1 | 3p22.2 | C | T | 0.027 | 3.470 | 3.965 |
| 9 | rs4687657 | ITIH4† | 3p21.1 | G | T | 0.028 | 3.787 | 3.781 |
| 11 | rs3134942 | NOTCH4† | 6p21.3 | G | T | 0.048 | 3.251 | 3.571 |
| 15 | rs3757440 | MAD1L1 | 7p22 | A | G | 0.031 | 3.490 | 3.425 |
| 20 | rs10883757 | TRIM8 | 10q24.3 | C | T | 0.040 | 3.261 | 3.046 |
| 22 | rs1006737 | CACNA1C† | 12p13.3 | A | G | 0.022 | 4.553 | 4.137 |
| 26 | rs961196 | TTC7B | 14q32.11 | C | T | 0.044 | 3.618 | 2.960 |
| 28 | rs12708772 | SHISA9 | 16p13.12 | C | T | 0.044 | 3.294 | 2.955 |
| 31 | rs1800359 | ZNF276 | 16q24.3 | A | G | 0.035 | 3.329 | 3.165 |
| 33 | rs159788 | BC039673 | 20p13 | G | A | 0.034 | 3.411 | −3.232 |
| 35 | rs381523 | PPM1F | 22q11.22 | A | G | 0.045 | 3.220 | 3.166 |

Independent complex or single gene loci (r² < 0.2) with SNP(s) with a conjunctional FDR (conjFDR) < 0.05 in schizophrenia (SCZ) and bipolar disorder (BD). All SNPs with a conjFDR value < 0.05 (bidirectional association, i.e. association with SCZ given association with BD (condFDR < 0.05) and association with BD given association with SCZ (condFDR < 0.05)) are listed and sorted in each LD block. We defined the most significant SNP in each LD block based on the minimum conjFDR. All independent loci are listed consecutively, and the same locus number are used as in the condFDR < 0.05 results (Table 1). Chromosome (Chr). Z-scores for each pleiotropic locus are provided, with minor allele (A1) and major allele (A2). All data were first corrected for genomic inflation.
†Same locus identified in previous BD or SCZ genome-wide association studies.

TABLE 4

| | | | |
|---|---|---|---|
| | | | Association SCZ, BD |
| Gene | Chr. loc. | Name encoded protein | (PheGenI) |

SCZ/BD

| | | | |
|---|---|---|---|
| RERE | 1p36.23 | arginine-glutamic acid dipeptide (RE) repeats | SCZ¹(Borderline) |
| KIAA1026 | 1p36.21 | (similar to karrin, periplakin interacting protein | |
| BC042538 | 1p35.2 | | |
| IFI44 | 1p31.1 | interferon-induced protein 44 | |
| LPAR3 | 1p22.3 | lycophosphatadic acid receptor 3 | |
| AK094607 | 1p21.3 | MIR137 host gene (non-protein coding) | SCZ¹(After replication) |
| PRP3 | 1q21.1 | PRP3 pre-mRNA processing factor 3 homolog | |
| RAD51AP2 | 2p24.2 | RAD51 associated protein 2 | |
| GCKR | 2p23 | glucokinase ( [symbol] kinase 4) regulator | |
| VRK2 | 2p16.1 | vaccinia related kinase 2 | SCZ¹ |
| SH3RF3 | 2q13 | SH3 domain containing sing finger 3 | |
| KIF5C | 2q23.1 | kinase family member 5C | |
| CWC22 | 2q31.3 | CWC22 splicesome-associated protein homolog | |
| PCGEM1 | 2q32 | [symbol] -specific transcript 1 (non-protein coding) | |
| C2orf32 | 2q37.1 | chromosome 2 open reading frame 32 | |
| AGAP1 | 2q37 | ArfGAP with GTPase domain, ankyrin repeat and | SCZ¹(Borderline) |
| | | PH domain 1 | |
| TRANE1 | 3p22.2 | tetratricopeptide repeat and ankyrin repeat | BD¹, BD¹ (Borderline), SCZ¹ |
| | | containing 1 | (Borderline) |
| ITIH4 | 3p21.1 | inter-alpha-trypsin inhibitor heavy chain family, | SCZ¹(After combining with |
| | | member 4 | BD) |
| PTPRG | 3p21-p14 | protein tyrosine phosphatase, receptor type, G | |
| DKF2p434A123 | 3q26.33 | | |
| SOFB52 | 4q35.1 | sorbin and SH3 domain containing 2 | |
| SCGN | 6p22.3-p22.1 | secregation, EF-hand calcium binding protein | |
| HIST1H2BC | 6p22.1 | histone cluster 1, H2bc | |
| HIST1H2BD | 6p21.3 | histone cluster 1, H2bd | |
| BC055101 | 6p22.1 | uncharacterised LOC100502123 | |
| ZSC43423 | 6p22.1 | zinc finger and SCAM domain containing 23 | |
| ZNF311 | 6p22.1 | zinc finger protein 311 | |
| TRIM26 | 6p21.32-p22.1 | tripartite motif containing 26 | SCZ¹ |
| MPCA | 6p21.33 | MHC class I polypeptide-related sequence A | |
| HCP5 | 6p21.3 | HLA complex P5 (non-protein coding) | |
| LT6G6C | 6p21.33 | lymphocyte antigen 6 complex, locus G6C | |
| HLA-DRA | 6p21.3 | major histocompatibility complex, class II, DR | |
| | | alpha | |
| HLA-DRB5 | 6p21.3 | major histocompatibility complex, class II, DR | |
| | | beta 5 | |
| HLA-DQB2 | 6p21 | major histocompatibility complex, class II, DQ | |
| | | beta 2 | |
| HLA-DOB | 6p21.3 | major histocompatibility complex, class II, DO | |
| | | beta | |
| HLA-DMA | 6p21.3 | major histocompatibility complex, class II, DM | |
| | | alpha | |
| CUL9 | 6p21.1 | [symbol] 9 | |
| FTHJ2 | 7p22 | FnJ RNA methyltransferase homolog 2 | |
| AK055363 | 8p23.1 | | |
| MM916 | 8q21.3 | matrix metallopeptidase 16 | SCZ¹(After replication) |
| ABCA1 | 9q31.1 | ATP-binding cassette, sub-family A (ABC1) | |
| | | member 1 | |
| AK094154 | 10p14 | | |
| ANK3 | 10q21 | ankyrin 3, node of Ranvier (ankyrin G) | BD¹, BD¹(Border-line), |
| | | | SCZ¹(After combining with |
| | | | BD), SCZ¹(Borderline) |
| RRP12 | 10q24.1 | ribosomal RNA processing 12 homolog | |
| SUFU | 10q24.32 | suppressor of fused homolog | |
| CNNM2 | 10q24.32 | cyclin M2 | SCZ¹(After replication) |
| NTSC2 | 10q24.32 | 5′-nucleotidase, cytosolic II | SCZ¹(After replication) |
| PIK3C2A | 11p15.5-p14 | phosphatidylinositol-4-phosphate 3-kinase, | SCZ¹(Borderline) |
| | | catalytic subunit type 2 alpha | |
| LRP5 | 11q13.4 | low density lipoprotein receptor-related protein 5 | |
| GAL | 11q13.3 | galanin prepropeptide | |
| LOC599919 | 11q24.1 | mir-100-let-7a-2 charter host gene (non-protein | |
| | | coding) | |
| SNX19 | 11q25 | sorting nexin 19 | SCZ¹(Borderline) |
| IGSF9B | 11q25 | immunoglobulin superfamily, member 9B | |
| CACNA1C | 12p13.3 | calcium channel, voltage-dependent, L type, alpha | SCZ¹(After combining with |
| | | 1C subunit | BD), BD [symbol] |
| DAOA | 13q34 | D-amino acid oxidase activator | SCZ¹(Borderline) |
| TTC7B | 14q32.11 | intratricopeptide repeat domain 7B | |
| TMCO5A | 15q14 | transmembrane and coiled-coil domain 5A | BD¹(Borderline) |
| C15orf54 | 15q14 | chromosome 15 open reading frame 54 | BD¹(Borderline) |
| PLCB2 | 15q15 | phospholipase C, beta 2 | SCZ¹(Borderline) |
| BC033902 | 15q22.2 | | |
| NMB | 15q22-qter | neuromedin B | |
| NTBK3 | 15q25 | neurotrophic tyrosine kinase, receptor, type 3 | |
| DNAJA3 | 15p13.3 | DnaJ (Hsp40) homolog, subfamily A, member 3 | |
| SH13A9 | 15p13.12 | [symbol] homolog 9 | SCZ¹(Borderline) |
| ZNF276 | 16q24.3 | zinc finger protein 276 | |
| AK093940 | 18q21.2 | | |
| BC039673 | 20p13 | | |
| PPMIF | 22q11.22 | protein phosphatase, Mg2+/Mn2+ dependent, 1F | |
| LARGE | 22q12.3 | like-glycosyltransferase | |
| EP300 | 22q13.2 | E1A binding protein p300 | |
| RPL23AP32 | 22q13.33 | ribosomal protein L23a pseudogene 82 | |

BD/SCZ (not already in SCZ/BD part of Table above)

| | | | |
|---|---|---|---|
| MGF | 1p13.1 | nerve growth factor (beta polypeptide) | |
| PLEKHO1 | 1q21.2 | pleckatin homolog domain containing, family O | |
| | | member 1 | |
| SIPA1L2 | 1q42.2 | signal-induced proliference-associated 1 like 2 | |
| FLJ16124 | 2p14 | FLJ16124 protein | |
| LMAN2L | 2q11.2 | lectin, mannose-binding 2-like | BD¹, BD [symbol] (Borderline) |
| ITIH3 | 3p21.1 | inter-alpha-trypsin inhibitor heavy chain 8 | BD⁴(After combining with |
| | | | SCZ) |
| ODZ2 | 5q34 | cdz, odd Ozten-m homolog 2 | |
| NOTCH4 | 6p21.3 | notch 4 | SCZ¹ |
| SYNE1 | 6q25 | spectris repeat containing nuclear envalope 1 | BD^{4,3} (Borderline), BD [symbol] |
| RPS [symbol] KA2 | 6q27 | ribosomal protein S6 kinase, 90 kDa, polypeptide 2 | |
| MAD1 | MAD1L1 | | |
| MAD1L1 | 7p22 | MAD1 [symbol] deficient-like 1 | SCZ¹(Borderline), BD [symbol] |
| | | | (Borderline) |
| THSD7A | 7p21.3 | thumbospondin, type 1, domain containing 7A | |
| AK747593 | 8q13.2 | | |
| CACSB2 | 10p12 | calcium channel, voltage-dependent, beta 2 | |
| | | subunit | |
| TRIMB | 10q24.3 | tripartite motif containing 8 | |
| ODZ4 | 11q14.1 | odr, odd Ozten-m homolog 4 | BD⁴(After replication) |
| DHH | 12q13.1 | decent [symbol] | |
| NEDD1 | 12q23.1 | neural precursor cell expressed, developmentally | |
| | | down-regelated 1 | |
| SLITEK1 | 13q31.1 | SLIT and NTRK-like family member 1 | |
| EML1 | 14q32 | enhmoderm microtubule associated protein like 1 | |
| AKTIP | 16q12.2 | AKT interacting protein | |
| CDH11 | 16q21 | calcineurin 11 type 2, OB-cadherin | |
| C16orf [symbol] | 16q24 | chromosome 16 open reading frame | |
| RASIP1 | 19q13.33 | Ras interacting protein 1 | BD¹(borderline) |
| BC039675 | 20p13 | | |
| ITGB2 | 21q22.3 | integrin, beta 2 (complement component 3 | |
| | | receptor 3 and 4 subunit) | |

BD = bipolar disorder,
SCZ = schizophrenia.
‘Borderline’ indicates not [symbol] significant p-values.
‘After replication’ indicates findings in original GWAS of SCZ or BD (used in the cancer study) that were not genome-wide significant, but reached significance only after including a large replication sample (see ref 1 and 4 for details). Some of the findings in Ripke et al (ref 1) were not significant after GC correction. PheGenI does base and [symbol] were used as indentity previous results. [symbol]
indicates data missing or illegible when filed

### REFERENCES

1. Glazier A M, Nadeau J H, Aitman T J (2002) Finding genes that underlie complex traits. Science 298:2345-2349.
2. Hindorff L A, Sethupathy P, Junkins H A, Ramos E M, Mehta J P, et al. (2009) Potential etiologic and functional implications of genome-wide association loci for human diseases and traits. Proc Natl Acad Sci USA 106: 9362-9367.
3. Hirschhorn J N, Daly M J (2005) Genome-wide association studies for common diseases and complex traits. Nat Rev Genet 6: 95-108.
4. Yang J, Manolio T A, Pasquale L R, Boerwinkle E, Caporaso N, et al. (2011) Genome partitioning of genetic variation for complex traits using common SNPs. Nat Genet 43: 519-525.
5. Yoo Y J, Pinnaduwage D, Waggott D, Bull S B, Sun L (2009) Genome-wide association analyses of North American Rheumatoid Arthritis Consortium and Framingham Heart Study data utilizing genome-wide linkage results. BMC Proc 3 Suppl 7: S103.
6. Stahl E A, Wegmann D, Trynka G, Gutierrez-Achury J, Do R, et al. (2012) Bayesian inference analyses of the polygenic architecture of rheumatoid arthritis. Nat Genet 44: 483-489.
7. Manolio T A, Collins F S, Cox N J, Goldstein D B, Hindorff L A, et al. (2009) Finding the missing heritability of complex diseases. Nature 461: 747-753.
8. Wagner G P, Zhang J (2011) The pleiotropic structure of the genotype-phenotype map: the evolvability of complex organisms. Nat Rev Genet 12: 204-213.
9. Chambers J C, Zhang W, Sehmi J, Li X, Wass M N, et al. (2011) Genome-wide association study identifies loci influencing concentrations of liver enzymes in plasma. Nat Genet 43: 1131-1138.
10. Sivakumaran S. Agakov F, Theodoratou E, Prendergast J G, Zgaga L. et al. (2011) Abundant pleiotropy in human complex diseases and traits. Am J Hum Genet 89: 607-618.
11. Cotsapas C, Voight B F, Rossin E, Lage K, Neale B M, et al. (2011) Pervasive sharing of genetic effects in autoimmune disease. PLoS Genet 7: e1002254.
12. Ripke S, Sanders A R, Kendler K S, Levinson D F, Sklar P, et al. (2011) Genome-wide association study identifies five new schizophrenia loci. Nat Genet 43: 969-976.
13. Sklar P, Ripke S, Scott L J, Andreassen O A, Cichon S, et al. (2011) Large-scale genome-wide association analysis of bipolar disorder identifies a new susceptibility locus near ODZ4. Nat Genet 43: 977-983.
14. Lichtenstein P, Yip B H, Bjork C, Pawitan Y, Cannon T D, et al. (2009) Common genetic determinants of schizophrenia and bipolar disorder in Swedish families: a population-based study. Lancet 373: 234-239.
15. Purcell S M, Wray N R, Stone J L, Visscher P M, O'Donovan M C, et al. (2009) Common polygenic variation contributes to risk of schizophrenia and bipolar disorder. Nature 460: 748-752.
16. Stefansson H, Ophoff R A, Steinberg S, Andreassen O A, Cichon S, et al. (2009) Common variants conferring risk of schizophrenia. Nature 460: 744-747.
17. Craddock N, Owen M J (2007) Rethinking psychosis: the disadvantages of a dichotomous classification now outweigh the advantages. World Psychiatry 6: 84-91.
18. Vieta E, Phillips M L (2007) Deconstructing bipolar disorder: a critical review of its diagnostic validity and a proposal for DSM-V and ICD-11. Schizophr Bull 33: 886-892.
19. Fischer B A, Carpenter W T, Jr. (2009) Will the Kraepelinian dichotomy survive DSM-V? Neuropsychopharmacology 34: 2081-2087.
20. Simonsen C, Sundet K, Vaskinn A, Birkenaes A B, Engh J A, et al. (2011) Neurocognitive dysfunction in bipolar and schizophrenia spectrum disorders depends on history of psychosis rather than diagnostic group. Schizophr Bull 37: 73-83.
21. Crow T J (1986) The continuum of psychosis and its implication for the structure of the gene. Br J Psychiatry 149: 419-429.
22. Craddock N, Owen M J (2005) The beginning of the end for the Kraepelinian dichotomy. Br J Psychiatry 186: 364-366.
23. Craddock N, O'Donovan M C, Owen M J (2009) Psychosis genetics: modeling the relationship between schizophrenia, bipolar disorder, and mixed (or “schizoaffective”) psychoses. Schizophr Bull 35: 482-490.
24. O'Donovan M C, Craddock N, Norton N, Williams H, Peirce T, et al. (2008) Identification of loci associated with schizophrenia by genome-wide association and follow-up. Nat Genet 40: 1053-1055.
25. Williams H J, Craddock N, Russo G, Hamshere M L, Moskvina V, et al. (2011) Most genome-wide significant susceptibility loci for schizophrenia and bipolar disorder reported to date crosstraditional diagnostic boundaries. Hum Mol Genet 20: 387-391.
26. Sun L, Craiu R V, Paterson A D, Bull S B (2006) Stratified false discovery control for large-scale hypothesis testing with application to genome-wide association studies. Genet Epidemiol 30: 519-530.
27. Efron B (2010) Large-scale inference: empirical Bayes methods for estimation, testing, and prediction. Cambridge; New York: Cambridge University Press. xii, 263 p. p.
28. Schweder T, Spjotvoll E (1982) Plots of P-Values to Evaluate Many Tests Simultaneously. Biometrika 69: 493-502.
29. Benjamini Y, Hochberg Y (1995) Controlling the False Discovery Rate: A Practical and Powerful Approach to Multiple Testing. Journal of the Royal Statistical Society Series B (Methodological): Blackwell Publishing. pp. 289-300.
30. Steinberg S, de Jong S, Andreassen O A, Werge T, Borglum A D, et al. (2011) Common variants at VRK2 and TCF4 conferring risk of schizophrenia. Hum Mol Genet 20: 4076-4081.
31. Ferreira M A, O'Donovan M C, Meng Y A, Jones I R, Ruderfer D M, et al. (2008) Collaborative genome-wide association analysis supports a role for ANK3 and CACNA1C in bipolar disorder. Nat Genet 40: 1056-1058.
32. Green E K, Grozeva D, Forty L, Gordon-Smith K, Russell E, et al. (2012) Association at SYNE1 in both bipolar disorder and recurrent major depression. Mol Psychiatry.
33. Craiu R V, Sun L (2008) Choosing the lesser evil: Trade-off between false discovery rate and nondiscovery rate. Statistica Sinica 18: 861-879.
34. Chen D T, Jiang X, Akula N, Shugart Y Y, Wendland J R, et al. (2011) Genome-wide association study meta-analysis of European and Asian-ancestry samples identifies three novel loci associated with bipolar disorder. Mol Psychiatry.
35. Detera-Wadleigh S D, McMahon F J (2006) G72/G30 in schizophrenia and bipolar disorder: review and meta-analysis. Biol Psychiatry 60: 106-114.
36. Dieset I, Djurovic S, Tesli M, Hope S, Mattingsdal M, et al. (2012) NOTCH4 Gene Expression is Upregulated in Bipolar Disorder. Am J Psychiatry in press.
37. Larkum M E, Nevian T, Sandler M, Polsky A, Schiller J (2009) Synaptic integration in tuft dendrites of layer 5 pyramidal neurons: a new unifying principle. Science 325: 756-760.
38. Pollard K S, Salama S R, Lambert N, Lambot M A, Coppens S, et al. (2006) An RNA gene expressed during cortical development evolved rapidly in humans. Nature 443: 167-172.
39. King M C, Wilson A C (1975) Evolution at two levels in humans and chimpanzees. Science 188:107-116.
40. Siepel A, Bejerano G, Pedersen J S, Hinrichs A S, Hou M, et al. (2005) Evolutionarily conserved elements in vertebrate, insect, worm, and yeast genomes. Genome Res 15: 1034-1050.
41. Efron B (2007) Size, power and false discovery rates. The Annals of Statistics 35: 1351-1377.
42. Nichols T, Brett M, Andersson J, Wager T, Poline J B (2005) Valid conjunction inference with the minimum statistic. Neuroimage 25: 653-660.

### Example 2

### Materials and Methods

Genome-Wide Association Study (GWAS) Data

Fourteen phenotypes, body mass index (BMI) [30], height, waist to hip ratio [31](WHR), Crohn's disease [32](CD), ulcerative colitis [33](UC), schizophrenia [34](SCZ), bipolar disorder [35](BD), smoking behavior as measured by cigarettes per day [36](CPD), systolic and diastolic blood pressure [37](SBP, DBP), and plasma lipids [38](triglycerides, TG, total cholesterol, TC, high density lipoprotein, HDL, low density lipoprotein, LDL), were considered. Genome-wide association study (GWAS) results were obtained as summary statistics (p-values or z-scores) from public access websites (BMI, Height, WHR, TC, TG, HDL, LDL: GIANT consortium data files; IBD Genetics; Psychiatric Genomics Consortium; Center for statistical genetics and the University of Michigan; Geneva University Hospital—Tulipe Center For Cardiovascular Research), published supplementary material (SBP, DBP; The International Consortium for Blood Pressure Genome—Wide Association Studies, Nature 478, 103-109 (6 Oct. 2011)), or through collaborations with investigators (CD, UC, SCZ, BD). For CD pre-meta-analysis, sub-study specific p-values and effect sizes (z-scores) were obtained from the study principal investigators. In total these studies considered more than 1.3 million phenotypic observations, but considerable sample overlap makes the number of unique individuals much less.

GWAS Summary Statistics Processing.

The summary statistics from the respective GWAS meta-analyses, derived according to best practices, were used as-is. No further processing was performed, with the exception of intergenic inflation control (described below). Results from SNPs with reference SNP (rs) numbers that did not map to the 1000 genomes project (1KGP) reference panel were excluded.

Positional Annotation Categories

Bi-allelic SNP genotypes from the European reference sample provided by the November 2010 release of Phase 1 of the 1KGP were obtained in pre-processed form. Using Plink version 1.07 [39,40] 1KGP SNPs with a minor allele frequency less than 1%, missing in more than 5% of individuals and/or violating Hardy-Weinberg equilibrium (p<1×10⁻⁶) were excluded from the reference panel. Individuals missing more than 10% of genotypes were excluded. Each remaining 1KGP SNP was assigned a single, mutually exclusive genic annotation category based on its genomic position (hg19). Genic annotation categories were: 1) 10,000 to 1,001 base pairs upstream (10 k Up); 2) 1,000 to 1 base pair upstream (1 k Up); 3) 5′ untranslated region (5′UTR); 4) exon; 5) intron; 6) 3′ untranslated region (3′UTR); 7) 1 to 1,000 base pairs downstream (1 k Down); 8) 1,001 to 10,000 base pairs downstream (10 k Down), all with reference to protein coding genes only. Annotations were assigned based on the first gene transcript listed in the UCSC known genes database [41]. In total 9,078,405 1KGP SNPs were assigned positional categories. All positional categories were scored 0 or 1.

Linkage Disequilibrium (LD) Weighted Scoring

For each GWAS tag SNP a pairwise correlation coefficient approximation to LD (r2) was calculated for all 1KGP SNPs within 1,000,000 base pairs (1 Mb) of the SNP using Plink version 1.07 [39,40]. LD scores were thresholded providing continuous valued estimates from 0.2 to 1.0; r2 values<0.2 were set to 0 and each SNP was assigned an r2 value of 1.0 with itself. LD-weighted annotation scores were computed as the sum of r2 LD between the tag SNP and all 1KGP SNPs positioned in a particular category. Each tag SNP was assigned to every LD-weighted annotation category for which its annotation score was greater than or equal to 1.0. The resulting LD-weighted annotation categories were not mutually exclusive such that each GWAS tag SNP could be annotated with multiple categories. All analyses were repeated using a second set of LD thresholding parameters and found to be robust.

Intergenic SNPs.

Intergenic SNPs were determined after LD-weighted scoring and defined as having LD-weighted annotations scores for each of the eight categories equal to zero. In addition they were defined to not be in LD with any SNPs in the 1KGP reference panel located within 100.000 base pairs of a protein coding gene, within a noncoding RNA, within a transcription factor binding site nor within a microRNA binding site. SNPs labeled intergenic were defined to be a specific collection of non-genic SNPs chosen to not represent any functional elements within the genome (including through LD). Because of how they are defined these SNPs are hypothesized to represent a collection of null associations. Other non-genic categories (1 k up, 10 k up, 1 k down and 10 k down) were included in the analyses to ensure SNPs not too far away from genes, but not within protein coding genes, were represented by non-genic categories and enrichment due to these SNPs was not solely attributed to LD with genie categories.

Stratified Q-Q Plots and Enrichment

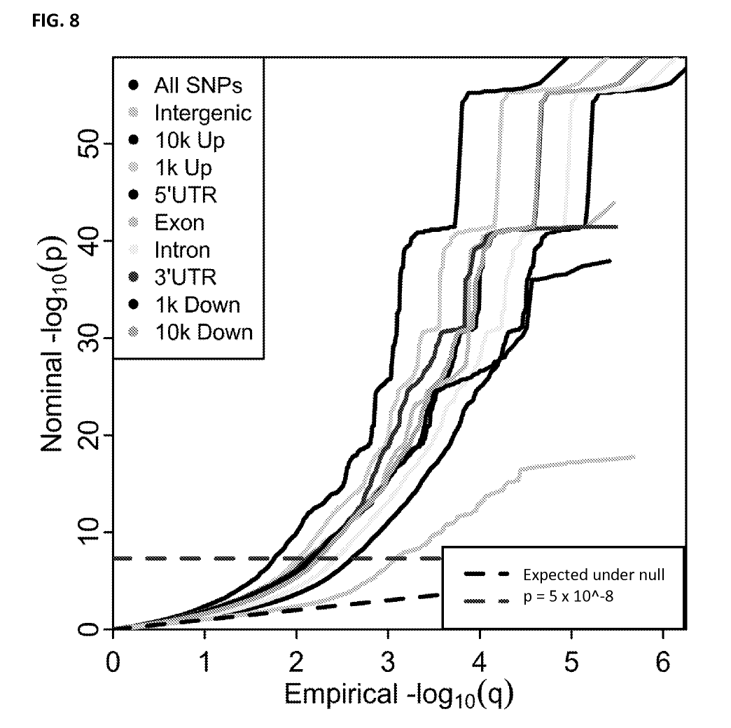

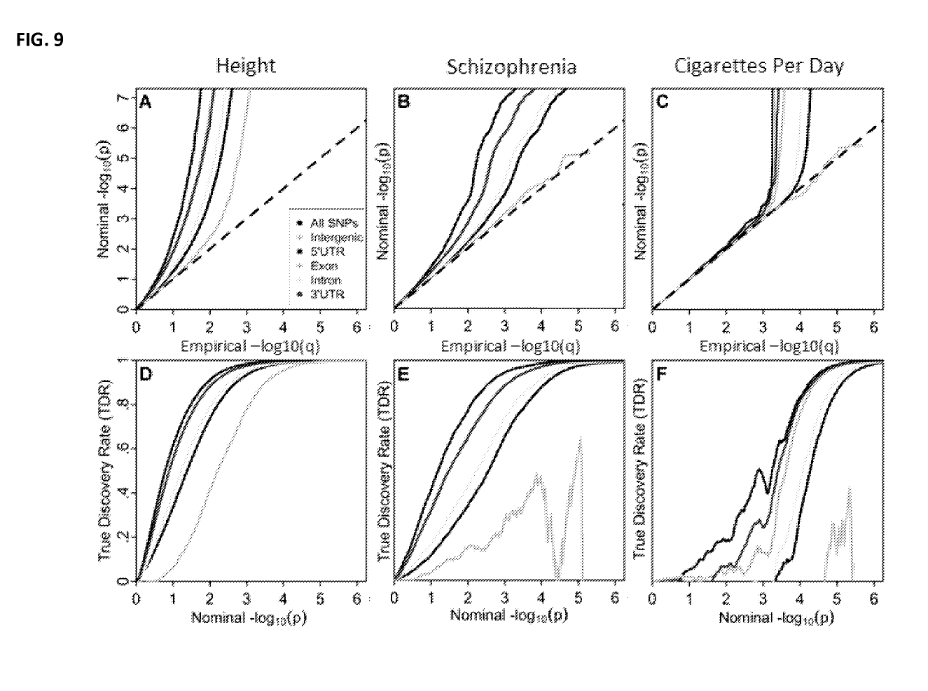

Q-Q plots compare two probability distributions. For each phenotype, for all SNPs and for each categorical subset, −log₁₀ nominal p-values were plotted against −log₁₀ empirical p-values. Leftward deflections of the observed distribution from the projected null line reflect increased tail probabilities in the distribution of test statistics (z-scores) and consequently an over-abundance of low p-values compared to that expected by chance. This deflection is referred to as “enrichment (FIGS. 8 and 9).

The significance of the annotation enrichment was estimated using two sample Kolmogorov-Smirnov (KS) Tests to compare the distribution of test statistics in each genic annotation category to the distribution of the intergenic category, for each phenotype. SNPs were pruned randomly to approximate independence (r²<0.2) ten times.

Intergenic Inflation Control

The empirical null distribution in GWAS is affected by global variance inflation due to factors including population stratification and cryptic relatedness [17] and deflation due to over-correction of test statistics for polygenic traits by standard genomic control methods. A control method leveraging was applied only intergenic SNPs which are likely depleted for true associations. All p-values were converted into z-scores, and, for each phenotype, the genomic inflation factor [16], λ_{GC}, was estimated for intergenic SNPs. All test statistics were divided by λ GC.

The inflation factor, λ_{GC} was computed as the median z-score squared divided by the expected median of a chi-square distribution with one degree of freedom or all phenotypes except CPD, where the 0.95 quantile was used in place of the median. 4.

Quantification of Categorical Enrichment

For each phenotype, enrichment was measured as the mean(z-score² −1) for each category and normalized by the largest value per phenotype. The mean(z-score² −1) is a conservative estimate of the variance attributable to non-null SNPs, given a standard normal null distribution and a non-null distribution symmetric around zero.

Q-Q Plots and False Discovery Rate (FDR)

Enrichment seen in the conditional Q-Q plots can be directly interpreted in terms of the FDR. Specifically, for a given p-value cutoff, the Bayes FDR [17] is defined as

FDR(p)=π₀F₀(p)/F(p), [1]

where π₀ is the proportion of null SNPs, F₀ is the null cdf, and F is the cdf of all SNPs, both null and non-null. Under the null hypothesis, F₀ is the cdf of the uniform distribution on the unit interval [0,1], so that Eq. [1] reduces to

FDR(p)=π₀p/F(p). [2]

The cdf F can be estimated by the empirical cdf q=Nₚ/N, where Nₚ is the number of SNPs with p-values less than or equal to p, and N is the total number of SNPs. Replacing F by q and replacing π₀ with unity in Eq. [2]

FDR(p)≈p/q, [3]

This is upwardly biased, and hence p/q is conservative estimate of the FDR, and 1−p/q is a conservative estimate of the Bayes TDR[17].

If π₀ is close to one, as is likely true for most GWAS, the increase in bias from setting π₀ to one in Eq. [3] is minimal. The quantity 1−p/q, is therefore biased downward, and hence a conservative estimate of the TDR.

Referring to the formulation of the Q-Q plots, FDR(p) is equivalent to the nominal p-value under the null hypothesis divided by the empirical quantile of the p-values. Given the −log₁₀ transformation applied to the Q-Q plots,

−log₁₀(FDR(p))≈log₁₀(q)−log₁₀(p) [4]

demonstrating that the (conservatively) estimated FDR is directly related to the horizontal shift of the curves in the stratified Q-Q plots from the expected line x=y, with a larger shift corresponding to a smaller FDR. For the TDR plots in FIG. 2, the TDR for each genic category was estimated according to Eq. [4].

Eq. [3] is the Empirical Bayes point estimate of the Bayes FDR given in Efron (2010). Using Eq. [3] to control FDR (e.g., the expected proportion of falsely rejected null hypotheses) [21] is closely related to the “fixed rejection region” approach of Storey[47,48]. Specifically, Storey[47] showed, for a given FDR α, rejecting all null hypotheses such that p/q<α is equivalent to the Benjamini-Hochberg procedure and provides asymptotic control of the FDR to α if the true null p-values are independent and uniformly distributed. Storey[47] also noted that asymptotic control is preserved under positive blockwise dependence, whereas Schwartzman and Lin [49] showed that Eq. [3] is a consistent estimator of FDR for asymptotically sparse dependence (e.g., the proportion of correlated pairs of p-values goes to zero as the number of hypothesis tests becomes large). Sparse dependence is a good description of the dependence present in GWAS data; for example, based on a threshold of R²>0.05 within 1,000,000 basepairs, one can estimate the ratio of correlated pairs to total pairs of p-values at 0.000128.

Replication Rate

For each of eight sub-studies contributing to the final meta-analysis in the CD report z-scores were independently adjusted using intergenic inflation control. For each of 70 (8 choose 4) possible combinations of four-study discovery and four-study replication sets, the four-study combined discovery z-score and four-study combined replication z-score for each SNP were calculated as the average z-score across the four studies, multiplied by two (the square root of the number of studies). For discovery samples the z-scores were converted to two-tailed p-values, while replication samples were converted to one-tailed p-values preserving the direction of effect in the discovery sample. For each of the 70 discovery-replication pairs cumulative rates of replication were calculated over 1000 equally-spaced bins spanning the range of negative log₁₀(p-values) observed in the discovery samples. The cumulative replication rate for any bin was calculated as the proportion of SNPs with a −log 10(discovery p-value) greater than the lower bound of the bin with a replication p-value<0.05. Cumulative replication rates were calculated independently for each of the eight genic annotation categories as well as intergenic SNPs and all SNPs. For each category, the cumulative replication rate for each bin was averaged across the 70 discovery-replication pairs and the results are reported in FIG. 4. The vertical intercept is the overall replication rate.

Stratified False Discovery Rates:

A multiple linear regression was used to predict the tagged variance (z2) for each SNP in the height GWAS from the unthresholded LD-weighted annotation scores. Using the category weights determined from the variance regression on the height GWAS, the tagged variance for each SNP was predicted for each other phenotype. For each phenotype, SNPs were grouped into strata according to the rank of their predicted tagged variance. Enrichment for each stratum was demonstrated using QQ-plots as described above. Sun et al [9] described a stratified false discovery rate (sFDR) procedure which results in improved statistical power over traditional FDR methods [16] when a collection of statistical tests can be grouped into disjoint strata with different levels of enrichment. In order to demonstrate the utility of using genic annotation categories in combination with sFDR for increasing power, the number of SNPs deemed significant at a given FDR threshold using both traditional[21] and stratified FDR was computed, where the strata were determined by the predicted tagged variance for each SNP based on regression weights determined from the height GWAS summary statistics (FIG. 5). From this, the ratio of Non-Discovery Rates (NDRs) [22] was estimated for the two methods for common FDR thresholds α. The average proportion of SNPs above a given rank (e.g., top 1000) that replicated based on unadjusted and strata adjusted ranks (determined from the sFDR procedure) across the 70 permutations of four study discovery and four study replication samples possible in the eight study CD meta-analysis GWAS was calculated. These results demonstrate that for a given threshold, SNPs ranked via genic category-informed sFDR replicate in higher numbers than SNPs ranked via traditional FDR.

### Data Acquisition and Processing

For all studies, Genome-wide association study (GWAS) results in the form of summary statistic p-values were obtained from public access websites (Speliotes E K, Willer C J, Berndt S I, Monda K L, Thorleifsson G, et al. (2010) Association analyses of 249,796 individuals reveal 18 new loci associated with body mass index. Nat Genet 42: 937-948; Lango Allen H, Estrada K, Lettre G, Berndt S I, Weedon M N, et al. (2010) Hundreds of variants clustered in genomic loci and biological pathways affect human height. Nature 467: 832-838; Heid I M, Jackson A U, Randall J C, Winkler T W, Qi L, et al. (2010) Meta-analysis identifies 13 new loci associated with waist-hip ratio and reveals sexual dimorphism in the genetic basis of fat distribution. Nat Genet 42: 949-960; Teslovich T M, Musunuru K, Smith A V, Edmondson A C, Stylianou I M, et al. (2010) Biological, clinical and population relevance of 95 loci for blood lipids. Nature 466: 707-713), (Ehret G B, Munroe P B, Rice K M, Bochud M, Johnson A D, et al. (2011) Genetic variants in novel pathways influence blood pressure and cardiovascular disease risk. Nature 478: 103-109) or through collaboration with investigators (Franke A, McGovern D P, Barrett J C, Wang K, Radford-Smith G L, et al. (2010) Genome-wide meta-analysis increases to 71 the number of confirmed Crohn's disease susceptibility loci. Nat Genet 42: 1118-1125; Anderson C A, Boucher G, Lees C W, Franke A, D'Amato M, et al. (2011) Meta-analysis identifies 29 additional ulcerative colitis risk loci, increasing the number of confirmed associations to 47. Nat Genet 43: 246-252; Consortium TSPG-WASG (2011) Genome-wide association study identifies five new schizophrenia loci. Nat Genet 43: 969-976; Group PGCBDW (2011) Large-scale genome-wide association analysis of bipolar disorder identifies a new susceptibility locus near ODZ4. Nat Genet 43: 977-983). For Crohn's disease (CD) (Franke et al., supra) pre-meta-analysis, sub-study specific p-values and effect sizes (z-scores) were obtained from the study principal investigators. See Table 11.

In total over 1.3 million phenotypic observations were considered; however, due to considerable overlap in samples, the number of unique individuals surveyed is significantly less. Blood pressure phenotypes (systolic blood pressure; SBP, diastolic blood pressure; DBP) were a part of one study sample (Ehret et al., supra) as were lipid traits (triglycerides; TG, total Cholesterol; TC, High density lipoprotein; HDL, Low density lipoprotein; LDL) (Teslovich et al., supra). In addition, Body Mass Index (BMI) (Speliotes et al., sura), Height (Lango et al., supra) and Waist-hip-ratio (WHR) (Heid et al., supra) all arose from the GIANT consortium and there is thus much sample redundancy.

The samples used in the lipids GWAS (Teslovich et al., supra) overlap considerably with the GIANT consortium samples, as do the samples used in the smoking GWAS (Consortium TaG (2010) Genome-wide meta-analyses identify multiple loci associated with smoking behavior. Nat Genet 42: 441-447). The Schizophrenia (Consortium, supra) and Bipolar Disorder GWAS (Group, supra) share some controls. The phenotypes, however, are diverse.

### Genic Annotation Categories

Bi-allelic SNP genotypes from the European reference sample provided by the November 2010 release of Phase 1 of the 1000 Genomes Project (1KGP) were obtained in pre-processed form. Additional quality control was performed on the 1KGP data using Plink version 1.07 (Purcell S, Neale B, Todd-Brown K, Thomas L, Ferreira M A, et al. (2007) PLINK: a tool set for whole-genome association and population-based linkage analyses. Am J Hum Genet 81: 559-575). 1KGP genotypes were pruned according to standard GWAS procedures, removing all SNPs with a minor allele frequency less than 1%, missing in more than 5% of individuals or violating Hardy-Weinberg equilibrium (p<1×10⁻⁶). Individuals missing more than 10% of genotypes were excluded. Plink implementations of identity by state (IBS) and identity by descent (IBD) analysis were used to remove one individual from each related pair present and implementations of multidimensional scaling were used to ensure population homogeneity within the reference sample.

Each SNP in the 1KGP based reference sample was assigned a mutually exclusive category based on its position within the genome. A computational annotation pipeline (Torkamani A, Scott-Van Zeeland A A, Topol E J, Schork N J (2011) Annotating individual human genomes. Genomics 98: 233-241), which calls upon a variety of publicly available tools and databases to aggregate comprehensive functional and positional information for any one variant, was utilized. For variants in genes with multiple transcripts or at positions that correspond to multiple genes categories were assigned based only on the position within the first gene listed in the UCSC known genes database (Hsu F, Kent W J, Clawson H, Kuhn R M, Diekhans M, et al. (2006) The UCSC Known Genes. Bioinformatics 22: 1036-1046). In total 9,078,405 1KGP SNPs were annotated with positional categories. All positional categories were scored 0 or 1.

The following genic annotation categories were used:

10 k Up. This category consisted of all 1KGP SNPs that were between 10,000 and 1,001 base pairs upstream of the transcription start site for the primary listing of protein coding genes in the UCSC known genes database (Hsu et al., supra). For SNPs gene dense areas, priority was given to upstream category over downstream. Thus SNPs both 10,000 base pairs upstream and downstream from a protein coding gene were only annotated with the upstream category.

1 k Up. This category consisted of all 1KGP SNPs that were between 1,000 and 1 base pair(s) upstream of the transcription start site for the primary listing of protein coding genes in the UCSC known genes database (Hsu et al., supra). For SNPs gene dense areas, priority was given to upstream category over downstream. Thus SNPs both 1,000 base pairs upstream and downstream from a protein coding gene were only annotated with the upstream category.

5′UTR. This category consisted of all 1KGP SNPs that were located within the five prime untranslated region (5′UTR) of the primary listing of protein coding genes in the UCSC known genes database (Hsu et al., supra). All regions that are transcribed, but not translated, are assigned to UTR categories. If a polymorphism was within an exon or intron within a 5′UTR, it was annotated only as 5′UTR.

Exon. This category consisted of all 1KGP SNPs that were located within an exon of the primary listing of protein coding genes in the UCSC known genes database (Hsu et al., supra). If a polymorphism was within an exon that fell within the 5′UTR or 3′UTR of a gene, it was annotated only as 5′UTR or 3′UTR.

Intron. This category consisted of all 1KGP SNPs that were located within an intron of the primary listing of protein coding genes in the UCSC known genes database (Hsu et al., supra). If a polymorphism was within an intron that fell within the 5′UTR or 3′UTR of a gene, it was annotated only as 5′UTR or 3′UTR.

3′UTR. This category consisted of all 1KGP SNPs that were located within the three prime untranslated region (3′UTR) of the primary listing of protein coding genes in the UCSC known genes database (Hsu et al., supra). All regions that are transcribed, but not translated, are assigned to UTR categories. If a polymorphism was within an exon or intron within a 3′UTR, it was annotated only as 5′UTR.

1 k Down. This category consisted of all 1KGP SNPs that were between 1 and 1,000 base pair(s) downstream of the transcription start site for the primary listing of protein coding genes in the UCSC known genes database (Hsu et al., supra). For SNPs gene dense areas, priority was given to upstream category over downstream. Thus SNPs both 1,000 base pairs upstream and downstream from a protein coding gene were only annotated with the upstream category.

10 k Down. This category consisted of all 1KGP SNPs that were between 1,001 and 10,000 base pair(s) downstream of the transcription start site for the primary listing of protein coding genes in the UCSC known genes database (Hsu et al., supra). For SNPs gene dense areas, priority was given to upstream category over downstream. Thus SNPs both 10,000 base pairs upstream and downstream from a protein coding gene were only annotated with the upstream category.

Additional categories were recorded, including 10,001-100,000 BP up and downstream of protein coding genes, presence within a non-coding RNA, presence within a transcription factor binding site, and presence within a microRNA binding site. These categories were used to help select intergenic SNPs but were not analyzed in terms of differential enrichment (see discussion below).

### Linkage Disequilibrium (LD) Weighted Annotation Score

The above positional annotations were leverages in the densely mapped 1KGP to characterize the types of variants that each GWAS studied SNP was a surrogate for, or tagged, as a result of Linkage Disequilibrium (LD). Each GWAS performed quality control according to best practices, as describes in detail in each of the original publications (See above). GWAS SNPs with reference SNP (rs) numbers that did not map to the 1KGP were excluded.

In order to assign LD-weighted annotation scores, a correlation coefficient approximation to r² pairwise linkage disequilibrium (LD) was calculated using Plink version 1.07 (Purcell et al., supra). For each GWAS tag SNP present in the 1KGP pairwise LD was calculated to all other 1KGP SNPs within 1,000,000 base pairs (1 Mb) on either side of the SNP. This provided, for each SNP, a 2 Mb window in which LD scores were considered. LD scores were thresholded at r²≧0.2. LD scores were continuous valued from 0.2 to 1. Each SNP was assigned an LD value of 1 with itself (The robustness of the results to these parameter settings is discussed below in the section entitled Robustness of LD Weighted Scoring Procedure).

For each GWAS tag SNP, continuous, non-exclusive LD-weighted category scores were assigned as the LD weighted sum of the positional category scores for variants tagged in each of the eight categories mentioned above as annotated in the 1KGP reference panel. Summary statistics describing the distribution of scores in each category for the 2,558,411 SNPs representing the union of all GWAS considered are provided in Table 12.

Intergenic SNPs were determined after LD-weighted scoring. They were defined by weighted LD scores for each of the eight categories equal to zero. In addition these SNPs did not tag any SNPs in the 1KGP reference panel located within 100,000 base pairs of a protein coding gene, within a noncoding RNA, within a transcription factor binding site nor within a microRNA binding site.

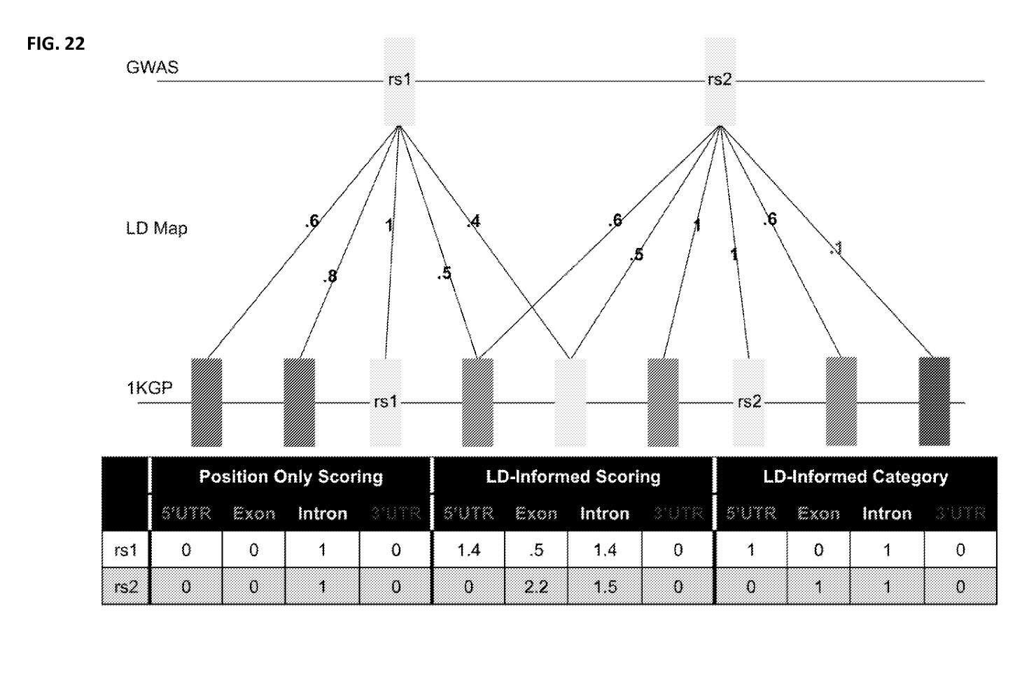

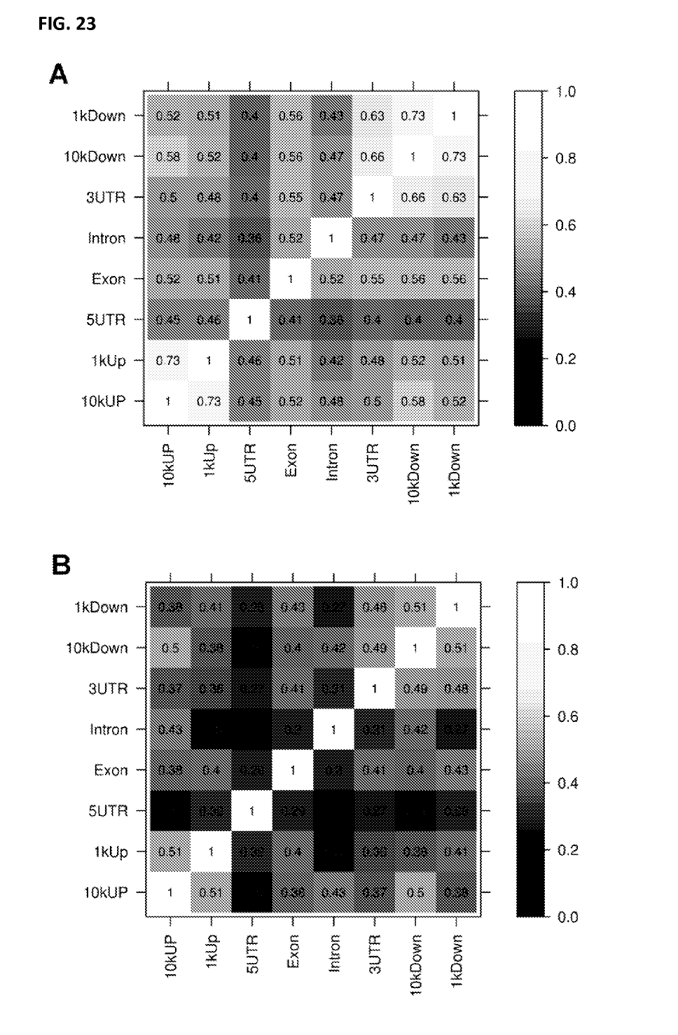

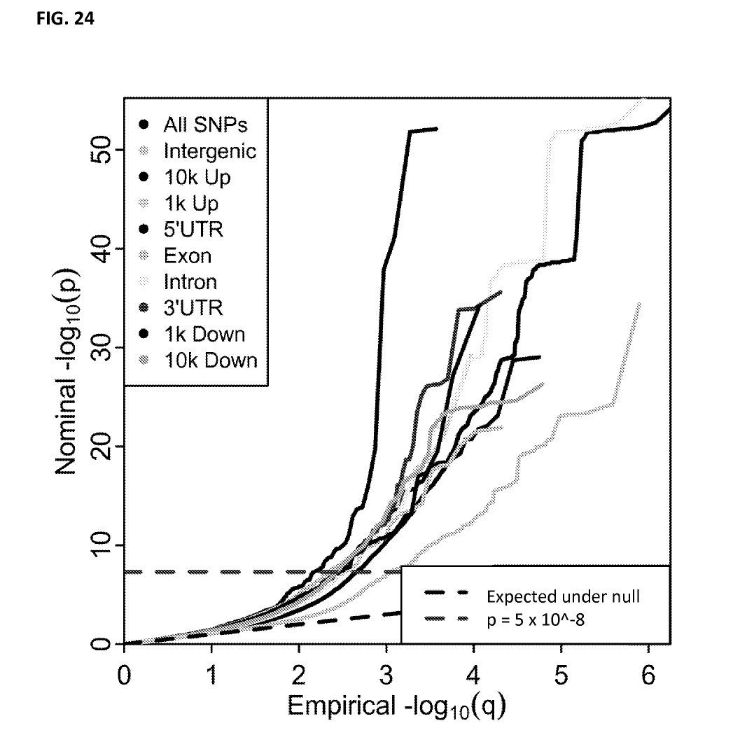

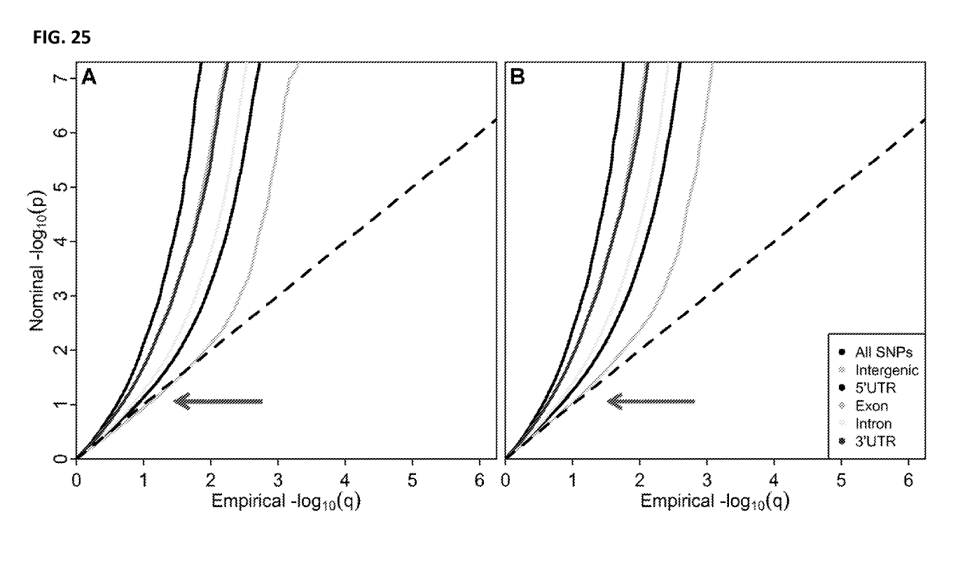

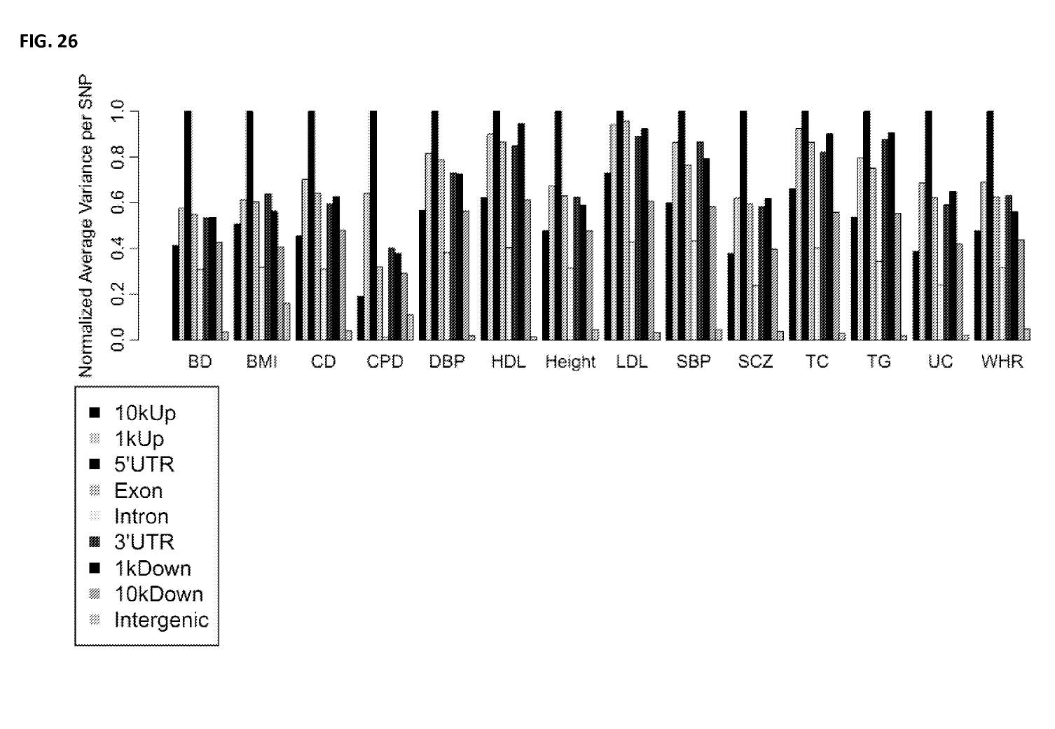

For comparison and to assess the effect of leveraging LD weighted scoring in this way comparisons were made between LD-weighted scores (FIG. 1) and positional or non-LD-weighted scores (i.e., using the categories of the tag SNPs themselves, and ignoring the annotation categories of SNPs in LD with the tag SNP, FIG. 24). Continuous valued scores were turned into binary categories by thresholding scores at a lower bound for inclusion of 1.0. SNPs with a score less than 1 were not counted as a category member. A schematic of the scoring method is presented in FIG. 22. Counts of SNPs in each category based on LD-weighted and non-LD-weighted (1KGP position only) are tabulated in Table 13.

### Intergenic Inflation Control

The empirical null distribution in GWAS is affected by global variance inflation due to population stratification and cryptic relatedness (Devlin B, Roeder K (1999) Genomic control for association studies. Biometrics 55: 997-1004) and deflation due to over-correction of test statistics for polygenic traits (Yang J, Weedon M N, Purcell S, Lettre G, Estrada K, et al. (2011) Genomic inflation factors under polygenic inheritance. Eur J Hum Genet 19: 807-812) by standard genomic control methods. A control method leveraging only intergenic SNPs which are likely depleted for true associations was applied. All p-values were converted into z-scores, and, for each phenotype, the genomic inflation factor (Devlin et al., supra), λ_{GC}, was estimated for intergenic SNPs. All test statistics were divided by λ_{GC}. The inflation factor, λ_{GC} was computed as the median z-score squared divided by the expected median of a chi-square distribution with one degree of freedom for all phenotypes except CPD, where the 0.95 quantile was used in place of the median. For correction statistics see Table 14.

The intergenic SNPs were leveraged to estimate inflation because their relative depletion of associations suggests they provide a robust estimate of true null SNPs that is uncontaminated by polygenic effects. Using annotation categories in this fashion is important given concerns posed by recent GWAS about the over-correction of test statistics using standard genomic control. Statistics from this procedure are shown in Table 14. The traditional GC value for the summary statistics from each GWAS in their received state are reported. Original values less than 1.0 suggest an over correction by traditional GC metrics, while values greater than 1.0 suggest an under correction or no correction at all. The values that remain after intergenic inflation correction are likely to represent variance inflation due to true polygenic effects.

### Q-Q Plots and False Discovery Rate (FDR)

Q-Q plots are standard tools for assessing similarity or differences between two cumulative distribution functions (cdfs) (Schweder T, Spjotvoll E (1982) Plots of P-Values to Evaluate Many Tests Simultaneously. Biometrika 69: 493-502). When the probability distribution of GWAS summary statistic two-tailed p-values is of interest, under the global null hypothesis the theoretical distribution is uniform on the interval [0,1]. If nominal p-values are ordered from smallest to largest, so that p₍₁₎<p₍₂₎< . . . <p_{(N)}, the corresponding empirical cdf, denoted by “q”, is simply q₍ᵢ₎=i/N (in practice adjusted slightly to account for the discreteness of the empirical cdf), where N is the number of SNPs in the GWAS (or genic category). Thus, for a given index i, the x-coordinate of the Q-Q curve is simply q₍ᵢ₎, since the theoretical inverse cdf is the identity function, and the y-coordinate is simply the nominal p-value p₍ᵢ₎. As is common practice in GWAS, −log₁₀ p is plotted against the −log₁₀ q to emphasize tail probabilities of the theoretical and empirical distributions; these coordinates are labeled “nominal −log₁₀ (p)” and “empirical −log₁₀ (q)” in the Q-Q plots. For a given threshold of GC-controlled p-values, category ‘enrichment’ is seen as a horizontal (not vertical) deflection of the Q-Q curve from the identity line (or from one genic category to another) as described in detail next.

The ‘enrichment’ seen in the Q-Q plots can be directly interpreted in terms of False Discovery Rate (FDR)[18]. For a given p-value cutoff, the Bayes FDR (Efron B (2010) Large-scale inference: empirical Bayes methods for estimation, testing, and prediction. Cambridge; New York: Cambridge University Press. xii, 263 p. p) is defined as

FDR(p)=π₀F₀(p)/F(p), [S1]

where π₀ is the proportion of null SNPs, F₀ is the null cumulative distribution function (cdf), and F is the cdf of all SNPs, both null and non-null; see below for details on this simple mixture model formulation (Efron B (2007) Size, power and false discovery rates. The Annals of Statistics 35: 1351-1377). Under the null hypothesis, F₀ is the cdf of the uniform distribution on the unit interval [0,1], so that Eq. [S1] reduces to

FDR(p)=π₀p/F(p), [S2]

The cdf F can be estimated by the empirical cdf q=Nₚ/N, where Nₚ is the number of SNPs with p-values less than or equal to p, and N is the total number of SNPs. Replacing F by q in Eq. [S2]

FDR(p)≈π₀p/q, [S3]

which is biased upwards as an estimate of the FDR[20]. Replacing no in Equation [S3] with unity gives an estimated FDR that is further biased upward;

FDR(p)≈p/q [S4]

If π₀ is close to one, as is likely true for most GWAS, the increase in bias from Eq. [S3] is minimal. The quantity 1−p/q, is therefore biased downward, and hence a conservative estimate of the True Discovery Rate (TDR, equal to 1-FDR). Given the −log₁₀ of the Q-Q plots

−log₁₀(FDR(p))≈log₁₀(q)−log₁₀(p) [S5]

demonstrating that the (conservatively) estimated FDR is directly related to the horizontal shift of the curves in the Q-Q plots from the expected line x=y, with a larger shift corresponding to a smaller FDR. As before, the estimated true discovery rate can be obtained as one minus the estimated FDR. For each TDR plot in FIG. 2 the TDR was calculated using each observed p-value as a threshold, according to Eq. [S5].

### Quantification of Enrichment

After appropriate genomic control enrichment can be assessed by its genic category-specific TDR for a given z-score (equivalently, nominal p-value). Categories of SNPs that have a higher TDR for a given nominal p-value are more “enriched” than categories of SNPs with a lower TDR for the same nominal p-value. This measure of enrichment depends on choice of p-value threshold.

An overall single number summary of category-specific enrichment is the sample mean of z minus one, where the mean is taken over all SNP z-scores in the given category. Both the TDR and the mean (z²)−1 are justified as measures of enrichment based on a simple Bayesian mixture model framework. Specifically, let f(z) be the probability density for the SNP summary statistic z-scores. This is modeled as the mixture of a null probability density f₀ and a non-null density f₁

f(z)=π₀f₀(z)+π₁f₁(z), [S6]

where, as above, π₀ is the proportion of SNPs with no association with the trait and π₁=1−π₀ the proportion of SNPs with a non-zero association with the trait. Assuming that the z-scores are symmetric about zero, the variance of this distribution is

∫z²f(z)dz=∫z²π₀f₀(z)dz+∫z²π₁f₁(z)dz=π₀+π₁∫z²f₁(z)dz, [S7]

since the variance of the null distribution is one after appropriate genomic control. Under the assumption that the proportion of null SNPs (π₀) is close to one, a mildly conservative estimate of the excess in variance attributable to non-null SNPs is given by ∫z² f(z) dz−1. An unbiased estimate of this expression is the sample mean of z² minus 1. Note, non-null z-scores are scaled by the square root of the sample size, and hence mean(z²)−1 is proportional to, not identical with, π₁ times the tagged phenotypic variance of the non-null SNPs.
Consistency with Local False Discovery Rate Estimates

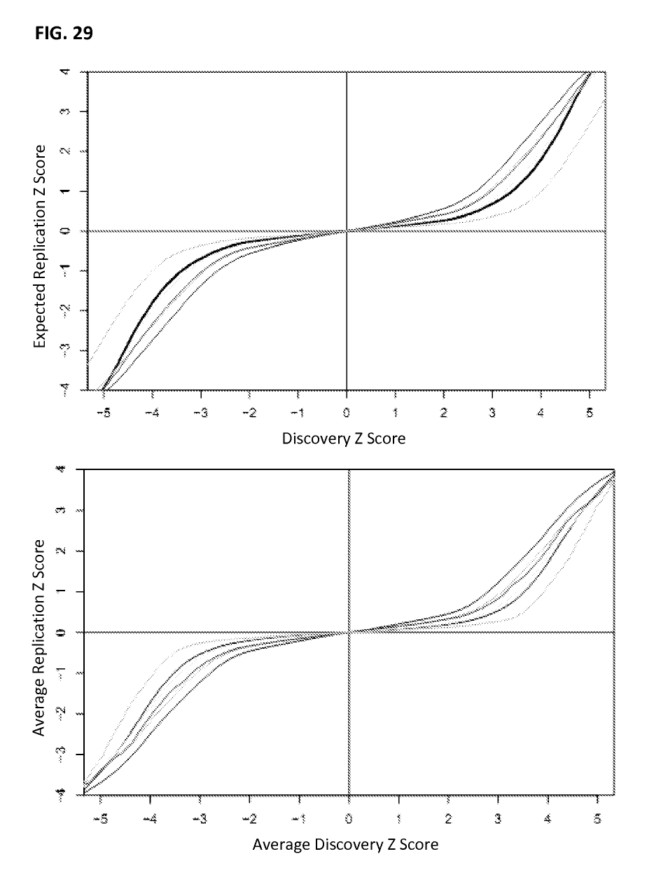

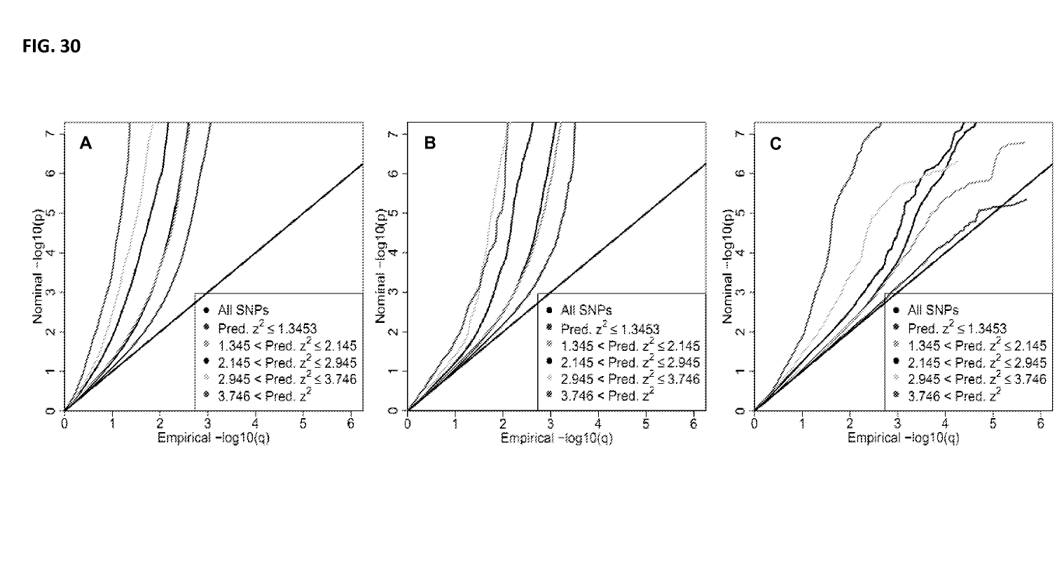

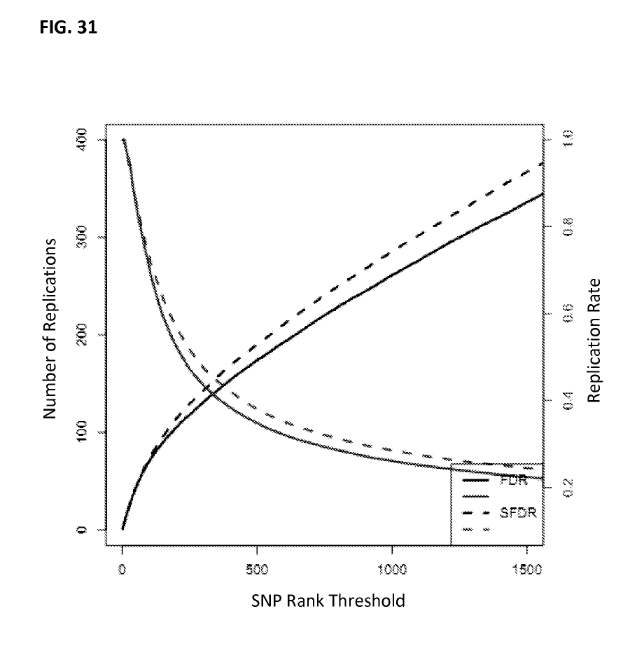

Under scenarios of multiple testing, such as GWAS, quantitative estimates of likely true associations can be estimated from the distributions of summary statistics. Efron (Efron B (2010) Large-scale inference: empirical Bayes methods for estimation, testing, and prediction. Cambridge; New York: Cambridge University Press. xii, 263 p. p) has developed a flexible framework for quantitatively estimating the null, non-null and mixture distributions from the resulting test statistics. Similar approaches have been applied in other fields, most relevantly to gene expression array data (Allison D B, Gadbury G L, Heo M S, Fernandez J R, Lee C K, et al. (2002) A mixture model approach for the analysis of microarray gene expression data. Computational Statistics & Data Analysis 39: 1-20) and linkage analysis (Ginns E I, St Jean P, Philibert R A, Galdzicka M, Damschroder-Williams P, et al. (1998) A genome-wide search for chromosomal loci linked to mental health wellness in relatives at high risk for bipolar affective disorder among the Old Order Amish. Proc Natl Acad Sci USA 95: 15531-15536). As a demonstration, the CD statistics were fit using this model (FIGS. 29 and 30).

The empirical Bayesian modeling approach described by Efron (2010; supra) is implemented in the freely available R package locfdr (Efron B, Turnbull B B, Narasimhan B (2011) locfdr: Computes local false discovery rates). The approach is to model the mixture density of effects in terms of z-scores as in Eq. [S6] above, or as a mixture density consisting of a weighted linear combination of a null density f₀(z) for the z-scores of SNPs with no association, and a non-null density f₁(z) for z-scores from trait-associated SNPs. The local false discovery rate (locfdr) is then given by

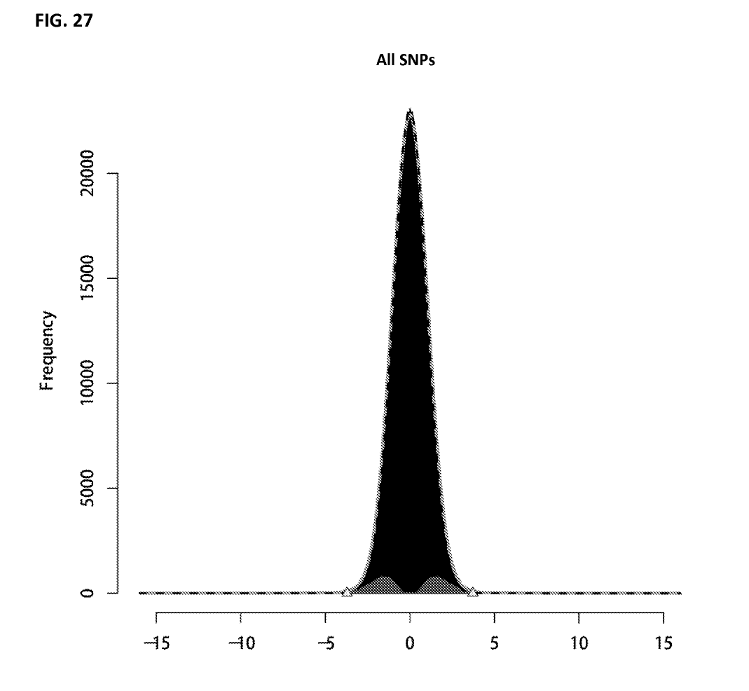

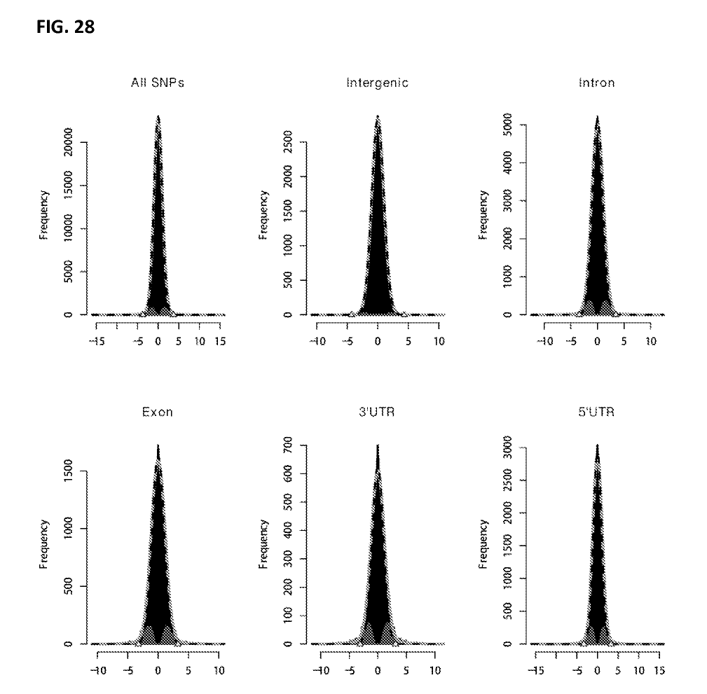

locfdr(z)=π₀f₀(z)/f(z), [S8]

where f(z) is given by Eq. [S6]. Using this model, the empirical null density (assumed to be normal, with mean 0 and data determined standard deviation) was estimated. The null for intergenic SNPs was estimated and all statistics were adjusted accordingly such that the intergenic test statistics conformed to the theoretical distribution (normal with mean 0 and standard deviation 1). This approach mirrors the intergenic inflation control described previously. The locfdr library was used to estimate the mixture density, fixing the null distribution to the theoretical standard normal and estimating the mixture density non-parametrically as a smoothed histogram. This model was fit to the overall data and per category (FIGS. 27 and 28).

This framework also allows us to estimate the a posteriori expected z-scores, as described in chapter 11, pp. 218 of (Efron, 2010; supra), based on the nonparametric estimates of the mixture density f(z) (Eq. [S6]) obtained with locfdr. For each of the 70 discovery sets used to calculate cumulative replication rates, the expected a posteriori effect size across the same 120 equally sized z-score bins ranging from −5.33 to 5.33 (corresponding to the GWAS p-value of 5×10⁻⁸) were calculated. The results were averaged across the 70 iterations and plotted as a function of discovery z-score independently for each genic annotation category. Because the direction of effect (z-score sign) is arbitrary with respect to the allele and strand chosen as causal, the data were duplicated with opposite sign to enforce symmetry. Again this procedure was carried out for the overall data and per category (FIG. 29).

For comparison, empirical replication z-scores were calculated using the same 70 discovery-replication pairs and averaged across iterations. For visualization a cubic smoothing spline was fit relating the discovery z-score bin midpoints to the corresponding average replication z-scores. The empirical z-score replications (FIG. 29B) closely match the theoretical expected values (FIG. 29A) and suggest that the a posteriori effect size for a given SNP is strongly modulated by genic annotation category.

### A Parametric Mixture Model

In addition to the the non-parametric approach to estimating the mixture model (Eq. [S6]) implemented in the locfdr package, a parametric model was implimate, to facilitate simulations and extensions of the basic locfdr model to include covariates, described below. Specifically, w=−2 ln(p) was modeled as a mixture of a (null) χ² density with two degrees of freedom and a (non-null) Weibull density with shape parameter a and scale parameter b. Note, under the null hypothesis the p-values are uniformly distributed and hence w has a χ² density with two degrees of freedom (df), equivalent to a Weibull density with a=1 and b=2. Hence, the mixture density for w is given by

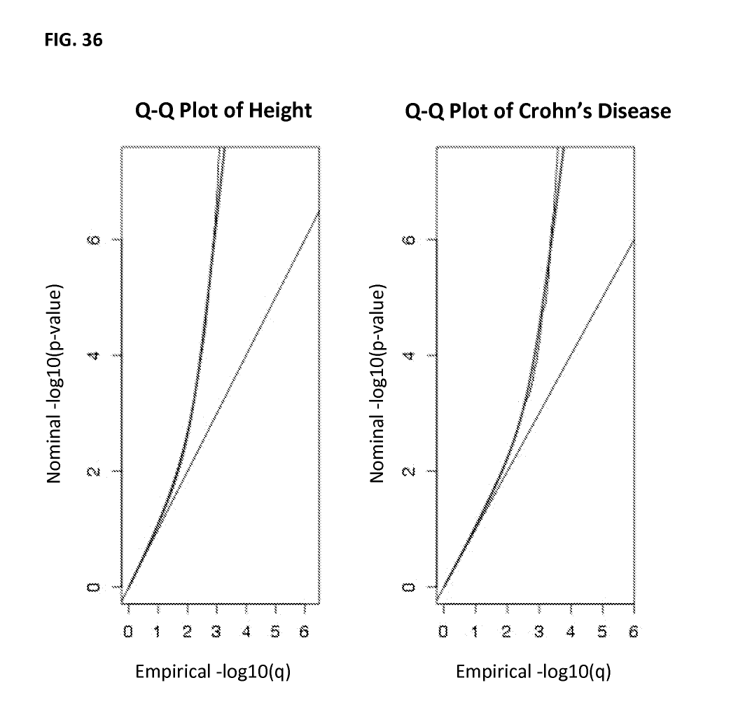

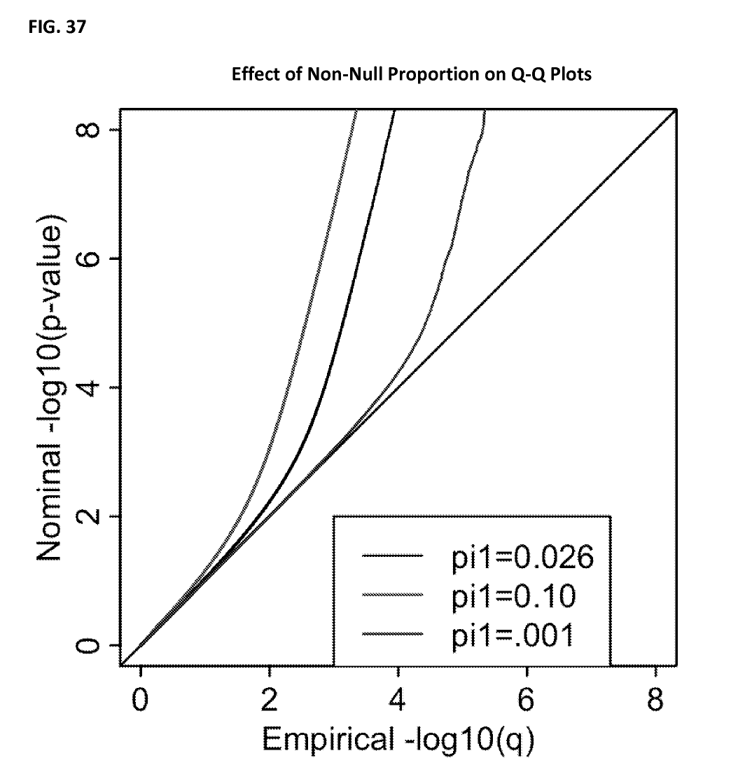

f(w)=π₀f₀(w)+π₁f₁(w), [S9]

where f₀(w) is Weibull(a₀=1, b₀=2) and f₁(w) is Weibull(a₁, b₁), where the parameters (π₀, a₁, b₁) are estimated from the data. For identifiability, the model is fit under the assumption (in common with the locfdr package) that the non-null density is zero in a small interval around zero, accomplished here by shifting f₁ to the right by a fixed margin, e.g., the median of the χ² distribution with 2 df. This is equivalent to the assumption that the vast majority of SNPs with z-scores close to zero are true nulls[19]. For parameter estimation, a Bayesian Monte Carlo Markov Chain (MCMC) algorithm was used, placing vague priors on the parameters (π₀, a₁, b₁). Q-Q plots and model fits for Height and CD for SNPs below the GWAS-level significance threshold of 5×10⁻⁸ are given in FIG. 36. For Height, parameter estimates from the MCMC algorithm were (π₀, a₁, b₁)=(0.959, 0.8, 5.7); for CD, parameter estimates were (π₀, a₁, b₁)=(0.974, 0.8, 4.1).

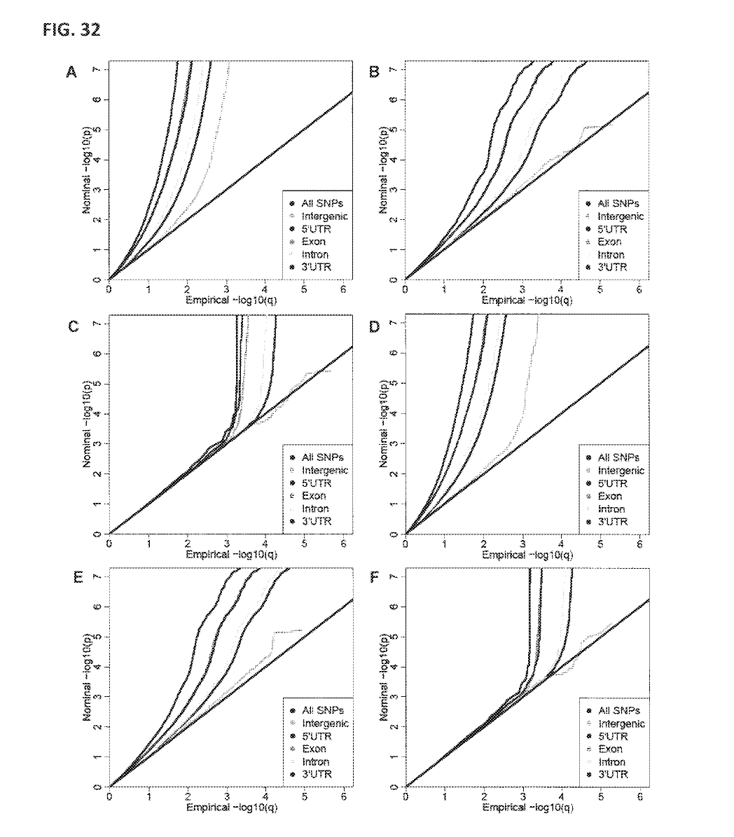

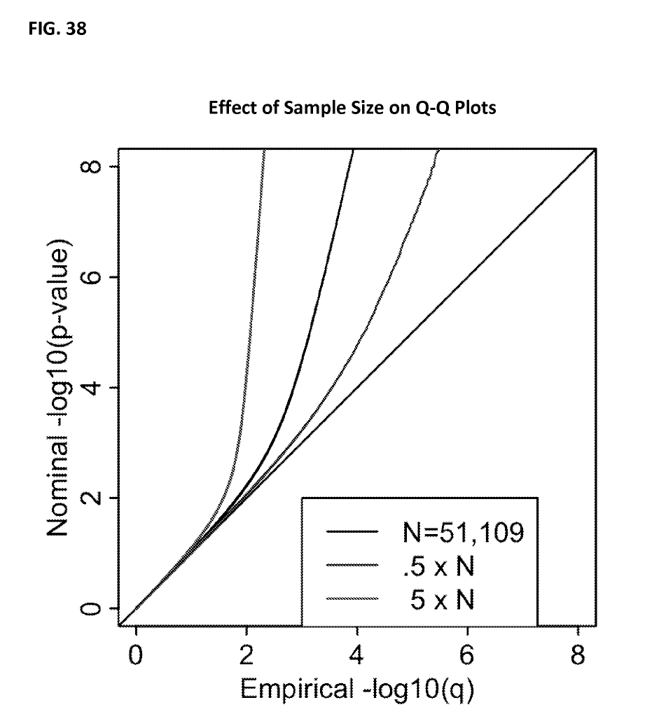

The CD parameter estimates were used to determine the impact of sample size and polygenicity on Q-Q plots and enrichment indices in the context of mixture models. FIG. 32 shows the impact of polygenicity (i.e., the non-null proportion π₁). The solid black line is the Q-Q curve for CD predicted from the Weibull mixture model, with π₁=0.0.026. The red line is the predicted Q-Q curve if π₁=0.10 (more polygenic) and the blue line is the predicted Q-Q curve if π₁=0.001 (less polygenic). Phenotypes that are more polygenic but otherwise have similar non-null densities f₁ have Q-Q curves that depart earlier from the non-null line but are approximately parallel thereafter. In contrast, for a fixed level of polygenicity but varying non-null distributions, Q-Q plots tend to depart from the null line at the same place but have different slopes thereafter. This can be illustrated by varying the effective sample size of the GWAS: increasing sample size leaves π₁ (the true proportion of non-null SNPs) fixed but increases the scale of the non-null density f₁. FIG. 38 shows the impact for decreasing or increasing the sample size on the Q-Q plots for the CD data.

The basic parametric mixture model [S9] was extended by allowing for covariates (e.g., genic annotations). Specifically, let x be a vector of annotations for a given SNP. The covariate-modulated mixture model is given by

f(w|x)=π₀(x)f₀(w)+π₁(x)f₁(w|x), [S10]

where π₀(x)=1/(1+exp(x′ν)) is a logistic function of the covariates, and f₁(w|x) is a Weibull distribution with shape parameter a=exp(x′α) and scale parameter b=exp(x′β). The model is estimated using an MCMC algorithm (Gibbs sampler with Metropolis-Hastings steps), placing non-informative priors on unknown parameters (ν, α, β). Estimates from this model, not presented here, could be used to replace the stratified FDR analyses in the main text by directly using Eq. [S10] to estimate the local fdr (Eq. [S8]). Control for potential confounds: LD and MAF

Significant categorical differences in terms of total LD and total number of SNPs captured by each GWAS SNP that mirrors the enrichment findings were observed (Tables 17 and 18). To rule out total LD as a potential confound, a multiple regression was performed on height GWAS summary values (log of z² after intergenic inflation control) using SNP annotation category scores and total summed LD as predictors. Each category score is computed as described in the main text. The category score of each SNP is pre-multiplied by the genetic variance (MAF*(1−MAF)) of that SNP. Annotations categories were centered to have mean zero. The analysis reveals only a minor effect of total LD on predicting log(z²) and strong individual category effects which mirror the enrichment findings (Table 20).

Systematic differences in the average minor allele frequency (MAF) could confound enrichment analysis as MAF acts multiplicatively with effect size to give z-scores. The average minor allele frequency per category are shown in Table 19.

### Replication Estimates

The estimated TDR can be thought of as the replication rate in an independent sample as the replication sample size goes to infinity. In practice, both the estimated TDR and the replication sample effect sizes will be measured with error, and hence the estimated TDR will not perfectly predict the independent sample replication rate. Nonetheless, there should be a close correspondence for reasonable discovery and replication sample sizes. Thus, to provide empirical support for the findings, category-specific rates of replication across eight truly independent GWAS samples studying CD were investigated. For each of eight sub-studies contributing to the final meta-analysis in the CD report, the reported z-scores were adjusted according to the intergenic inflation correction method described above. For each of the 70 (8 choose 4) possible combinations of four-study discovery and four-study replication sets, the four-study combined discovery z-score and four-study combined replication z-score for each SNP as the average z-score across the four studies was calculated, multiplied by the square root of the number of studies. For discovery samples the z-scores were converted to two-tailed p-values, while replication samples were converted to one-tailed p-values preserving the direction of effect in the discovery sample. Replication was defined as a one-tailed p-value less than 0.05 in the replication set. For each of the 70 discovery-replication pairs cumulative rates of replication were calculated over 1000 equally-spaced bins spanning the range of negative log₁₀(p-values) observed in the discovery samples. The cumulative replication rate calculated for any bin was the total number of replicated SNPs (p<0.05, one-tailed test with direction of effect given by the discovery sample) with a negative log₁₀(discovery p-value) greater than or equal to the lower bound of the bin divided by the total number of SNPs with a negative log₁₀ (discovery p-value) greater than or equal to the lower bound of that bin. This analysis was repeated for each of the eight genic annotation categories as well as intergenic SNPs and all SNPs. The cumulative replication rates were averaged across the 70 discovery-replication pairs and the results are reported in FIG. 3. The vertical intercept is the overall replication rate.

### Robustness of LD Weighted Scoring Procedure

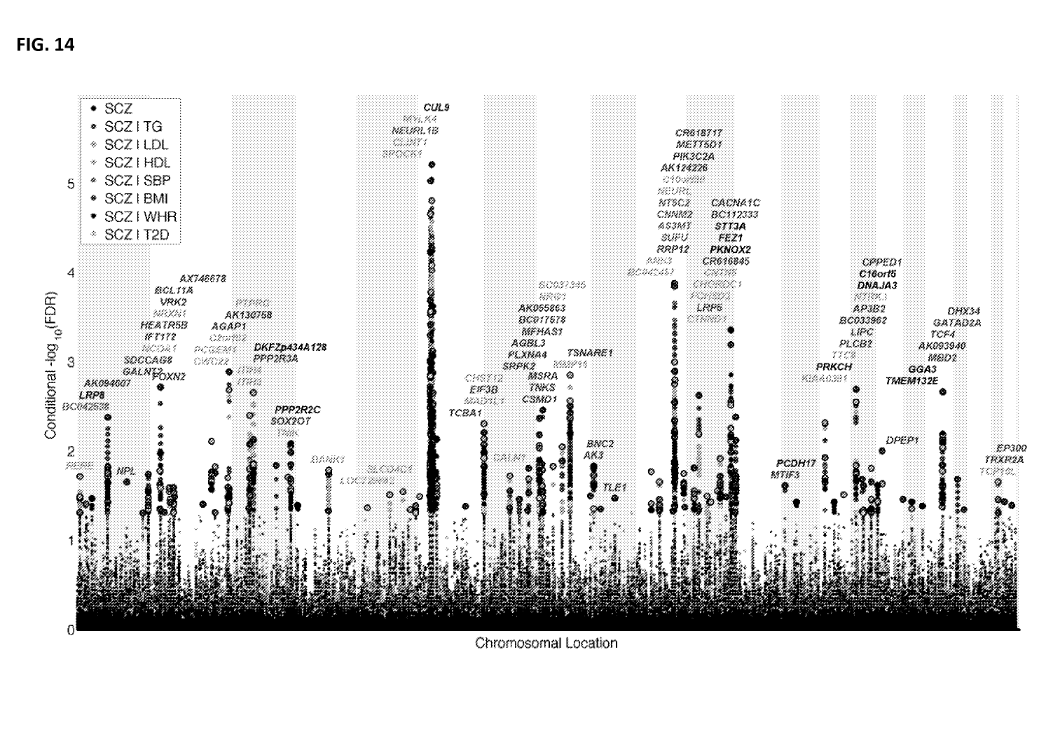

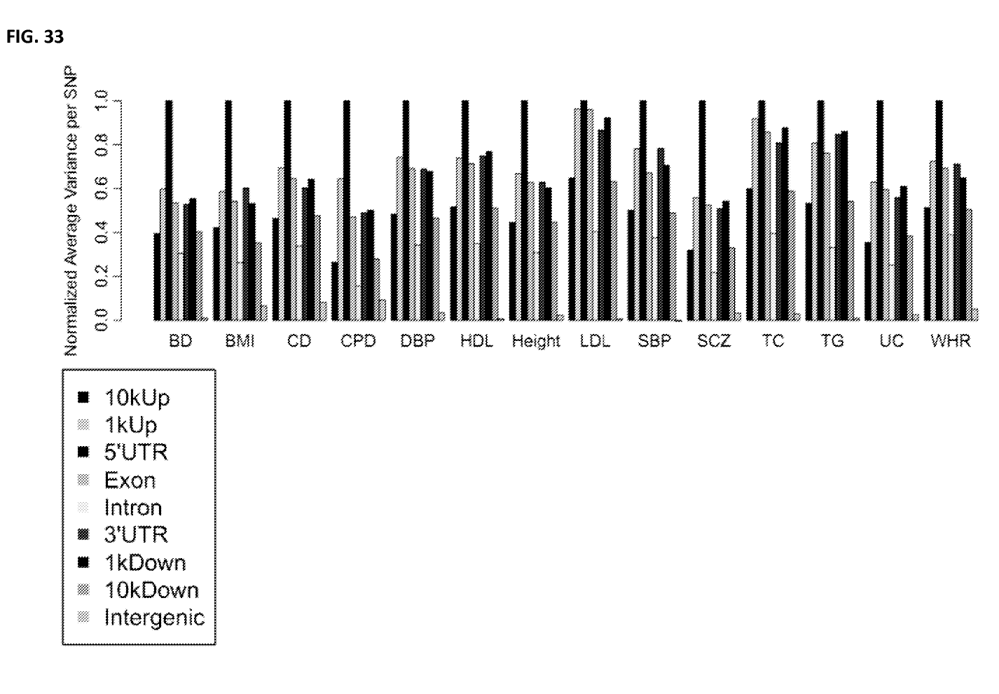

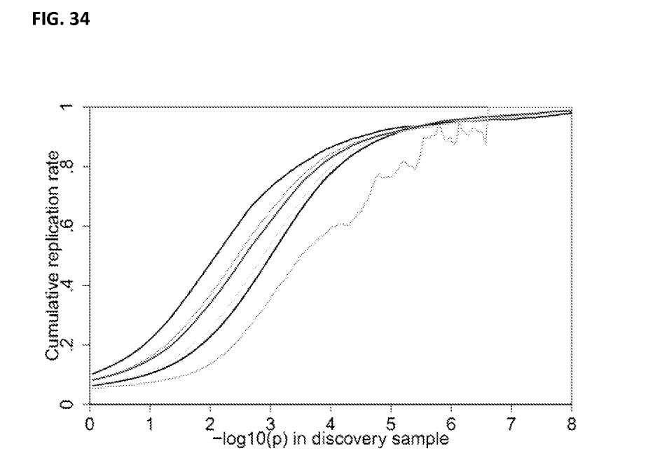

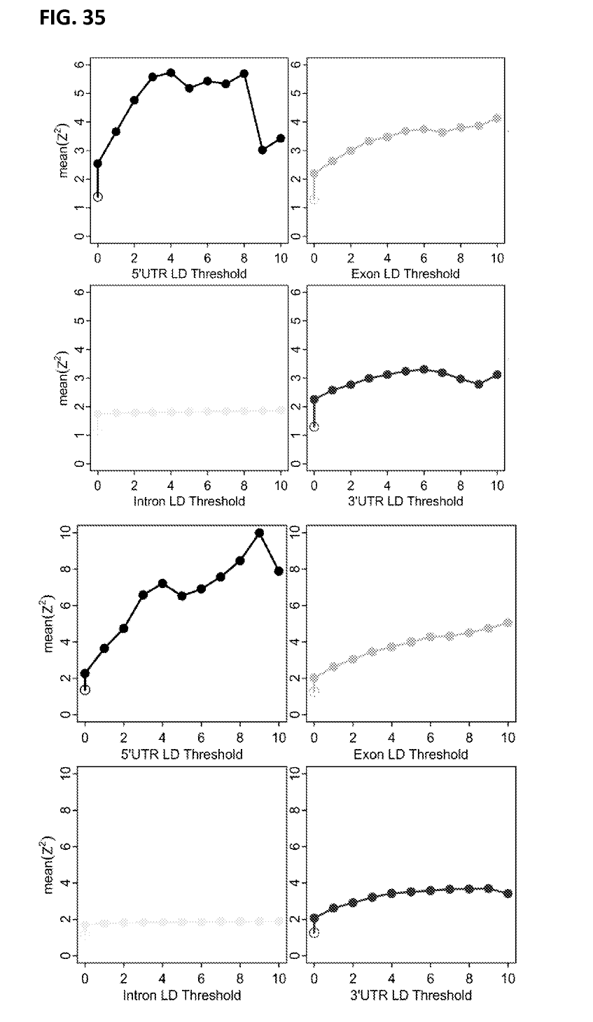

The original LD weighted annotation scoring approach (see: Linkage Disequilibrium (LD) Weighted Annotation Score above) only considered pairwise r² LD greater than 0.2 and within 1 megabase of the target GWAS SNP. However, it is likely that true correlations exist at lower level than r²=0.2 and beyond 1 megabase. To test the dependence of the results upon the parameters of the scoring approach, each SNP was reclassified following the same procedure as before, but including estimated r² LD greater than 0.05 and within 2 megabases. The pattern of enrichment described in the original stratified QQ-plots appears robust to these changes (FIG. 32). Three subtle qualitative trends that did emerge in the more inclusive LD scoring across most to all traits (data not shown) were: a noticeable reduction in the enrichment of the intergenic category relative to all SNPs, a slight decrease in the enrichment of the intronic category relative to all SNPs, and a slight increase in the enrichment of the 5′UTR category relative to the exon and 3′UTR categories. Further, the quantification of enrichment as mean(z²−1) presented in FIG. 27 is likewise robust to the scoring parameters (FIG. 33). As with the original LD weighted scoring parameters, the differential enrichment corresponds to a mirroring increase in replication rates across independent samples (FIG. 34). In addition to choosing parameters for thresholding LD to assign LD weighted annotation scores, GWAS tag SNPs were assigned to a category according to a threshold on their total LD weighted score with 1000 SNPs of a particular variety (original threshold was 1). Supplementary FIG. 14 shows the relationship between the mean(z²) of a particular SNP category and the threshold for inclusion for height. The monotonic relationship and the different slopes among the categories shows the enrichment results to be consistent across a number of thresholds. One noticeable exception in FIG. 35A is that the 5′UTR category decreases its mean(z²) when the threshold becomes very high. There are very few SNPs that remain at this point making the line unstable. Choosing a more liberal LD weighting scheme (FIG. 35B) increases the number of SNPs in this category with high scores and recovers the trend. These trends are generally consistent across all other phenotypes (data not shown). Together these results demonstrate that the results are robust to the parameters within the LD-weighted annotation scoring procedure and, in fact, would likely be strengthened by a careful tuning of these parameters.

Results

LD Based Enrichment of Genic Elements in Height

Under multiple testing paradigms, such as GWAS, quantitative estimates of likely true associations can be estimated from the distributions of summary statistics [12,13]. A common method for visualizing the enrichment of statistical association relative to that expected under the global null hypothesis is through Q-Q plots of the nominal p-values resulting from GWAS. Under the global null hypothesis the theoretical distribution is uniform on the interval [0,1]. Thus, the usual Q-Q curve has as the y-coordinate the nominal p-value, denoted by “p”, and the x-coordinate the value of the empirical cdf at p, denoted by “q”. As is common in GWAS, −log 10 p is plotted against the −log₁₀ q to emphasize tail probabilities of the theoretical and empirical distributions. In such plots, enrichment results in a leftward shift in the Q-Q curve, corresponding to a larger fraction of SNPs with nominal −log₁₀ p-value greater than or equal to a given threshold.

The stratified Q-Q plot for height (FIG. 8) shows a clear variation in enrichment across genic annotation categories. The separation between the curves for different categories is enhanced when using LD-weighted genic annotation categories in comparison to non LD-weighted positional categories. The parallel shape of these curves is likely caused by the significant but imperfect correlation among categories due to the non-exclusive nature of the annotation scoring.

An earlier departure from the null line (leftward shift) suggests a greater proportion of true associations, for a given nominal p-value. The divergence of the curves for different categories thus suggests that the proportion of non-null effects varies considerably across annotation categories of genic elements. For example, the proportion of SNPs in the 5′UTR category reaching a given significance level (−log₁₀(p)>10) is roughly 10 times greater than for all SNPs, and 50-100 times greater than for intergenic SNPs.

Polygenic Enrichment Across Diverse Phenotypes

Recently Yang et al [14] demonstrated that an abundance of low p-values beyond what is expected under null hypotheses in GWAS, but not necessarily reaching stringent multiple comparison thresholds, and often seen as ‘spurious inflation,’ can also be consistent with an enrichment of true ‘polygenic’ effects [14]. The prevalence of enrichment below the established genome-wide significance threshold of p<5×10⁻⁸ (−log₁₀(p)>7.3;) in height (FIG. 9A) is consistent with their hypotheses and indicates that current GWAS do not capture all of the additive ‘tagged variance’ in this phenotype. This enrichment varies across genic annotation categories.

The enrichment patterns among annotation categories are consistent across phenotypes, including schizophrenia (SCZ) and tobacco smoking (cigarettes per day; CPD; FIG. 9B-C) The stratified Q-Q plots for height, SCZ and CPD each demonstrate the largest enrichment for tag SNPs in LD with 5′UTR, and exonic variation, showing nearly tenfold increases in terms of the proportion of p-values expected below a given threshold under the null hypothesis. SNPs that tag intergenic regions show nearly tenfold depletions in comparison to all tag SNPs, although not when compared to the expected null. SNPs tagging intronic variation show minimal enrichment over all tag SNPs, despite making up the largest proportion of genic SNPs. A consistent pattern is found for all phenotypes considered (data not shown). Given the log-scaling of the Q-Q plots, 90% of SNPs fall between 0 and 1 and 99% fall between 0 and 2 on the horizontal axis, and thus it is clear that a majority of enriched SNPs have p-values that do not reach genome-wide significance.

Significance values were computed for the curves for each annotation category relative to those for intergenic SNPs, using a two-sample Kolmogorov-Smirnov Test. The enrichment for height was highly significant for all categories when compared with the intergenic category, with all p-values less than 2.2×10⁻¹⁶. Nearly all genic categories were also significantly enriched for all the other phenotypes (Table 15).

While the pattern of enrichment is consistent, the shape of the curves varies across phenotypes. In particular, the point at which the curves deviate from the expected null line occurs earliest for height, followed by SCZ, and finally CPD (FIGS. 9A-C), consistent with different proportions of SNPs that are likely associated with each trait (e.g., different levels of ‘polygenicity’). These findings are consistent with results obtained using an established mixture modeling framework [12].

Intergenic Genomic Control

The relative absence of enrichment in intergenic SNPs indicates minimal inflation due to polygenic effects and a more robust estimate of the global null. This fact can be exploited for estimation of variance inflation due to stratification [15] that is minimally confounded by true polygenic effects [14], by confining the estimation of the genomic inflation factor [15], λ_{GC}, to only intergenic SNPs. Here, summary statistics were adjusted for all phenotypes according to this “intergenic inflation control” procedure.

Category Specific True Discovery Rate

Since specific genic tag SNP categories are significantly more likely to be associated with common phenotypes, while intergenic ones are less likely, all tag SNPs should not be treated as exchangeable. Variation in enrichment across diverse genic categories is expected to be associated with corresponding variation in true discovery rate TDR for a given nominal p-value threshold. A conservative estimate of the TDR for each nominal p-value is equivalent to 1−(p/q) as plotted on the Q-Q plots. This relationship is shown for height, SCZ and CPD (FIG. 9D-E). Similar category-specific TDR plots were calculated for each of the 14 phenotypes (data not shown). For a given TDR the corresponding estimated nominal p-value threshold varies with a factor of 100 from the most enriched genic category to the intergenic category, and the pattern is consistent across phenotypes. Since TDR is strongly related to predicted replication rate, it is expected that for a given p-value threshold the replication rate will be higher for SNPs in genic categories with high TDR.

Quantification of Enrichment

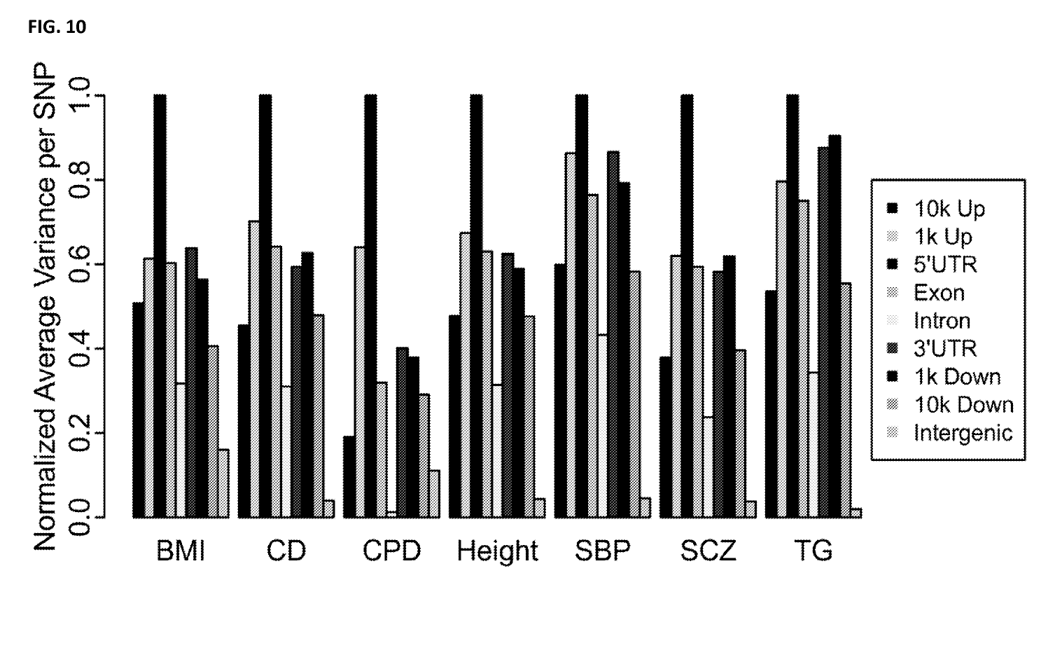

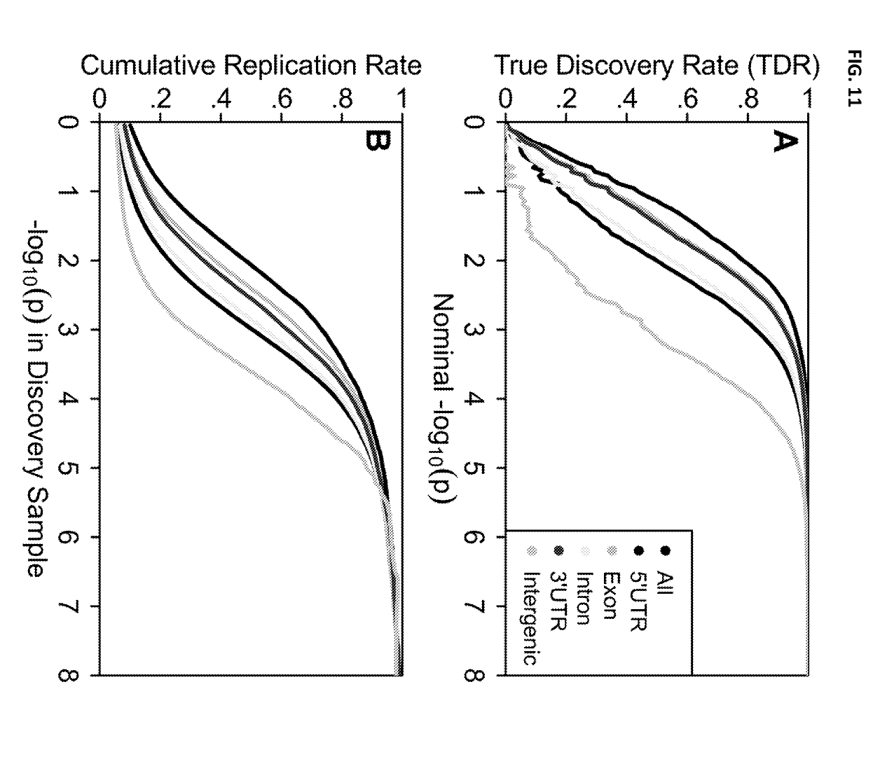

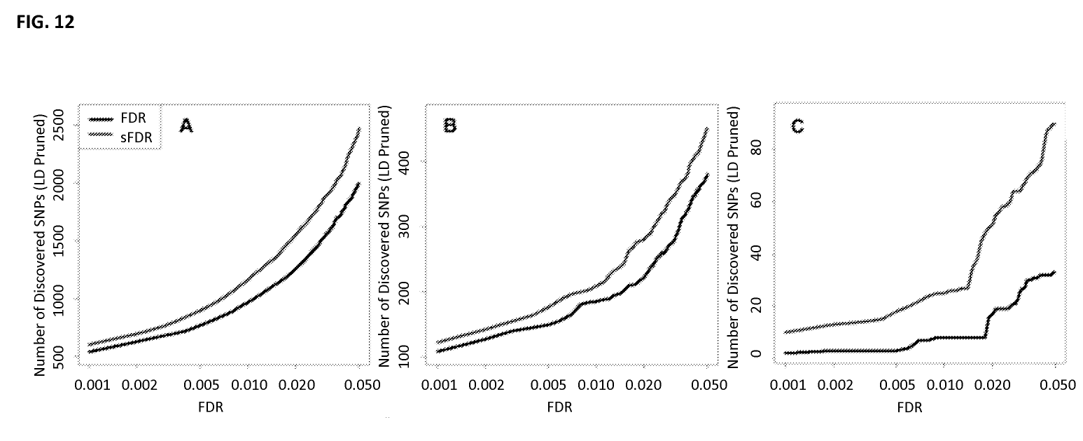

While the TDR provides a quantification of enrichment for a given nominal p-value threshold (equivalently, SNP z-score threshold), a single number quantification of enrichment for each LD-weighted annotation category within each phenotype, computed as the sample mean (z2)−1 is provided. The sample mean, taken over all SNPs in a given category, provides an estimate of the variance due to null and non-null SNPs; by subtracting one can obtain a conservative estimate of the variance in effect sizes attributable to non-null SNPs alone. Both TDR and mean (z²)−1 are justified based on a standard mixture model formulation. These enrichment scores, normalized by the maximum value across categories within each phenotype, are presented in FIG. 10. The 5′UTR annotation category was the most enriched category across all fourteen phenotypes. Additionally, the exon category is consistently more enriched than the intron category.

Categories where each SNP, on average, tags more SNPs or represents a larger total amount of LD could spuriously appear enriched. Categorical differences in the number of SNPs and total summed LD captured by each SNP were observed but multiple regression shows the effect is negligible and independent categorical effects persist despite the significant correlation among categories. Likewise, systematic deviations in minor allele frequency (MAF) across categories could bias annotation category effects as MAF acts multiplicatively with effect size to explain variance. Minimal categorical stratification was found for MAF not consistent with it driving the enrichment findings. To further address the possibility that some of the differential enrichment of categories could be due to category-specific genomic inflation from the above factors, null-GWAS simulations based on genotypes from the 1000 Genome Project were performed. The results indicate that such effects are non-existent or negligible.

Replication Rate

To further address the possibility that the observed pattern of differential enrichment results from spurious (e.g., non-generalizable) associations due to category-specific confounding effects or statistical modeling errors, the empirical replication rate across independent sub-studies for one phenotype (CD), for which the required sub-study summary statistics were available was studied. FIG. 11A shows the estimated TDR curves for different annotation categories in CD, with a similar pattern as that described for in height, SCZ and CPD, above. Since the TDR is an estimate of the expected replication rate for a sufficiently large replication sample, it was hypothesized that strata with higher TDR for a given nominal p-value would also show higher empirical replication rate. FIG. 11B shows the empirical cumulative replication rate plots as a function of nominal p-value, for the same categories as for the stratified TDR plot in FIG. 11A. Consistent with the category-specific TDR pattern, it was found that the nominal p-value corresponding to a wide range of replication rates was 100 times higher for intergenic relative to the most enriched genic category (5′UTR). Similarly, SNPs from genic annotation categories showing the greatest enrichments replicated at higher rates, up to five times higher than intergenic for 5′UTR SNPs, independent of p-value thresholds. The increase in replication rate was found to be greatest for SNPs that do not meet genome-wide significance, indicating that adjusting p-value thresholds according to the estimated category-specific TDR greatly improves the discovery of replicating SNP associations.

Increased Power Using Stratified False Discovery Rates

In order to demonstrate the utility of the enriched category information for improved discovery, an established method for computing stratified False Discovery Rates [9] was utilized. The sFDR method extends the traditional methods for FDR control [21], improving power by taking advantage of pre-defined, differentially enriched strata among multiple hypothesis testing p-values. Here, an increase in power from using stratified (vs. unstratified) methods is defined as a decreased Non-Discovery Rate (NDR) for a given level of FDR control α, where NDR is the proportion of false negatives among all tests [22]. Specifically, the ratio of NDR from stratified FDR control vs. NDR was estimated from unstratified FDR control. A ratio above one is equivalent to sFDR rejecting more SNPs than unstratified FDR for a common level α.

For each phenotype, the SNPs are divided into independent strata according to their predicted tagged variance (z²) based on a linear regression predictor with regression weights for each annotation category trained using the height GWAS summary statistics. An increase in the number of discovered SNPs was observed. For example, for α=0.05 the increased proportion of declared non-null SNPs using sFDR ranges from 20% in height to 300% in schizophrenia. Leveraging the genic annotation categories in the sFDR framework provides one possible avenue for improving the output of likely non-null SNPs in GWAS by taking advantage of the non-exchangeability of SNPs demonstrated by the genic annotation category enrichment analyses.

TABLE 11
GWAS Study Summary Statistics

| | | | | | | Genome-wide | Minimum |
|---|---|---|---|---|---|---|---|
| | Trait | Heritability | | N | # SNPs | significant SNPs | p-value |
| BD | Bipolar Disorder[9] | .79 | [24] | 16,731 | 2,381,661 | 42 | 5.54 × 10⁻¹⁰ |
| BMI | Body Mass Index[1] | .50-.90 | [25] | 123,865 | 2,400,377 | 765 | 2.05 × 10⁻⁶² |
| CD | Crohn's disease[6] | .50 | [26] | 51,109 | 942,858 | 968 | 4.00 × 10⁻⁶⁹ |
| CPD | Cigarettes Per Day[10] | .40-.51 | [27] | 74,053 | 2,397,337 | 128 | 4.23 × 10⁻³⁵ |
| DBP | Diastolic Blood Pressure[5] | .34-.68 | [5] | 203,056 | 2,382,073 | 85 | 1.64 × 10⁻¹⁴ |
| HDL | High Density Lipoprotein[4] | .52 | [28] | 96,598 | 2,508,370 | 2,165 | 1.98 × 10⁻³²³ |
| Height | Height[2] | .80 | [29] | 183,727 | 2,398,527 | 4,456 | 4.47 × 10⁻⁵² |
| LDL | Low Density Lipoprotein[4] | .59 | [28] | 99,900 | 2,508,375 | 1,704 | 9.7 × 10⁻¹⁷¹ |
| SBP | Systolic Blood Pressure[5] | .31-.63 | [5] | 203,056 | 2,382,073 | 107 | 9.73 × 10⁻¹³ |
| SCZ | Schizophrenia[8] | .81 | [30] | 21,856 | 1,171,056 | 101 | 4.30 × 10⁻¹¹ |
| TC | Total Cholesterol[4] | .57 | [28] | 100,184 | 2,508,369 | 2,407 | 5.77 × 10⁻¹³¹ |
| TG | Triglycerides[4] | .48 | [28] | 96,568 | 2,508,363 | 1,706 | 6.71 × 10⁻²⁴⁰ |
| UC | Ulcerative Colitis[7] | .28 | [26] | 26,405 | 1,273,589 | 671 | 4.62 × 10⁻⁷⁷ |
| WHR | Waist to hip ratio[3] | .22-.61 | [3] | 77,167 | 2,376,820 | 296 | 7.66 × 10⁻¹⁵ |

Table 11. Descriptive statistics for each GWAS study. All traits are highly heritable and summary statistics are from well powered studies. All Studies were imputed with using the HapMap phase II as a reference, with the exception of CD, UC and SCZ which used HapMap phase III as a reference.

TABLE 12
Score distributions for the union of all GWAS

| | 10kUp | 1kUp | 5UTR | Exon | Intron | 3UTR | 1kDown | 10kDown | Intergenic* |
|---|---|---|---|---|---|---|---|---|---|
| Minimum | 0 | 0 | 0 | 0 | 0 | 0 | 0 | 0 | 0 |
| score | | | | | | | | | |
| Mean | 2.4 | 0.35 | 0.12 | 0.43 | 31.45 | 0.46 | 0.37 | 2.32 | — |
| Score | | | | | | | | | |
| Maximum | 484.54 | 76.82 | 19.25 | 76.51 | 2152.44 | 41.07 | 76.26 | 609.73 | 1 |
| Score | | | | | | | | | |
| Score | 9.17 | 1.47 | 0.49 | 1.68 | 62.59 | 1.46 | 1.53 | 10.46 | — |
| Standard | | | | | | | | | |
| Deviation | | | | | | | | | |
| Number of | 1,659,215 | 1,986,855 | 2,235,907 | 1,901,520 | 972,219 | 1,949,074 | 1,977,171 | 1,673,499 | 2,058,603 |
| SNPs with | | | | | | | | | |
| score = 0 | | | | | | | | | |
| Number of | 183,245 | 305,008 | 224,002 | 339,804 | 89,984 | 278,025 | 298,783 | 185,096 | 0 |
| SNPs with | | | | | | | | | |
| 0 < score < | | | | | | | | | |
| 1 | | | | | | | | | |
| Number of | 715,951 | 266,548 | 98,502 | 317,087 | 1,496,208 | 331,312 | 282,457 | 699,816 | 499,808 |
| SNPs with | | | | | | | | | |
| 1 < score | | | | | | | | | |

Table 12. Statistics describing the distribution of LD-weighted scores for the union of SNPs across all studies. The average score for different categories varies widely and reflects the relative abundance of the different elements within the genome.
*Note intergenic scores are binary, with a score of 1 denoting an intergenic SNP.

TABLE 13
SNP counts by annotation category

| | 10kup | | 1kup | | 5UTR | | Exon | | Intron | |
|---|---|---|---|---|---|---|---|---|---|---|
| | No LD | LD | No LD | LD | No LD | LD | No LD | LD | No LD | LD |
| BD | 56,291 | 658,206 | 9,262 | 242,373 | 3,710 | 89,101 | 20,337 | 289,028 | 883,284 | 1,384,663 |
| BMI | 56,559 | 664,831 | 9,315 | 244,786 | 3,726 | 90,257 | 20,450 | 292,307 | 890,332 | 1,397,945 |
| CD | 24,570 | 283,235 | 5,615 | 106,748 | 2,068 | 39,634 | 13,226 | 129,257 | 371,351 | 582,663 |
| CPD | 56,517 | 664,449 | 9,293 | 244,832 | 3,731 | 90,288 | 20,727 | 292,558 | 889,600 | 1,396,171 |
| DBP | 56,180 | 653,459 | 8,400 | 238,691 | 3,265 | 87,475 | 18,324 | 284,159 | 881,145 | 1,380,664 |
| HDL | 60,393 | 692,708 | 9,797 | 255,053 | 3,877 | 93,730 | 21,604 | 304,226 | 928,690 | 1,458,846 |
| Height | 56,487 | 664,637 | 9,306 | 244,743 | 3,722 | 90,265 | 20,467 | 292,279 | 889,683 | 1,397,131 |
| LDL | 60,394 | 692,711 | 9,797 | 255,054 | 3,876 | 93,732 | 21,599 | 304,228 | 928,696 | 1,458,854 |
| SBP | 56,180 | 653,459 | 8,400 | 238,691 | 3,265 | 87,475 | 18,324 | 284,159 | 881,145 | 1,380,664 |
| SCZ | 32,728 | 342,208 | 7,643 | 130,170 | 2,770 | 48,830 | 16,766 | 157,027 | 460,311 | 719,261 |
| TC | 60,393 | 692,706 | 9,797 | 255,054 | 3,876 | 93,730 | 21,601 | 304,223 | 928,693 | 1,458,849 |
| TG | 60,393 | 692,706 | 9,797 | 255,053 | 3,875 | 93,728 | 21,601 | 304,224 | 928,687 | 1,458,841 |
| UC | 35,373 | 368,528 | 7,945 | 139,383 | 2,869 | 51,971 | 17,287 | 167,615 | 496,671 | 776,643 |
| WHR | 55,894 | 653,032 | 8,334 | 238,574 | 3,263 | 87,488 | 18,588 | 284,232 | 878,798 | 1,378,211 |

| | 3UTR | | 1kdown | | 10kdown | | Intergenic | | |
|---|---|---|---|---|---|---|---|---|---|
| | No LD | LD | No LD | LD | No LD | LD | No LD | LD | Total |
| BD | 20,039 | 302,770 | 11,475 | 258,036 | 60,589 | 644,533 | 775,733 | 471,457 | 2,381,661 |
| BMI | 20,163 | 306,228 | 11,528 | 260,594 | 60,887 | 651,341 | 783,042 | 474,630 | 2,400,377 |
| CD | 11,991 | 135,767 | 5,582 | 113,650 | 25,249 | 277,680 | 273,611 | 164,853 | 942,858 |
| CPD | 20,208 | 306,168 | 11,539 | 260,669 | 60,838 | 650,990 | 781,170 | 473,972 | 2,397,337 |
| DBP | 18,373 | 298,552 | 11,268 | 254,160 | 60,653 | 640,036 | 781,680 | 474,102 | 2,382,073 |
| HDL | 21,177 | 318,156 | 12,096 | 271,037 | 64,260 | 677,541 | 816,074 | 495,102 | 2,508,370 |
| Height | 20,157 | 306,186 | 11,521 | 260,558 | 60,844 | 651,188 | 782,493 | 474,233 | 2,398,527 |
| LDL | 21,178 | 318,162 | 12,096 | 271,043 | 64,262 | 677,557 | 816,072 | 495,098 | 2,508,375 |
| SBP | 18,373 | 298,552 | 11,268 | 254,160 | 60,653 | 640,036 | 781,680 | 474,102 | 2,382,073 |
| SCZ | 15,476 | 164,371 | 7,467 | 137,862 | 32,920 | 334,291 | 333,963 | 202,703 | 1,171,056 |
| TC | 21,178 | 318,158 | 12,095 | 271,036 | 64,261 | 677,541 | 816,070 | 495,101 | 2,508,369 |
| TG | 21,177 | 318,159 | 12,097 | 271,039 | 64,260 | 677,544 | 816,070 | 495,098 | 2,508,363 |
| UC | 16,148 | 175,429 | 7,912 | 147,535 | 35,648 | 359,651 | 369,360 | 224,432 | 1,273,589 |
| WHR | 18,263 | 298,474 | 11,232 | 254,086 | 60,404 | 639,727 | 780,759 | 473,392 | 2,376,820 |

Table 13. The table shows the number of tag SNPs in each annotation category from each GWAS without LD based annotation (using only positional information (No LD) and after LD based annotation (LD). Note the increased number of SNPs in all annotation categories, especially in annotation categories such as 3′UTR and 5′UTR when using LD-weighted categories. BD, Bipolar Disorder; BMI, Body Mass Index; CD, Crohn's disease; CPD, Cigarettes per Day; DBP, Diastolic blood pressure; HDL, High density lipoprotein; LDL, Low density lipoprotein; SBP, systolic blood pressure; SCZ, Schizophrenia; TC, total Cholesterol; TG, triglycerides; UC, Ulcerative Colitis; WHR, Waist-hip-ratio.

TABLE 14
Genomic Control Estimates

| | BD | BMI | CD | CPD | DBP | HDL | Height | LDL | SBP | SCZ | TC | TG | UC | WHR |
|---|---|---|---|---|---|---|---|---|---|---|---|---|---|---|
| λ_{GC} All | 1.15 | 1.04 | 1.25 | 1.05 | 1.02 | 1.00 | 1.05 | 1.00 | 1.02 | 1.24 | 1.00 | 1.00 | 1.23 | 1.00 |
| Before IIC | | | | | | | | | | | | | | |
| λ_{GC} All | 1.06 | 1.03 | 1.09 | .97 | 1.07 | 1.06 | 1.21 | 1.07 | 1.07 | 1.06 | 1.11 | 1.05 | 1.05 | 1.05 |
| After IIC | | | | | | | | | | | | | | |
| λ_{GC} | 1.08 | 1.01 | 1.15 | 1.09 | 0.96 | 0.95 | 0.87 | 0.94 | 0.95 | 1.17 | 0.90 | 0.95 | 1.18 | 0.95 |
| Intergenic | | | | | | | | | | | | | | |
| Before IIC | | | | | | | | | | | | | | |
| λ_{GC} | 1 | 1 | 1 | 1 | 1 | 1 | 1 | 1 | 1 | 1 | 1 | 1 | 1 | 1 |
| Intergenic | | | | | | | | | | | | | | |
| After IIC | | | | | | | | | | | | | | |

Table 14. Estimated genomic inflation factors for either all SNPs or Intergenic SNPs before and after application of intergenic inflation control (IIC). The λ_{GC} values calculated before IIC were calculated from the summary statistics as they were made available to us either by collaborators or public data repositories. Many of these studies already had performed a standard genomic control procedure, adjusting the test statistics down, to correct for inflation. For these studies the procedure may correct statistics upwards, increasing the computed λ_{GC} values. The intergenic SNPs were used to estimate inflation because their relative depletion of associations indicates they provide a robust estimate of true null SNPs that is less contaminated by polygenic effects. Using annotation categories in this fashion is important given concerns posed by recent GWAS[8] about the over-correction of test statistics using standard genomic control[15]. Values greater than 1 indicate inflation and values less than 1 indicate an over correction, relative to the theoretical empirical null distribution. λ_{GC} was calculated as the ratio of the median z-score² to the expected median of a Chi-square distribution with 1 degree of freedom, for all SNPs and intergenic SNPs independently. IIC, Intergenic Inflation Control; BD, Bipolar Disorder; BMI, Body Mass Index; CD, Crohn's disease; CPD, Cigarettes per Day; DBP, Diastolic blood pressure; HDL, High density lipoprotein; LDL, Low density lipoprotein; SBP, systolic blood pressure; SCZ, Schizophrenia; TC, total Cholesterol; TG, triglycerides; UC, Ulcerative Colitis; WHR, Waist-hip-ratio.

TABLE 15
Enrichment P-Values

| | 10kUp | 1kUp | 5′UTR | Exon | Intron | 3′UTR | 1kdown | 10kdown |
|---|---|---|---|---|---|---|---|---|
| BD | 7.40E−06 | 3.14E−03 | 1.43E−06 | 1.86E−04 | 1.06E−02 | 1.75E−04 | 5.65E−04 | 1.19E−03 |
| BMI | 9.82E−09 | 1.80E−09 | 9.40E−14 | 5.55E−16 | 3.01E−03 | 3.33E−16 | 7.08E−11 | 4.78E−08 |
| CD | 8.88E−15 | <2.2E−16 | 2.24E−12 | 6.15E−14 | 9.97E−08 | 8.94E−13 | 1.00E−13 | 8.68E−12 |
| CPD | 6.32E−01 | 2.25E−01 | 6.43E−01 | 8.08E−03 | 7.81E−01 | 5.52E−02 | 1.18E−01 | 3.90E−02 |
| DBP | 9.77E−15 | 3.28E−13 | 1.48E−10 | 5.55E−15 | 1.65E−08 | 5.96E−09 | 4.28E−10 | 8.48E−10 |
| HDL | 3.99E−14 | 1.45E−13 | 4.44E−16 | 4.01E−14 | 1.10E−04 | 5.55E−16 | 1.61E−11 | 6.95E−09 |
| Height | <2.2E−16 | <2.2E−16 | <2.2E−16 | <2.2E−16 | <2.2E−16 | <2.2E−16 | <2.2E−16 | <2.2E−16 |
| LDL | 5.78E−13 | 2.90E−09 | 8.55E−15 | <2.2E−16 | 1.31E−08 | 3.22E−15 | 1.35E−12 | 7.90E−12 |
| SBP | 9.82E−11 | 2.72E−10 | 1.82E−12 | 3.04E−13 | 6.96E−06 | 8.05E−08 | 5.38E−09 | 2.58E−06 |
| SCZ | 3.17E−06 | 7.28E−06 | 2.67E−05 | 2.36E−07 | 2.25E−02 | 4.45E−08 | 2.12E−05 | 1.26E−09 |
| TC | <2.2E−16 | <2.2E−16 | 8.88E−16 | <2.2E−16 | 1.85E−13 | <2.2E−16 | <2.2E−16 | <2.2E−16 |
| TG | 9.69E−14 | 9.99E−16 | 4.07E−11 | <2.2E−16 | 8.57E−05 | 8.55E−14 | 7.05E−13 | 3.22E−15 |
| UC | 3.64E−06 | 2.60E−05 | 3.69E−06 | 3.00E−08 | 1.76E−02 | 2.38E−05 | 4.01E−07 | 1.03E−05 |
| WHR | 1.20E−09 | 1.09E−08 | 1.98E−08 | 1.28E−09 | 5.81E−05 | 1.38E−07 | 2.26E−05 | 6.80E−09 |

Table 15. The p-values of the enrichment of the Q-Q plots of the different phenotypes, comparing intergenic annotation category with the different genic annotation categories. Each p-value corresponds to the median Kolmogorov-Smirnov statistic from 10 iterations of each comparison for 10 different random prunings of SNPs to approximate independence (r² < 0.2). BD, Bipolar Disorder; BMI, Body Mass Index; CD, Crohn's disease; CPD, Cigarettes per Day; DBP, Diastolic blood pressure; HDL, High density lipoprotein; LDL, Low density lipoprotein; SBP, systolic blood pressure; SCZ, Schizophrenia; TC, total Cholesterol; TG, triglycerides; UC, Ulcerative Colitis; WHR, Waist-hip-ratio.

TABLE 16
Enrichment Scores

| | 10kUp | 1kUp | 5′UTR | Exon | Intron | 3′UTR | 1kDown | 10kDown | Intergenic |
|---|---|---|---|---|---|---|---|---|---|
| BD | 0.413 | 0.576 | 1.000 | 0.549 | 0.310 | 0.533 | 0.535 | 0.427 | 0.035 |
| BMI | 0.507 | 0.613 | 1.000 | 0.603 | 0.317 | 0.638 | 0.563 | 0.406 | 0.160 |
| CD | 0.455 | 0.702 | 1.000 | 0.642 | 0.310 | 0.594 | 0.627 | 0.479 | 0.040 |
| CPD | 0.191 | 0.640 | 1.000 | 0.320 | 0.012 | 0.401 | 0.379 | 0.291 | 0.111 |
| DBP | 0.567 | 0.816 | 1.000 | 0.787 | 0.382 | 0.731 | 0.726 | 0.563 | 0.018 |
| HDL | 0.623 | 0.900 | 1.000 | 0.866 | 0.402 | 0.849 | 0.946 | 0.613 | 0.014 |
| Height | 0.478 | 0.675 | 1.000 | 0.630 | 0.314 | 0.624 | 0.589 | 0.476 | 0.044 |
| LDL | 0.730 | 0.941 | 1.000 | 0.957 | 0.428 | 0.890 | 0.924 | 0.606 | 0.032 |
| SBP | 0.599 | 0.863 | 1.000 | 0.764 | 0.433 | 0.866 | 0.793 | 0.583 | 0.045 |
| SCZ | 0.379 | 0.620 | 1.000 | 0.594 | 0.237 | 0.582 | 0.619 | 0.396 | 0.038 |
| TC | 0.661 | 0.925 | 1.000 | 0.865 | 0.401 | 0.821 | 0.901 | 0.558 | 0.029 |
| TG | 0.536 | 0.796 | 1.000 | 0.751 | 0.343 | 0.876 | 0.905 | 0.554 | 0.020 |
| UC | 0.387 | 0.687 | 1.000 | 0.622 | 0.242 | 0.592 | 0.649 | 0.420 | 0.021 |
| WHR | 0.477 | 0.690 | 1.000 | 0.625 | 0.315 | 0.630 | 0.561 | 0.437 | 0.047 |

Table 16. Mean(z-score² − 1) estimates of the relative variance per non null SNP. This table describ [symbol] enrichment values used to create FIG. 2 and FIG. 27. All values are expressed in relative proportions highest category for each phenotype. BD, Bipolar Disorder; BMI, Body Mass Index; CD, Crohn's disease; [symbol] Cigarettes per Day; DBP, Diastolic blood pressure; HDL, High density lipoprotein; LDL, Low d [symbol] lipoprotein; SBP, systolic blood pressure; SCZ, Schizophrenia; TC, total Cholesterol; TG, triglycerides [symbol] Ulcerative Colitis; WHR, Waist-hip-ratio. [symbol]
indicates data missing or illegible when filed

[symbol]

TABLE 17
Categorical average total LD

| | 10kup | 1kup | 5UTR | Exon | Intron | 3UTR | 1kdown | 10kdown | Intergenic | Total |
|---|---|---|---|---|---|---|---|---|---|---|
| BD | 132.24 | 176.51 | 224.30 | 167.87 | 97.16 | 159.23 | 169.56 | 132.56 | 86.31 | 89.02 |
| BMI | 132.17 | 176.37 | 223.85 | 167.61 | 97.25 | 159.01 | 169.25 | 132.40 | 86.56 | 89.23 |
| CD | 121.62 | 159.05 | 197.13 | 151.36 | 90.76 | 145.16 | 153.44 | 121.46 | 78.45 | 83.08 |
| CPD | 132.22 | 176.35 | 223.72 | 167.48 | 97.34 | 159.01 | 169.22 | 132.44 | 86.60 | 89.31 |
| DBP | 132.16 | 176.95 | 225.46 | 168.44 | 97.02 | 159.50 | 169.69 | 132.38 | 86.35 | 88.96 |
| HDL | 131.48 | 175.38 | 222.53 | 166.80 | 96.47 | 158.37 | 168.63 | 131.78 | 85.79 | 88.42 |
| Height | 132.19 | 176.39 | 223.84 | 167.61 | 97.29 | 159.03 | 169.27 | 132.41 | 86.61 | 89.29 |
| LDL | 131.48 | 175.38 | 222.53 | 166.80 | 96.47 | 158.37 | 168.62 | 131.78 | 85.79 | 88.42 |
| SBP | 132.16 | 176.95 | 225.46 | 168.44 | 97.02 | 159.50 | 169.69 | 132.38 | 86.35 | 88.96 |
| SCZ | 118.91 | 155.77 | 192.98 | 148.46 | 86.30 | 142.80 | 151.31 | 119.01 | 73.88 | 78.31 |
| TC | 131.48 | 175.38 | 222.54 | 166.80 | 96.47 | 158.37 | 168.63 | 131.78 | 85.79 | 88.42 |
| TG | 131.48 | 175.38 | 222.54 | 166.80 | 96.47 | 158.37 | 168.63 | 131.78 | 85.79 | 88.42 |
| UC | 119.52 | 157.12 | 195.97 | 149.84 | 86.68 | 143.87 | 152.63 | 119.66 | 74.69 | 78.77 |
| WHR | 132.27 | 177.10 | 225.58 | 168.51 | 97.20 | 159.61 | 169.80 | 132.48 | 86.47 | 89.15 |

Table 17. The table shows the average total LD score for GWAS tag SNPs per LD-weighted genic annotation category for each phenotype. Total LD is measured as the sum of pairwise LD scores (r² > .2) relating each GWAS tag SNP to all 1KGP SNPs within 1,000,000 base pairs. Note the consistent pattern across phenotypes, with large variation between annotaion categories, with highest LD score in 5′UTR. BD, Bipolar Disorder; BMI, Body Mass Index; CD, Crohn's disease; CPD, Cigarettes per Day; DBP, Diastolic blood pressure; HDL, High density lipoprotein; LDL, Low density lipoprotein; SBP, systolic blood pressure; SCZ, Schizophrenia; TC, total Cholesterol; TG, triglycerides; UC, Ulcerative Colitis; WHR, Waist-hip-ratio.

TABLE 18
Categorical average SNP counts

| | 10kup | 1kup | 5UTR | Exon | Intron | 3UTR | 1kdown | 10kdown | Intergenic | Total |
|---|---|---|---|---|---|---|---|---|---|---|
| BD | 249.03 | 321.91 | 392.94 | 306.58 | 184.77 | 291.67 | 310.30 | 250.08 | 165.49 | 169.47 |
| BMI | 248.49 | 321.13 | 391.29 | 305.61 | 184.57 | 290.80 | 309.35 | 249.32 | 165.62 | 169.51 |
| CD | 235.71 | 299.93 | 359.48 | 285.23 | 177.64 | 273.96 | 289.23 | 235.69 | 155.61 | 162.99 |
| CPD | 248.57 | 321.08 | 391.12 | 305.37 | 184.71 | 290.80 | 309.30 | 249.40 | 165.69 | 169.63 |
| DBP | 248.32 | 321.81 | 393.34 | 306.74 | 184.05 | 291.38 | 309.83 | 249.14 | 165.20 | 168.94 |
| HDL | 247.53 | 319.95 | 389.97 | 304.70 | 183.31 | 290.14 | 308.81 | 248.53 | 164.29 | 168.13 |
| Height | 248.52 | 321.17 | 391.28 | 305.61 | 184.65 | 290.83 | 309.37 | 249.35 | 165.72 | 169.61 |
| LDL | 247.53 | 319.95 | 389.97 | 304.70 | 183.31 | 290.13 | 308.81 | 248.53 | 164.29 | 168.13 |
| SBP | 248.32 | 321.81 | 393.34 | 306.74 | 184.05 | 291.38 | 309.83 | 249.14 | 165.20 | 168.94 |
| SCZ | 229.88 | 293.15 | 351.59 | 279.01 | 168.45 | 268.73 | 284.53 | 230.31 | 146.22 | 153.22 |
| TC | 247.53 | 319.95 | 389.97 | 304.70 | 183.31 | 290.14 | 308.81 | 248.53 | 164.29 | 168.13 |
| TG | 247.53 | 319.95 | 389.97 | 304.70 | 183.31 | 290.14 | 308.81 | 248.53 | 164.29 | 168.13 |
| UC | 230.67 | 294.93 | 355.65 | 280.99 | 168.97 | 270.19 | 286.38 | 231.22 | 147.55 | 153.91 |
| WHR | 248.59 | 322.19 | 393.67 | 306.97 | 184.44 | 291.66 | 310.12 | 249.39 | 165.46 | 169.33 |

Table 18. The average total number of SNP tagged (r² > 0.2) by a tag SNP per genic annotation category for each phenotype. Note the consistent pattern across phenotypes, with variation between categories, and highest number in 5′UTR. The distribution of block sizes does match the ordering of enrichment by category. BD, Bipolar Disorder; BMI, Body Mass Index; CD, Crohn's disease; CPD, Cigarettes per Day; DBP, Diastolic blood pressure; HDL, High density lipoprotein; LDL, Low density lipoprotein; SBP, systolic blood pressure; SCZ, Schizophrenia; TC, total Cholesterol; TG, triglycerides; UC, Ulcerative Colitis; WHR, Waist-hip-ratio.

TABLE 19
Categorical average minor allele frequency

| | 10kup | 1kup | 5UTR | Exon | Intron | 3UTR | 1kdown | 10kdown | Intergenic | Total |
|---|---|---|---|---|---|---|---|---|---|---|
| BD | 0.2396 | 0.2489 | 0.2473 | 0.2443 | 0.2327 | 0.2452 | 0.2484 | 0.2409 | 0.2412 | 0.2341 |
| BMI | 0.2374 | 0.2467 | 0.2444 | 0.2418 | 0.2303 | 0.2428 | 0.2462 | 0.2386 | 0.2391 | 0.2318 |
| CD | 0.2516 | 0.2593 | 0.2548 | 0.2545 | 0.2492 | 0.2565 | 0.2588 | 0.2531 | 0.2589 | 0.2514 |
| CPD | 0.2375 | 0.2467 | 0.2444 | 0.2417 | 0.2307 | 0.2428 | 0.2462 | 0.2387 | 0.2396 | 0.2322 |
| DBP | 0.2363 | 0.2452 | 0.2429 | 0.2402 | 0.2291 | 0.2413 | 0.2447 | 0.2374 | 0.2386 | 0.2309 |
| HDL | 0.2375 | 0.2466 | 0.2445 | 0.2416 | 0.2299 | 0.2428 | 0.2463 | 0.2386 | 0.2388 | 0.2314 |
| Height | 0.2375 | 0.2467 | 0.2444 | 0.2418 | 0.2304 | 0.2428 | 0.2462 | 0.2386 | 0.2392 | 0.2319 |
| LDL | 0.2375 | 0.2466 | 0.2445 | 0.2416 | 0.2299 | 0.2428 | 0.2463 | 0.2386 | 0.2388 | 0.2314 |
| SBP | 0.2363 | 0.2452 | 0.2429 | 0.2402 | 0.2291 | 0.2413 | 0.2447 | 0.2374 | 0.2386 | 0.2309 |
| SCZ | 0.2442 | 0.2519 | 0.2481 | 0.2460 | 0.2380 | 0.2488 | 0.2517 | 0.2454 | 0.2483 | 0.2399 |
| TC | 0.2375 | 0.2466 | 0.2445 | 0.2416 | 0.2299 | 0.2428 | 0.2463 | 0.2386 | 0.2388 | 0.2314 |
| TG | 0.2375 | 0.2466 | 0.2445 | 0.2416 | 0.2299 | 0.2428 | 0.2463 | 0.2386 | 0.2388 | 0.2314 |
| UC | 0.2433 | 0.2512 | 0.2475 | 0.2453 | 0.2370 | 0.2481 | 0.2511 | 0.2445 | 0.2472 | 0.2388 |
| WHR | 0.2365 | 0.2455 | 0.2432 | 0.2406 | 0.2294 | 0.2415 | 0.2450 | 0.2376 | 0.2388 | 0.2312 |

Table 19. The table shows the average minor allele frequency of GWAS tag SNPs in each genic annotation category for every phenotype. Note the similarities across phenotypes and annotation categories. BD, Bipolar Disorder; BMI, Body Mass Index; CD, Crohn's disease; CPD, Cigarettes per Day; DBP, Diastolic blood pressure; HDL, High density lipoprotein; LDL, Low density lipoprotein; SBP, systolic blood pressure; SCZ, Schizophrenia; TC, total Cholesterol; TG, triglycerides; UC, Ulcerative Colitis; WHR, Waist-hip-ratio.

TABLE 20
Multiple regression analysis predicting log(Z²) in height
Table 10. Multiple regression analysis reveals a minimal, but significant,
effect of total LD on the log Z² for height. This represents a minimal,
but significant, effect of overall LD block size on enrichment. Categorical
effects remain independently strong in this analysis with an effect size
order that mirrors enrichment.

| Variables | Coeff. | Adjusted SE* | Adjusted 95% CI* |
|---|---|---|---|
| Intercept | −1.2027 | 0.00108 | (−1.2048, −1.2006) |
| Total LD | 0.0019 | 0.00008 | (0.0018, 0.0021) |
| Intron | 0.0025 | 0.00013 | (0.0022, 0.0028) |
| Exon | 0.1686 | 0.00543 | (0.0062, 0.0275) |
| 3′UTR | 0.1182 | 0.00440 | (0.1182, 0.1269) |
| 1K Upstream | 0.0905 | 0.00668 | (0.0774, 0.1035) |
| 5′UTR | 0.3467 | 0.01303 | (0.3212, 0.3723) |

*Standard errors of regression coefficients adjusted to reflect effective independent sample size degrees of freedom of 10\hat{ }5.

TABLE 21
Null GWAS simulations
Table 21. Simulations of categorical enrichment based on multiple
independent null GWAS simulations based on subjects with European
ancestry from the 1000 Genomes Project. Random phenotypes were
generated unrelated to genotypes for each subject, association
z-scoress were computed for each tag SNP, and mean(z²)
was computed for each annotation category, using the same procedure
as applied to the actual GWAS data. The means and standard
deviations were computed from 20 independent simulation runs.
The results demonstrate that the observed differential enrichment of
annotation categories cannot be explained by category-specific
spurious sources of genomic inflation due to differential LD or MAF.

| Annotation category | z² mean (stdev) |
|---|---|
| 10kUp | 0.997 (0.014) |
| 1kUp | 0.996 (0.018) |
| 5′UTR | 1.003 (0.033) |
| Exon | 1.000 (0.021) |
| Intron | 0.998 (0.013) |
| 3′UTR | 1.001 (0.016) |
| 1kdown | 0.994 (0.015) |
| 10kDown | 1.000 (0.013) |
| Intergenic | 0.999 (0.018) |

TABLE 22
22. FDR versus sFDR Discovery

| | 0.01 | | 0.05 | | 0.5 | |
|---|---|---|---|---|---|---|
| | FDR | sFDR | FDR | sFDR | FDR | sFDR |
| BD | 4 | 8 | 6 | 73 | 28285 | 28466 |
| BMI | 64 | 93 | 152 | 275 | 7502 | 15715 |
| CPD | 4 | 4 | 5 | 7 | 38624 | 36338 |
| CD | 185 | 209 | 381 | 452 | 30194 | 28815 |
| DBP | 33 | 45 | 83 | 137 | 27848 | 29051 |
| HDL | 297 | 356 | 528 | 772 | 47404 | 42874 |
| Height | 968 | 1162 | 1993 | 2478 | 48126 | 45870 |
| LDL | 343 | 422 | 610 | 871 | 55569 | 51901 |
| SBP | 31 | 50 | 90 | 182 | 29177 | 29166 |
| SCZ | 8 | 25 | 33 | 90 | 11463 | 14259 |
| TC | 469 | 575 | 921 | 1249 | 62700 | 58554 |
| TG | 239 | 307 | 464 | 647 | 49355 | 44142 |
| UC | 260 | 273 | 453 | 590 | 44149 | 41042 |
| WHR | 32 | 51 | 86 | 151 | 41941 | 37816 |

Leveraging the enriched genic annotation categories to create strata among the SNPs it is shown that the stratified false discovery rate (sFDR) method[31] improves the discovery of SNPs for a given FDR threshold, across all phenotypes. The numbers reported are after pruning SNPs for LD at a threshold of r² ≦ 0.2.

### REFERENCES

1. Glazier A M, Nadeau J H, Aitman T J (2002) Finding genes that underlie complex traits. Science 298: 2345-2349.
2. Hirschhorn J N, Daly M J (2005) Genome-wide association studies for common diseases and complex traits. Nat Rev Genet 6: 95-108.
3. Hindorff L A, Sethupathy P, Junkins H A, Ramos E M, Mehta J P, et al. (2009) Potential etiologic and functional implications of genome-wide association loci for human diseases and traits. Proc Natl Acad Sci USA 106: 9362-9367.
4. Manolio T A, Collins F S, Cox N J, Goldstein D B, Hindorff L A, et al. (2009) Finding the missing heritability of complex diseases. Nature 461: 747-753.
5. Yang J, Benyamin B, McEvoy B P, Gordon S, Henders A K, et al. (2010) Common SNPs explain a large proportion of the heritability for human height. Nat Genet 42: 565-569.
6. Yang J, Manolio T A, Pasquale L R, Boerwinkle E, Caporaso N, et al. (2011) Genome partitioning of genetic variation for complex traits using common SNPs. Nat Genet 43: 519-525.
7. Stahl E A, Wegmann D, Trynka G. Gutierrez-Achury J. Do R, et al. (2012) Bayesian inference analyses of the polygenic architecture of rheumatoid arthritis. Nat Genet 44: 483-489.
8. Benjamini Y, Hochberg Y (1995) Controlling the False Discovery Rate: A Practical and Powerful Approach to Multiple Testing. Journal of the Royal Statistical Society Series B (Methodological): Blackwell Publishing. pp. 289-300.
9. Sun L, Craiu R V, Paterson A D, Bull S B (2006) Stratified false discovery control for large-scale hypothesis testing with application to genome-wide association studies. Genet Epidemiol 30: 519-530.
10. Yoo Y J, Pinnaduwage D, Waggott D, Bull S B, Sun L (2009) Genome-wide association analyses of North American Rheumatoid Arthritis Consortium and Framingham Heart Study data utilizing genome-wide linkage results. BMC Proc 3 Suppl 7: S103.
11. Smith E N, Koller D L, Panganiban C, Szelinger S, Zhang P, et al. (2011) Genome-wide association of bipolar disorder suggests an enrichment of replicable associations in regions near genes. PLoS Genet 7: e1002134.
12. Efron B (2010) Large-scale inference: empirical Bayes methods for estimation, testing, and prediction. Cambridge; New York: Cambridge University Press. xii, 263 p. p.
13. Schwedcr T, Spjotvoll E (1982) Plots of P-Values to Evaluate Many Tests Simultaneously. Biometrika 69: 493-502.
14. Yang J, Weedon M N, Purcell S, Lettre G, Estrada K, et al. (2011) Genomic inflation factors under polygenic inheritance. Eur J Hum Genet 19: 807-812.
15. Devlin B, Roeder K (1999) Genomic control for association studies. Biometrics 55: 997-1004.
16. Benjamini Y. Hochberg Y (1995) Controlling the false discovery rate: a practical and powerful approach to multiple testing. Journal of the Royal Statistical Society Series B (Methodological) 57: 289-300.
17. Consortium I S, Purcell S M, Wray N R, Stone J L, Visscher P M, et al. (2009) Common polygenic variation contributes to risk of schizophrenia and bipolar disorder. Nature 460: 748-752.
18. Schweder T, Spjøtvoll E (1982) Plots of P-values to evaluate many tests simultaneously. Biometrika 69: 493-502.
19. Flint J, Mackay T F (2009) Genetic architecture of quantitative traits in mice, flies, and humans. Genome Res 19: 723-733.
20. Keane T M, Goodstadt L, Danecek P, White M A, Wong K, et al. (2011) Mouse genomic variation and its effect on phenotypes and gene regulation. Nature 477: 289-294.
21. So H C, Gui A H, Cherny S S, Sham P C (2011) Evaluating the heritability explained by known susceptibility variants: a survey often complex diseases. Genet Epidemiol 35: 310-317.
22. So H C, Yip B H, Sham P C (2010) Estimating the total number of susceptibility variants underlying complex diseases from genome-wide association studies. PLoS One 5: e13898.
23. Pawitan Y, Seng K C, Magnusson P K (2009) How many genetic variants remain to be discovered? PLoS One 4: e7969.
24. Falconer D S, Mackay T F C (1996) Introduction to quantitative genetics. Essex, England: Longman. xiii, 464 p. p.
25. Visscher P M, Goddard M E, Derks E M, Wray N R (2012) Evidence-based psychiatric genetics, AKA the false dichotomy between common and rare variant hypotheses. Mol Psychiatry 17: 474-485.
26. Mignone F, Gissi C, Liuni S, Pesole G (2002) Untranslated regions of mRNAs. Genome Biol 3: REVIEWS0004.
27. Siepel A, Bejerano G, Pedersen J S, Hinrichs A S, Hou M, et al. (2005) Evolutionarily conserved elements in vertebrate, insect, worm, and yeast genomes. Genome Res 15: 1034-1050.
28. King M C, Wilson A C (1975) Evolution at two levels in humans and chimpanzees. Science 188: 107-116.
29. Cooper G M, Shendure J (2011) Needles in stacks of needles: finding disease-causal variants in a wealth of genomic data. Nat Rev Genet 12: 628-640.
30. Speliotes E K, Willer C J, Berndt S I, Monda K L, Thorleifsson G, et al. (2010) Association analyses of 249,796 individuals reveal 18 new loci associated with body mass index. Nat Genet 42: 937-948.
31. Heid I M, Jackson A U, Randall J C, Winkler T W, Qi L, et al. (2010) Meta-analysis identifies 13 new loci associated with waist-hip ratio and reveals sexual dimorphism in the genetic basis of fat distribution. Nat Genet 42: 949-960.
32. Franke A, McGovern D P, Barrett J C, Wang K, Radford-Smith G L, et al. (2010) Genome-wide meta-analysis increases to 71 the number of confirmed Crohn's disease susceptibility loci. Nat Genet 42: 1118-1125.
33. Anderson C A, Boucher G, Lees C W, Franke A, D'Amato M, et al. (2011) Meta-analysis identifies 29 additional ulcerative colitis risk loci, increasing the number of confirmed associations to 47. Nat Genet 43: 246-252.
34. The Schizophrenia Psychiatric Genome-Wide Association Study (GWAS) Consortium (2011) Genome-wide association study identifies five new schizophrenia loci. Nat Genet 43: 969-976.
35. Psychiatric GWAS Consortium Bipolar Disorder Working Group (2011) Large-scale genome-wide association analysis of bipolar disorder identifies a new susceptibility locus near ODZ4. Nat Genet 43: 977-983.
36. The Tobacco and Genetics Consortium (2010) Genome-wide meta-analyses identify multiple loci associated with smoking behavior. Nat Genet 42: 441-447.
Schork et al.
27
37. Ehret G B, Munroe P B, Rice K M, Bochud M, Johnson A D, et al. (2011) Genetic variants in novel pathways influence blood pressure and cardiovascular disease risk. Nature 478: 103-109.
38. Teslovich T M, Musunuru K, Smith A V, Edmondson A C, Stylianou I M, et al. (2010) Biological, clinical and population relevance of 95 loci for blood lipids. Nature 466: 707-713.
39. Purcell S (2009) Plink. 1.07 ed. (http://pngu.mgh.harvard.edu/purcell/plink/)
40. Purcell S, Neale B, Todd-Brown K, Thomas L, Ferreira M A, et al. (2007) PLINK: a tool set for whole-genome association and population-based linkage analyses. Am J Hum Genet 81: 559-575.
41. Hsu F, Kent W J, Clawson H, Kuhn R M, Diekhans M, et al. (2006) The UCSC Known Genes. Bioinformatics 22: 1036-1046.
42. Efron B (2007) Size, power and false discovery rates. The Annals of Statistics 35: 1351-1377.

### Example 3

### MATERIAL and METHODS

Participant Samples

Complete GWAS results in the form of summary statistics p-values were obtained from public access websites or through collaboration with investigators (T2D cases and controls from the DIAGRAM Consortium and schizophrenia cases and controls from the Psychiatric GWAS Consortium (PGC)—Table 25). There was no overlap among participants in the CVD GWAS and the schizophrenia case-control sample (n=21,856), except for 2,974 of 12,462 controls (24%)137. The schizophrenia GWAS summary statistics results were obtained from the Psychiatric GWAS Consortium (PGC)13, which consisted of 9,394 cases with schizophrenia or schizoaffective disorder and 12,462 controls (52% screened) from a total of 17 samples from 11 countries. The quality of phenotypic data was verified by a systematic review of data collection methods and procedures at each site, and only studies that fulfilled these criteria were included. This involved nine key items: i) the use of a structured psychiatric interview, ii) systematic training of interviewers in the use of the instrument, iii) systematic quality control of diagnostic accuracy, iv) reliability trials, v) review of medical record information, vi) best-estimate procedure employed, vii) specific inclusion and exclusion criteria developed and utilized, viii) MDs or PhDs as making the final diagnostic determination, and ix) special additional training for the final Schizophrenia PGC. One sample from Sweden used another approach, but further empirical support for the validity of this approach was provided. Controls consisted of 12,462 samples of European ancestry collected from the same countries. As the prevalence of schizophrenia is low, a large control sample where some controls were not screened for schizophrenia was utilized. For further details on sample characteristics and quality control procedures applied, please see Ripke et al 13. There were 2974 controls in the schizophrenia UK case control sample from the Welcome Trust Case Control Consortium that were also included in several of the CVD risk factor GWAS. This constitutes 24% of the total number of controls (n=12,462) in the Schizophrenia PGC sample13. More information about inclusion criteria and phenotype characteristics of the Cardiovascular Disease (CVD) risk factors samples of the different GWAS are described in the original publications 29-33. The relevant institutional review boards or ethics committees approved the research protocol of the individual GWAS used in the current analysis and all human participants gave written informed consent.

Statistical Analyses

Stratified Q-Q Plots

Q-Q plots compare a nominal probability distribution against an empirical distribution. In the presence of all null relationships, nominal p-values form a straight line on a Q-Q plot when plotted against the empirical distribution. For each phenotype, for all SNPs and for each categorical subset (strata), −log 10 nominal p-values were plotted against −log 10 empirical p-values (stratified Q-Q plots). Leftward deflections of the observed distribution from the projected null line reflect increased tail probabilities in the distribution of test statistics (z-scores) and consequently an over-abundance of low p-values compared to that expected by chance, also termed “enrichment”. Under large-scale testing paradigms, such as GWAS, quantitative estimates of likely true associations can be estimated from the distributions of summary statistics36; 37. A common method for visualizing the enrichment of statistical association relative to that expected under the global null hypothesis is through Q-Q plots of nominal p-values obtained from GWAS summary statistics. The usual Q-Q curve has as the y-ordinate the nominal p-value, denoted by “p”, and as the x-ordinate the corresponding value of the empirical cdf, denoted by “q”. Under the global null hypothesis the theoretical distribution is uniform on the interval [0.1]. As is common in GWAS, −log 10p is plotted against −log 10 q to empha 1 size tail probabilities of the theoretical and empirical distributions. Therefore, genetic enrichment results in a leftward shift in the Q-Q curve, corresponding to a larger fraction of SNPs with nominal −log 10 p-value greater than or equal to a given threshold. Stratified Q-Q plots are constructed by creating subsets of SNPs based on levels of an auxiliary measure for each SNP, and computing Q-Q plots separately for each level. If SNP enrichment is captured by variation in the auxiliary measure, this is expressed as successive leftward deflections in a stratified Q-Q plot as levels of the auxiliary measure increase.

Genomic Control

The empirical null distribution in GWAS is affected by global variance inflation due to population stratification and cryptic relatedness38 and deflation due to over-correction of test statistics for polygenic traits by standard genomic control methods39. A control method leveraging only intergenic SNPs, which are likely depleted for true associations (Example 2), was applied. First, the SNPs were annotated to genic (5″UTR, exon, intron, 3″UTR) and intergenic regions using information from the 1000 Genomes Project (1KGP). As illustrated in FIG. 15, there is an enrichment of functional genic regions in schizophrenia compared to the intergenic SNP category. Intergenic SNPs were used because their relative depletion of associations indicates that they provide a robust estimate of true null effects and thus seem a better category for genomic control than all SNPs. All p-values were converted to z-scores and for each phenotype the genomic inflation factor λ_{GC} for intergenic SNPs was estimated. The inflation factor, λ_{GC} is calculated as the median z-score squared divided by the expected median of a chi-square distribution with one degree of freedom and divided all test statistics by λ_{GC}. The stratified Q-Q plot for schizophrenia after control for genomic inflation is shown in FIG. 15.

Stratified 1 Q-Q Plots for Pleiotropic Enrichment

To assess pleiotropic enrichment, Q-Q plot stratified by “pleiotropic” effects were used. For a given associated phenotype, enrichment for pleiotropic signals is present if the degree of deflection from the expected null line is dependent on SNP associations with the second phenotype. Stratified Q-Q plots of empirical quantiles of nominal −log₁₀(p) values were constructed for SNP association with schizophrenia for all SNPs, and for subsets (strata) of SNPs determined by the nominal p-values of their association with a given CVD risk factor. Specifically, the empirical cumulative distribution of nominal p-values was computed for a given phenotype for all SNPs and for SNPs with significance levels below the indicated cut-offs for the other phenotype (−log₁₀(p)≧0, −log₁₀(p)≧1, −log₁₀(p)≧2, −log₁₀(p)≧3 corresponding to p<1, p<0.1, p<0.01, p<0.001, respectively). The nominal p-values (−log₁₀(p)) are plotted on the y-axis, and the empirical quantiles (−log₁₀(q), where q=1−cdf(p)) are plotted on the x-axis. To assess for polygenic effects below the standard GWAS significance threshold, the stratified Q-Q plots were focused on SNPs with nominal −log₁₀(p)<7.3 (corresponding to p>5×10⁻⁸).

Stratified True Discovery Rate (TDR)

Enrichment seen in the stratified Q-Q plots can be directly interpreted in terms of TDR (equivalent to one minus the FDR40). The stratified FDR method35, previously used for enrichment of GWAS based on linkage information were applied 34. Specifically, for a given p-value cutoff, the FDR is defined as

FDR(p)=π₀F₀(p)/F(p), [1]

where π₀ is the proportion of null SNPs, F0 is the null cdf, and F is the cdf of all SNPs, both null and non-null; see below for details on this simple mixture model formulation41. Under the null hypothesis, F0 is the cdf of the uniform distribution on the unit interval [0,1], so that Eq. [1] reduces to

FDR(p)=π₀p/F(p), [2].

The cdf F can be estimated by the empirical cdf 1 q=Np/N, where Np is the number of SNPs with p2 values less than or equal to p, and N is the total number of SNPs. Replacing F by q in Eq. [2]

Estimated FDR(p)=π₀p/q, [3],

which is biased upwards as an estimate of the FDR41. Replacing π₀ 4 in Equation [3] with unity gives an estimated FDR that is further biased upward; q*=p/q [4]. If no is close to one, as is likely true for most GWAS, the increase in bias from Eq. [3] is minimal. The quantity 1−p/q, is therefore biased downward, and hence is a conservative estimate of the TDR. Referring to the formulation of the Q-Q plots, q* is equivalent to the nominal p-value divided by the empirical quantile, as defined earlier. Given the −log 10 of the Q-Q plots

−log₁₀(q)=log₁₀(q)−log₁₀(p) [5]

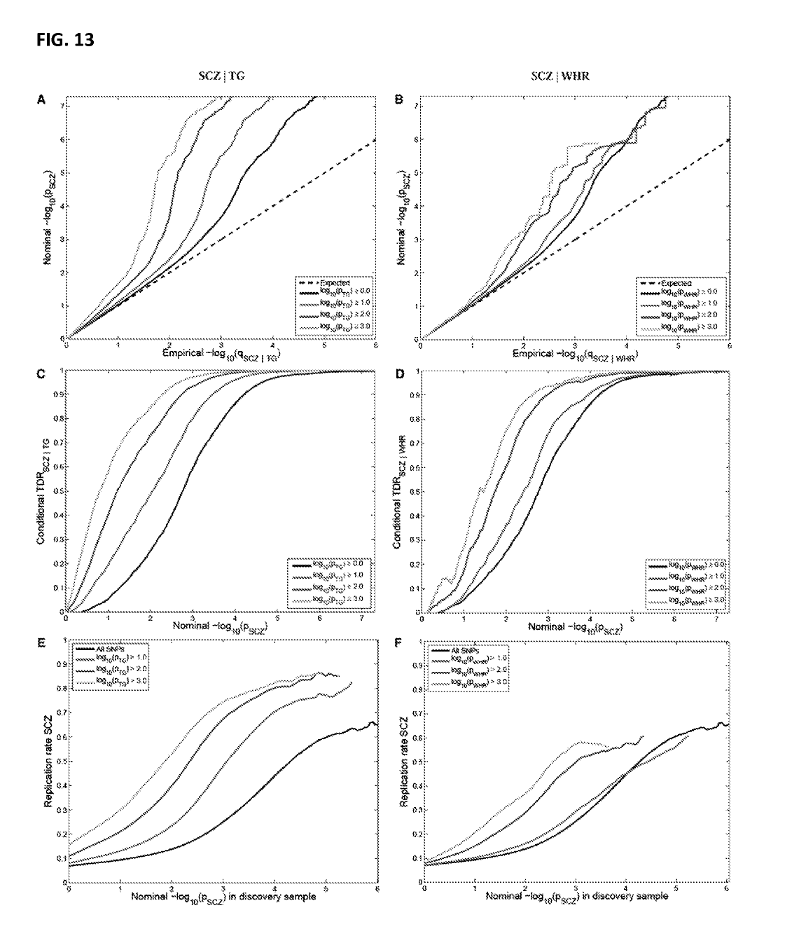

demonstrating that the (conservatively) estimated FDR is directly related to the horizontal shift of the curves in the stratified Q-Q plots from the expected line x=y, with a larger shift corresponding to a smaller FDR, as illustrated in FIG. 13. As before, the estimated TDR can be obtained as 1-FDR. For each range of p-values (stratum) in a pleiotropic trait, the TDR is calculated as a function of p-value in schizophrenia (indicated by different colored curves) in FIG. 13, using each observed p-value as a threshold, according to Eq. [5].

Stratified Replication Rate

For each of the 17 sub-studies contributing to the final meta-analysis in schizophrenia, z-scores were independently adjusted using intergenic inflation control. For 1000 of the possible combinations of eight-study discovery and nine study replication sets, the eight-study combined discovery z-score and eight or nine-study combined replication z-score for each SNP as the average z-score across the eight or nine 1 studies, multiplied by two (the square root of the number of 2 studies). For discovery samples the z-scores were converted to two-tailed p-values, while replication samples were converted to one-tailed p-values preserving the direction of effect in the discovery sample. For each of the 1000 discovery-replication pairs cumulative rates of replication were calculated over 1000 equally-spaced bins spanning the range of negative log 10(p-values) observed in the discovery samples. The cumulative replication rate for any bin was calculated as the proportion of SNPs with a −log 10(discovery p-value) greater than the lower bound of the bin with a replication p-value<0.05. Cumulative replication rates were calculated independently for each of the four pleiotropic enrichment categories as well as intergenic SNPs and all SNPs. For each category, the cumulative replication rate for each bin was averaged across the 1000 discovery-replication pairs and the results are reported in FIG. 13. The vertical intercept is the overall replication rate.

Stratified Replication Effect Sizes

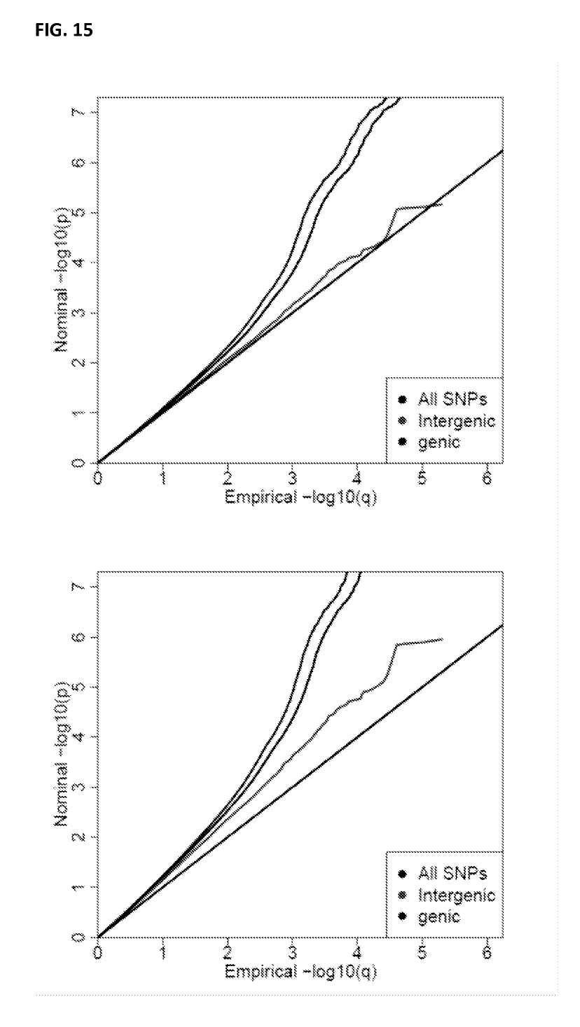

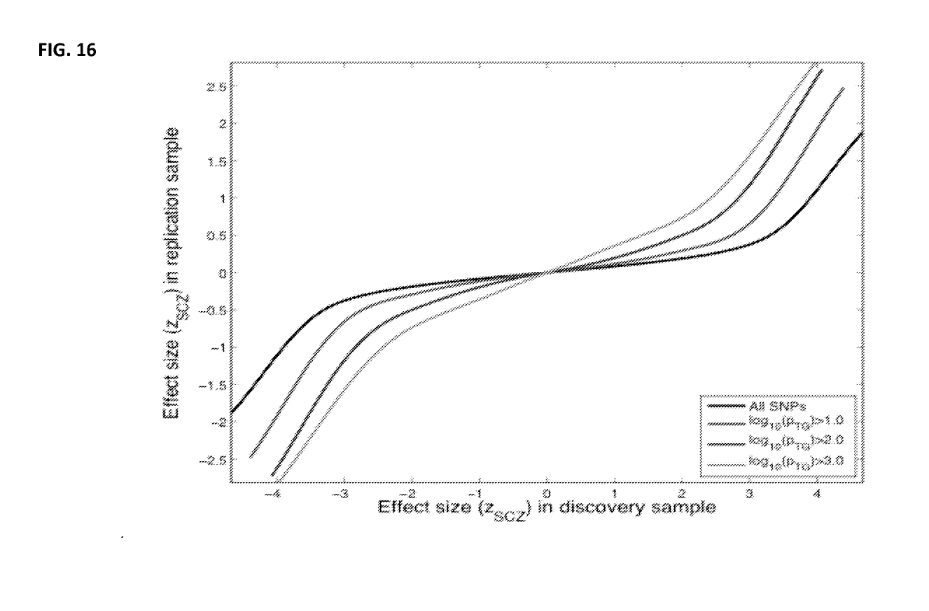

Stratified TDR is directly related to stratified replication effect sizes and hence replication rates. As before, for each of the 17 sub-studies contributing to the final meta-analysis in schizophrenia z-scores were independently adjusted using intergenic inflation control. For 1000 of the possible combinations of eight-study discovery and nine study replication sets, the eight-study combined discovery z-score and eight or nine-study combined replication z-score were calculated for each SNP. The effect sizes were stratified by levels of log 10(p-values) from the triglycerides GWAS. For visualization, a cubic smoothing spline was fit relating the discovery z-score bin midpoints to the corresponding average replication z-scores (see FIG. 16). The nonlinear pattern of shrinkage is typical of that observed in mixture models as in Eq. 1. Importantly, the amount of shrinkage is highly dependent on enrichment stratum: replication effects sizes in more enriched strata exhibit more fidelity with discovery sample effect sizes. This directly relates to increased TDR and translates into increased replication rates for enriched strata.

Conditional Statistics—Test of Association with Schizophrenia

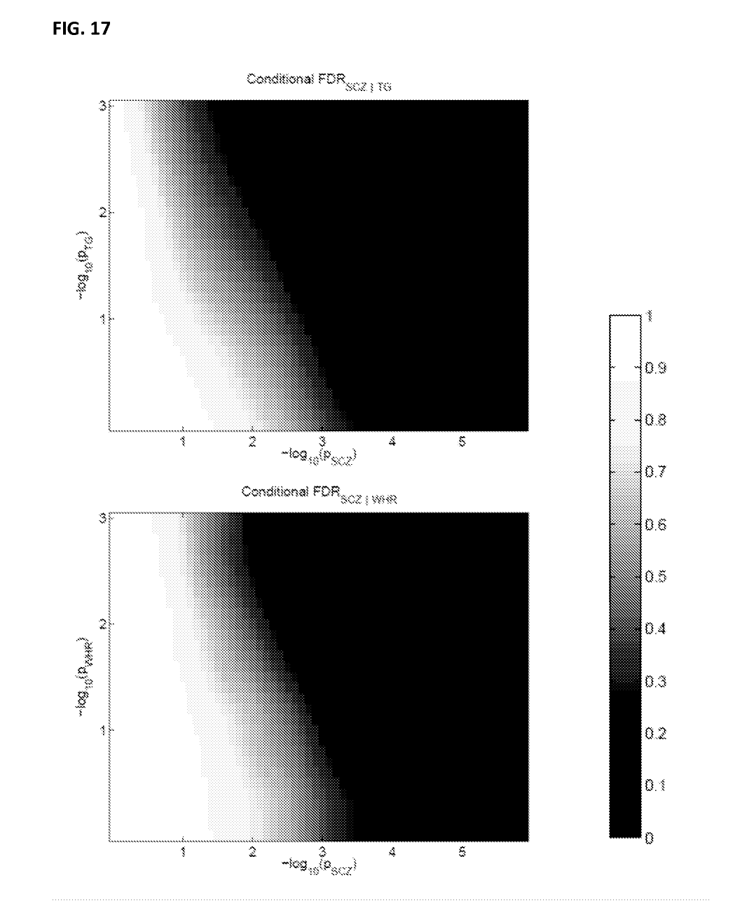

To improve detection of SNPs associated with schizophrenia, a stratified FDR approach was used, leveraging pleiotropic phenotypes using established stratified FDR methods34; 35. Specifically, SNPs were stratified based on p-values in the pleiotropic phenotype (e.g. Triglycerides; TG). A conditional FDR value (denoted as FDR SCZ|TG) for schizophrenia (SCZ) was assigned to each SNP, based on the combination of p-value for the SNP in schizophrenia and the pleiotropic trait, by interpolation into a 2-D look-up table (FIG. 17). All SNPs with FDR<0.01 (−log 10(FDR)>2) in schizophrenia given the different CVD risk factors are listed in Table 23 after “pruning” (removing all SNPs with r2 10>0.2 based on 1KGP linkage disequilibrium (LD) structure). A significance threshold of FDR<0.01 corresponds to 1 false positive per 100 reported associations. All SNPs with FDR<0.05 (−log 10(FDR)>1.3) are listed in Table 26.

Conditional Manhattan Plots

To illustrate the localization of the genetic markers associated with schizophrenia given the CVD risk factor effect, a “Conditional Manhattan plot” was used, plotting all SNPs within an LD block in relation to their chromosomal location. As illustrated in FIG. 14, the large points represent the SNPs with FDR<0.05, whereas the small points represent the non-significant SNPs. All SNPs without “pruning” (removing all SNPs with r2>0.2 based on 1KGP LD structure) are shown. The strongest signal in each LD block is illustrated with a black line around the circles. This was identified by ranking all SNPs in increasing order, based on the conditional FDR value for schizophrenia, and then removing SNPs in LD r2>0.2 with any higher ranked SNP. Thus, the selected locus was the most significantly associated with schizophrenia in each LD block (FIG. 14).

Conjunction Statistics 1—Test of Association with Both Phenotypes

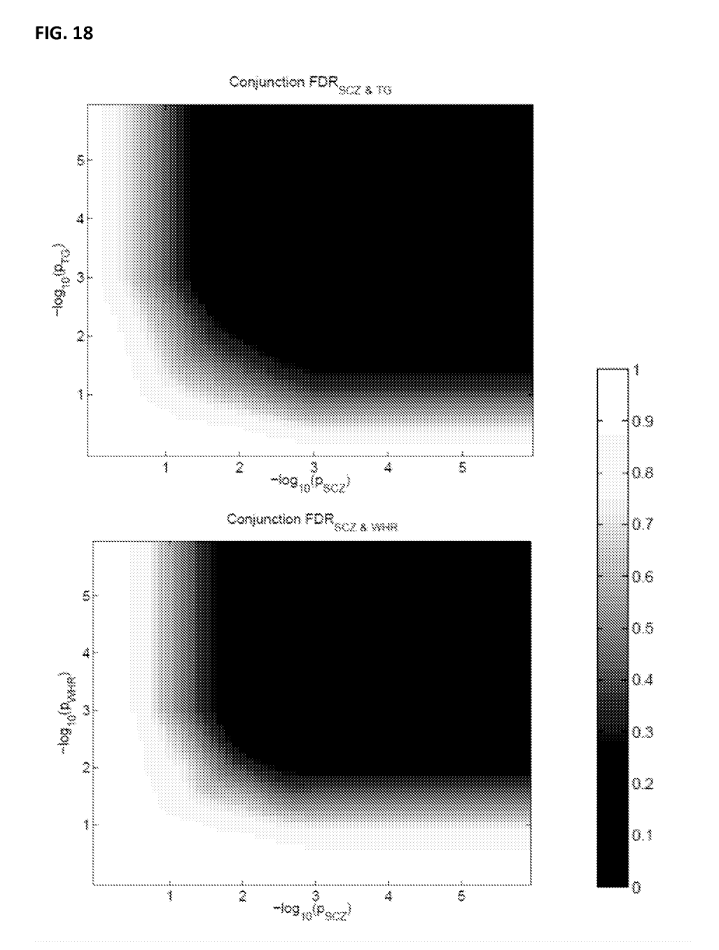

In order to identify which of the SNPs associated with schizophrenia given the CVD risk factor (SCZ|CVD, Table 23) were also associated with CVD risk factors given schizophrenia (opposite direction), the conditional FDR was calculated in the other direction (CVD|SCZ). This is reported in in Table 24. The corresponding z-scores are listed in Table 27. The z-scores were calculated from the p-values and the direction of effect was determined by the risk allele. In addition, to make a comprehensive, unselected map of pleiotropic signals, a conjunction testing procedure was used, as outlined for p-value statistics in Nichols et al.42 and adapted this method for FDR statistics based on the conditional FDR approach34; 35. The conjunction statistics (denoted as FDR SCZ & TG) were defined as the max of the conditional FDR in both directions, i.e. FDR SCZ & TG=max(FDR SCZ|TG, FDR TG|SCZ) based on the combination of p-value for the SNP in schizophrenia and the pleiotropic trait, by interpolation into a bidirectional 2-D look-up table (FIG. 18). The conjunction statistic allows for identification of SNPs that are associated with both phenotypes, which minimizes the effect of a single phenotype driving the common association signal. All SNPs with conjunction FDR<0.05 (−log 10(FDR)>1.3) with schizophrenia and any of the CVD risk factors considered are listed in Table 28 (after pruning).

Conjunction Manhattan Plots

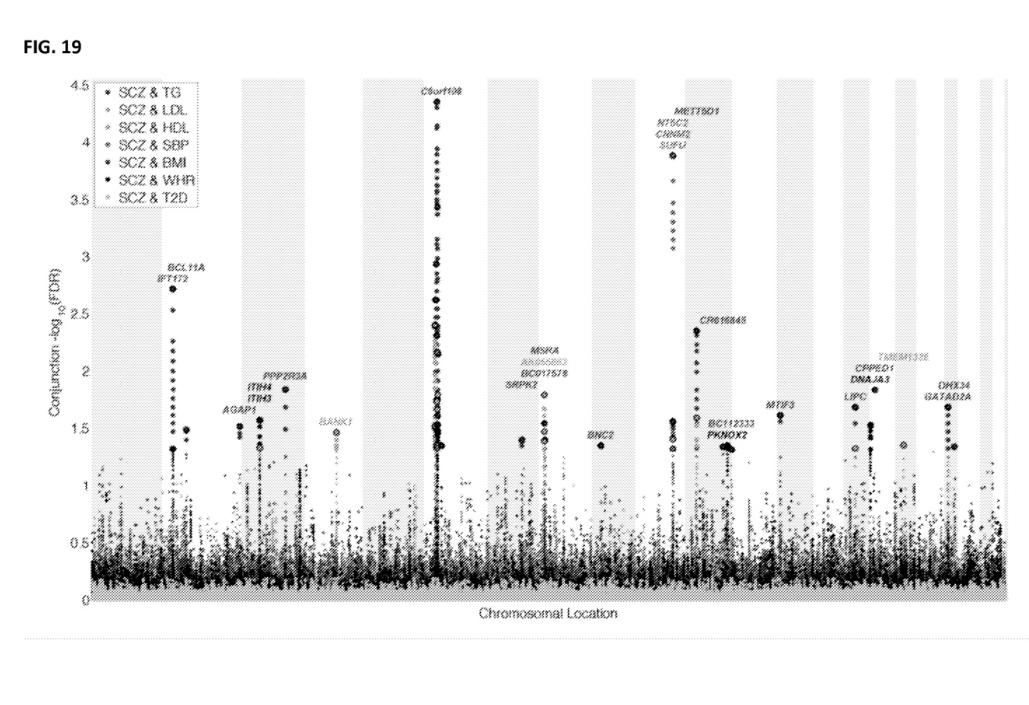

To illustrate the localization of the pleiotropic genetic markers association with both schizophrenia and CVD risk factors, a “Conjunction Manhattan plot” was used, plotting all SNPs with a significant conjunction FDR within an LD block in relation to their chromosomal location. As illustrated in FIG. 19, the large points represent the significant SNPs (FDR<0.05), whereas the small points represent the non-significant SNPs. All SNPs without “pruning” (removing all SNPs with r2>0.2 based on 1KGP LD structure are shown, and the stron 1 gest signal in each LD block is illustrated with a black line around the circles. First, all SNPs were ranked based on the conjunction FDR and removed SNPs in LD r2 3>0.2 with any higher ranked SNP (FIG. 19).

Results

Q-Q Plots of Schizophrenia SNPs Stratified by Association with Pleiotropic CVD Risk Factors

Stratified Q-Q plots for schizophrenia conditioned on nominal p-values of association with triglycerides (TG) showed enrichment across different levels of significance for TG (FIG. 13A). The earlier departure from the null line (leftward shift) indicates a greater proportion of true associations for a given nominal schizophrenia p-value. Successive leftward shifts for decreasing nominal TG p-values indicate that the proportion of non-null effects varies considerably across different levels of association with CVD risk factors. For example, the proportion of SNPs in the −log 10(pTG)≧3 category reaching a given significance level (e.g., −log 10(pSCZ)>6) is roughly 100 times greater than for −log 10(pTG)≧0 category (all SNPs), indicating a very high level of enrichment. Similarly, a clear pleiotropic enrichment was also seen for HDL and LDL. A less clear pleiotropic enrichment was seen for WHR (FIG. 13B), BMI and SBP, but there was no evidence for enrichment in T2D.

Conditional True Discovery Rate (TDR) in Schizophrenia is Increased by CVD Risk Factors

Since categories of SNPs with stronger pleiotropic enrichment are more likely to be associated with schizophrenia, to maximize power for discovery, all tag SNPs should not be treated exchangeably. Specifically, variation in enrichment across pleiotropic categories is expected to be associated with corresponding variation in the TDR (equivalent to 1-FDR)40 for association of SNPs with schizophrenia. A conservative estimate of the TDR for each nominal p-value is equivalent to 1−(p/q), obtained from the stratified Q-Q plots. This relationship is shown for schizophrenia conditioned on TG (FIG. 13C) and WHR (FIG. 13D). For a given conditional TDR the corresponding estimated nominal p-value threshold varies by a factor of 100 from the most to the least enriched SNP category (strata) for schizophrenia conditioned by TG (SCZ|TG), and approximately a factor of 40 for the schizophrenia conditioned on WHR (SCZ|WHR). Phenotypes with weaker pleiotropy with schizophrenia showed sm 1 aller increases in conditional TDR. Since TDR is strongly related to predicted replication rate, it is expected that the replication rate will increase for a given nominal p-value for SNPs in categories with higher conditional TDR.

Replication Rate in Schizophrenia is Increased by Pleiotropic CVD Risk Factors

To demonstrate that the observed pattern of differential enrichment does not result from spurious (e.g., non-generalizable) associations due to category-specific stratification or errors in statistical modeling, the empirical replication rate across independent sub-studies for schizophrenia was studied. FIGS. 13E and 13F show the empirical cumulative replication rate plots as a function of nominal p-value, for the same categories as for the conditional stratified TDR plots in FIGS. 13C and 13D. Consistent with the conditional TDR pattern, it was found that the nominal p-value corresponding to a wide range of replication rates was 100 times higher for −log 10(pTG)≧3 relative to the −log 10(pTG)≧0 category (FIG. 13E). Similarly, SNPs from pleiotropic SNP categories showing the greatest enrichments (−log 10(pTG)≧3) replicated at highest rates, up to five times higher than all SNPs (−log 10(pTG)≧0), for a wide range of p value thresholds. This indicates that adjusting p-value thresholds according to the estimated category specific conditional TDR improves the discovery of replicating SNP associations. The same relationship between conditional TDR and replication rate was shown for SCZ|WHR (FIG. 13F), but here the increase in enrichment and thus increase in replication rate was weaker than for SCZ|TG.

Schizophrenia Gene Loci Identified with Conditional FDR

To identify SNPs associated with schizophrenia, a “conditional” Manhattan plot was constructed for schizophrenia showing the FDR conditional on each of the CVD risk factors (FIG. 14). Significant loci located on a total of 21 chromosomes (1-19 and 21-22) associated with schizophrenia were identified by leveraging the reduced FDR obtained by the associated CVD risk factor. To estimate the number of independent loci, the associated SNPs were pruned (removed SNP with LD>0.2), and a total of 106 independent loci with a significance threshold of conditional FDR<0.05 were identified (Table 26). Using the more conservative conditional FDR threshold of 0.01, 25 independent loci remained significant, of which 4 were complex loci and 21 single gene loci (Table 23 and black line around large circles in FIG. 14). The largest locus was on chromosome 6 in the HLA region. This is the only locus that would have been discovered using standard methods based on p-values (Bonferroni correction), and the 6p21.3 region (close to TRIM26) was significantly associated with schizophrenia in the primary analysis of the current sample13. Using the FDR method in schizophrenia alone, 6 loci were identified. Of these, the regions close to TRIM26 (6p21.3), MMP16 (8q21.3), CNNM2/NT5C2 (10q24.32), and TCF4 (18q21.1) have been identified in earlier GWAS, but except for 6p21.3, only after including large replication samples 13; 15. The remaining 19 loci would not have been identified in the current sample without using the pleiotropy-informed stratified FDR method. Of interest, the AK094607/MIR137 region (1p21.3) and the CSMD1 region (8p23.2) were identified in the primary analysis of the current schizophrenia sample after including a large replication sample13, and the ITIH4 region (3p21.1) and CACNA1C (12p13.3, locus 81) were identified in the primary analysis after combination with a large bipolar disorder sample12; 13. Thus, the current pleiotropy-informed FDR method validated 9 loci discovered in considerably larger samples, and discovered 16 new loci. Further, several of these new loci are located in regions with borderline significance association with schizophrenia in previous studies: AGAP1 (2q37)13, PTPRG (3p21)13, MAD1L1 region (7p22)43, STT3A region (11q23.3)13, and PLCB2 region (15q5)13.

Pleiotropic Gene Loci in Schizophrenia and CVD Risk Factors Identified with Conjunction FDR

As a secondary analysis, it was investigated if any of the SNPs associated with schizophrenia conditioned on CVD (SCZ|CVD) were also significantly associated with CVD risk factors conditioned on SCZ (CVD|SCZ), i.e. the 1 conditional FDR in the opposite direction. 10 independent loci (pruned based on LD>0.2) were identified with a significant association also with the CVD risk factor (conditional FDR<0.05), including 3 complex loci, and 7 single gene loci. Of these, the ITIH4 region (3p21.1), and the CNNM2/NT5C2 region (10q24.32), in addition to the HLA region (chr. 6) have been identified in previous schizophrenia studies after including large replication samples 13. The significant loci were found in the TG|SCZ (6 loci), LDL|SCZ (3 loci), HDL|SCZ (4 loci), SBP|SCZ (2 loci), BMI|SCZ (1 locus) and WHR|SCZ (4 loci), and 6 loci were jointly associated with schizophrenia and more than one CVD risk factor (Table 24). This indicates that overlapping genetic pathways are involved in schizophrenia and CVD risk factors. The direction of the different SNP associations (z-scores) is shown in Table 27. There was no clear evidence for systematic directions across all the SNPs in the different phenotypes, probably due to complex LD structures, especially on chromosome 6.

Further, to provide a comprehensive, unselected map of pleiotropic loci between schizophrenia and CVD risk factors in addition to those primarily associated with schizophrenia a conjunction FDR analysis was performed and a “conjunction” Manhattan plot was constructed. 26 independent pleiotropic loci were identified (pruned based on LD>0.2, black line around large circles) with a significance threshold of conjunctional FDR<0.05, located on a total of 14 chromosomes. See Table 28 for more details.

TABLE 23

| locus | SNP | Gene region | Chr | SCZ p | SCZ FDR | Min condFDR | CVD |
|---|---|---|---|---|---|---|---|
| 4 | rs1625579 | AK094607T | 1p21.3 | 5.52E−06 | 0.02105 | 0.00420 | TG |
| 9 | rs2272417 | IFT172 | 2p23.3 | 4.47E−05 | 0.07516 | 0.00193 | TG |
| 17 | rs17180327 | CWC22 | 2q31.3 | 6.37E−06 | 0.02332 | 0.00780 | HDL |
| 20 | rs13025591 | AGAP1 | 2q37 | 9.26E−06 | 0.02953 | 0.00131 | TG |
| 22 | rs2239547 | ITIH4T | 3p21.1 | 1.73E−05 | 0.03920 | 0.00400 | HDL |
| 23 | rs11715438 | PTPRG | 3p21-p14 | 2.47E−06 | 0.01601 | 0.00222 | HDL |
| 25 | rs9838229 | DKFZp434A128 | 3q27.2 | 1.11E−05 | 0.02953 | 0.00825 | HDL |
| 37 | rs2021722 | TRIM26T | 6p21.3 | 2.08E−09 | 0.00046 | 0.00001 | TG |
| | rs17693963 | BC035101 | 6p22.1 | 6.06E−09 | 0.00128 | 0.00001 | TG |
| | rs2232423 | ZSCAN12 | 6p21 | 4.99E−08 | 0.00328 | 0.00004 | TG |
| | rs3118357 | AK291391 | 6p22.1 | 1.93E−07 | 0.00462 | 0.00006 | TG |
| | rs3857546 | HIST1H1E | 6p21.3 | 3.87E−08 | 0.00309 | 0.00006 | HDL |
| | rs7746199 | POM121L2 | 6p22.1 | 1.18E−08 | 0.00197 | 0.00005 | WHR |
| | rs9468413 | AK056211 | 6p22.1 | 2.68E−08 | 0.00267 | 0.00007 | TG |
| | rs853685 | ZNF323 | 6p22.1 | 5.54E−08 | 0.00328 | 0.00008 | HDL |
| | rs6921919 | ZKSCAN3 | 6p22.1 | 7.79E−07 | 0.00919 | 0.00011 | TG |
| | rs9295740 | BC035101 | 6p22.1 | 1.22E−06 | 0.01185 | 0.00017 | TG |
| | rs13198716 | BC033330 | 6p22.2 | 7.34E−07 | 0.00919 | 0.00021 | TG |
| | rs2596565 | MICA | 6p21.33 | 2.72E−06 | 0.01601 | 0.00024 | TG |
| | rs9276601 | HLA-DQB2 | 6p21 | 2.36E−06 | 0.01601 | 0.00024 | TG |
| | rs1270942 | CFB | 6p21.3 | 4.94E−06 | 0.02105 | 0.00037 | TG |
| | rs2328893 | SLC17A4 | 6p22.2 | 5.11E−06 | 0.02105 | 0.00051 | TG |
| | rs9272105 | HLA-DQA1 | 6p21.3 | 2.33E−07 | 0.00504 | 0.00076 | HDL |
| | rs9268862 | HLA-DRA | 6p21.3 | 1.32E−06 | 0.01185 | 0.00085 | WHR |
| | rs9379780 | SCGN | 6p22.2 | 3.25E−06 | 0.01746 | 0.00096 | HDL |
| | rs1339896 | ZSCAN23 | 6p22.1 | 4.38E−07 | 0.00625 | 0.00097 | HDL |
| | rs853683 | ZNF323 | 6p22.1 | 1.71E−06 | 0.01325 | 0.00168 | HDL |
| | rs2071303 | HFE | 6p21.3 | 5.79E−06 | 0.02332 | 0.00214 | HDL |
| | rs198856 | HIST1H4C | 6p22.1 | 5.64E−06 | 0.02332 | 0.00234 | TG |
| | rs198821 | HIST1H2BC | 6p22.1 | 6.36E−06 | 0.02332 | 0.00234 | TG |
| | rs3094127 | FLOT1 | 6p21.3 | 6.66E−05 | 0.10338 | 0.00294 | TG |
| | rs3129890 | HLA-DPA | 6p21.3 | 1.89E−06 | 0.01464 | 0.00357 | TG |
| | rs2207338 | OR2J2 | 6p22.1 | 3.28E−05 | 0.06382 | 0.00387 | TG |
| | rs707938 | MSHS | 6p21.3 | 1.95E−05 | 0.04590 | 0.00392 | HDL |
| | rs1265099 | PSOR51C1 | 6p21.3 | 2.30E−05 | 0.05408 | 0.00420 | HDL |
| | rs198828 | HIST1H2BC | 6p22.1 | 5.49E−06 | 0.02105 | 0.00420 | TG |
| | rs7752195 | LRRC16A | 5p22.2 | 2.74E−05 | 0.05403 | 0.00589 | HDL |
| | rs3130827 | OR14J1 | 6p22.1 | 2.31E−05 | 0.05403 | 0.00639 | TG |
| | rs6923811 | FK5G83 | 6p22.1 | 7.51E−06 | 0.02609 | 0.00652 | HDL |
| | rs2516049 | HLA-DRB5 | 6p21.3 | 4.96E−05 | 0.08828 | 0.00710 | HDL |
| | rs2284178 | HCP5 | 6p21.3 | 2.03E−04 | 0.20629 | 0.00870 | TG |
| | rs9268853 | HLA-DRA | 6p21.3 | 5.25E−05 | 0.08828 | 0.00956 | HDL |
| 38 | rs7383287 | HLA-DOB | 6p21.3 | 3.44E−05 | 0.06382 | 0.00740 | HDL |
| 39 | rs1480380 | HLA-DMA | 6p21.3 | 3.05E−06 | 0.01746 | 0.00028 | TG |
| 40 | rs9462875 | CUL9 | 6p21.1 | 1.20E−05 | 0.03383 | 0.00739 | WHR |
| 42 | rs1107592 | MAD1L1 | 7p22 | 7.63E−07 | 0.00919 | 0.00493 | HDL |
| 48 | rs10503253 | CSMD1T | 8p23.2 | 3.96E−06 | 0.01912 | 0.00432 | TG |
| 51 | rs12234997 | AK055863 | 8p23.1 | 2.23E−05 | 0.04590 | 0.00347 | TG |
| 55 | rs755223 | BC037345 | 8q12.3 | 6.91E−05 | 0.10338 | 0.00895 | HDL |
| 56 | rs7004633 | MMP16T | 8q21.3 | 2.60E−07 | 0.00504 | 0.00141 | HDL |
| 65 | rs11191580 | NT5C2T | 10q24.32 | 3.73E−07 | 0.00625 | 0.00013 | SBP |
| | rs7914558 | CNNM2T | 10q24.32 | 1.90E−06 | 0.01464 | 0.00101 | HDL |
| | rs2296569 | CNNM2 | 10q24.32 | 3.78E−06 | 0.01912 | 0.00127 | TG |
| | rs10748835 | AS3MT | 10q24.32 | 2.21E−06 | 0.01464 | 0.00274 | HDL |
| 67 | rs11191732 | NEURL | 10q25.1 | 2.55E−06 | 0.01601 | 0.00160 | HDL |
| 71 | rs2172225 | METTSD1 | 11p14.1 | 4.88E−05 | 0.08828 | 0.00238 | TG |
| | rs7938219 | CR618717 | 11p14.1 | 3.75E−05 | 0.07516 | 0.00331 | TG |
| 78 | rs548181 | STT3A | 11q23.3 | 4.65E−07 | 0.00707 | 0.00044 | WHR |
| | rs11220082 | FEZ1 | 11q24.2 | 2.84E−06 | 0.01746 | 0.00279 | TG |
| | rs671789 | PKNOX2 | 11q24.2 | 1.46E−05 | 0.03920 | 0.00695 | WHR |
| 80 | rs7972947 | CACNA1CT | 12p13.2 | 7.12E−06 | 0.02609 | 0.00415 | TG |
| 81 | rs4765905 | CACNA1CT | 12p13.3 | 7.99E−06 | 0.02609 | 0.00758 | TG |
| 84 | rs8003074 | KIAA0391 | 14q13.2 | 7.23E−06 | 0.02609 | 0.00484 | HDL |
| | rs10135277 | KIAA0391 | 14q13.1 | 5.02E−06 | 0.02105 | 0.00491 | TG |
| 87 | rs1869901 | PLCB2 | 15q15 | 3.66E−06 | 0.01912 | 0.00203 | TG |
| 101 | rs17597926 | TCF4T | 18q21.1 | 6.49E−07 | 0.00805 | 0.00216 | TG |

TABLE 24

| locus | SNP | Gene | chr | TG\|SCZ | LDL\|SCZ | HDL\|SCZ | SBP\|SCZ | BMI\|SCZ | WHR\|SCZ | T2D\|SCZ |
|---|---|---|---|---|---|---|---|---|---|---|
| 9 | rs780110 | IFT172 | 2p23.3 | 0.00000 | 0.73578 | 0.66350 | 0.88851 | 0.57686 | 0.01079 | 1.00000 |
| | rs2272417 | IFT172 | 2p23.3 | 0.00000 | 0.86268 | 0.55896 | 0.83749 | 0.70089 | 0.06244 | 1.00000 |
| 20 | rs6759205 | AGAP1 | 2q37 | 0.01764 | 0.89696 | 0.25333 | 1.00000 | 1.00000 | 0.95347 | 1.00000 |
| 22 | rs3617 | ITIH3 | 3p21.1 | 0.69128 | 0.84071 | 0.37022 | 0.97795 | 0.45287 | 0.00942 | 1.00000 |
| | rs2276817 | ITIH4 | 3p21.1 | 0.28255 | 0.04717 | 0.25333 | 0.61208 | 0.45287 | 1.00000 | 1.00000 |
| 37 | rs2328893 | SLC17A4 | 6p22.2 | 0.03788 | 0.34581 | 0.00396 | 0.83749 | 0.65586 | 1.00000 | 1.00000 |
| | rs1324082 | SLC17A1 | 6p22.2 | 0.03113 | 0.63999 | 0.00465 | 0.65717 | 0.78940 | 0.95347 | 1.00000 |
| | rs13198474 | SLC17A3 | 6p22.2 | 0.69128 | 0.73578 | 0.00289 | 0.80634 | 1.00000 | 0.93285 | 1.00000 |
| | rs16891235 | HIST2H1A | 6p22.2 | 0.95191 | 0.02569 | 0.00213 | 0.70268 | 1.00000 | 0.93285 | 1.00000 |
| | rs13194781 | HIST1H2BN | 6p22.2 | 0.00239 | 0.97314 | 0.14244 | 0.88851 | 1.00000 | 0.93285 | 1.00000 |
| | rs1235162 | GABBR1 | 6p22.1 | 0.00117 | 0.73578 | 0.10885 | 0.70268 | 0.82974 | 1.00000 | 1.00000 |
| | rs2844762 | HLA-B | 6p22.1 | 0.00491 | 0.53895 | 0.78537 | 0.61208 | NaN | 0.93285 | 1.00000 |
| | rs3130380 | HCG18 | 6p22.1 | 0.00708 | 0.73578 | 0.01852 | 0.77857 | 0.70039 | 0.81643 | 1.00000 |
| | rs2524222 | GNL1 | 6p22.1 | 0.28255 | 0.02945 | 0.41447 | 0.80634 | 1.00000 | 0.93285 | 1.00000 |
| | rs9262143 | KIAA1949 | 6p22.1 | 0.00004 | 0.26238 | 0.05759 | 0.77857 | 0.92201 | 0.52829 | 1.00000 |
| | rs3095326 | IER3 | 6p22.1 | 0.00003 | 0.04717 | 0.04502 | 0.74450 | 0.92201 | 0.42354 | 1.00000 |
| | rs3099840 | HCP5 | 6p21.3 | 0.00000 | 0.39032 | 0.02988 | 0.28698 | 1.00000 | 0.37454 | 1.00000 |
| | rs2284178 | HCP5 | 6p21.3 | 0.01764 | 0.48709 | 0.25333 | 0.18351 | 0.74603 | 0.87368 | 1.00000 |
| | r5805294 | LY666C | 6p21.33 | 1.00000 | 0.97314 | 0.12393 | 0.00248 | 0.61339 | 0.75370 | 1.00000 |
| | rs3117577 | MSH5 | 6p21.3 | 0.00000 | 0.02164 | 0.41447 | 0.61208 | 0.87106 | 0.42354 | 1.00000 |
| | rs3130679 | C6orf43 | 6p21.33 | 0.00000 | 0.07243 | 0.14244 | 0.41364 | 0.70039 | 0.13758 | 1.00000 |
| | rs412657 | AK123889 | 6p21.33 | 0.69128 | 0.97314 | 0.03447 | 0.65717 | 0.65586 | 0.37454 | 1.00000 |
| | rs9268219 | C6orf10 | 6p21.33 | 0.00000 | 0.04220 | 0.12393 | 0.38400 | 0.65586 | 0.03366 | 1.00000 |
| | rs3129963 | BTNL2 | 6p21.33 | 0.59071 | 0.77938 | 0.00548 | 0.52604 | 0.92201 | 0.04119 | 1.00000 |
| | rs9268853 | HLA-DRA | 6p21.3 | 0.69128 | 0.81421 | 0.03447 | 0.41364 | 0.61339 | 0.02983 | 1.00000 |
| | rs9275524 | HLA-DQA2 | 6p21.32 | 0.00409 | 0.03128 | 0.00548 | 0.33310 | 0.27214 | 0.05832 | 1.00000 |
| 39 | rs1480380 | HLA-DMA | 6p21.3 | 0.00708 | 0.86268 | 0.41447 | 0.18351 | 0.78940 | 0.10401 | NaN |
| 40 | rs7832 | C6orf108 | 6p21.2 | 0.03399 | 0.97057 | 0.10762 | NaN | NaN | NaN | NaN |
| 51 | rs983309 | AK055863 | 8p23.1 | 0.48760 | 0.00000 | 0.00000 | 0.80634 | 0.78940 | 0.47533 | 1.00000 |
| | rs17660635 | AK055863 | 8p23.1 | 0.69128 | 0.00080 | 0.00010 | 0.74450 | 0.92201 | 0.81643 | 1.00000 |
| 65 | rs4919666 | SUFU | 10q24.32 | 0.85168 | 0.86268 | 0.78537 | 0.04405 | 0.40025 | 0.87368 | 1.00000 |
| | rs2296569 | CNNM2 | 10q24.32 | 0.15574 | 0.59079 | 0.03950 | 1.00000 | 1.00000 | 1.00000 | 1.00000 |
| | rs11191560 | NT5C2 | 10p24.32 | 0.69128 | 0.97314 | 0.72193 | 0.00000 | 0.02776 | 0.47533 | 1.00000 |
| | rs11191580 | NT5C2 | 10q24.32 | 0.78905 | 1.00000 | 0.61021 | 0.00000 | 0.02897 | 0.52829 | 1.00000 |
| 71 | rs2958625 | METT5D1 | 11p14.1 | 0.00491 | 0.89696 | 0.02569 | 0.88851 | 0.52128 | 0.52829 | 1.00000 |
| | rs10835491 | METT5D1 | 11p14.1 | 0.00409 | 0.89696 | 0.03950 | 0.88851 | 0.52128 | 0.52829 | 1.00000 |
| | rs10790734 | PKNOX2 | 11q24.2 | 0.37774 | 0.89696 | 1.00000 | 0.80634 | 0.65586 | 0.04476 | 1.00000 |

TABLE 25

| Disease/Trait | N | # SNPs | Reference |
|---|---|---|---|
| Schizophrenia | 21,856 | 1,171,056 | Psychiatric GWAS Consortium Schizophrenia Group. |
| | | | Ripke S, Sanders AR, Kendler KS, et al. Genome-wide |
| | | | association study identifies five new schizophrenia loci. Nat |
| | | | Genet 2011; 43: 969-76. |
| Body Mass Index | 123,865 | 2,400,377 | Speliotes EK, Willer CJ, Berndt SI, et al. Association |
| (BMI) | | | analyses of 249,796 individuals reveal 18 new loci |
| | | | associated with body mass index. Nat Genet 2010; 42: |
| | | | 937-48. |
| Waist to hip ratio | 77,167 | 2,376,820 | Heid IM, Jackson AU, Randall JC, et al. Meta-analysis |
| (WHR) | | | identifies 13 new loci associated with waist-hip ratio and |
| | | | reveals sexual dimorphism in the genetic basis of fat |
| | | | distribution. Nat Genet 2010; 42: 949-60. |
| Type 2 Diabetes | 22,044 | 2,426,886 | Voight BF, Scott LJ, Steinthorsdottir V, et al. Twelve type |
| (T2D) | | | 2 diabetes susceptibility loci identified through large-scale |
| | | | association analysis. Nat Genet 2010; 42: 579-89. |
| Systolic Blood Pressure | 203,056 | 2,382,073 | Ehret GB, Munroe PB, Rice KM, et al. Generic variants in |
| (SBP) | | | novel pathways influence blood pressure and |
| | | | cardiovascular disease risk. Nature 2011; 478: 103-9. |
| Diastolic Blood Pressure | 203,056 | 2,382,073 | |
| (DBP) | | | |
| Low density lipoprotein | 100,184 | 2,508,369 | Teslovich TM, Musunuru K, Smith AV, et al. Biological, |
| Cholesterol (LDL) | | | clinical and population relevance of 95 loci for blood lipids. |
| | | | Nature 2010; 466: 707-13. |
| High density lipoprotein | 100,184 | 2,508,369 | |
| Cholesterol (HDL) | | | |
| Triglycerides (TG) | 96,568 | 2,508,369 | |

TABLE 26

| lo- | | | | | FDR | | | | | | | | min |
|---|---|---|---|---|---|---|---|---|---|---|---|---|---|
| cus | SNP | geneid | ch | pval SCZ | SCZ | SCZ\|TG | SCZ\|LDL | SCZ\|HDL | SCZ\|SBP | SCZ\|BMI | SCZ\|WHR | SCZ\|T2D | cFDR |
| 1 | rs10779702 | RERE | 1 | 4.12E−05 | 0.0752 | 0.0339 | 0.0402 | 0.0194 | 0.0492 | 0.0693 | 0.0552 | 0.0710 | 0.0194 |
| | rs172531 | RERE | 1 | 4.49E−05 | 0.0883 | 0.0408 | 0.0328 | 0.0485 | 0.0568 | 0.0621 | 0.0824 | 0.0976 | 0.0328 |
| | rs6694545 | BC042538 | 1 | 8.28E−05 | 0.1204 | 0.1204 | 0.1198 | 0.1214 | 0.0391 | 0.1209 | 0.1156 | 0.1334 | 0.0391 |
| 3 | rs5174 | LBP8 | 1 | 1.59E−04 | 0.1822 | 0.1487 | 0.1486 | 0.0672 | 0.1274 | 0.1420 | 0.0343 | 0.1724 | 0.0343 |
| 4 | rs1625579 | AK094607 | 1 | 5.52E−06 | 0.0210 | 0.0042 | 0.0203 | 0.0170 | 0.0177 | 0.0152 | 0.0227 | 0.0376 | 0.0042 |
| | rs1198588 | AK094607 | 1 | 5.64E−06 | 0.0233 | 0.0077 | 0.0194 | 0.0190 | 0.0193 | 0.0176 | 0.0269 | 0.0463 | 0.0077 |
| 5 | rs7540658 | NPL | 1 | 8.20E−05 | 0.1204 | 0.0222 | 0.1109 | 0.1214 | 0.0734 | 0.1097 | 0.0921 | 0.1132 | 0.0222 |
| 6 | rs2057233 | GALNT2 | 1 | 4.38E−04 | 0.2836 | 0.0493 | 0.2705 | 0.0633 | 0.2627 | 0.2860 | 0.2816 | 0.2898 | 0.0493 |
| 7 | rs2171975 | SDCCAG8 | 1 | 2.87E−05 | 0.0638 | 0.0244 | 0.0558 | 0.0336 | NaN | NaN | NaN | NaN | 0.0244 |
| | rs3818802 | SDCCAG8 | 1 | 2.67E−05 | 0.0541 | 0.0203 | 0.0511 | 0.0390 | 0.0372 | 0.0502 | 0.0528 | 0.0532 | 0.0203 |
| | rs10803133 | SDCCAG8 | 1 | 3.33E−05 | 0.0638 | 0.0182 | 0.0604 | 0.0546 | 0.0431 | 0.0590 | 0.0614 | 0.0624 | 0.0182 |
| | rs6703335 | SDCCAG8 | 1 | 2.35E−05 | 0.0541 | 0.0316 | 0.0452 | 0.0280 | 0.0372 | 0.0502 | 0.0286 | 0.0686 | 0.0280 |
| | rs10803143 | SDCCAG8 | 1 | 7.63E−05 | 0.1204 | 0.0446 | 0.0935 | 0.0348 | 0.0628 | 0.0603 | 0.0651 | 0.1334 | 0.0348 |
| | rs11810833 | SDCCAG8 | 1 | 5.33E−05 | 0.0883 | 0.0883 | 0.0782 | 0.0272 | 0.0407 | 0.0767 | 0.0488 | 0.0885 | 0.0272 |
| 8 | rs2165738 | NCOA1 | 2 | 1.50E−04 | 0.1822 | 0.0236 | 0.1486 | 0.0166 | 0.1658 | 0.0446 | 0.1853 | 0.1705 | 0.0166 |
| 9 | rs2272417 | IFT172 | 2 | 4.47E−05 | 0.0752 | 0.0019 | 0.0661 | 0.0258 | 0.0593 | 0.0503 | 0.0105 | 0 0731 | 0.0019 |
| 10 | rs6735749 | HEATR58 | 2 | 1.23E−04 | 0.1599 | 0.0487 | 0.1309 | 0.1275 | 0.1037 | 0.0955 | 0.1671 | 0.1509 | 0.0487 |
| 11 | rs12475492 | FOXN2 | 2 | 3.43E−04 | 0.2574 | 0.0258 | 0.2124 | 0.0285 | 0.2371 | 0.2494 | 0.1832 | 0.2517 | 0.0258 |
| 12 | rs12616792 | FOXN2 | 2 | 2.30E−04 | 0.2316 | 0.0723 | 0.1502 | 0.0261 | 0.1836 | 0.1044 | 0.1333 | 0.2302 | 0.0261 |
| 13 | rs1819972 | NSXN1 | 2 | 7.36E−05 | 0.1204 | 0.0668 | 0.1152 | 0.0348 | 0.0784 | 0.0375 | 0.1156 | 0.1112 | 0.0348 |
| 14 | rs11682175 | VRK2 | 2 | 2.82E−05 | 0.0638 | 0.0377 | 0.0490 | 0.0396 | 0.0431 | 0.0257 | 0.0671 | 0.1057 | 0.0257 |
| | rs2312147 | VRK2 | 2 | 7.00E−05 | 0.1034 | 0.0728 | 0.0808 | 0.1040 | 0.0291 | 0.0534 | 0.1013 | 0.1062 | 0.0291 |
| 15 | rs13415835 | BCL11A | 2 | 1.11E−03 | 0.4059 | 0.0327 | 0.3379 | 0.2759 | 0.3909 | 0.3549 | 0.3400 | 0.4138 | 0.0327 |
| 16 | rs10211143 | AX746678 | 2 | 1.71E−04 | 0.1822 | 0.0394 | 0.1678 | 0.1851 | 0.1339 | 0.1291 | 0.1651 | 0.1774 | 0.0394 |
| 17 | rs17180327 | CWC22 | 2 | 6.37E−06 | 0.0233 | 0.0172 | 0.0230 | 0.0078 | 0.0185 | 0.0204 | 0.0269 | 0.0221 | 0.0078 |
| 18 | rs17662626 | PCGEM1 | 2 | 2.25E−05 | 0.0541 | 0.0175 | 0.0511 | 0.0151 | 0.0490 | 0.0523 | 0.0571 | 0.0894 | 0.0151 |
| 19 | rs2675968 | C2orf82 | 2 | 1.93E−05 | 0.0459 | 0.0459 | 0.0434 | 0.0200 | 0.0330 | 0.0254 | 0.0521 | 0.0556 | 0.0200 |
| 20 | rs13025591 | A6AP1 | 2 | 9.26E−05 | 0.0295 | 0.0013 | 0.0265 | 0.0021 | 0.0267 | 0.0305 | 0.0337 | 0.0383 | 0.0013 |
| 21 | rs7640056 | AK130758 | 3 | 1.11E−04 | 0.1393 | 0.1008 | 0.1241 | 0.1089 | 0.1256 | 0.0436 | 0.1466 | 0.1500 | 0 0436 |
| 22 | rs3617 | ITIH3 | 3 | 1.85E−04 | 0.2063 | 0.1239 | 0.1772 | 0.0546 | 0.1885 | 0.0881 | 0.0270 | 0.1972 | 0.0270 |
| | rs2239547 | ITIH4 | 3 | 1.73E−05 | 0.0392 | 0.0167 | 0.0158 | 0.0040 | 0.0314 | 0.0202 | 0.0420 | 0.0545 | 0 0040 |
| | rs2276817 | ITIH4 | 3 | 2.44E−05 | 0.0541 | 0.0084 | 0.0172 | 0.0065 | 0.0368 | 0.0235 | 0.0571 | 0.0686 | 0.0065 |
| 23 | rs11130874 | PTPRG | 3 | 2.39E−06 | 0.0160 | 0.0079 | 0.0155 | 0.0031 | 0.0138 | 0.0176 | 0.0178 | 0.0142 | 0.0031 |
| | rs11715438 | PTPRG | 3 | 2.47E−06 | 0.0160 | 0.0079 | 0.0155 | 0.0022 | 0.0138 | 0.0176 | 0.0178 | 0.0142 | 0.0022 |
| | rs191558 | PTPRG | 3 | 3.41E−06 | 0.0175 | 0.0074 | 0.0171 | 0.0029 | 0.0151 | 0.0191 | 0.0193 | 0.0155 | 0.0029 |
| 24 | rs1447595 | PPP2R3A | 3 | 4.42E−04 | 0.2836 | 0.0146 | 0.0723 | 0.2162 | 0.2823 | 0.1882 | 0.1443 | 0.2797 | 0.0146 |
| 25 | rs4894814 | TNIK | 3 | 1.95E−04 | 0.2063 | 0.1691 | 0.1897 | 0.0197 | NaN | NaN | NaN | NaN | 0.0197 |
| 26 | rs9838229 | DKFZo434A | 3 | 1.11E−05 | 0.0295 | 0.0142 | 0.0265 | 0.0089 | 0.0222 | 0.0104 | 0.0083 | 0.0282 | 0.0083 |
| | rs1879248 | DKFZo434A | 3 | 1.07E−05 | 0.0295 | 0.0142 | 0.0264 | 0.0089 | 0.0223 | 0.0104 | 0.0083 | 0.0282 | 0.0083 |
| 27 | rs12485391 | SOX2OT | 3 | 3.76E−05 | 0.0752 | 0.0586 | 0.0629 | 0.0555 | 0.0681 | 0.0205 | 0.0816 | 0.1140 | 0.0205 |
| 28 | rs7437478 | PPP2R2C | 4 | 3.90E−04 | 0.2836 | 0.1821 | 0.2705 | 0.1553 | 0.2627 | 0.2758 | 0.0406 | 0.2684 | 0.0406 |
| 29 | rs7700191 | BANK1 | 4 | 9.57E−05 | 0.1393 | 0.0467 | 0.1172 | 0.1243 | 0.0963 | 0.1339 | 0.1394 | 0.1455 | 0.0467 |
| 30 | rs4295265 | BANK1 | 4 | 6.46E−05 | 0.1034 | 0.0182 | 0.0782 | 0.0219 | 0.0724 | 0.0663 | 0.0738 | 0.1102 | 0.0182 |
| | rs2850378 | BANK1 | 4 | 1.24 E−04 | 0.1599 | 0.0252 | 0.1474 | 0.0164 | 0.0953 | 0.0784 | 0.1375 | 0.1531 | 0.0164 |
| 31 | rs4473780 | LOC729862 | 5 | 6.70E−05 | 0.1034 | 0.0821 | 0.0852 | 0.0435 | NaN | NaN | NaN | NaN | 0.0435 |
| 32 | rs2113092 | SLCO4C1 | 5 | 2.24E−04 | 0.2316 | 0.1031 | 0.1919 | 0.0309 | 0.1656 | 0.2338 | 0.1558 | 0.2191 | 0.0309 |
| 33 | rs2974499 | SPOCK1 | 5 | 2.82E−04 | 0.2574 | 0.1075 | 0.2124 | 0.0285 | 0.2564 | 0.2494 | 0.2580 | 0.2580 | 0.0285 |
| 34 | rs17242471 | CLINT1 | 5 | 4.70E−04 | 0.3096 | 0.0583 | 0.2553 | 0.0455 | 0.2332 | 0.3021 | 0.3056 | 0.3181 | 0.0455 |
| 35 | rs1433019 | NEURL1B | 5 | 2.25E−05 | 0.0541 | 0.0474 | 0.0449 | 0.0460 | 0.0409 | 0.0478 | 0.0571 | 0.0494 | 0.0409 |
| 36 | rs9503247 | MYLK4 | 6 | 2.12E−04 | 0.2063 | 0.1107 | 0.1971 | 0.0323 | NaN | NaN | NaN | NaN | 0.0323 |
| 37 | rs7752195 | LRRC16A | 6 | 2.74E−05 | 0.0541 | 0.0316 | 0.0452 | 0.0059 | 0.0384 | 0.0478 | 0.0609 | 0.0494 | 0.0059 |
| | rs9379760 | SCGN | 6 | 3.25E−06 | 0.0175 | 0.0063 | 0.0173 | 0.0010 | 0.0148 | 0.0191 | 0.0194 | 0.0155 | 0.0010 |
| | rs2328893 | SLC17A4 | 6 | 5.11E−06 | 0.0210 | 0.0005 | 0.0158 | 0.0033 | 0.0177 | 0.0152 | 0.0227 | 0.0321 | 0.0005 |
| | rs2071303 | HFE | 6 | 5.79E−06 | 0.0233 | 0.0023 | 0.0221 | 0.0021 | 0.0033 | 0.0162 | 0.0174 | 0.0283 | 0.0021 |
| | rs198856 | HIST1H4C | 6 | 5.64E−06 | 0.0233 | 0.0023 | 0.0219 | 0.0092 | 0.0148 | 0.0137 | 0.0271 | 0.0221 | 0.0023 |
| 49 | rs565169 | MFHA51 | 8 | 1.80E−04 | 0.2063 | 0.0140 | 0.1897 | 0.1500 | 0.2048 | 0.1204 | 0.2101 | 0.2006 | 0.0140 |
| 50 | rs367543 | BC017578 | 8 | 1.03E−03 | 0.4059 | 0.0288 | 0.3379 | 0.2559 | 0.1833 | 0.1722 | 0.3951 | 0.3926 | 0.0288 |
| 51 | rs983309 | AK055863 | 8 | 1.25E−04 | 0.1599 | 0.0557 | 0.0411 | 0.0163 | 0.1166 | 0.1142 | 0.0923 | 0.1559 | 0.0163 |
| | rs11990096 | AK055863 | 8 | 2.57E−04 | 0.2316 | 0.2316 | 0.2209 | 0.0247 | NaN | NaN | NaN | NaN | 0.0247 |
| | rs12234997 | AK055863 | 8 | 2.23E−05 | 0.0459 | 0.0035 | 0.0385 | 0.0329 | 0.0281 | 0.0287 | 0.0488 | 0.0798 | 0.0035 |
| 52 | rs7837054 | TNKS | 8 | 7.53E−04 | 0.3697 | 0.0472 | 0.3695 | 0.2259 | 0.1477 | 0.2198 | 0.3065 | 0.3846 | 0.0472 |
| 53 | rs7824675 | M5RA | 8 | l.74E−03 | 0.4847 | 0.0400 | 0.4661 | 0.4873 | 0.2887 | 0.2163 | 0.4862 | 0.5142 | 0.0400 |
| 54 | rs13275015 | NRG1 | 8 | 1.09E−04 | 0.1393 | 0.0534 | 0.1241 | 0.0150 | 0.0813 | 0.1007 | 0.1475 | 0.1513 | 0.0150 |
| 55 | rs755223 | BC037345 | 8 | 6.91E−05 | 0.1034 | 0.0242 | 0.0893 | 0.0090 | 0.0680 | 0.0663 | 0.0738 | 0.1222 | 0.0090 |
| | rs1834419 | BC037345 | 8 | 8.27E−05 | 0.1204 | 0.0130 | 0.1041 | 0.0105 | 0.0784 | 0.0705 | 0.0777 | 0.1354 | 0.0105 |
| 56 | rs7004633 | MMP16 | 8 | 2.60E−07 | 0.0050 | 0.0041 | 0.0044 | 0.0014 | 0.0043 | 0.0031 | 0.0063 | 0.0027 | 0.0014 |
| | rs7005110 | MMP16 | 8 | 3.39E−07 | 0.0056 | 0.0037 | 0.0045 | 0.0019 | 0.0047 | 0.0038 | 0.0069 | 0.0042 | 0.0019 |
| 57 | rs10098073 | TSNARE1 | 8 | 3.59E−05 | 0.0752 | 0.0664 | 0.0715 | 0.0648 | 0.0521 | 0.0320 | 0.0787 | 0.0977 | 0.0320 |
| 58 | rs12352353 | AK3 | 9 | 6.20E−06 | 0.0233 | 0.0148 | 0.0230 | 0.0190 | 0.0185 | 0.0247 | 0.0185 | 0.0461 | 0.0148 |
| | rs396861 | AK3 | 9 | 6.89E−05 | 0.0233 | 0.0148 | 0.0230 | 0.0157 | 0.0185 | 0.0247 | 0.0153 | 0.0442 | 0.0148 |
| 59 | rs1330304 | BNC2 | 9 | 1.17E−03 | 0.4440 | 0.0447 | 0.1080 | 0.0963 | 0.1746 | 0.2242 | 0.4210 | 0.4248 | 0.0447 |
| 60 | rs2039368 | TLE1 | 9 | 7.72E−05 | 0.1204 | 0.0338 | 0.1109 | 0.1062 | 0.0933 | 0.1030 | 0.1244 | 0.1183 | 0.0338 |
| 61 | rs41441548 | BC042457 | 10 | 1.98E−05 | 0.0459 | 0.0459 | 0.0388 | 0.0170 | NaN | NaN | NaN | NaN | 0.0170 |
| 62 | rs2199209 | ANK3 | 10 | 8.41E−05 | 0.1204 | 0.1204 | 0.0964 | 0.1062 | 0.0350 | 0.0503 | 0.1288 | 0.1183 | 0.0350 |
| 63 | rs2068043 | ANK3 | 10 | 3.56E−05 | 0.0752 | 0.0515 | 0.0597 | 0.0223 | 0.0509 | 0.0537 | 0.0753 | 0.0843 | 0.0223 |
| | rs1442550 | ANK3 | 10 | 3.32E−05 | 0.0638 | 0.0432 | 0.0520 | 0.0247 | 0.0447 | 0.0463 | 0.0671 | 0.0781 | 0.0247 |
| | rs16915157 | ANK3 | 10 | 3.03E−05 | 0.0638 | 0.0432 | 0.0533 | 0.0247 | 0.0400 | 0.0495 | 0.0671 | 0.0690 | 0.0247 |
| 64 | rs7895695 | RRP12 | 10 | 2.10E−04 | 0.2063 | 0.0473 | 0.1268 | 0.2099 | 0.1885 | 0.1031 | 0.2119 | 0.1972 | 0.0473 |
| 65 | rs11818043 | SUFU | 10 | 2.62E−04 | 0.2316 | 0.1909 | 0.2052 | 0.1935 | 0.0411 | 0.0970 | 0.1992 | 0.2277 | 0.0411 |
| | rs10748835 | AS3MT | 10 | 2.21E−06 | 0.0146 | 0.0070 | 0.0139 | 0.0027 | 0.0132 | 0.0046 | 0.0163 | 0.0224 | 0.0027 |
| | rs7914558 | CNNM2 | 10 | 1.90E−06 | 0.0146 | 0.0122 | 0.0139 | 0.0010 | 0.0133 | 0.0046 | 0.0163 | 0.0229 | 0 0010 |
| | rs2296569 | CNNM2 | 10 | 3.78E−06 | 0.0191 | 0.0013 | 0.0180 | 0.0025 | 0.0184 | 0.0207 | 0.0209 | 0.0219 | 0.0013 |
| | rs17094583 | NT5C2 | 10 | 1.08E−06 | 0.0105 | 0.0029 | 0.0101 | 0.0038 | 0.0003 | 0.0004 | 0.0082 | 0.0105 | 0.0003 |
| | rs11191580 | NT5C2 | 10 | 3.73E−07 | 0.0062 | 0.0034 | 0.0062 | 0.0018 | 0.0001 | 0.0001 | 0.0060 | 0.0061 | 0.0001 |
| 67 | rs6584554 | NEURL | 10 | 1.32E−04 | 0.1599 | 0.1044 | 0.1381 | 0.0199 | 0.1577 | 0.1611 | 0.1671 | 0.1509 | 0.0199 |
| | rs11191732 | NEURL | 10 | 2.55E−06 | 0.0160 | 0.0047 | 0.0155 | 0.0016 | 0.0140 | 0.0174 | 0.0179 | 0.0156 | 0.0016 |
| 68 | rs1025641 | C10orf90 | 10 | 7.51E−06 | 0.0261 | 0.0225 | 0.0242 | 0.0178 | 0.0237 | 0.0260 | 0.0300 | 0.0521 | 0.0178 |
| 69 | rs1339617 | AK124226 | 10 | 6.49E−05 | 0.1034 | 0.0426 | 0.0988 | 0.0904 | 0.0680 | 0.0946 | 0.1073 | 0.0972 | 0.0426 |
| 70 | rs4356203 | PIK3C2A | 11 | 1.50E−05 | 0.0392 | 0.0342 | 0.0336 | 0.0279 | 0.0301 | 0.0155 | 0.0450 | 0.0532 | 0.0155 |
| 71 | rs2172225 | METT5D1 | 11 | 4.88E−05 | 0.0883 | 0.0024 | 0.0842 | 0.0088 | 0.0799 | 0.0446 | 0.0584 | 0.0854 | 0.0024 |
| | rs7938219 | CR618717 | 11 | 3.75E−05 | 0.0752 | 0.0033 | 0.0685 | 0.0064 | 0.0681 | 0.0475 | 0.0504 | 0.0731 | 0.0033 |
| 72 | rs9420 | CTNND1 | 11 | 1.03E−04 | 0.1393 | 0.1254 | 0.1241 | 0.0321 | 0.0963 | 0.0654 | 0.1466 | 0.1292 | 0.0321 |
| 73 | rs545382 | LRP5 | 11 | 5.22E−04 | 0.3096 | 0.0372 | 0.2856 | 0.2149 | 0.3094 | 0.3120 | 0.3092 | 0.3244 | 0.0372 |
| 74 | rs1791936 | FCHSD2 | 11 | 2.83E−04 | 0.2574 | 0.1075 | 0.1829 | 0.0373 | 0.1590 | 0.2192 | 0.1554 | 0.4409 | 0.0373 |
| 75 | rs7124944 | CHORDC1 | 11 | 1.04E−04 | 0.1393 | 0.0896 | 0.1333 | 0.0279 | 0.0902 | 0.1339 | 0.1466 | 0.1292 | 0.0279 |
| 76 | rs2852034 | CNTN5 | 11 | 1.12E−05 | 0.0295 | 0.0222 | 0.0269 | 0.0122 | 0.0251 | 0.0259 | 0.0344 | 0.0299 | 0.0122 |
| | rs2848519 | CNTN5 | 11 | 1.08E−05 | 0.0295 | 0.0222 | 0.0269 | 0.0122 | 0.0267 | 0.0259 | 0.0337 | 0.0320 | 0.0122 |
| | rs2509843 | CNTN5 | 11 | 9.54E−06 | 0.0295 | 0.0192 | 0.0264 | 0.0245 | 0.0225 | 0.0243 | 0.0342 | 0.0423 | 0.0192 |
| 77 | rs949341 | CSR616845 | 11 | 5.92E−04 | 0.3377 | 0.0326 | 0.2901 | 0.1826 | 0.2288 | 0.3146 | 0.3368 | 0.3343 | 0.0326 |
| 78 | rs671789 | PKNOX2 | 11 | 1.46E−05 | 0.0392 | 0.0078 | 0.0372 | 0.0331 | 0.0277 | 0.0384 | 0.0070 | 0.0392 | 0.0070 |
| | rs11220082 | FEZ1 | 11 | 2.84E−06 | 0.0175 | 0.0028 | 0.0172 | 0.0055 | 0.0167 | 0.0103 | 0.0086 | 0.0155 | 0.0028 |
| | rs548181 | STT3A | 11 | 4.65E−07 | 0.0071 | 0.0006 | 0.0068 | 0.0031 | 0.0066 | 0.0077 | 0.0004 | 0.0078 | 0.0004 |
| 79 | rs11224103 | BC112333 | 11 | 1.40E−03 | 0.4440 | 0.0488 | 0.1161 | 0.1513 | 0.3651 | 0.4434 | 0.4419 | 0.4531 | 0.0488 |
| 80 | rs77972947 | CACNA1C | 12 | 7.12E−06 | 0.0261 | 0.0042 | 0.0257 | 0.0214 | 0.0202 | 0.0190 | 0.0276 | 0.0382 | 0.0042 |
| 81 | rs4765905 | CACNA1C | 12 | 7.99E−06 | 0.0261 | 0.0076 | 0.0241 | 0.0214 | 0.0201 | 0.0205 | 0.0291 | 0.0285 | 0.0076 |
| 82 | rs4771136 | MTIF3 | 13 | 8.71E−04 | 0.3697 | 0.0245 | 0.0763 | 0.1321 | 0.2677 | 0.1692 | 0.3690 | 0.3551 | 0.0245 |
| 83 | rs9317009 | PCDH17 | 13 | 1.72E−04 | 0.1822 | 0.1487 | 0.1814 | 0.0672 | 0.1119 | 0.0798 | 0.0374 | 0.1705 | 0.0374 |
| 84 | rs8003074 | KIAA0391 | 14 | 7.23E−06 | 0.0261 | 0.0076 | 0.0245 | 0.0048 | 0.0152 | 0.0268 | 0.0259 | 0.0248 | 0.0048 |
| | rs10135277 | KIAA0391 | 14 | 5.02E−06 | 0.0210 | 0.0049 | 0.0203 | 0.0050 | 0.0119 | 0.0224 | 0.0200 | 0.0200 | 0.0049 |
| 85 | rs3783778 | PRKCH | 14 | 1.76E−04 | 0.1822 | 0.0662 | 0.1571 | 0.1851 | 0.0860 | 0.1839 | 0.0374 | 0.1801 | 0.0374 |
| 86 | rs12878333 | TTC8 | 14 | 2.56E−04 | 0.2316 | 0.0723 | 0.1919 | 0.0309 | 0.1967 | 0.2338 | 0.2274 | 0.2214 | 0.0309 |
| 87 | rs1869901 | PLCB2 | 15 | 3.66E−05 | 0.0191 | 0.0020 | 0.0145 | 0.0028 | 0.0176 | 0.0170 | 0.0215 | 0.0183 | 0.0020 |
| 88 | rs6494005 | LIPC | 15 | 6.28E−04 | 0.3377 | 0.0207 | 0.3250 | 0.0477 | 0.1889 | 0.3300 | 0.2220 | 0.3519 | 0.0207 |
| 79 | rs11071612 | BC033962 | 15 | 2.98E−05 | 0.0638 | 0.0244 | 0.0579 | 0.0546 | 0.0624 | 0.0616 | 0.0711 | 0.0624 | 0.0244 |
| | rs4775413 | BC033962 | 15 | 2.79E−05 | 0.0541 | 0.0274 | 0.0472 | 0.0460 | 0.0457 | 0.0542 | 0.0571 | 0.0494 | 0.0274 |
| 90 | rs8043401 | AP3B2 | 15 | 3.41E−04 | 0.2574 | 0.0469 | 0.2124 | 0.1933 | 0.2564 | 0.1533 | 0.2167 | 0.2467 | 0.0469 |
| 91 | rs1078163 | NTRK3 | 15 | 3.43E−05 | 0.0638 | 0.0493 | 0.0558 | 0.0336 | 0.0480 | 0.0561 | 0.0671 | 0.0781 | 0.0336 |
| | rs3784434 | NTRK3 | 15 | 3.91E−05 | 0.0752 | 0.0515 | 0.0685 | 0.0347 | 0.0521 | 0.0752 | 0.0787 | 0.0799 | 0.0347 |
| | rs4887348 | NTRK3 | 15 | 4.69E−05 | 0.0883 | 0.0613 | 0.0760 | 0.0156 | 0.0741 | 0.0719 | 0.0443 | 0.1045 | 0.0156 |
| 92 | rs991728 | NTRK3 | 15 | 1.79E−04 | 0.2063 | 0.0223 | 0.1358 | 0.1703 | 0.1265 | 0.1884 | 0.2119 | 0.2026 | 0.0223 |
| 93 | rs6500606 | DNAIA3 | 16 | 1.84E−04 | 0.2063 | 0.1532 | 0.1671 | 0.0367 | 0.1623 | 0.1109 | 0.0270 | 0.2006 | 0.0270 |
| | rs3747600 | C16orf5 | 16 | 1.49E−04 | 0.1822 | 0.1487 | 0.1345 | 0.0458 | 0.1274 | 0.1420 | 0.0243 | 0.1746 | 0.0243 |
| 94 | rs4238618 | CPPED1 | 16 | 2.69E−04 | 0.2316 | 0.0100 | 0.2124 | 0.0233 | 0.1656 | 0.2338 | 0.2324 | 0.2261 | 0.0100 |
| 95 | rs154665 | DPEP1 | 16 | 4.46E−04 | 0.2836 | 0.0347 | 0.2705 | 0.0806 | 0.2022 | 0.2758 | 0.1988 | 0.2797 | 0.0347 |
| 96 | rs12602358 | TMEM132 | 17 | 1.53E−04 | 0.1822 | 0.0953 | 0.0443 | 0.1851 | 0.1423 | 0.1662 | 0.0374 | NaN | 0.0374 |
| 97 | rs1471454 | GGA3 | 17 | 7.43E−05 | 0.1204 | 0.0860 | 0.1198 | 0.0799 | 0.0767 | 0.1097 | 0.0415 | 0.1112 | 0.0415 |
| 98 | rs16957445 | MBD2 | 18 | 5.04E−05 | 0.0883 | 0.0354 | 0.0421 | 0.0361 | NaN | NaN | NaN | NaN | 0.0354 |
| 99 | rs12954483 | AK093940 | 18 | 3.95E−04 | 0.2836 | 0.0699 | 0.2600 | 0.0335 | NaN | NaN | NaN | NaN | 0.0335 |
| 100 | rs12966547 | AK093940 | 18 | 8.81E−06 | 0.0261 | 0.0225 | 0.0241 | 0.0178 | 0.0253 | 0.0249 | 0.0301 | 0.0248 | 0.0178 |
| | rs9951150 | AK093940 | 18 | 1.54E−05 | 0.0392 | 0.0143 | 0.0336 | 0.0168 | 0.0355 | 0.0384 | 0.0420 | 0.0683 | 0.0143 |
| 101 | rs17597926 | TCF4 | 18 | 6.49E−07 | 0.0081 | 0.0022 | 0.0072 | 0.0066 | 0.0076 | 0.0081 | 0.0093 | 0.0092 | 0.0022 |
| 102 | rs2965189 | GATAD2A | 19 | 5.94 E−04 | 0.3377 | 0.0207 | 0.0622 | 0.3174 | 0.3383 | 0.1626 | 0.3371 | 0.3343 | 0.0207 |
| 103 | rs755327 | DHX34 | 19 | 9.99E−04 | 0.4059 | 0.0456 | 0.3258 | 0.1278 | NaN | NaN | NaN | NaN | 0.0456 |
| 104 | rs2833899 | TCP10L | 21 | 2.83E−05 | 0.0638 | 0.0493 | 0.0579 | 0.0247 | 0.0447 | 0.0639 | 0.0657 | 0.0584 | 0.0247 |
| | rs2236430 | TCP10L | 21 | 2.13E−04 | 0.2063 | 0.1868 | 0.1833 | 0.1016 | 0.0350 | 0.1751 | 0.2119 | 0.1934 | 0.0350 |
| | rs2833926 | TCP10L | 21 | 4.45E−05 | 0.0752 | 0.0752 | 0.0685 | 0.0223 | 0.0509 | 0.0725 | 0.0804 | 0.0709 | 0.0223 |
| 105 | rs7289747 | TRXR2A | 22 | 5.81E−05 | 0.1034 | 0.0821 | 0.0808 | 0.0674 | 0.0934 | 0.0372 | 0.0876 | 0.1138 | 0.0372 |
| 106 | rs5758209 | EP300 | 22 | 5.16E−05 | 0.0883 | 0.0408 | 0.0810 | 0.0766 | 0.0799 | 0.0669 | 0.0966 | 0.1211 | 0.0408 |

TABLE 27

| locus | SNP | Gene | chr A1 | A2 | SCZ | TG | LDL | HDL | SBP | BMI | WHR | T2D |
|---|---|---|---|---|---|---|---|---|---|---|---|---|
| 9 | rs780110 | IFT172 | 2A | G | 3.44 | −15.40 | −1.35 | 1.04 | NaN | 1.60 | −4.13 | 0.92 |
| | rs2272417 | IFT172 | 2C | T | 4.08 | −11.45 | −0.70 | 1.24 | NaN | 1.27 | −3.13 | −0.43 |
| 20 | rs6759206 | AGAP1 | 2A | G | 3.31 | −3.20 | 0.54 | 2.03 | NaN | 0.00 | −0.58 | −0.66 |
| 22 | rs3617 | ITIH3 | 3C | A | 3.74 | 1.04 | −0.77 | −1.80 | NaN | −2.11 | 4.15 | 1.68 |
| | rs2276817 | ITH4 | 3C | T | 4.22 | −1.97 | −3.15 | 2.01 | NaN | −2.14 | −0.32 | −1.09 |
| 37 | rs2328893 | SLC17A4 | 6G | A | 4.56 | −2.98 | −2.12 | 4.07 | NaN | −1.39 | 0.08 | −1.09 |
| | rs1324082 | SLC17A1 | 6C | T | 4.29 | −3.00 | −1.50 | 3.99 | NaN | −0.95 | −0.45 | −1.03 |
| | rs13198474 | SLC17A3 | 6G | A | 4.46 | 0.94 | −1.34 | 4.18 | NaN | 0.10 | 0.64 | −0.18 |
| | rs16891235 | HIST1H1A | 6T | C | 4.01 | −0.24 | −3.64 | 4.26 | NaN | −0.15 | 0.61 | −0.68 |
| | rs13194781 | HIST1H2BN | 6A | G | 5.64 | 3.86 | 0.16 | 2.44 | NaN | 0.16 | −0.65 | 0.80 |
| | rs1235162 | GABBR1 | 6A | G | 5.02 | 4.12 | 1.25 | 2.56 | NaN | −0.87 | −0.03 | 0.03 |
| | rs2844762 | HLA-B | 6T | C | 4.23 | 3.64 | −1.78 | −0.66 | NaN | NaN | 0.70 | −1.32 |
| | rs3130380 | HCG18 | 6G | A | 5.17 | 3.56 | 1.34 | 3.57 | NaN | −1.29 | 1.15 | 0.59 |
| | rs2524222 | GNL1 | 6T | C | 3.75 | 1.92 | 3.56 | 1.60 | NaN | 0.24 | 0.59 | 0.91 |
| | rs9262143 | KIAA1949 | 6C | T | 5.31 | 4.88 | 2.29 | 3.05 | NaN | −0.50 | 1.78 | 0.00 |
| | rs3095326 | IER3 | 6C | T | 4.87 | 4.94 | 3.14 | 3.13 | NaN | −0.48 | 1.55 | 0.54 |
| | rs3099840 | HCP5 | 6A | G | 4.04 | 5.53 | 2.07 | 3.38 | NaN | −0.01 | 2.03 | 0.33 |
| | rs2284178 | HCP5 | 6T | C | 3.71 | 3.25 | 1.82 | 2.03 | NaN | −1.13 | 1.01 | 1.17 |
| | rs805294 | LY6G6C | 6A | G | 4.18 | −0.09 | −0.14 | 2.53 | NaN | −1.55 | 1.25 | −2.53 |
| | rs3117577 | MSH5 | 6A | G | 4.30 | 6.43 | 3.77 | 1.62 | NaN | −0.75 | 1.92 | −0.60 |
| | rs3130679 | C6orf48 | 6A | G | 4.55 | 5.97 | 2.94 | 2.41 | NaN | −1.22 | 2.66 | −1.08 |
| | rs412657 | AK123889 | 6T | G | 3.57 | −0.97 | 0.32 | 3.29 | NaN | −1.42 | 2.09 | 0.46 |
| | rs9268219 | C6orf10 | 6T | G | 4.50 | 6.03 | 3.25 | 2.46 | NaN | −1.36 | 3.64 | −0.01 |
| | rs3129963 | BTNL2 | 6A | G | 3.85 | 1.25 | 1.16 | 3.94 | NaN | −0.48 | 3.55 | −0.89 |
| | rs9268853 | HLA-ORA | 6C | T | 4.04 | 0.94 | −1.02 | 3.28 | NaN | −1.55 | 3.71 | 2.17 |
| | rs9275524 | HLA-DQA2 | 6C | T | 3.36 | 3.71 | 3.50 | 3.93 | NaN | −2.67 | 3.23 | 1.18 |
| 39 | rs1480380 | HLA-DMA | 6C | T | 4.67 | 3.55 | 0.68 | 1.68 | NaN | −1.05 | 2.77 | NaN |
| 40 | rs7832 | C6orf108 | 6G | A | 3.23 | −2.99 | 0.28 | 2.64 | NaN | NaN | NaN | NaN |
| 51 | rs983309 | AK055863 | 8T | G | 3.84 | 1.55 | −7.54 | −9.13 | NaN | 0.95 | 1.84 | 0.68 |
| | rs17660635 | AK055863 | 8G | A | 3.53 | 1.07 | −4.72 | −5.08 | NaN | 0.47 | 1.12 | 0.32 |
| 65 | rs4919666 | SUFU | 10G | A | 3.61 | 0.44 | −0.62 | 0.61 | NaN | −2.32 | 0.97 | 2.25 |
| | rs2296569 | CNNM2 | 10G | A | 4.62 | −2.29 | 1.65 | 3.20 | NaN | 0.13 | 0.00 | 0.63 |
| | rs11191560 | NT5C2 | 10T | C | 5.00 | 1.03 | 0.25 | 0.92 | NaN | −4.13 | 1.83 | 0.20 |
| | rs11191580 | NT5C2 | 10T | C | 5.08 | 0.71 | 0.12 | 1.17 | NaN | −4.08 | 1.78 | 0.22 |
| 71 | rs2958625 | METT5D1 | 11A | C | 3.80 | −3.66 | −0.42 | 3.39 | NaN | −1.88 | −1.74 | 0.55 |
| | rs10835491 | METT5D1 | 11G | C | NaN | NaN | NaN | NaN | NaN | NaN | NaN | NaN |
| 78 | rs10790734 | PKNOX2 | 11T | G | 3.93 | −1.75 | 0.52 | −0.03 | NaN | −1.36 | −3.50 | 0.58 |

TABLE 28

| locus | SNP | Gene | chr | SCZ&TG | SCZ&LDL | SCZ&HDL | SCZ&SBP | SCZ&BMI | SCZ&WHR | SCZ&T2D | min FDR |
|---|---|---|---|---|---|---|---|---|---|---|---|
| 9 | rs780110 | IFT172 | 2 | 0.02074 | 0.73578 | 0.66350 | 0.88851 | 0.57686 | 0.04831 | 1.00000 | 0.02074 |
| | rs2272417 | IFT172 | 2 | 0.00193 | 0.86268 | 0.55896 | 0.83749 | 0.70039 | 0.06244 | 1.00000 | 0.00193 |
| 15 | rs13415835 | BCL11A | 2 | 0.03269 | 0.81421 | 0.66350 | 0.97795 | 0.87106 | 0.81643 | 1.00000 | 0.03269 |
| 20 | rs6759206 | AGAP1 | 2 | 0.03063 | 0.89696 | 0.25333 | 1.00000 | 1.00000 | 0.95347 | 1.00000 | 0.03063 |
| 22 | rs3617 | ITIH3 | 3 | 0.69128 | 0.84071 | 0.37022 | 0.97795 | 0.45287 | 0.02701 | 1.00000 | 0.02701 |
| | rs2276817 | ITIH4 | 3 | 0.28255 | 0.04717 | 0.25333 | 0.61203 | 0.45287 | 1.00000 | 1.00000 | 0.04717 |
| 24 | rs1447595 | PPP2R3A | 3 | 0.01459 | 0.11842 | 0.78537 | 1.00000 | 0.74603 | 0.47533 | 1.00000 | 0.01459 |
| 30 | rs1872701 | BANK1 | 4 | 0.54054 | 1.00000 | 0.03447 | 0.48555 | 0.70035 | 1.00000 | 1.00000 | 0.03447 |
| 37 | rs2328893 | SLC17A4 | 6 | 0.03788 | 0.34581 | 0.00396 | 0.83745 | 0.65586 | 1.00000 | 1.00000 | 0.00396 |
| | rs1324082 | SLC17A1 | 6 | 0.03113 | 0.63999 | 0.00602 | 0.65717 | 0.78940 | 0.95347 | 1.00000 | 0.00602 |
| | rs13198474 | SLC17A3 | 6 | 0.69128 | 0.73578 | 0.00406 | 0.80634 | 1.00000 | 0.93286 | 1.00000 | 0.00406 |
| | rs16891235 | HIST1H1A | 6 | 0.95191 | 0.03017 | 0.01088 | 0.70268 | 1.00000 | 0.93285 | 1.00000 | 0.01088 |
| | rs13194781 | HIST1H2BN | 6 | 0.00239 | 0.97314 | 0.14244 | 0.88851 | 1.00000 | 0.93235 | 1.00000 | 0.00239 |
| | rs1235162 | GABBR1 | 6 | 0.00117 | 0.73578 | 0.10885 | 0.70268 | 0.82974 | 1.00000 | 1.00000 | 0.00117 |
| | rs2844762 | HLA-B | 6 | 0.00491 | 0.53895 | 0.78537 | 0.61208 | NaN | 0.93285 | 1.00000 | 0.00491 |
| | rs3130380 | HCG18 | 6 | 0.00708 | 0.73578 | 0.01852 | 0.77857 | 0.70039 | 0.81643 | 1.00000 | 0.00708 |
| | rs2524222 | GNL1 | 6 | 0.28255 | 0.04455 | 0.41447 | 0.80634 | 1.00000 | 0.93285 | 1.00000 | 0.04455 |
| | rs9262143 | KIAA1949 | 6 | 0.00004 | 0.26238 | 0.05759 | 0.77857 | 0.92201 | 0.52829 | 1.00000 | 0.00004 |
| | rs3095326 | IER3 | 6 | 0.00015 | 0.04717 | 0.04502 | 0.74450 | 0.92201 | 0.42354 | 1.00000 | 0.00015 |
| | rs3099840 | HCP5 | 6 | 0.00238 | 0.39032 | 0.02988 | 0.28698 | 1.00000 | 0.37454 | 1.00000 | 0.00238 |
| | rs2284178 | HCP5 | 6 | 0.01764 | 0.48709 | 0.25333 | 0.18351 | 0.74603 | 0.87368 | 1.00000 | 0.01764 |
| | rs805294 | LY6G6C | 6 | 1.00000 | 0.97314 | 0.12393 | 0.00686 | 0.61339 | 0.75370 | 1.00000 | 0.00686 |
| | rs3117577 | MSH5 | 6 | 0.00086 | 0.02164 | 0.41447 | 0.61203 | 0.87106 | 0.42354 | 1.00000 | 0.00086 |
| | rs3130679 | C6orf48 | 6 | 0.00037 | 0.07243 | 0.14244 | 0.41364 | 0.70039 | 0.13758 | 1.00000 | 0.00037 |
| | rs412657 | AK123889 | 6 | 0.69128 | 0.97314 | 0.03447 | 0.65717 | 0.65586 | 0.37454 | 1.00000 | 0.03447 |
| | rs9268219 | C6orf10 | 6 | 0.00043 | 0.04220 | 0.12393 | 0.38400 | 0.65586 | 0.03366 | 1.00000 | 0.00043 |
| | rs3129963 | BTNL2 | 6 | 0.59071 | 0.77938 | 0.01626 | 0.52604 | 0.92201 | 0.04119 | 1.00000 | 0.01626 |
| | rs9268853 | HLA-DRA | 6 | 0.69128 | 0.81421 | 0.03447 | 0.41364 | 0.61339 | 0.02983 | 1.00000 | 0.02983 |
| | rs9275524 | HLA-DQA2 | 6 | 0.02449 | 0.06693 | 0.05699 | 0.33310 | 0.27214 | 0.05832 | 1.00000 | 0.02449 |
| 39 | rs1480380 | HLA-DMA | 6 | 0.00708 | 0.86268 | 0.41447 | 0.18351 | 0.78940 | 0.10401 | NaN | 0.00708 |
| 40 | rs7832 | C6orf108 | 6 | 0.04474 | 0.97057 | 0.10762 | NaN | NaN | NaN | NaN | 0.04474 |
| 45 | rs10257135 | SRPK2 | 7 | 0.03997 | 0.89790 | 0.61139 | 0.90252 | 0.99278 | 0.68597 | 1.00000 | 0.03997 |
| 50 | rs367543 | BC017578 | 8 | 0.02878 | 0.81421 | 0.61021 | 0.30944 | 0.27214 | 0.93285 | 1.00000 | 0.02878 |
| 51 | rs983309 | AK055863 | 8 | 0.46760 | 0.04114 | 0.01626 | 0.80634 | 0.78940 | 0.47533 | 1.00000 | 0.01626 |
| | rs17660635 | AK055863 | 8 | 0.69128 | 0.05555 | 0.03395 | 0.74450 | 0.92201 | 0.81643 | 1.00000 | 0.03395 |
| 53 | rs7824675 | MSRA | 8 | 0.03997 | 0.96852 | 1.00000 | 0.50957 | 0 26660 | 1.00000 | 1.00000 | 0.03997 |
| 59 | rs1330304 | BNC2 | 9 | 0.04474 | 0.10799 | 0.13726 | 0.20975 | 0.40002 | 0.91864 | 1.00000 | 0.04474 |
| 65 | rs4919666 | SUFU | 10 | 0.85168 | 0.86268 | 0.78537 | 0.04783 | 0.40025 | 0.87363 | 1.00000 | 0.04783 |
| | rs2296569 | CNNM2 | 10 | 0.15574 | 0.59079 | 0.03950 | 1.00000 | 1.00000 | 1.00000 | 1.00000 | 0.03950 |
| | rs11191560 | NTSC2 | 10 | 0.69128 | 0.97314 | 0.72193 | 0.00022 | 0.02776 | 0.47533 | 1.00000 | 0.00022 |
| | rs11191580 | NTSC2 | 10 | 0.78905 | 1.00000 | 0.61021 | 0.00013 | 0.02897 | 0.52829 | 1.00000 | 0.00013 |
| 71 | rs2958625 | METTSD1 | 11 | 0.00672 | 0.89696 | 0.02569 | 0.88851 | 0.51128 | 0.52829 | 1.00000 | 0.00672 |
| | rs10835491 | METTSD1 | 11 | 0.00446 | 0.89696 | 0.03950 | 0.88851 | 0.52128 | 0.52829 | 1.00000 | 0.00446 |
| 77 | rs949341 | CR6166845 | 11 | 0.04607 | 0.94071 | 0.55896 | 0.65717 | 0.92201 | 1.00000 | 1.00000 | 0.04607 |
| 78 | rs10790734 | PKNOX2 | 11 | 0.37774 | 0.89696 | 1.00000 | 0.80634 | 0.65586 | 0.04476 | 1.00000 | 0.04476 |
| 79 | rs11224103 | BC112333 | 11 | 0.04883 | 0.12617 | 0.27436 | 0.79396 | 1.00000 | 1.00000 | 1.00000 | 0.04883 |
| 82 | rs4771136 | MTIF3 | 13 | 0.02449 | 0.07628 | 0.32759 | 0.70268 | 0.33766 | 1.00000 | 1.00000 | 0.02449 |
| 88 | rs6494005 | LIPC | 15 | 0.02074 | 0.97314 | 0.04771 | 0.48555 | 1.00000 | 0.63564 | 1.00000 | 0.02074 |
| 93 | rs4786493 | DNAJA3 | 16 | 0.85168 | 0.77938 | 0.28865 | 0.77857 | 0.65586 | 0.02983 | 1.00000 | 0.02983 |
| 94 | rs4238618 | CPPED1 | 16 | 0.01470 | 0.89696 | 0.07881 | 0.77857 | 1.00000 | 1.00000 | 1.00000 | 0.01470 |
| 96 | rs12602358 | TMEM132E | 17 | 0.64084 | 0.04430 | 1.00000 | 0.83749 | 0.92201 | 0.13758 | NaN | 0.04430 |
| 102 | rs2965189 | GATAD2A | 19 | 0.02074 | 0.06215 | 0.96086 | 1.00000 | 0.40025 | 1.00000 | 1.00000 | 0.02074 |
| 103 | rs755327 | DHX34 | 19 | 0.04607 | 0.77938 | 0.25333 | NaN | NaN | NaN | NaN | 0.04607 |

### REFERENCES

1. Glazier, A. M., Nadeau, J. H., and Aitman, T. J. (2002). Finding genes that underlie complex traits. Science 298, 2345-2349.
2. Hirschhorn, J. N., and Daly, M. J. (2005). Genome-wide association studies for common diseases and complex traits. Nat Rev Genet 6, 95-108.
3. Hindorff, L. A., Sethupathy, P., Junkins, H. A., Ramos, E. M., Mehta, J. P., Collins, F. S., and Manolio, T. A. (2009). Potential etiologic and functional implications of genome-wide association loci for human diseases and traits. Proc Natl Acad Sci USA 106, 9362-9367.
4. Manolio, T. A., Collins, F. S., Cox, N. J., Goldstein, D. B., Hindorff, L. A., Hunter, D. J., McCarthy, M. I., Ramos, E. M., Cardon, L. R., Chakravarti. A., et al. (2009). Finding the missing heritability of complex diseases. Nature 461, 747-753.
5. Yang, J., Benyamin, B., McEvoy, B. P., Gordon, S., Henders, A. K., Nyholt, D. R., Madden, P. A., Heath, A. C., Martin, N. G., Montgomery. G. W., et al. (2010). Common SNPs explain a large proportion of the heritability for human height. Nat Genet 42, 565-569.
6. Yang, J., Manolio, T. A., Pasquale, L. R., Boerwinkle, E., Caporaso, N., Cunningham. J. M., de Andrade, M., Feenstra, B., Feingold, E., Hayes, M. G., et al. (2011). Genome partitioning of genetic variation for complex traits using common SNPs. Nat Genet 43, 519-525.
7. Stahl, E. A., Wegmann, D., Trynka, G., Gutierrez-Achury, J., Do, R., Voight, B. F., Kraft. P., Chen, R., Kallberg, H. J., Kurreeman, F. A., et al. (2012). Bayesian inference analyses of the polygenic architecture of rheumatoid arthritis. Nat Genet 44, 483-489.
8. Wagner, G. P., and Zhang, J. (2011). The pleiotropic structure of the genotype-phenotype map: the evolvability of complex organisms. Nat Rev Genet 12, 204-213.
9. Sivakumaran, S., Agakov, F., Theodoratou, E., Prendergast, J. G., Zgaga, L., Manolio, T., Rudan, I., McKeigue, P., Wilson, J. F., and Campbell, H. (2011). Abundant pleiotropy in human complex diseases and traits. Am J Hum Genet 89, 607-618.
10. Chambers, J. C., Zhang, W., Sehmi, J., Li, X., Wass, M. N., Van der Harst, P., Holm, H., Sanna, S., Kavousi, M., Baumeister, S. E., et al. (2011). Genome-wide association study identifies loci influencing concentrations of liver enzymes in plasma. Nat Genet 43, 1131-1138.
11. Cotsapas, C., Voight, B. F., Rossin, E., Lage, K., Neale, B. M., Wallace, C., Abecasis, G. R., Barrett, J. C., Behrens, T., Cho, J., et al. (2011). Pervasive sharing of genetic effects in autoimmune disease. PLoS Genet 7. e1002254.
12. Sklar, P., Ripke, S., Scott, L. J., Andreassen, O. A., Cichon, S., Craddock, N., Edenberg, H. J., Nurnberger, J. I., Jr., Rietschel, M., Blackwood, D., et al. (2011). Large-scale genome-wide association analysis of bipolar disorder identifies a new susceptibility locus near ODZ4. Nat Genet 43, 977-983.
13. Ripke, S., Sanders, A. R., Kendler, K. S., Levinson, D. F., Sklar, P., Holmans, P. A., Lin, D. Y., Duan, J., Ophoff. R. A., Andreassen, O. A., et al. (2011). Genome-wide association study identifies five new schizophrenia loci. Nat Genet 43, 969-976.
14. Lichtenstein, P., Yip, B. H., Bjork, C., Pawitan, Y., Cannon, T. D., Sullivan, P. F., and Hultman, C. M. (2009). Common genetic determinants of schizophrenia and bipolar disorder in Swedish families: a population-based study. Lancet 373, 234-239.
15. Stefansson, H., Ophoff, R. A., Steinberg, S., Andreassen, O. A., Cichon, S., Rujescu, D., Werge, T., Pietilainen, O. P., Mors, O., Mortensen, P. B., et al. (2009). Common variants conferring risk of schizophrenia. Nature 460, 744-747.
16. Purcell, S. M., Wray, N. R., Stone, J. L., Visscher, P. M., O'Donovan, M. C., Sullivan, P. F., and Sklar, P. (2009). Common polygenic variation contributes to risk of schizophrenia and bipolar disorder. Nature 460, 748-752.
17. Murray C J L, L. A. (1996). The Global Burden of Disease: A comprehensive assessment of mortality, injuries, and risk factors in 1990 and projected to 2020. In. (Cambridge Mass., Harvard School of Public Health.
18. Colton, C. W., and Manderscheid, R. W. (2006). Congruencies in increased mortality rates, years of potential life lost, and causes of death among public mental health clients in eight states. Prev Chronic Dis 3, A42.
19. Laursen, T. M., Munk-Olsen, T., and Vestergaard, M. (2012). Life expectancy and cardiovascular mortality in persons with schizophrenia. Curr Opin Psychiatry 25, 83-88.
20. Saha, S., Chant, D., and McGrath, J. (2007). A systematic review of mortality in schizophrenia: is the differential mortality gap worsening over time? Arch Gen Psychiatry 64, 1123-1131.
21. Marder, S. R., Essock, S. M., Miller, A. L., Buchanan, R. W., Casey, D. E., Davis, J. M., Kane, J. M., Lieberman, J. A., Schooler, N. R., Covell, N., et al. (2004). Physical health monitoring of patients with schizophrenia. Am J Psychiatry 161, 1334-1349.
22. Mitchell, A. J., Vancampfort, D., Sweets, K., van Winkel, R., Yu, W., and De Hert, M. (2011). Prevalence of Metabolic Syndrome and Metabolic Abnormalities in Schizophrenia and Related Disorders—A Systematic Review and Meta-Analysis. Schizophr Bull.
23. (2004). Consensus development conference on antipsychotic drugs and obesity and diabetes. Diabetes Care 27, 596-601.
24. De Hert, M. A., van Winkel, R., Van Eyck, D., Hanssens, L., Wampers, M., Scheen, A., and Peuskens, J. (2006). Prevalence of the metabolic syndrome in patients with schizophrenia treated with antipsychotic medication. Schizophr Res 83, 87-93.
25. Kaddurah-Daouk, R., McEvoy, J., Baillie, R. A., Lee, D., Yao, J. K., Doraiswamy, P. M., and Krishnan, K. R. (2007). Metabolomic mapping of atypical antipsychotic effects in schizophrenia. Mol Psychiatry 12, 934-945.
26. Raphael, T. P., and Parsons, J. P. (1921). Blood sugar studies in dementia praecox and manic depressive insanity. Arch Neurol Psychiatry 5, 687-709.
27. Ryan, M. C., Collins, P., and Thakore, J. H. (2003). Impaired fasting glucose tolerance in first episode, drug-naive patients with schizophrenia. Am J Psychiatry 160, 284-289.
28. Hansen, T., Ingason, A., Djurovic, S., Melle, I., Fenger, M., Gustafsson, O., Jakobsen, K. D., Rasmussen, H. B., Tosato, S., Rietschel, M., et al. (2011). At-risk variant in TCF7L2 for type II diabetes increases risk of schizophrenia. Biol Psychiatry 70, 59-63.
29. Ehret, G. B., Munroe, P. B., Rice, K. M., Bochud, M., Johnson, A. D., Chasman, D. I., Smith, A. V., Tobin, M. D., Verwoert, G. C., Hwang, S. J., et al. (2011). Genetic variants in novel pathways influence blood pressure and cardiovascular disease risk. Nature 478, 103-109.
30. Teslovich, T. M., Musunuru, K., Smith, A. V., Edmondson, A. C., Stylianou, I. M., Koseki, M., Pirruccello, J. P., Ripatti, S., Chasman, D. I., Willer, C. J., et al. (2010). Biological, clinical and population relevance of 95 loci for blood lipids. Nature 466, 707-713.
31. Voight, B. F., Scott, L. J., Steinthorsdottir, V., Morris, A. P., Dina, C., Welch, R. P., Zeggini, E., Huth, C., Aulchenko, Y. S., Thorleifsson, G., et al. (2010). Twelve type 2 diabetes susceptibility loci identified through large-scale association analysis. Nat Genet 42, 579-589.
32. Speliotes, E. K., Willer, C. J., Berndt, S. I., Monda, K. L., Thorleifsson, G., Jackson, A. U., Allen, H. L., Lindgren, C. M., Luan, J., Magi, R., et al. (2010). Association analyses of 249,796 individuals reveal 18 new loci associated with body mass index. Nat Genet 42, 937-948.
33. Heid, I. M., Jackson. A. U., Randall, J. C., Winkler, T. W., Qi, L., Steinthorsdottir, V., Thorleifsson, G., Zillikens, M. C., Speliotes, E. K., Magi, R., et al. (2010). Meta-analysis identifies 13 new loci associated with waist-hip ratio and reveals sexual dimorphism in the genetic basis of fat distribution. Nat Genet 42, 949-960.
34. Yoo, Y. J., Pinnaduwage, D., Waggott, D., Bull, S. B., and Sun. L. (2009). Genome-wide association analyses of North American Rheumatoid Arthritis Consortium and Framingham Heart Study data utilizing genome-wide linkage results. BMC proceedings 3 Suppl 7, S103.
35. Sun, L., Craiu, R. V., Paterson, A. D., and Bull, S. B. (2006). Stratified false discovery control for large-scale hypothesis testing with application to genome-wide association studies. Genetic epidemiology 30, 519-530.
36. Efron, B. (2010). Large-scale inference: empirical Bayes methods for estimation, testing, and prediction. (Cambridge; New York: Cambridge University Press).
37. Schweder, T., and Spjotvoll, E. (1982). Plots of P-Values to Evaluate Many Tests Simultaneously. Biometrika 69, 493-502.
38. King, M. C., and Wilson, A. C. (1975). Evolution at two levels in humans and chimpanzees. Science 188, 107-116.
39. Siepel, A., Bejerano, G., Pedersen, J. S., Hinrichs, A. S., Hou, M., Rosenbloom, K., Clawson, H., Spieth, J., Hillier, L. W., Richards, S., et al. (2005). Evolutionarily conserved elements in vertebrate, insect, worm, and yeast genomes. Genome research 15, 1034-1050.
40. Benjamini, Y., and Hochberg, Y. (1995). Controlling the False Discovery Rate: A Practical and Powerful Approach to Multiple Testing. In Journal of the Royal Statistical Society Series B (Methodological). (Blackwell Publishing), pp 289-300.
41. Efron, B. (2007). Size, power and false discovery rates. The Annals of Statistics 35, 1351-1377.
42. Nichols, T., Brett. M., Andersson, J., Wager, T., and Poline, J. B. (2005). Valid conjunction inference with the minimum statistic. Neuroimage 25, 653-660.
43. Wang, K. S., Liu, X. F., and Aragam, N. (2010). A genome-wide meta-analysis identifies novel loci associated with schizophrenia and bipolar disorder. Schizophr Res 124, 192-199.
44. Sullivan, P. F. (2012). Puzzling over schizophrenia: Schizophrenia as a pathway disease. Nat Med 18, 210-211.
45. Craiu, R. V., and Sun, L. (2008). Choosing the lesser evil: Trade-off between false discovery rate and non-discovery rate. Statistica Sinica 18, 861-879.
46. Davis, K. L., Stewart, D. G., Friedman, J. I., Buchsbaum, M., Harvey, P. D., Hof, P. R., Buxbaum, J., and Haroutunian, V. (2003). White matter changes in schizophrenia: evidence for myelinrelated dysfunction. Arch Gen Psychiatry 60, 443-456.
47. Karoutzou, G., Emrich, H. M., and Dietrich, D. E. (2008). The myelin-pathogenesis puzzle in schizophrenia: a literature review. Mol Psychiatry 13, 245-260.
48. Marenco, S., and Weinberger, D. R. (2000). The neurodevelopmental hypothesis of schizophrenia: following a trail of evidence from cradle to grave. Dev Psychopathol 12, 501-527.

### Example 4

### Methods

### Overview of Statistical Methods

These methods have been described in detail in a series of studies investigating psychiatric 11-13 and nonpsychiatric disorders.13,14

Q-Q Plots and False Discovery Rates

Q-Q plots are standard tools for assessing similarity or differences between two cumulative distribution functions (CDFs). When the probability distribution of GWAS summary statistic two-tailed P values is of interest, under the global null hypothesis, the theoretical distribution is uniform on the interval [0,1]. If nominal P values are ordered from smallest to largest, so that P(1)<P(2)< . . . <P(N), the corresponding empirical CDF, denoted by “Q,” is simply Q(i)=i/N (in practice, adjusted slightly to account for the discreteness of the empirical CDF), where N is the number of SNPs in the GWAS (or genic category). Thus, for a given index i, the x-coordinate of the Q-Q curve is Q(i) (since the theoretical inverse CDF is the identity function) and the y-coordinate is the nominal P value P(i). It is a common practice in GWAS to instead plot −log 10 P against the −log 10 Q to emphasize tail probabilities of the theoretical and empirical distributions. For a given threshold of genomic control-corrected P values, “enrichment” is seen as a horizontal deflection of the Q-Q curves from the identity line.

Enrichment seen in the Q-Q plots can be directly interpreted in terms of false discovery rate (FDR). For a given P value cutoff, the Bayes FDR, defined as the posterior probability of a given SNP is null, given its observed P value, is given by:

FDR(P)=π₀F₀(P)/F(P), (1)

where π0 is the proportion of null SNPs, F0 is the CDF under the null hypothesis, and F is the CDF of all SNPs, both null and non-null. Here, F0 is the CDF of the uniform distribution on the unit interval [0,1], and F(P) can be estimated with the empirical CDF Q, so that an estimate of equation (1) is given by:

FDR(P)≈π₀·P/Q^{t}, (2)

which is biased upwards as an estimate of the FDR. Setting π0=1 in equation (2), an estimated FDR is further biased upward; if π0 is close to 1, as is likely true for most GWAS, the increase in bias from equation (2) is minimal. The quantity 1−P/Q is, therefore, biased downward, and hence a conservative estimate of the true discovery rate (equal to 1 FDR). Given the −log 10 of the Q-Q plots:

−log₁₀(FDR(P))≈log₁₀(Q)−log₁₀(P), (3)

demonstrating that the (conservatively) estimated FDR is directly related to the horizontal shift of the curves in the Q-Q plots from the expected line x=y, with a larger leftward shift corresponding to a smaller FDR.

Conditional Q-Q Plots and FDR. The Conditional

FDR as the posterior probability that a SNP belonging to a category c is null for a phenotype, given a P value as small as the observed P value. Formally, this is given by:

FDR(P|c)=π₀(c)·P/F(P|c), (4)

where P is the P value for the phenotype, c=1, . . . , C is one of C possible categories, F(P|c) is the conditional CDF, and π0(c) is the proportion of null SNPs in category c. A conservative estimate of FDR(P|c) is produced by setting π0(c)=1 and using the empirical conditional CDF in place of F(P1|c) in equation (4). This is a straightforward generalization of the empirical Bayes approach developed by Efron.10

In terms of Q-Q plots, enrichment of category c2 compared with category c1 is expressed as a leftward deflection of the Q-Q curve for category c2 compared with c1. Given equation (3), this is equivalent to showing that the conditional FDR is smaller for SNPs in category c2 compared with c1 for the same P value, ie, FDR(P|c2)<FDR(P|c1). Thus, by choosing a priori categories that result in differentially enriched samples, a larger proportion of SNPs can be discovered for a given FDR threshold than can be obtained from typical (unconditional) FDR or P value-based analyses.

Covariate-Modulated FDR

Using summary statistics derived from SNP associations of huge GWAS, it was shown that functional genic elements show differential contribution to phenotypic variance, with some categories (eg, regulatory elements and exons) showing strong enrichment (ie, more likely to have an effect) for phenotypic association.13 The enrichment of SNPs in genic elements of the genome (the 5′UTR and 3′UTR regions) was present across a wide spectrum of complex phenotypes and traits, including SCZ.13 This shows that SNPs in 5′UTR, in particular, but also in exons and 3′UTR regions are more likely to be involved in susceptibility to SCZ. This information can be used in Bayesian statistical models to enhance gene discovery by including information on the genic region in which each SNP is located, as this indicates how likely it is for each SNP to have an effect. By applying this approach to data from the Psychiatric Genomics Consortium (PGC) SCZ sample,16 the power for detecting small genetic effects was improved, leading to discovery of new susceptibility loci that did not reach threshold of significance in traditional GWAS analyses.13

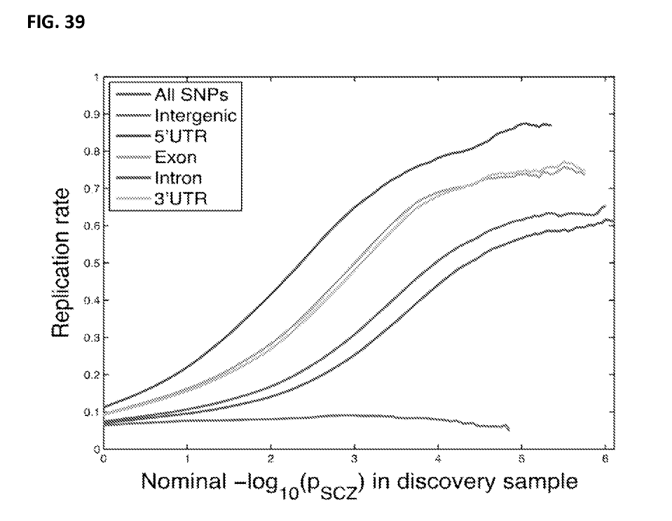

Empirical independent replication remains the gold standard for confirming statistical findings. The replication rates, defined as proportion of SNPs declared significant in training samples with P values below a given threshold in the replication sample and with z-scores with the same sign in both discovery and replication samples were tested in independent SCZ substudies from the PGC17 and it was found that annotation categories with the greatest enrichment (5′UTR, exons, 3′UTR) showed the highest replication rate for a given nominal P value, confirming that the observed enrichment is due to true associations and not to inflation due to population stratification or other potential sources of spurious effects (FIG. 39). These results are all based on summary statistics (P values, z-scores) for each substudy.

In order to illustrate the increased sensitivity and specificity for gene discovery, the publically available PGC SCZ sample was utilized.16 Applying the CMFDR method to the PGC SCZ sample, a total of 86 gene loci (CMFDR<0.05) were identified. By computing a posteriori effect sizes from the CMFDR model, it is expected that a very large proportion of these loci will replicate in a SCZ GWAS of similar size.

Gene Discovery Due to Pleiotropy Enrichment

The small number of genes relative to the vast number of human phenotypes necessitates pleiotropy—the influence of one gene or haplotype on two or more distinct phenotypes. The value of pleiotropy for improved understanding of disease pathogenesis and classification, identification of new molecular targets for drug development, and genetic risk profiling have been recognized.18 But few studies have systematically investigated pleiotropy in human complex traits and disorders, and those that have have looked for pleiotropy only among SNPs that reach a threshold level of significance in one or both phenotypes.18 This approach fails to capitalize on the power inherent in pleiotropy to robustly detect weak genetic effects.

The pleiotropy approach described herein was used to assess the contribution of all SNPs from two independent GWAS to determine their common association with two distinct phenotypes. SCZ and bipolar disorder share several clinical phenotypes, and there is growing evidence indicating overlapping gene variants.6,16 This approach was used to increase gene discovery in these disorders, using two large GWAS from the PGC,6,16 where overlapping controls had been removed with same procedure as in the recent cross-disorder analysis.19 A very high degree of polygenic overlap between SCZ and bipolar disorder was discovered.12 This information was used to increase the power of the GWAS, by including level of pleiotropy as a factor in the statistical models. This resulted in an improved yield (sensitivity) of genes discovered for SCZ and bipolar disorder compared to standard methods at a given significance level (specificity). 12 Thus, by applying the pleiotropy enrichment method and leveraging the bipolar disorder GWAS, gene discovery in the SCZ GWAS was increased. Note, while the power to detect nonpleiotropic loci is not increased using the pleiotropy enrichment method, neither is power lost.

Simulations showed that a larger increase in gene discovery would occur, using standard GWAS approaches, if the SCZ sample was as large as the combined SCZ bipolar disorder GWAS.12 However, it is very expensive to recruit and genotype new samples; applying the new statistical tools to existing samples is a cost-efficient way to improve gene discovery.

The results also showed that an estimated 1.2% of all SNPs analyzed are pleiotropic for SCZ and bipolar disorder. With approximately 1 million SNPs analyzed, this means that there are approximately 12 000 SNPs involved. This is very similar to the estimate from a recent large SCZ GWAS.7 This quantification of the polygenicity further emphasizes that most of these variants must have very small effects.

The new statistical tools can also be used to investigate genetic overlap between SCZ and nonpsychiatric diseases and traits to gain more knowledge about shared genetic mechanisms. There is a well-known comorbidity between SCZ and cardiovascular risk factors, including obesity, hypertension, and dyslipidemia.20 For each of these phenotypes, results are available from large GWAS. The pleiotropy methods were used to investigate polygenic pleiotropy. A genetic overlap between SCZ and several cardiovascular risk factors, particularly blood lipids (cholesterol, triglycerides) was found. This enrichment was leveraged to boost gene discovery and identify several gene loci associated with SCZ,11 strongly indicating that common molecular genetic mechanisms are underlying some of the epidemiological relationships between SCZ and cardiovascular risk factors.

Immune factors have been implicated in SCZ. By investigating pleiotropy with multiple sclerosis, a demyelination disorder with clear evidence for involvement of immune genes, the statistical tools were applied to determine polygenic overlap. A strong genetic overlap between SCZ and multiple sclerosis were found 21 and several independent loci associated with SCZ were identified. In contrast, no genetic overlap was found between bipolar disorder and multiple sclerosis. Imputation of the major histocompatibility complex (MHC) alleles indicated opposite direction of effect in multiple sclerosis and SCZ. As most of the overlap between multiple sclerosis and SCZ was located in the MHC region, and there is previous evidence for large genetic overlap between bipolar disorder and SCZ, the findings indicate that the MHC region could differentiate between bipolar disorder and SCZ.

Polygenic Architecture: Implications for Disease Mechanisms and Clinic

The underlying biology of complex brain disorders such as SCZ remains mostly unknown. Structural magnetic resonance imaging (MRI) brain phenotypes are highly heritable (80%-90%),22 and a new cluster analytical method has shown how pleiotropic brain phenotypes cluster together.17 Previous work has shown how a selected number of SNPs can be used to identify genetically determined brain structure variation.23,24 Recent large meta-analysis showed how brain structure volumes can be successfully used in a GWAS, and SNPs associated with hippocampal volume were identified.25 By extending a twin study-based approach to a large MRI sample across different behavioral phenotypes, combined with the statistical framework for analysis of GWAS data to identify polygenic effects, it is possible to identify genetically determined brain substrates related to SCZ and core disease phenotypes.

### REFERENCES

1. Wagner G P, Zhang J. The pleiotropic structure of the genotype-phenotype map: the evolvability of complex organisms. Nat Rev Genet. 2011; 12:204-213.
2. International Schizophrenia Consortium, Purcell S M, Wray N R, Stone J L, et al. Common polygenic variation contributes to risk of schizophrenia and bipolar disorder. Nature. 2009; 460:748-752.
3. Glazier A M, Nadeau J H, Aitman T J. Finding genes that underlie complex traits. Science. 2002; 298:2345-2349.
4. Hindorff L A, Sethupathy P, Junkins H A, et al. Potential etiologic and functional implications of genome-wide association loci for human diseases and traits. Proc Natl Acad Sci USA. 2009; 106:9362-9367.
5. Manolio T A, Collins F S, Cox N J, et al. Finding the missing heritability of complex diseases. Nature. 2009; 461:747-753.
6. Schizophrenia Psychiatric Genome-Wide Association Study (GWAS) Consortium; Ripke S, Sanders A R, Kendler K S, et al. Genome-wide association study identifies five new schizophrenia loci. Nat Genet. 2011; 43:969-976.
7. Ripke S, O'Dushlaine C, Chambert K, et al. Genome-wide association analysis identifies 13 new risk loci for schizophrenia. Nat Genet. 2013; 45:1150-1159.
8. Stefansson H, Ophoff R A, Steinberg S, et al. Genetic Risk and Outcome in Psychosis (GROUP). Common variants conferring risk of schizophrenia. Nature. 2009; 460:744-747.
9. Yang J, Benyamin B, McEvoy B P, et al. Common SNPs explain a large proportion of the heritability for human height. Nat Genet. 2010; 42:565-569.
10. Efron B. Large-Scale Inference: Empirical Bayes Methods for Estimation, Testing, and Prediction. Cambridge, UK: Cambridge University Press; 2010.
11. Andreassen O A, Djurovic S, Thompson W K, et al. International Consortium for Blood Pressure GWAS; Diabetes Genetics Replication and Meta-analysis Consortium; Psychiatric Genomics Consortium Schizophrenia Working Group. Improved detection of common variants associated with schizophrenia by leveraging pleiotropy with cardiovascular-disease risk factors. Am J Hum Genet. 2013; 92:197-209.
12. Andreassen O A, Thompson W K, Schork A J, et al. Psychiatric Genomics Consortium (PGC); Bipolar Disorder and Schizophrenia Working Groups. Improved detection of common variants associated with schizophrenia and bipolar disorder using pleiotropy-informed conditional false discovery rate. PLoS Genet. 2013; 9:e1003455.
13. Schork A J, Thompson W K, Pham P, et al. Tobacco and Genetics Consortium; Bipolar Disorder Psychiatric Genomics Consortium; Schizophrenia Psychiatric Genomics Consortium. All SNPs are not created equal: genome-wide association studies reveal a consistent pattern of enrichment among functionally annotated SNPs. PLoS Genet. 2013; 9:e1003449.
14. Liu J Z, Hov J R, Folseraas T, et al. Dense genotyping of immune-related disease regions identifies nine new risk loci for primary sclerosing cholangitis. Nat Genet. 2013; 45:670-675.
15. Zablocki R W, Levine R A, Schork A J, Andreassen O A, Dale A M, Thompson W K. Covariate-modulated local false discovery rate for genome-wide association studies. Bioinformatics.
16. Sklar P, Ripke S, Scott L J, et al. Large-scale genome-wide association analysis of bipolar disorder identifies a new susceptibility locus near ODZ4. Nat Genet. 2011; 43:977-983.
17. Chen C H, Panizzon M S, Eyler L T, et al. Genetic influences on cortical regionalization in the human brain. Neuron. 2011; 72:537-544.
18. Sivakumaran S, Agakov F, Theodoratou E, et al. Abundant pleiotropy in human complex diseases and traits. Am J Hum Genet. 2011; 89:607-618.
19. Cross-Disorder Group of the Psychiatric Genomics Consortium; Genetic Risk Outcome of Psychosis (GROUP) Consortium, Smoller J W, Ripke S, Lee P H, et al. Identification of risk loci with shared effects on five major psychiatric disorders: a genome-wide analysis. Lancet. 2013; 381:1371-1379.
20. Birkenaes A B, Opjordsmoen S, Brunborg C, et al. The level of cardiovascular risk factors in bipolar disorder equals that of schizophrenia: a comparative study. J Clin Psychiatry. 2007; 68:917-923.
21. Andreassen O A, Harbo H F, Wang Y, et al. Genetic pleiotropy between multiple sclerosis and schizophrenia but not bipolar disorder: differential involvement of immune related gene loci. Mol Psychiatry.
22. Panizzon M S, Fennema-Notestine C, Eyler L T, et al. Distinct genetic influences on cortical surface area and cortical thickness. Cereb Cortex. 2009; 19:2728-2735.
23. Joyner A H, J C R, Bloss C S, et al. A common MECP2 haplotype associates with reduced cortical surface area in humans in two independent populations. Proc Natl Acad Sci USA. 2009; 106:15483-15488.
24. Rimol L M, Agartz I, Djurovic S, et al. Alzheimer's Disease Neuroimaging Initiative. Sex-dependent association of common variants of microcephaly genes with brain structure. Proc Natl Acad Sci USA. 2010; 107:384-388.
25. Stein J L, Medland S E, Vasquez A A, et al. Alzheimer's Disease Neuroimaging Initiative; EPIGEN Consortium; IMAGEN Consortium; Saguenay Youth Study Group; Cohorts for Heart and Aging Research in Genomic Epidemiology Consortium; Enhancing Neuro Imaging Genetics through Meta-Analysis Consortium. Identification of common variants associated with human hippocampal and intracranial volumes. Nat Genet. 2012; 44:552-561.
26. van Os J, Kapur S. Schizophrenia. Lancet. 2009; 374:635-645.
27. Lancaster M A, Renner M, Martin C A, et al. Cerebral organoids model human brain development and microcephaly. Nature. 2013; 501:373-379.

### Example 5

### Methods

Review of fdr

Efron and Tibshirani (2002) Efron and Tibshirani (2002) made the assumption that the test statistic zᵢ, 1≦i≦n, has a different distribution based on whether the null hypothesis H_{0,i} is true or false, where n is the total number of tests (SNPs). The non-null distribution will tend to have more extreme values of the test statistic. Hence, zᵢ follows a two-group

mixture model f(zᵢ)=π₀f₀(zᵢ)+π₁f₁(zᵢ), (1) where π0 is the proportion of true null hypotheses, π1=1−π0 is the proportion of true non-null hypotheses, f₀ is the probability density function if H₀ is true, and f₁ is the probability density function if H₀ is false. Local fdr is the posterior probability that the ith test is null given zi, which by

Bayes rule is given by

$$fdr ( {z}_{i} ) = \frac{{π}_{0} {f}_{0} ( {z}_{i} )}{f ( {z}_{i} )} = \frac{{π}_{0} {f}_{0} ( {z}_{i} )}{{π}_{0} {f}_{0} ( {z}_{i} ) + {π}_{1} {f}_{1} ( {z}_{i} )} . \qquad ( 2 )$$

The null density was assumed to be standard normal (theoretical null) or normal with mean and variance estimated from the data (empirical null). The mixture density π₀f₀(z)+π₁f₁(z) (z) was estimated by fitting a high degree polynomial to histogram counts (Efron, 2010). If a set of SNPs are selected with an estimated fdr≦α for some αε 2 (0; 1), then on average (1−α)×100% of these will be true non-null SNPs.

Covariate-Modulated fdr

A set of external covariates observed for each hypothesis test may influence the distribution of the test statistic (Sun et al., 2006; Efron, 2010). Under this scenario, incorporating the covariate effects into fdr estimation can dramatically increase power for gene discovery. For example, the distribution of GWAS z-scores may depend on SNP-level functional annotations (Schork et al., 2013), pleiotropic relationships with related phenotypes (Andreassen et al.a, 2013; Andreassen et al.b, 2013), gene expression levels in certain tissues, evolutionary conservation scores, and so forth. These external covariates can be used to break the exchangeability assumption implicit in Eq. (1) and potentially increase the power for gene discovery over using standard local fdr given in Eq. (2).

Let xᵢ=(1, x₁ᵢ, x₂ᵢ, . . . , xₘᵢ)^{T}, where xi denotes an (m+1)-dimensional vector of covariates (including intercept) for the ith SNP. The cmfdr is defined as

$$\begin{matrix}cmfdr ( {z}_{i} ) = \frac{{π}_{0} ( {x}_{i} ) {f}_{0} ( {z}_{i} )}{f ( {z}_{i} \vert {x}_{i} )} \\ = \frac{{π}_{0} ( {x}_{i} ) {f}_{0} ( {z}_{i} )}{{π}_{0} ( {x}_{i} ) {f}_{0} ( {z}_{i} ) + {π}_{1} ( {x}_{i} ) {f}_{1} ( {z}_{i} \vert {x}_{i} )}\end{matrix} \qquad ( 3 )$$

where π₁(xᵢ)=1−π₀(xᵢ) is the prior probability that the ith test is non-null given xᵢ and fᵢ(zᵢ|xᵢ) is the non-null density of zi given xi. By Bayes' rule cmfdr is the posterior probability that the ith test is null given both zi and xi. It was assumed that the density under the null hypothesis does not depend on covariates. Both the probability of null status and the non-null density are allowed to depend on covariates, as described below.

Central to the estimation of the null proportion is the assumption that π0 is large (say greater than 0.90) and that the vast majority of SNPs with test statistics close to zero are in fact null. These assumptions are reasonable for GWA data (Hon-Cheong et al., 2010).

A Bayesian Two-Group Model

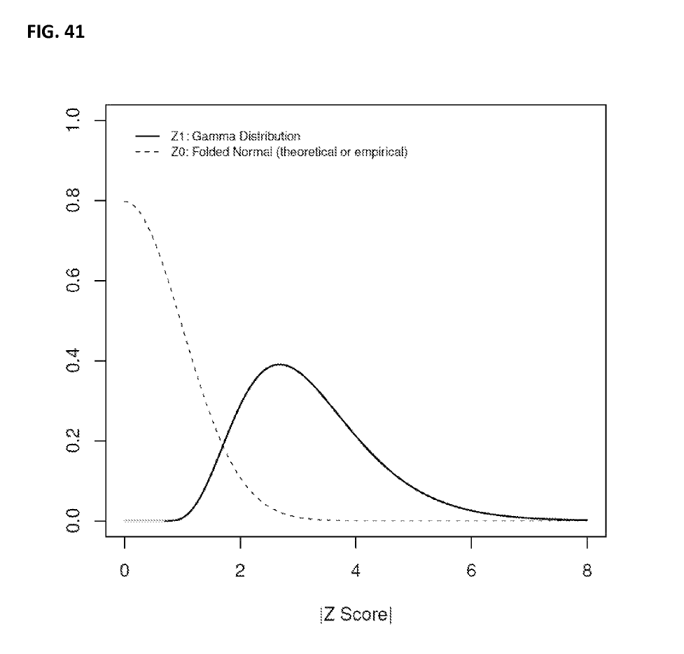

Summary statistics from GWAS are often made publicly available only as two-tailed p-values, and hence the magnitude of the z score is recoverable but not the sign. Moreover, the sign of the z score is a result of arbitrary allele coding. Hence, the mixture model was formulated for the absolute z-scores. The extension of the method to signed z-scores is straightforward. Folded Normal-Gamma Mixture Model The distribution of z under H₀ is assumed to have the folded normal distribution, with null density f₀(z)=φ_{σ0}(z)I_{z≧0}, where φ(z) is the normal density with mean zero and standard deviation σ0 and I_{z≧0} is an indicator function which takes the value 1 when z≧0 and 0 otherwise. The density of z under the alternative hypothesis H1 is assumed to have a gamma distribution with shape parameter a(x) and rate parameter β. FIG. 41 gives a graphic presentation of these distributions. A parametric non-null density was chosen for computational efficiency in modeling the effects of covariates. Parametric estimates of the non-null density also potentially provide more power than non-parametric estimates. The gamma density was chosen because of its flexible shape and ability to model right-skewed, heavy-tailed distributions. Covariates x are allowed to modulate the shape parameter of the gamma distribution α(x)=exp{x^{T}α} where α={α₀, α₁, α₂, . . . , αₘ}^{T} is an unknown parameter vector. The rate parameter β is an unknown scalar not depending on x. While it is possible to model the rate parameter as a function of x, it was found that this leads to poor model convergence in the sampling algorithm, perhaps due to lack of identifiability with other model parameters.

Additionally, a location parameter μ>0 was specified to bound the nonnull gamma densities away from zero. The “zero assumption” of Efron (2007) states that the central peak of the z-scores consists primarily of null cases. Such an assumption is necessary to make the non-null distribution identifiable and for the MCMC sampling algorithm to converge. The assumption that the vast majority of SNPs with z-scores close to zero are null is already commonly made in GWAS. Hence, the location parameter μ=0.68 is set in the gamma distribution, corresponding to the median of the null density f0. All SNPs with absolute z-scores less than 0.68 are thus a priori considered null.

The mixture model formulation was completed by positing a latent indicator δ=(δ₁, . . . , δₙ), where δi=1 if the ith SNP is non-null and zero otherwise. Then π1(xi) is the prior probability that δi=1 given covariates xi. The dependence of _{—}1 on x is modelled via a logistic regression

$${π}_{1} ( {x}_{i} ) = Pr ( {δ}_{i} = 1 \vert {x}_{i} ) = \frac{exp ( {x}_{i}^{T} γ )}{1 + exp ( {x}_{i}^{T} γ )} ,$$

where =z=(z₁, . . . , zₙ)^{T} is a vector of test statistics and X is a vector of unknown parameters.

The augmented likelihood function is then given by

$$L ( β , α , γ , {σ}_{0}^{2} \vert δ , z , X ) = {\prod }_{i = 1}^{n} ( {[ {f}_{0} ( {z}_{i} \vert {σ}_{0}^{2} ) {π}_{0} ( {x}_{i} \vert γ ) ]}^{1 - {δ}_{i}} \times {[ {f}_{1} ( {z}_{i} \vert β , α ) {π}_{1} ( {x}_{i} \vert γ ) ]}^{{δ}_{i}} ) , \qquad ( 4 )$$

where z=(z₁, . . . , zₙ)^{T} is the vector of test statistics and X is the n×(m+1) design matrix. Integrating out the latent indicators δ gives the mixture model corresponding to Eq. (3).

Prior Distributions Weakly-informative priors were applied to unknown parameters {β, α, γ, σ₀²}:

α˜N(0,Σ_{α}),

γ˜N(0,Σ_{γ}),

β˜Gamma(a₀,b₀),

σ₀²˜Inverse Gamma(a_{σ0},b_{σ0}), (5)

0 g

where Σ_{α} and Σ_{γ} have large values on the diagonal, a₀ and b= are shape and rate parameters of gamma distribution, and a_{—}0 and b_{—}0 are shape and scale parameters of inverse gamma distribution. Hyperparameters are fixed by the user. In the applications below, the dispersion matrices Σ_{α} and Σ_{γ} are set to be diagonal with variance 10,000; (a0; b0) and (a_{—}0; b_{—}0) were both set to (0.001,0.001).

Sampling Scheme The parameters sampled were α, β, γ and σ₀² in turn from their full conditional distributions via a Gibbs sampler using Metroplis-Hastings (M-H) steps. Combining (4) and (5), the full conditional distributions are given by:

$$f ( α \vert … ) ∝ [ {\prod }_{i : {δ}_{i} = 1} \frac{{\vert {z}_{i} - μ \vert}^{a ( {x}_{i} )}}{Γ ( a ( {x}_{i} ) )} {β}^{a ( {x}_{i} )} ] exp \{ - \frac{{α}^{T} {Σ}_{α}^{- 1} α}{2} \} \\ f ( γ \vert … ) ∝ [ {\prod }_{i = 1}^{n} \frac{exp {\{ {x}^{T} γ \}}^{{δ}_{i}}}{1 + exp \{ {x}^{T} γ \}} ] exp \{ - \frac{{γ}^{T} {Σ}_{γ}^{- 1} γ}{2} \} \\ f ( β \vert … ) ∝ {β}^{a 0 - 1 + {\sum }_{i : {δ}_{i} = 1} a ( {x}_{i} )} \times exp \{ - β ( {b}_{0} + {\sum }_{i : {δ}_{i} = 1} \vert {z}_{i} - μ \vert ) \} . \\ f ( {σ}_{0}^{2} \vert … ) ∝ [ {( {σ}_{0}^{2} )}^{- ( \frac{{\sum }_{i = 1}^{n} {I}_{( {δ}_{i} = 0 )}}{2} + {a}_{{σ}_{0}} + 1 )} ] \times exp \{ \frac{1}{{σ}_{0}^{2}} ( \frac{{\sum }_{i : {δ}_{i} = 0} {z}_{i}^{2}}{2} + {b}_{{σ}_{0}} ) \} \qquad ( 6 )$$

where I_{(β=0)} is an indicator function and f(| . . . ) denotes the probability density of a parameter conditional on all other parameters and the data. The full conditional posteriors for α and γ in (6) do not take standard forms and are sampled using a multiple-try M-H sampler (Givens and Hoeting, 2005) with a multivariate t-distribution candidate. The full conditional for β has a gamma distribution and for σ₀² an inverse gamma distribution, so that both can be sampled directly. Each iteration of the Gibbs sampler also includes generation of δ, with a Bernoulli full conditional distribution. For

$$k ∈ \{ 0 , 1 \}$$

$$p ( {δ}_{i} = k \vert … ) ∝ {{f}_{0} ( {z}_{i} \vert {σ}_{0}^{2} )}^{1 - k} {{f}_{1} ( {z}_{i} \vert a ( {x}_{i} ) , β )}^{k} \frac{{exp ( {x}_{i}^{T} γ )}^{k}}{1 + exp ( {x}_{i}^{T} γ )} .$$

One can obtain an a posteriori estimate of cmfdr(zi) for each zi as follows.

Assume that {(β⁽ⁱ⁾, α⁽ⁱ⁾, γ⁽ⁱ⁾, σ₀²⁽ⁱ⁾) <1≦i≦L} from the posterior distribution of the parameters. For each draw 1

$${cmfdr}^{( l )} ( {z}_{i} ) = \frac{{π}_{0} ( {x}_{i} \vert {γ}^{( l )} ) {f}_{0} ( {z}_{i} \vert {σ}_{0}^{2 ( l )} )}{{π}_{0} ( {x}_{i} \vert {γ}^{( l )} ) {f}_{0} ( {z}_{i} \vert {σ}_{0}^{2 ( l )} ) + {π}_{1} ( {x}_{i} \vert {γ}^{( l )} ) {f}_{1} ( {z}_{i} \vert {β}^{( l )} , a ( {x}_{i} \vert {α}^{( l )} ) )} .$$

Then, for example, the posterior median of cmfdr(zi) can be estimated by taking the median of cmfdr(1)(zi) across all L posterior draws. The algorithm has been implemented in the R statistical package.

### Results

Simulation

Phenotypes were simulated under different settings of generative parameters from real genotype data obtained in n=3,719 healthy individuals. For each permutation of simulation settings 100 unique phenotypes were generated. The simulations were restricted to chromosome 1 (N=191,128 SNPs) for computational efficiency, assuming it was representative of the whole genome. These simulations allow us to evaluate the performance of the method in scenarios that approximate realistic GWAS conditions, including correlated SNPs according to true linkage disequilibrium (LD) patterns.

Table 29 displays the number of SNPs rejected and the False Discovery Proportion (FDP), or the proportion of rejected SNPs not in LD with a causal SNP. The cmfdr performs reasonably well across enrichment settings for more highly polygenic phenotypes, rejected SNPs conservatively for 1=0:05, but becoming progressively worse at controlling the FDP for phenotypes with low 1. In comparison, the fdr of Efron (2007) is much more conservative over the entire range of 1, but also has less power. The 2 mixture model of Lewinger et al. (2007) is performs similarly to that of cmfdr, but does not control fdr throughout the range of 1 considered. In particular, their model is very unstable for null GWAS, and performs poorly in the presence of population stratification; if no genomic control (GC) is applied (Devlin and Roeder, 1999), the Lewinger et al. (2007) method rejects far too many SNPs. If standard GC is applied, their method becomes overly conservative, as seen in the real data analysis below.

TABLE 29

| | | | fdr | cmfdr |
|---|---|---|---|---|
| Enrich. | Strat. | π₁ | Rejected | FDP |
| None | None | 0.00 | 1 [0, 5] | 1.00 [0.00, 1.00] |
| None | Low | 0.00 | 4 [0, 15] | 1.00 [0.00, 1.00] |
| High | None | 0.001 | 90 [63, 132] | 0.28 [0.13, 0.41] |
| High | Low | 0.001 | 17 [5, 47] | 0.46 [0.21, 0.67] |
| Low | None | 0.001 | 92 [62, 149] | 0.30 [0.00, 0.46] |
| Low | Low | 0.001 | 17 [4, 77] | 0.44 [0.00, 0.70] |
| None | None | 0.001 | 79 [45, 137] | 0.25 [0.11, 0.42] |
| None | Low | 0.001 | 19 [4, 70] | 0.55 [0.19, 0.79] |
| High | None | 0.01 | 60 [16, 124] | 0.11 [0.00, 0.23] |
| High | Low | 0.01 | 8 [1, 28] | 0.14 [0.00, 1.00] |
| Low | None | 0.01 | 43 [17, 101] | 0.10 [0.00, 0.20] |
| Low | Low | 0.01 | 9 [1, 38] | 0.23 [0.00, 0.67] |
| None | None | 0.01 | 7 [1, 19] | 0.00 [0.00, 0.17] |
| None | Low | 0.01 | 6 [1, 18] | 0.25 [0.00, 0.85] |
| High | None | 0.05 | 47 [18, 101] | 0.00 [0.00, 0.07] |
| High | Low | 0.05 | 8 [1, 27] | 0.00 [0.00, 0.23] |
| Low | None | 0.05 | 39 [8, 106] | 0.00 [0.00, 0.07] |
| Low | Low | 0.05 | 8 [2, 25] | 0.00 [0.59, 0.23] |
| None | None | 0.05 | 4 [0, 17] | 0.00 [0.00, 0.17] |
| None | Low | 0.05 | 4 [0, 15] | 0.00 [0.00, 1.00] |

Median number of SNPs rejected (Rejected) and False Discovery Proportion (FDP) for the proposed cmfdr methodology. Settings include level of covariate enrichment (Enrich.), level of population statification (Strat.), and level of polygenicity (π1). Numbers in brackets give middle 95% of distributions across 100 simulations for each setting.

Real Data Application

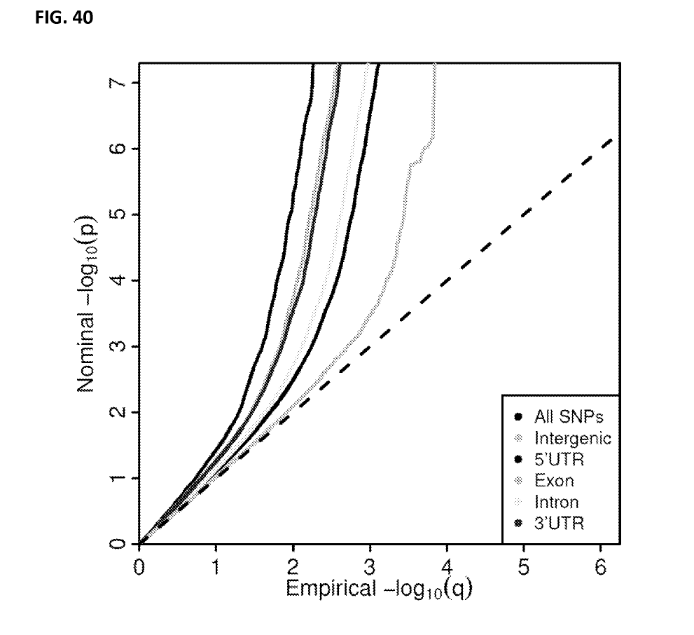

The data consist of n=942,772 SNP summary test statistics (SNP z-scores) from a GWAS meta-analysis of eight sub-studies of Crohn's Disease (CD) on a total of 51,109 subjects, obtained through a publicly accessible database Franke et al. (2010). CD is a type of inflammatory bowel disease that is caused by multiple factors in genetically susceptible individuals. For this example the five SNP annotations from Schork et al. (2013) displayed in FIG. 40 were selected to serve as covariates: intron, exon, 3′UTR, 5′UTR, and intergenic. All were standardized to have zero mean and unit standard deviation. These were entered together into the covariate-modulated mixture model, with the empirical null setting. The MCMC algorithm was run for 2,500 iterations with 250 retained draws; taking approximately 50 hours to run on a 2.6 GHz Intel Core 17 processor with 8 GB 1600 MHz DDR3 memory.

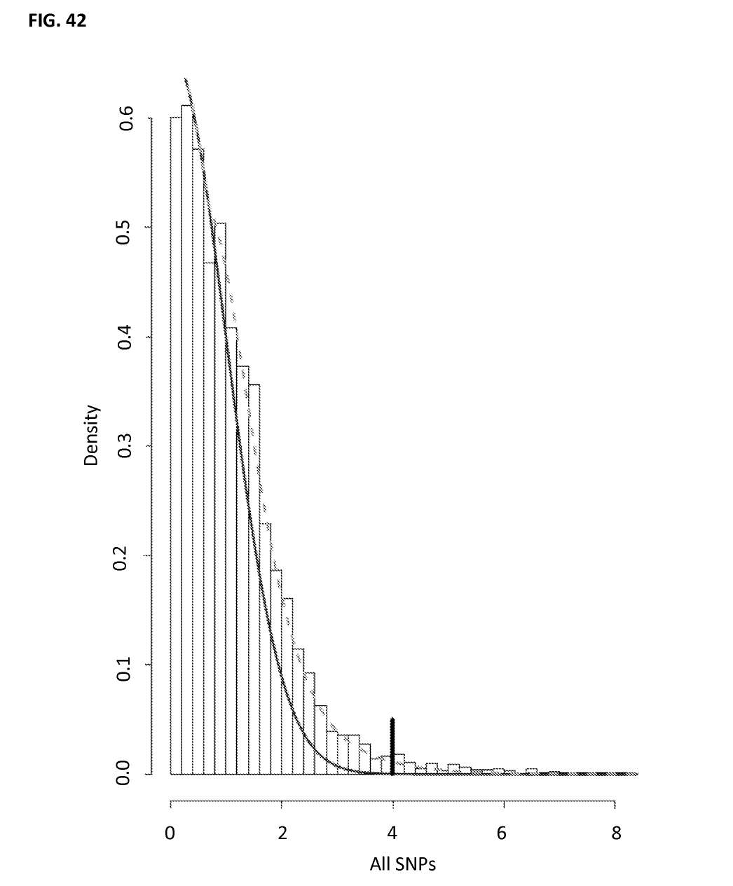

Plots of posterior draws showed convergence to stable posterior distributions for all parameters. FIG. 42 shows the histogram of z-scores (all cases), the null subdensity π₀f₀α, and the posterior median fit of the mixture density. The fdr for each z score is given by the height of the null subdensity at that score divided by the height of the mixture density. The parameter estimates are shown in Table 30. The exon and 5′UTR categories are associated with higher values of the shape parameter (and hence higher variance). Intron, exon, 3′UTR and 5′UTR are all associated with higher probability of nonnull status. In contrast, intergenic SNPs are associated with lower values of the shape parameter and much lower probability of non-null status. The estimated non-null proportion x₁ is exp{−2.27}/exp{−2.27}+1)=0:094, or very highly polygenic.

The proposed cmfdr methodology rejected far more SNPs than fdr (Efron, 2007). For example, for a 0.05 cut-off, cmfdr rejects 2,742 SNPs whereas fdr rejects only 592. The Lewinger et al. (2007) method rejected 782 SNPs with the same cut-off. The lower number of rejected SNPs compared to cmfdr is due in part to the combination of GC and the lack of empirical null option with their methodology (Lewinger et al., 2007).

The 2,742 SNPS consisted of 108 independent loci (leading SNP cmfdr≦0:05 and more than 1 Mb apart from each other). Of these 108 independent loci, 66 had been previously described in Franke et al. (2010). Franke et al. (2010) described an additional 5 loci that were not discovered using a 0:05 cut-off; however, in this analysis, each of these loci had a cmfdr<0:06. 42 novel loci where the leading SNP had a cmfdr≦0:05. To demonstrate that the method identifies candidate SNPs pleiotropy analysis was performed. Given that Crohn's disease is known to share etiology, including pleiotropic genetic factors (Cho and Brant, 2011) with Ulcerative Colitis (UC), it is likely that causal SNPs would show joint associations. Significant enrichment was found for nomial associations (p<0:05) with UC (Anderson et al., 2011) for both the 71 previously discovered loci (bonferroni adjusted hypergeometric p-value=1.33×10⁻³⁶) and the 42 novel loci (bonferroni adjusted hypergeometric p-value=6.24×10⁻⁵).

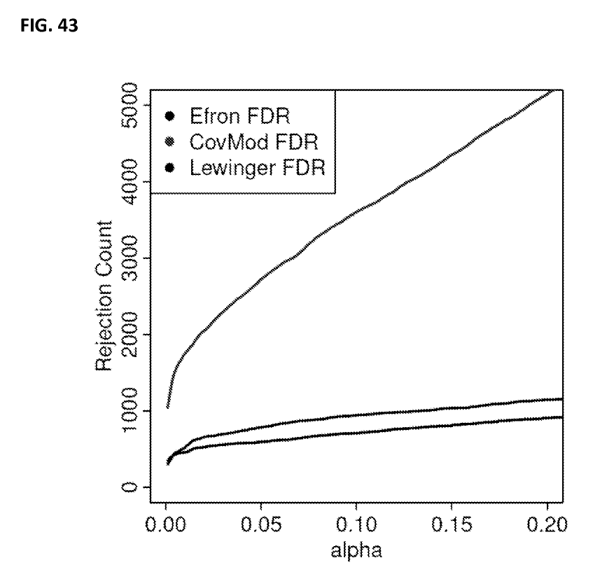

Power to detect non-null SNPs using cmfdr vs. usual fdr is displayed in FIG. 43. This figure compares the number of non-null SNPs rejected using usual fdr to cmfdr with the five annotation categories. Usual fdr was estimated using the locfdr library (Efron et al., 2011) employing the theoretical null option and default values for other inputs. The increase in power across a range of cut-offs ([0:001; 0:20]) is dramatic. For example, for cut-off 0:05, fdr rejects an estimated 1,952 non-null SNPs, whereas cmfdr rejects 3,449, or 77% more non-null SNPs. Proportionally similar increases are observed across the range of fdr cut-offs.

Further analyses was performed on CD substudies to determine whether this observed increase in power translates to increased replication rates in de novo samples. The CD meta-analysis was composed of summary statistics from eight substudies (Franke et al., 2010). Z-scores were computed from each of the 70 possible combinations of four substudies, leaving the z-scores computed from the remaining four independent substudies as test samples. Fdr and cmfdr were then estimated for each training sample. For a given fdr cut-off, the number of SNPs that replicated in the test sample was determined. Replication was defined as p≦0:05 and with the same sign as the corresponding z score in the training sample.

Number of replicated SNPs was much higher using cmfdr compared to fdr. For example, for usual fdr there was an average of 192 replicated SNPs (44% of SNPs declared significant) with an fdr cut-off of 0:05 in the training sample. In contrast, with the same cut-off using cmfdr there was an average of 1,068 SNPs (47% of declared significant SNPs) that replicated according to this definition, or almost 5.6 times as many SNPs. Similar increases in number of replicated SNPs were observed for other cutoffs in the range. Note, replication rates (44% and 47%) were much lower than the nominal fdr level of 0:05 would suggest. This is due to a significant degree of heterogeneity in the substudies (Franke et al., 2010), as well as limited sample sizes. For comparison, the usual GWAS threshold of 5×10⁼⁸ resulted in an average of 89 replicated SNPs, comprising 54% of declared significant SNPs from the training samples. In general, fdr provides a conservative estimate of the non-replication rate in an infinitely sized replication sample from a population like that of the training sample. Application of the cmfdr methodology in other GWAS samples with more homogeneous training and test sets has lead to replication rates much closer to nominal levels while maintaining large advantages in number of replicated SNPs over usual fdr.

TABLE 30

| Parameter | \hat{α} | | \hat{γ} | |
|---|---|---|---|---|
| Intercept | 0.62 | [0.60, 0.65] | −2.27 | [−2.29, −2.25] |
| Intron | −0.012 | [−0.015, −0.009] | 0.15 | [0.14, 0.16] |
| Exon | 0.046 | [0.039, 0.053] | 0.02 | [0.01, 0.03] |
| 3′UTR | −0.010 | [−0.013, −0.002] | 0.11 | [0.10, 0.12] |
| 5′UTR | 0.05 | [0.04, 0.06] | 0.03 | [0.01, 0.04] |
| Intergenic | −0.03 | [−0.04, −0.02] | −0.19 | [−0.22, −0.17] |
| Rate Parameter (\hat{β}) | 1.50 | [1.48, 1.53] | | |

All estimates are presented in the form of median [95% credible interval]

### REFERENCES

Anderson, C. A. and Boucher, G. and Lees, C. W. and et al. (2011). Meta-analysis identifies 29 additional ulcerative colitis risk loci, increasing the number of confirmed associations to 47. Nature Genetics, 43, 246-252.
Andreassen, O. A., Djurovic, S., Thompson, W. K., Schork, A. J., Kendler, K. S., O'Donovan, M. C., Rujescu, D., Werge, T., van de Bunt, M., Morris, A. P., McCarthy, M. I., Roddey, J. C., McEvoy, L. K., Desikan, R. S. and Dale. A. M. (2013). Improved detection of common variants associated with schizophrenia by leveraging pleiotropy with cardiovascular disease risk factors. American Journal of Human Genetics, 7, 197-209.
Andreassen, O. A., Thompson, W. K., Ripke, S., Schork, A. J., Mattingsdal, M., Kelsoe, J., Kendler, K. S., O'Donovan, M. C., Rujescu, D., Werge, T. and Sklar, P., The Psychiatric Genomics Consortium (PGC) Bipolar Disorder and Schizophrenia Working Groups, Roddey, J. C., Chen, C. H., Desikan, R. S., Djurovic, S., Dale, A. M. (2013). Improved detection of common variants associated with schizophrenia and bipolar disorder using pleiotropy-informed conditional False Discovery Rate method. PLoS Genetics, 9, e1003455.
Benjamini, Y. and Hochberg, Y. (1995). Controlling the False Discovery Rate: A Practical and Powerful Approach to Multiple Testing. Journal of the Royal Statistical Society, Series B (Methodological), 57(1),289-300.
Brown, L., Gans, N., Mandelbaum, N. G. A., Sakov, A., Shen, H., Zeltyn, S. and Zhao, L. (2005). Statistical Analysis of a Telephone Call Center: A Queueing-Science Perspective. Journal of American Statistical Association, 100, 36-50.
Cho, J. H. and Brant, S. R. (2011). Recent insights into the genetics of inflammatory bowel disease. Gastroenterology 140, 1704-1712.
Collins F. (2010). Has the revolution arrived? Nature, 464, 674-675.
Devlin, B. and Roeder, K. (1999). Genomic Control for Association Studies, Biometrics, 55(4),997-1004.
Efron, B. (2007). Size, Power and False Discovery Rates. The Annals of Statistics, 35(4),1351-1377.
Efron, B. (2010). Large-Scale Inference: Empirical Bayes Methods for Estimation, Testing, and Prediction (Cambridge: Cambridge University Press).
Efron, B. and Tibshirani, R. (2002). Empirical Bayes Methods and False Discovery Rates for Microarrays. Genetic Epidemiology, 23, 70-86.
Efron, B. and Turnbull, B. B. and Narasimhan, B. (2011). R package locfdr.
The ENCODE Consortium (2012). An integrated encyclopedia of DNA elements in the human genome, Nature 489, 57-74.
Ferkingstad, E., Frigessi, A., Rue, H., Thorleifsson, G., Kong, A. (2008). Unsupervised Empirical Bayesian Multiple Testing with External Covariates. The Annals of Applied Statistics, 2(2),714-735.
Franke, A., McGovern, D. P., Barrett, J. C., Wang, K., Radford-Smith, G. L., Ahmad, T., Lees, C. W., Balschun, T., Lee, J., Roberts, R., et al. (2010). Genome-wide metaanalysis increases to 71 the number of confirmed Crohn's disease susceptibility loci. Nature Genetics, 42, 1118-1125.
Genovese, C. R., Lazar, N. A. and Nichols, T. (2002). Thresholding of Statistical Maps in Functional Neuroimaging Using the False Discovery Rate. NeuroImage, 15, 870-878.
Givens, G. H. and Hoeting, J. A. (2005). Computational statistics (Vol. 483) (Wiley-Interscience Press).
Hindorff, L. A., Sethupathy, P., Junkins, H. A., Ramos, E. M., Mehta, J. P., Collins, F. S. and Manolio, T. A. (2009). Potential etiologic and functional implications of genome-wide association loci for human diseases and traits. Proc Natl Acad Sci USA 106, 9362-9367.
Hon-Cheong, H., Yip, B. H. K. and Sham, P. C. (2010). Estimating the total number of susceptibility variants underlying complex diseases from genome-wide association studies. PloS One 5, e13898.
Lawyer, G., Ferkingstad, E., Nesvag, R., Varnas, K. and Agartz, I. (2009). Local and Covariate-Modulated False Discovery Rates Applied in Neuroimaging. NeuroImage, 47, 213-219.
Lewinger, J. P. and Conti, D. V. and Baurley, J. W. and Triche, T. J. and Thomas, D. C. (2007). Hierarchical Bayes prioritization of marker associations from a genomewide association scan for further investigation. Genetic Epidemiology, 31, 871-883.
Li, H., Wei, Z. and Maris, J. (2010). A hidden Markov random field model for genomewide association studies. Biostatistics 11, 139-150.
Manolio, T. A., Collins, F. S., Cox, N. J., Goldstein, D. B., Hindorff, L. A., Hunter, D. J., McCarthy, M. I., Ramos, E. M., Cardon, L. R., Chakravarti, A., et al. (2009). Finding the missing heritability of complex diseases. Nature 461, 747-753.
Miller, C. J., Genovese, C., Nichol, R. C., Wasserman, L., Connolly, A., Reichart, D., Hopkins, A, Schneider, J. and Moore, A. (2001). Controlling the False Discovery Rate in Astrophysical Data Analysis. Astronomical Journal, 122(6),3492-3505.
Ploner, A., Calza, S., Gusnanto, A. and Pawitan, Y. (2006). Multidimensional local false discovery rate for microarray studies. Bioinformatics 22, 556-565.
Ripke, S. and Sanders, A. R. and Kendler, K. S. and et al. (2011). Genome-wide association study identifies five new schizophrenia loci. Nature Genetics, 43, 969-976.
Risch, N. and Merikangas, K. (1996). The future of genetic studies of complex human diseases. Science, 255, 1516-1517.
Schork, A. J., Thompson, W. K., Pham, P., Torkamani, A., Roddey, J. C., Sullivan, P. F., Kelsoc, J. R., Purcell, S. R., O'Donovan, M. C., Tobacco Consortium, Bipolar Disorder Psychiatric Genome-Wide Association Study (GWAS) Consortium, Schizophrenia Psychiatric Genome-Wide Association Study (GWAS) Consortium,
Schork, N. J., Andreassen, O. A. and Dale, A. M. Genetic architecture of the missing heritability for complex human traits and diseases. PLoS Genetics, 9, e1003449.
Smith, E. N., Koller, D. L., Panganiban, C., Szelinger, S., Zhang, P., Badner, J. A., Barrett, T. B., Berrettini, W. H., Bloss, C. S., Byerley, W., et al. (2011). Genome-wide association of bipolar disorder suggests an enrichment of replicable associations in regions near genes. PLoS Genetics 7, e1002134.
Sun. L., Craiu, R. V., Paterson, A. D. and Bull, S. B. (2006). Stratified false discovery control for large-scale hypothesis testing with application to genome-wide association studies. Genetic Epidemiology 30, 519-530.
Torkamani, A., Scott-Van Zeeland, A. A., Topol, E. J. and Schork, N. J. (2011) Annotating individual human genomes. Genomics 98: 233-241.
Tusher, V. G., Tibshirani, R. and Chu, G. (2001). Significance Analyses of Microarrays Applied to the Ionizing Radiation Response. Proceedings of the National Academy of Sciences of the Unite State of America (PNAS), 98(9),5116-5121.
Yang. B., Benyamin, B., McEvoy, B. P., Gordon, S., Henders, A. K., Nyholt, D. R., Madden, P. A., Heath, A. C., Martin, N. G., Montgomery, G. W., et al. (2010). Common SNPs explain a large proportion of the heritability for human height. Nature Genetics, 42, 565-569.

### Example 6

### Material and Methods

Participant Samples

Summary statistics from a large MS GWAS study performed by IMSGC (15), n=27 148, and from two large GWAS studies from the Psychiatric GWAS Consortium (PGC), PGC Schizophrenia sample (7), n=21 856, PGC Bipolar disorder sample (12), n=16 731. P-values and minor allele frequencies from the discovery samples were included in the analyses. For follow up analysis, the PGC Major depressive disorder (MDD)(25), Autism Spectrum Disorder (AUT)(26) and Attention Deficit/Hyperactivity Disorder (ADHD) (27) GWAS summary statistics were utilized.

Statistical Analyses

Conditional Q-Q Plots for Pleiotropic Enrichment

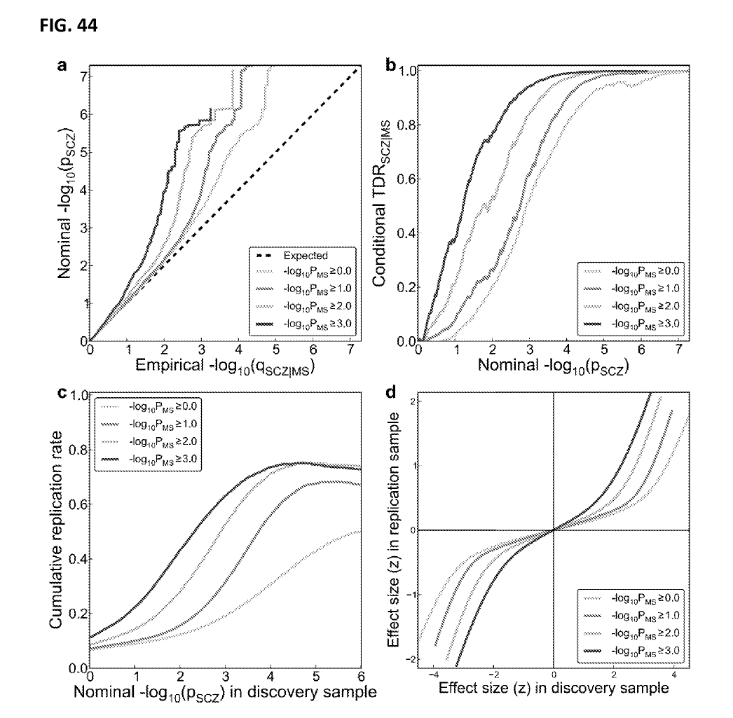

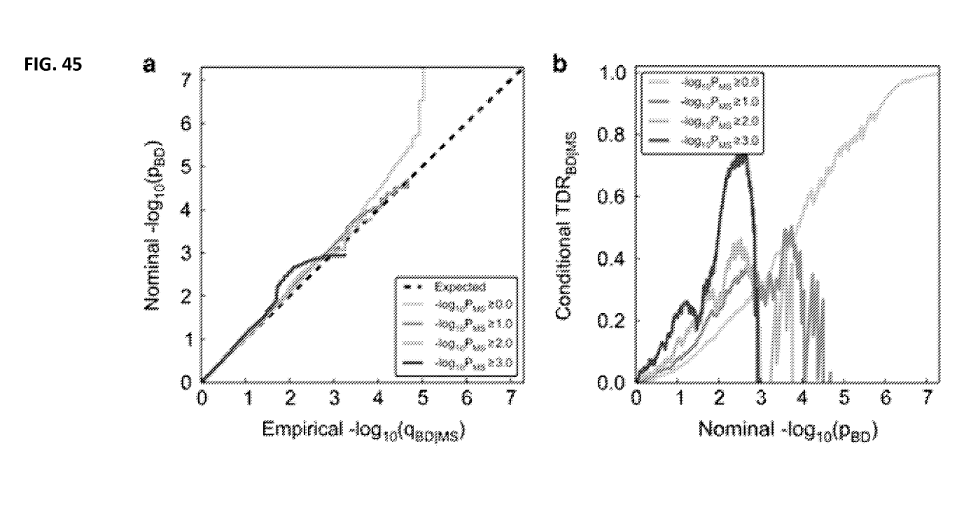

To visually assess pleiotropic enrichment, Q-Q plots conditioned on ‘pleiotropic’ effects (13, 23) (FIG. 1a and FIG. 2a for BD) were used. For a given associated phenotype, pleiotropic ‘enrichment’ exists if the degree of deflection from the expected null line is dependent on associations with the second phenotype. Conditional Q-Q plots of empirical quantiles of nominal −log 10(p) values were constructed for all SNPs and for subsets of SNPs determined by the significance of their association with MS. Specifically, the empirical cumulative distribution function (ecdf) of nominal p-values was computed for a given phenotype for all SNPs and for SNPs with significance levels below the indicated cut-offs for the other phenotype (−log 10(p)≧0, −log 10(p)≧1, −log 10(p)≧2, −log 10(p)≧3 corresponding to p≦1, p≦0.1, p≦0.01, p≦0.001, respectively). Nominal pvalues (−log 10(p)) are plotted on the y-axis, and empirical quantiles (−log 10(q), where q=1−ecdf(p)) are plotted on the x-axis. To assess polygenic effects below the standard GWAS significance threshold, the Q-Q plots were focused on SNPs with nominal −log 10(p)<7.3 (corresponding to p>5×10-8). The same procedure was used for BD. The ‘enrichment’ seen in the conditional Q-Q plots can be directly interpreted in terms of true discovery rate (TDR=1−FDR) (280. This is illustrated in FIG. 44b and FIG. 45b for each range of p-values in the pleiotropic traits.

Conditional Replication Rate

For each of the 17 sub-studies contributing to the final meta-analysis in SCZ, the z-scores were independently adjusted using intergenic inflation control (29). 1000 combinations of eight and nine sub-study groupings were randomly sampled. The eight-or-nine-study combined discovery zscore and eight-or-nine-study combined replication z-score was calculated for each SNP as the average z-score across the sub-studies multiplied by the square root of the number of studies. For discovery samples the zscores were converted to two-tailed p-values, while replication samples were converted to one-tailed pvalues preserving the direction of effect in the discovery sample. For each of the 1000 discovery replication pairs cumulative rates of replication were computed over 1000 equally-spaced bins spanning the range of −log 10(p-values) observed in the discovery samples. The cumulative replication rate for any bin was the proportion of SNPs with a −log 10 (discovery p-value) greater than the lower bound of the bin with a replication p-value<0.05 and the same sign as the discovery sample. Cumulative replication rates were calculated independently for each of the four pleiotropic enrichment categories. For each category, the cumulative replication rate for each bin was averaged across the 1000 discovery-replication pairs and the results are reported in FIG. 44c. The vertical intercept in the figure is the overall replication rate.

Conditional Replication Effect Size

Using the same z-score adjustment scheme and sampling method used for estimating cumulative replication rates (see above), the relationship of replication effect size of the discovery sample versus replication samples (FIG. 1d) was evaluated for each SNP. The effect sizes were conditioned on various enrichment categories. For visualization a cubic spline relating the bin mid-point of Z-scores of discovery was fitted to the corresponding average replication z-scores (FIG. 1d).

Improving Discovery of SNPs in SCZ and BD Using Conditional FDR

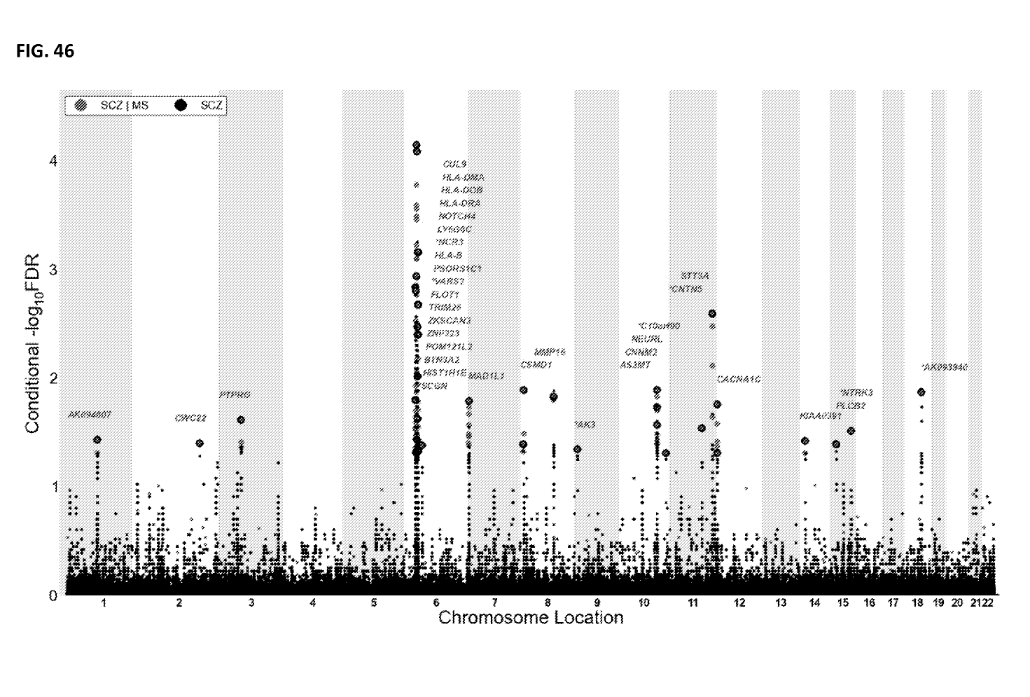

To improve detection of SNPs associated with SCZ and BD, a genetic epidemiology approach was employed, leveraging the MS phenotype from an independent GWAS using conditional FDR as outlined in Andreassen (13, 23). Specifically, conditional FDR is defined as the posterior probability that a given SNP is null for the first phenotype given that the p-values for both phenotypes are as small as or smaller than their observed p-values. A conditional FDR value for each SNP in SCZ given the p-value in MS (denoted as FDRSCZ|MS). The same procedure was applied to compute FDRBD|MS for each SNP. To display the localization of the genetic markers associated with SCZ and BD given the MS effect, a ‘Conditional Manhattan plot’, plotting all SNPs within an LD block in relation to their chromosomal location was used. As illustrated for SCZ in FIG. 46, the large points represent the significant SNPs (−log 10(FDRSCZ|MS)>1.3 equivalent to FDRSCZ|MS<0.05), whereas the small points represent non-significant SNPs. All SNPs are shown without ‘pruning’ (e.g., without removing all SNPs with r2>0.2 based on 1000 Genome Project (1KGP) linkage disequilibrium (LD) structure). The strongest signal in each LD block is illustrated with a black line around the circles. This was identified by ranking all SNPs in increasing order, based on the FDRSCZ|MS value and then removing SNPs in LD r2>0.2 with any higher ranked SNP. Thus, the selected locus was the most significantly associated with SCZ in each LD block.

Annotation of Novel Loci

Based on 1KGP linkage disequilibrium (LD) structure, significant SNPs identified by conditional FDR were clustered into LD blocks at the LD−r2>0.2 level. These blocks are numbered (locus #) in Tables 31 and 32. Any block may contain more than one SNP. Genes close to each SNP were obtained from the NCBI gene database. Only blocks that did not contain previously reported SNPs or genes related to previously reported SNPs were deemed as novel loci in the current study (Tables 31 and 32). Loci that contained either SNPs or genes known to be associated with SCZ were considered as replication findings.

HLA Allele Analysis

The PGC1 genotype data from the 17 sub-studies were used for HLA imputation (a detailed description of the datasets, quality control procedures, imputation methods, and, principal components estimation, are given in reference 7). First, genotypes of SNPs in the extended MHC (Major Histocompatibility Complex) (chr6: 25652429-33368333) of each individual in all the samples were extracted. Then, the program HIBAG30 was used to impute genotypes of classical HLA alleles for each sample separately, using the parameters trained on the Scottish 1958 birth cohort data. HLA alleles with posterior probabilities≧0.5 and frequency>0.01 were used in subsequent analysis. The genotypes of the 63 HLA alleles meeting these criteria were encoded as binary variables for the following conditional analysis.

Samples with imputed HLA genotypes were combined before the analysis. First, the logistic regression method implemented in PLINK31 was employed to test HLA alleles for associations with SCZ, using the first 5 principal components and sample indicator variable as covariates. After Bonferroni correction, 5 alleles passed the genomic significance threshold (7.9×10-4). The dosages of SNPs in the MHC, imputed based on HapMap3 data, were tested using logistic regression. The analysis was first performed with only sample indicator variables and the first 5 principal components as covariates and then including, in turn, one of the significant HLA alleles from the previous step as an additional covariate. In addition to the SCZ associated HLA alleles, 4 other alleles reported to be associated with MS were also tested in this framework. A large increase in a SNP's association p-value upon conditioning on HLA alleles is considered to indicate overlap with that HLA allele (Supplementary FIG. 5).

Conditional Q-Q Plots

Q-Q plots compare a nominal probability distribution against an empirical distribution. In the presence of all null relationships, nominal p-values form a straight line on a Q-Q plot when plotted against the empirical distribution. For each phenotype, for all SNPs and for each categorical subset (strata), −log 10 nominal p-values were plotted against −log 10 empirical p-values (conditional Q-Q plots). Leftward deflections of the observed distribution from the projected null line reflect increased tail probabilities in the distribution of test statistics (z-scores) and consequently an over-abundance of low p-values compared to that expected by chance, also named ‘enrichment’.

Conditional True Discovery Rate (TDR)

The ‘enrichment’ seen in the conditional Q-Q plots can be directly interpreted in terms of true discovery rate (TDR=1−FDR). More specifically, for a given p-value cutoff, the FDR is defined as

FDR(p)=π₀F₀(p)/F(p), [1]

where π0 is the proportion of null SNPs, F0 is the null cumulative distribution function (cdf), and F is the cdf of all SNPs, both null and non-null7. Under the null hypothesis, F0 is the cdf of the uniform distribution on the unit interval [0,1], so that Eq. [1] reduces to

FDR(p)=π₀p/F(p), [2].

The cdf F can be estimated by the empirical cdf q=Np/N, where Np is the number of SNPs with pvalues less than or equal to p, and N is the total number of SNPs. Replacing F by q in Eq. [2],

Estimated FDR(p)=π₀p/q, [3],

which is biased upwards as an estimate of the FDR32. Replacing π0 in Equation [3] with unity gives an estimated FDR that is further biased upward;

q=p/q [4].

If π0 is close to one, as is likely true for most GWASs, the increase in bias from Eq. [3] is minimal. The quantity 1−p/q, is therefore biased downward, and hence a conservative estimate of the TDR. Referring to the Q-Q plots, q* is equivalent to the nominal p-value divided by the empirical quantile, as defined earlier. The FDR estimate is ready directly off the Q-Q plot as

−log 10(q*)=log₁₀(q)−log₁₀(p), [5]

e.g., the horizontal shift of the curves in the Q-Q plots from the expected line x=y, with a larger shift corresponding to a smaller FDR. This is illustrated in FIG. 1a. For each range of p-values in the pleiotropic trait (indicated by differently colored curves), the TDR was calculated as a function of the p-value in SCZ and reported it in FIG. 44b (FIG. 45 for BD).

Further Analyses Performed

Significance of Conditional Enrichment

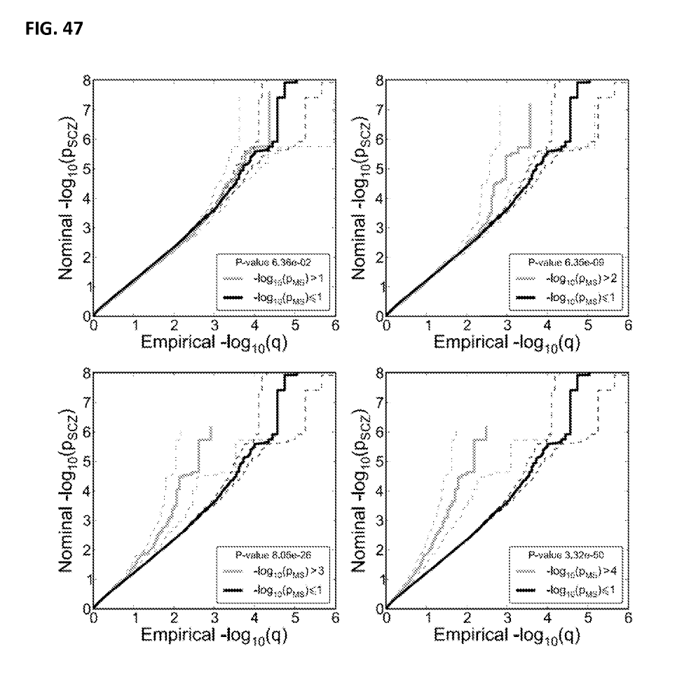

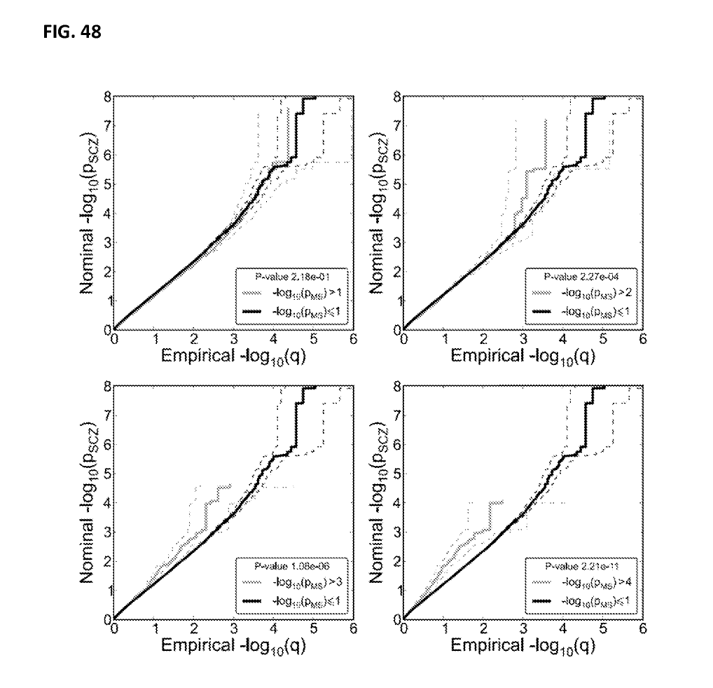

After pruning the SNPs by removing SNPs in linkage disequilibrium (r2≧0.2), 95% confidence intervals were calculated for the conditional Q-Q plots. From these confidence intervals standard errors were calculated and two sample t-tests were used to estimate the difference (degree of departure) of the empirical distribution of SNPs in SCZ or BD (phenotype 1) that are above a given association threshold (−log 10(p)≧1, −log 10(p)≧2, −log 10(p)≧3, −log 10(p)≧4; red lines) in MS (phenotype 2) compared to the −log 10(p)≧0 in phenotype 1 category (blue line). The same procedure was used for the “censored data” of MS conditional on SCZ. FIGS. 47 and 48 indicate the most significant difference, as assessed using a two samples t-test, between the red (−log 10(p)>1, 2, 3 or 4) and blue (−log 10(p)>0) lines along with p-values. This is reflected in the biggest difference between the 95% confidence intervals.

Conditional Analysis of HLA Alleles

It was tested if the associated HLA signals were independent of each other by conditional analysis between them. Samples with imputed HLA allele genotypes were combined before the analysis. The logistic regression method implemented in PLINK8 was employed to test each significant HLA allele for associations with SCZ, including another significant HLA allele, the first 5 principal components and sample indicator variable as covariates. It is more probable that the observed associations were driven by a single haplotype-block, consisting of the 5 individual HLA alleles.

The Effect of HLA Region on Enrichment

The enrichment method was reapplied to the same dataset with SNPs either located within the HLA region or in LD (r2>0.2) with such SNPs (in total 9379 SNPs). These results indicate that the enrichment of SCZ conditional on MS is largely the consequence of the HLA region (Supplementary FIG. 6a) whereas, the enrichment pattern of BD is unaffected by the absence of the HLA region. This further confirms the important role of HLA region in SCZ pathology. To further evaluate the role of the HLA region in SCZ and BD, SNPs located within the 5 HLA genes, which were shown to associate with SCZ by above conditional analysis, and other SNPs that in LD (r2>0.2) with such SNPs (in total 3480 SNPs) were removed. In this setting, genetic enrichment in both SCZ and BD was unaffected (Supplementary FIG. 6b). This corroborates the result of the conditional analysis of HLA allele that the SNPs revealed by the pleiotropic enrichment methods are independent of the known alleles comprising the HLA region.

### Results

Enrichment of SCZ SNPs Due to Association with MS—Conditional Q-Q Plots

Conditional Q-Q plots for SCZ given level of association with MS (FIG. 44a) show variation in enrichment. Earlier (and steeper) departures from the null line (leftward shift) with higher levels of association with MS indicate a greater proportion of true associations (FIG. 44b) for a given nominal pvalue. The divergence of the curves for different conditioning subsets thus indicates that the proportion of non-null effects varies considerably across different degrees of association with MS. For example, the proportion of SNPs in the −log 10(pMS)≧3 category reaches a given significance level (−log 10(pSCZ)>6) that is roughly 50-100 times greater than for the −log 10(pMS)≧0 category (all SNPs), indicating considerable enrichment. The enrichment was significant after pruning, as shown by the Q-Q plots with confidence intervals given in FIG. 47. The enrichment also remained significant after removing the SNPs with genome-wide significant p-values (censored Q-Q plots. FIG. 48). In contrast, no evidence was found for enrichment in BD conditional on MS (FIG. 2).

Association with MS Increases Conditional True Discovery Rate (TDR) in SCZ

Variation in enrichment in pleiotropic SNPs is associated with corresponding variation in conditional TDR, equivalent to one minus the conditional FDR (28). A conservative estimate of the conditional TDR for each nominal p-value is equivalent to 1−(p/q) as plotted on the conditional Q-Q plots (see Methods). This relationship is shown for SCZ conditioned on MS in a conditional TDR plot (FIG. 44b; TDR SCZ|MS, and for BD FIG. 45b; TDRBD|MS). For a given conditional TDR, the corresponding estimated nominal p-value threshold varied by a factor of 100 from the most to the least enriched SNP category for SCZ conditioned by MS. Since the conditional TDR is strongly related to predicted replication rate, the replication rate is expected to increase for SNPs in categories with higher conditional TDR.

Replication Rate in SCZ is Increased by MS Association

To address the possibility that the observed pattern of differential enrichment results from spurious (e.g., non-generalizable) associations due to category-specific stratification or statistical modeling errors, the empirical replication rate was examined across independent sub-studies for SCZ. FIG. 44c shows the empirical cumulative replication rate plots as a function of nominal p-value, for the same categories as for the conditional Q-Q and TDR plots in FIG. 44a and b. Consistent with the conditional TDR pattern, it was found that the nominal p-value corresponding to a wide range of replication rates was 100 times higher for −log 10 (pMS)≧3 relative to the −log 10 (pMS)≧0 category (FIG. 44c). Similarly, SNPs from pleiotropic SNP categories showing the greatest enrichments (−log 10 (pMS)≧3) replicated at highest rates, up to five times higher than all SNPs (−log 10(pMS)≧0), for a wide range of p-value thresholds. This indicates that replication of SNP associations varies as a function of estimated conditional TDR.

Replication Effect Size Depends Upon MS Association

Consistent with the pattern observed for replication rates in SCZ sub-studies (see above), it was found that the effect sizes of SNPs in enriched categories (e.g. −log 10 (pMS)≧3) replicated better than effect sizes of SNPs in less enriched categories (e.g. −log 10(pMS)≧0; FIG. 44d). This indicates that the fidelity of replication effect sizes is closely related to the conditional TDR.

SCZ Gene Loci Identified with Conditional FDR

Conditional FDR methods (13, 23) improve the ability to detect SNPs associated with SCZ due to the additional power generated by use of the MS GWAS data. Using the conditional FDR for each SNP, a ‘conditional FDR Manhattan plot’ for SCZ and MS (FIG. 47) was constructed. The reduced FDR obtained by leveraging association with MS enabled us to identify loci significantly (conditional FDR<0.05) associated with SCZ on a total of 13 chromosomes. The associated SNPs (removed SNP with LD-r2>0.2) were pruned and a total of 21 independent loci were identified, of which one complex locus was located in the MHC on chromosome 6 (Table 32) and 20 single gene loci were located in chromosomes 1-3, 6-12, 14, 15 and 18 (Table 31). These loci are marked by large points with black edges in FIG. 46. Only ten of the independent loci have been identified by previous SCZ GWASs using standard analysis (7, 32). However, several have also been identified in previous analyses of genetic pleiotropy between SCZ and cardiovascular disease risk factors (CVD) (23) and between SCZ and BDI3 (Tables 31 and 32).

Effect of the Size of Strata on Enrichment

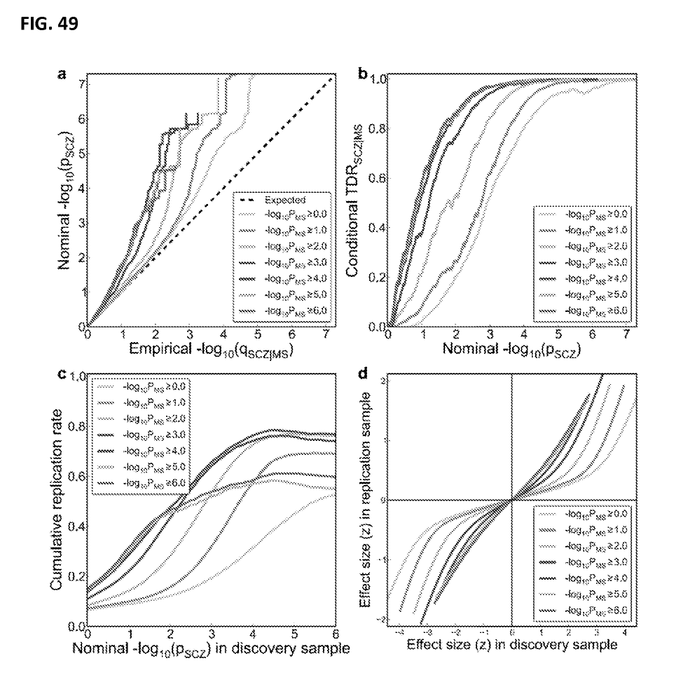

The observed enrichment was further confirmed by performing the same analysis on additional categories (−log 10 (pMS)≧4, −log 10(pMS)≧5 and −log 10(pMS)≧6. FIG. 49). While the general enrichment pattern persisted, the number of valid SNPs, which exist in both SCZ and MS dataset and also have valid p values, in these extra categories was smaller. In total, 425028 SNPs having valid p-values for both SCZ and MS were analyzed in this study. They contribute 425028, 47410, 7077, 1781, 808, 525 and 391 to the six categories conditioned by the significance level of MS, respectively.

Distribution of Allele Frequencies in Strata

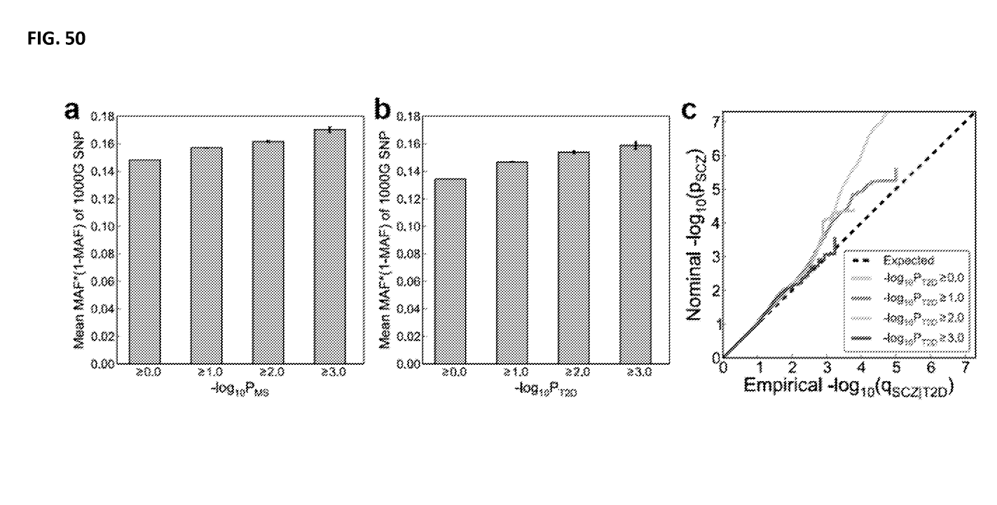

The distribution of the minor allele frequencies (MAF) of the corresponding SNPs of each stratum were identified from the 1KGP. FIG. 50 shows the average MAF*(1−MAF), namely, the genetic variance, in strata after pruning SNPs in LD (r2>0.2). As the significance level of SNPs with MS increases, there is a noticeable increase in average genetic variance, which is expected as MAF confounds multiplicatively with the true effect size of the variants (29). However, the effect of MAF alone cannot explain the observed enrichment (see FIG. 50).

HLA Imputation and Association Analysis

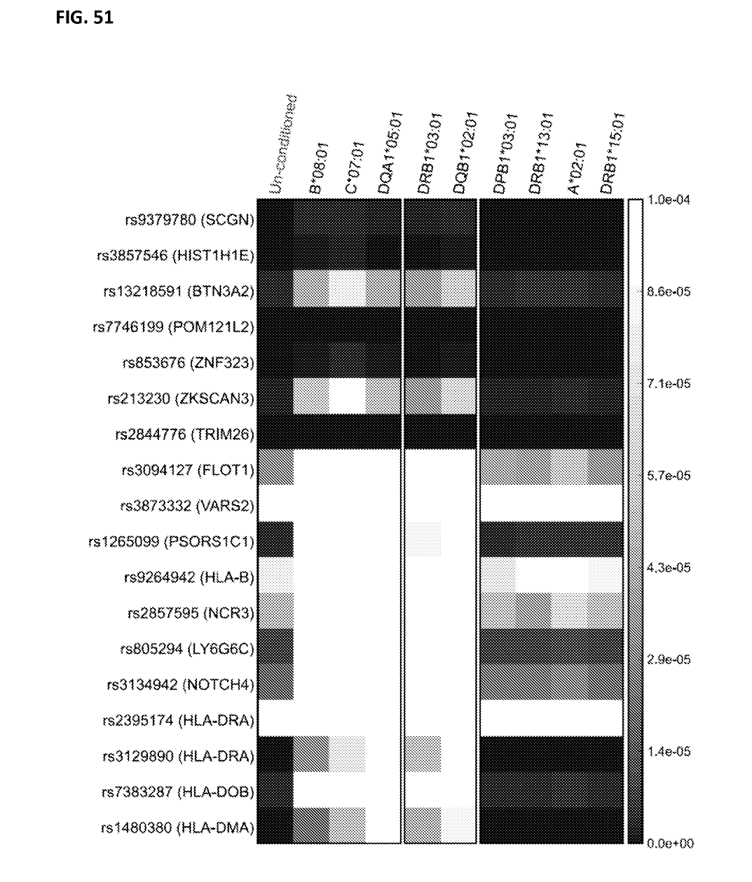

Among the loci identified by conditional FDR methods, eight are located in the MHC (Table 32). It is possible that these signals may be driven by common HLA alleles affecting both SCZ and MS. To test this hypothesis, HLA class I and class II alleles were investigated using the PGC1 genotype data (see Methods). Association analysis between imputed HLA alleles and SCZ was performed. The alleles HLA-B*08:01, HLA-C*07:01, HLA-DRB1*03:01. HLADQA1*05:01 and HLA-DQB1*02:01 are negatively associated with SCZ (p<7.8×10⁻⁴). Among these, HLA-DRB1*03:01 and HLA-DQB1*02:01 have been reported to be positively associated with MS 15. However, no association was seen with SCZ for the strong MS predisposing HLA-DRB1*15:01 and HLA-DRB1*13:03 alleles, nor for the protective HLA-A*02:01 allele. It was further tested whether SNPs in the MHC with conditional FDR<0.05 were independent of the association signal with the classical HLA alleles (see Methods). SNPs rs9379780, rs3857546, rs7746199, rs853676 and rs2844776 are to be independent of the HLA allelic signal (FIG. 51).

It was further tested if the associated HLA alleles were independent of each other by conditional analysis between them (see Methods). The results indicate that the observed associations are driven by a single haplotype-block (i.e. ancestral haplotype 8.1), consisting of the 5 individual HLA alleles.

The Effect of MHC SNPs on Enrichment

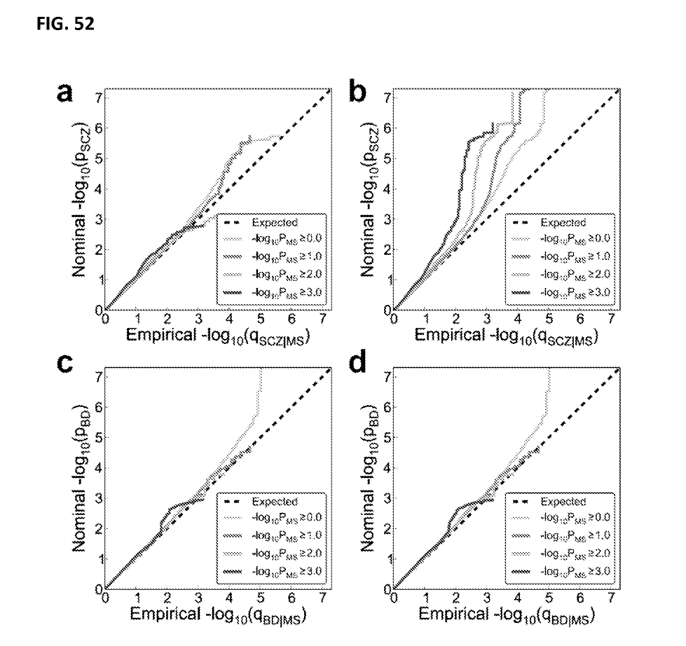

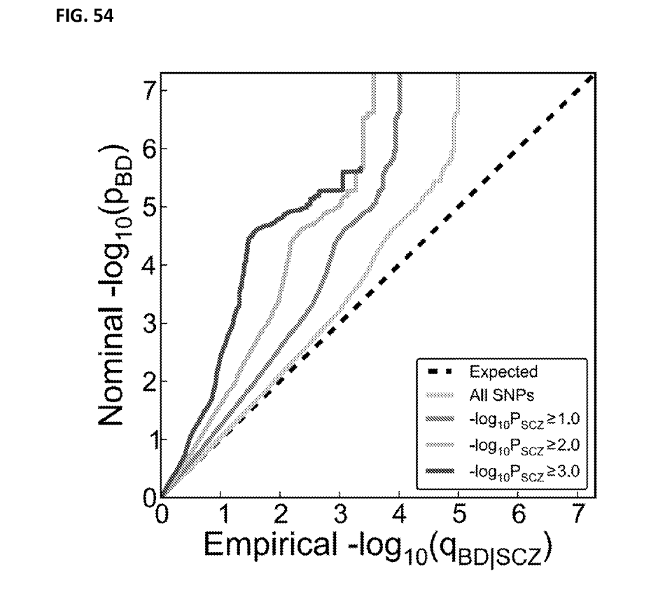

The effect of MHC-related SNPs (SNPs located within the MHC or SNPs within 1 Mb and in LD (r2>0.2) with such SNPs) on the observed enrichment for SCZ and BD conditional on MS was investigated (see FIG. 52). After removing the MHC-related SNPs the enrichment of SCZ conditioned on MS was substantially attenuated (FIG. 52). In contrast, removing the MHC-related SNPs did not affect the enrichment of BD conditioned on MS (FIG. 52). The effect of removing the MHC-related SNPs on the previously reported enrichment of SCZ conditioned on BD. As illustrated in FIG. 54, the enrichment between BD and SCZ was not affected by removing the MHC-related SNPs.

Enrichment Analysis of Other Psychiatry Disorders

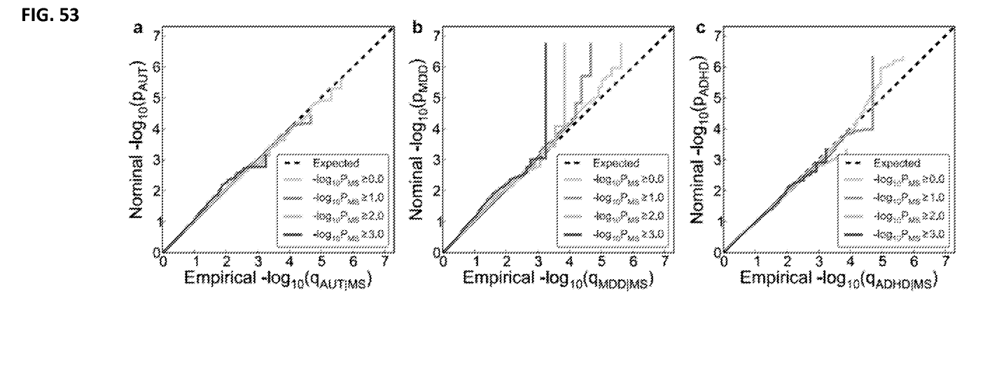

Using the analysis approach described above, genetic enrichment in Major depressive disorder (MDD)25, Autism spectrum disorder (AUT)26 and Attention Deficit/Hyperactivity Disorder (ADHD)27 was analyzed. GWAS summary statistics from the PGC conditioned on MS. In contrast to SCZ, none of these phenotypes demonstrated significant enrichment (FIG. 53).

TABLE 31

| Locus# | SNP | Location | Gene | SCZ P | FDR SCZ | FDR SCZ \| MS |
|---|---|---|---|---|---|---|
| 1 | rs1625579 | 1p21.3 | AK094607 ^{1, 2} | 5.52E−06 | 4.92E−02 | 3.69E−02 |
| | | | (MIR137HG) | | | |
| 2 | rs17180327 | 2q31.3 | CWC22 ^{2, 3} | 6.37E−06 | 5.19E−02 | 3.95E−03 |
| 3 | rs7646226 | 3p21-p14 | PTPRG ^{2, 3} | 5.51E−06 | 4.92E−02 | 2.43E−02 |
| 4 | rs9462875 | 6p21.1 | CUL9 ^{2, 3} | 1.20E−05 | 6.59E−02 | 4.14E−02 |
| 5 | rs10257990 | 7p22 | MAD1L1 ^{1, 2} | 5.53E−06 | 4.92E−02 | 1.63E−02 |
| 6 | rs10503253 | 8p23.2 | CSMD1 ^{1, 2} | 3.96E−06 | 4.70E−02 | 4.04E−02 |
| | rs10503256 | 8p23.2 | CSMD1 ^{1, 2} | 2.27E−06 | 4.32E−02 | 1.29E−02 |
| 7 | rs6990941 | 8q21.3 | MMP16 ^{1, 2} | 2.48E−06 | 4.32E−02 | 1.48E−02 |
| 8 | rs396861 | 9p24 | AK3 | 6.89E−06 | 5.19E−02 | 4.53E−02 |
| 9 | rs4532960 | 10q24.32 | AS3MT ² | 2.65E−06 | 4.32E−02 | 1.29E−02 |
| 10 | rs12411886 | 10q24.32 | CNNM2 ^{1, 2} | 1.79E−06 | 4.10E−02 | 1.86E−02 |
| 11 | rs11191732 | 10q25.1 | NEURL ² | 2.55E−06 | 4.32E−02 | 2.69E−02 |
| 12 | rs1025641 | 10q26.2 | C10orf90 | 7.51E−06 | 5.54E−02 | 4.87E−02 |
| 13 | rs2852034 | 11q22.1 | CNTN5 | 1.12E−05 | 6.00E−02 | 2.90E−02 |
| 14 | rs540723 | 11q23.3 | STT3A ² | 1.82E−06 | 4.10E−02 | 2.56E−02 |
| 15 | rs7972947 | 12p13.3 | CACNA1C ^{1, 2} | 7.12E−06 | 5.54E−02 | 4.87E−02 |
| 16 | rs2007044 | 12p13.3 | CACNA1C ^{1, 2} | 2.74E−05 | 9.43E−02 | 1.75E−02 |
| 17 | rs12436216 | 14q13.2 | KIAA0391 ² | 7.40E−06 | 5.54E−02 | 4.87E−02 |
| 18 | rs1869901 | 15q15 | PLCB2 ² | 3.66E−06 | 4.70E−02 | 4.04E−02 |
| 19 | rs4887348 | 15q25 | NTRK3 | 4.69E−05 | 1.39E−01 | 3.05E−02 |
| 20 | rs4309482 | 18 | AK093940 | 9.66E−06 | 6.00E−02 | 1.34E−02 |

Independent complex or single-gene loci (r² < 0.2) with SNP(s) with a conditional FDR (SCZ|MS) < 0.05 in schizophrenia (SCZ) given association in multiple sclerosis (MS). All significant SNPs are listed and sorted in each LD block and independent loci are listed consecutively (Locus #). Chromosome location (Location), closest gene (Gene), p-value of SCZ (SCZ P-value) and false discovery rate of SCZ, FDR (SCZ) are also listed. All data were first corrected for genomic inflation.
¹ Loci identified by GWASs without leveraging genetic pleiotropy structure between phenotypes.
² Loci identified using conditional FDR method on SCZ with CVD.
³ Loci identified using conditional FDR method on SCZ with BD.

TABLE 32

| SNP | Location | Gene | SCZ P | FDR SCZ | FDR SCZ\|MS |
|---|---|---|---|---|---|
| rs9379760 | 6p22.3 | SCGN^{2,3} | 3.25E−06 | 4.51E−02 | 1.59E−02 |
| rs3857546 | 6p21.3 | HIST1H1E² | 3.87E−08 | 4.49E−03 | 1.47E−03 |
| rs13218591 | 6p22.1 | BTN3A2 | 4.24E−05 | 1.23E−01 | 4.86E−02 |
| rs7746199 | 6p22.1 | POM121L2^{α} | 1.18E−08 | 2.69E−03 | 1.59E−03 |
| rs853676 | 6p22.3-p22.1 | ZNF323² | 6.71E−08 | 2.69E−03 | 1.59E−03 |
| rs213230 | 6p22.1 | ZKSCAN3² | 3.64E−06 | 4.70E−02 | 1.15E−03 |
| rs2844776 | 6p21.3 | TRIM25^{1,2,3} | 2.34E−09 | 7.23E−04 | 8.15E−05 |
| rs3094127 | 6p21.3 | FLOT1² | 6.66E−05 | 1.57E−01 | 3.68E−02 |
| rs3873332 | 6p21.33 | VARS2 | 8.61E−04 | 4.37E−01 | 4.69E−02 |
| rs1265099 | 6p21.3 | PSORS1C1² | 2.30E−05 | 9.43E−02 | 3.38E−03 |
| rs9264942 | 6p21.3 | HLA-B^{1,2} | 3.25E−04 | 3.26E−01 | 2.36E−02 |
| rs2857595 | 6p21.3 | NCR3 | 8.96E−05 | 1.96E−01 | 9.55E−03 |
| rs805294 | 6p21.33 | LY6G6C³ | 2.93E−05 | 1.08E−01 | 3.99E−03 |
| rs3134942 | 6p21.3 | NOTCH4^{1,2} | 3.04E−05 | 1.08E−01 | 3.99E−03 |
| rs2395174 | 6p21.3 | HLA-DRA^{2,3} | 8.07E−04 | 4.37E−01 | 4.69E−02 |
| rs3129890 | 6p21.3 | HLA-DRA^{2,3} | 1.89E−06 | 4.10E−02 | 6.98E−04 |
| rs7383267 | 6p21.3 | HLA-DOB^{2,3} | 3.44E−06 | 1.08E−01 | 3.89E−03 |
| rs1480360 | 6p21.3 | HLA-DMA^{2,3} | 3.05E−06 | 4.51E−02 | 2.11E−03 |

SNPs located in the MHC region identified with a conditional FDR (SCZ|MS) <0.05 in schizophrenia (SCZ) given association in Multiple Sclerosis (MS).
Chromosome location (Location), closest gene (Gene), p value of SCZ (SCZ P-value) and false discovery rate of SCZ, FDR (SCZ) are also listed.
All data were first corrected for genomic inflation.
¹Loci identified by GWASs without leveraging genetic pleiotropy structure between phenotypes.
²Loci identified using conditional FDR method on SCZ with CVD.
³Loci identified using conditional FDR method on SCZ with BD.

### REFERENCES

1. Murray C J L, Health HSOP, World Health Organization, Bank W. The global burden of disease: A comprehensive assessment of mortality, injuries, and risk factors in 1990 and projected to 2020. 1st ed. Harvard School of Public Health: Cambridge Mass.; 1996.
2. Olesen J, Leonardi M. The burden of brain diseases in Europe. Eur J Neurol 2003; 10: 471-477.
3. Craddock N, Owen M J. The beginning of the end for the Kraepelinian dichotomy. Br J Psychiatry 2005; 186: 364-366.
4. Editorial. A decade for psychiatric disorders. Nature 2010; 463: 9.
5. Arias I, Sorlozano A, Villegas E, de Dios Luna J, McKenney K, Cervilla J et al. Infectious agents associated with schizophrenia: a meta-analysis. Schizophr Res 2012; 136: 128-136.
6. Hope S, Melle I, Aukrust P, Steen N E, Birkenaes A B, Lorentzen S et al. Similar immune profile in bipolar disorder and schizophrenia: selective increase in soluble tumor necrosis factor receptor I and von Willebrand factor. Bipolar Disord 2009; 11: 726-734.
7. Schizophrenia Psychiatric Genome-Wide Association Study (GWAS) Consortium. Genomewide association study identifies five new schizophrenia loci. Nat Genet 2011; 43: 969-976.
8. Stefansson H, Ophoff R A, Steinberg S, Andreassen O A, Cichon S. Rujescu D et al. Common variants conferring risk of schizophrenia. Nature 2009; 460: 744-747.
9. Ripke S, O'Dushlaine C, Chambert K, Moran J L, Kähler A K, Akterin S et al. Genome-wide association analysis identifies 13 new risk loci for schizophrenia. Nat Genet 2013;
10. Shatz C J. MHC class I: an unexpected role in neuronal plasticity. Neuron 2009; 64: 40-45.
11. Goldstein B I, Kemp D E, Soczynska J K, McIntyre R S. Inflammation and the phenomenology, pathophysiology, comorbidity, and treatment of bipolar disorder: a systematic review of the literature. J Clin Psychiatry 2009; 70: 1078-1090.
12. Psychiatric GWAS Consortium Bipolar Disorder Working Group. Large-scale genome-wide association analysis of bipolar disorder identifies a new susceptibility locus near ODZ4. Nat Genet 2011; 43: 977-983.
13. Andreassen O A, Thompson W K, Schork A J, Ripke S, Mattingsdal M, Kelsoe J R et al. Improved detection of common variants associated with schizophrenia and bipolar disorder using pleiotropy-informed conditional false discovery rate. PLoS Genet 2013; 9: e1003455.
14. Gourraud P-A, Harbo H F, Hauser S L, Baranzini S E. The genetics of multiple sclerosis: an up-to date review. Immunol Rev 2012; 248: 87-103.
15. International Multiple Sclerosis Genetics Consortium, Wellcome Trust Case Control Consortium 2, Sawcer S, Hellenthal G, Pirinen M, Spencer C C A et al. Genetic risk and a primary role for cell-mediated immune mechanisms in multiple sclerosis. Nature 2011; 476: 214-219.
16. de Jager P L, Jia X, Wang J, de Bakker P I W, Ottoboni L, Aggarwal N T et al. Meta-analysis of genome scans and replication identify CD6, IRF8 and TNFRSF1A as new multiple sclerosis susceptibility loci. Nat Genet 2009; 41: 776-782.
17. Gourraud P-A, Sdika M, Khankhanian P, Henry R G, Beheshtian A, Matthews P M et al. A genome-wide association study of brain lesion distribution in multiple sclerosis. Brain 2013; 136: 1012-1024.
18. Patsopoulos N A, Bayer Pharma MS Genetics Working Group, Steering Committees of Studies Evaluating IFNβ-1b and a CCR1-Antagonist, ANZgene Consortium, GeneMSA, International Multiple Sclerosis Genetics Consortium et al. Genome-wide meta-analysis identifies novel multiple sclerosis susceptibility loci. Ann Neurol 2011; 70: 897-912.
19. Compston A, Coles A. Multiple sclerosis. Lancet 2008; 372: 1502-1517.
20. Takahashi N, Sakurai T, Davis K L, Buxbaum J D. Linking oligodendrocyte and myelin dysfunction to neurocircuitry abnormalities in schizophrenia. Prog Neurobiol 2011; 93: 13-24.
21. Sivakumaran S, Agakov F, Theodoratou E, Prendergast J G, Zgaga L, Manolio T et al. Abundant pleiotropy in human complex diseases and traits. Am J Hum Genet 2011; 89: 607-618.
22. Chambers J C, Zhang W, Sehmi J, Li X, Wass M N, van der Harst P et al. Genome-wide association study identifies loci influencing concentrations of liver enzymes in plasma. Nat Genet 2011; 43: 1131-1138.
23. Andreassen O A, Djurovic S, Thompson W K, Schork A J, Kendler K S, O'Donovan M C et al. Improved detection of common variants associated with schizophrenia by leveraging pleiotropy with cardiovascular-disease risk factors. Am J Hunt Genet 2013; 92: 197-209.
24. Liu J Z, Hov J R, Folseraas T, Ellinghaus E, Rushbrook S M, Doncheva N T et al. Dense genotyping of immune-related disease regions identifies nine new risk loci for primary sclerosing cholangitis. Nat Genet 2013; 45: 670-675.
25. Major Depressive Disorder Working Group of the Psychiatric GWAS Consortium, Ripke S, Wray N R, Lewis C M, Hamilton S P, Weissman M M et al. A mega-analysis of genome-wide association studies for major depressive disorder. Mol Psychiatry 2013; 18: 497-511.
26. Cross-Disorder Group of the Psychiatric Genomics Consortium, Smoller J W, Craddock N, Kendler K, Lee P H, Neale B M et al. Identification of risk loci with shared effects on five major psychiatric disorders: a genome-wide analysis. Lancet 2013; 381: 1371-1379.
27. Neale B M, Medland S E, Ripke S, Asherson P, Franke B, Lesch K-P et al. Meta-analysis of genome-wide association studies of attention-deficit/hyperactivity disorder. J Am Acad Child Adolesc Psychiatry 2010; 49: 884-897.
28. Benjamini Y, Hochberg Y. Controlling the False Discovery Rate: A Practical and Powerful Approach to Multiple Testing. J R Stat Soc Series B Stat Methodol 1995; 57: 289-300.
29. Schork A J, Thompson W K, Pham P, Torkamani A, Roddey J C, Sullivan P F et al. All SNPs Are Not Created Equal: Genome-Wide Association Studies Reveal a Consistent Pattern of Enrichment among Functionally Annotated SNPs. PLoS Genet 2013; 9: e1003449.
30. Zheng X, Shen J, Cox C, Wakefield J C, Ehm M G, Nelson M R et al. HIBAG-HLA genotype imputation with attribute bagging. Pharmacogenomics J 2013;
31. Purcell S, Neale B, Todd-Brown K, Thomas L, Ferreira M A R, Bender D et al. PLINK: A Tool Set for Whole-Genome Association and Population-Based Linkage Analyses. Am J Hum Genet 2007; 81: 559-575.
32. Purcell S M, Wray N R, Stone J L, Visscher P M, O'Donovan M C, Sullivan P F et al. Common polygenic variation contributes to risk of schizophrenia and bipolar disorder. Nature 2009; 460: 748-752.
33. Shi J, Levinson D F, Duan J, Sanders A R, Zheng Y, Pe'er I et al. Common variants on chromosome 6p22.1 are associated with schizophrenia. Nature 2009; 460: 753-757.
34. Hope S, Melle I, Aukrust P, Agartz I, Lorentzen S, Steen N E et al. Osteoprotegerin levels in patients with severe mental disorders. J Psychiatry Neurosci 2010; 35: 304-310.
35. Yolken R H, Torrey E F. Are some cases of psychosis caused by microbial agents? A review of the evidence. Mol Psychiatry 2008; 13: 470-479.
36. Karoutzou G, Emrich H M, Dietrich D E. The myelin-pathogenesis puzzle in schizophrenia: a literature review. Mol Psychiatry 2008; 13: 245-260.
37. Abi-Rached L, Jobin M J, Kulkarni S, McWhinnie A, Dalva K, Gragert L et al. The shaping of modern human immune systems by multiregional admixture with archaic humans. Science 2011; 334: 89-94.
38. Sullivan P F, Daly M J, O'Donovan M. Genetic architectures of psychiatric disorders: the emerging picture and its implications. Nat Rev Genet 2012; 13: 537-551.
39. Gershon E S, Alliey-Rodriguez N, Liu C. After GWAS: searching for genetic risk for schizophrenia and bipolar disorder. Am J Psychiatry 2011; 168: 253-256.

### Example 7

### Methods

Participant Samples

Complete GWAS results in the form of summary statistics p-values were obtained from public access websites or through collaboration with investigators (Table 33). Details on the inclusion criteria and phenotype characteristics of the different GWAS are described in the original publications 4,25-28. There was some overlap among several of the participants in the CVD risk factor GWAS and the SBP GWAS sample4. The relevant institutional review boards or ethics committees approved the research protocol of the individual GWAS and all participants gave written informed consent. All studies adhered to the principles of the Declaration of Helsinki.

Statistical Analyses

Genomic Control

A control method was applied using only intergenic SNPs to compute the inflation factor, λGC and all test statistics were divided by λGC, as detailed in prior publications21,22.

Conditional Quantile-Quantile (Q-Q) Plots for Pleiotropic Enrichment

Enrichment of statistical association relative to that expected under the global null hypothesis can be visualized through Q-Q plots of nominal p-values obtained from GWAS summary statistics. Genetic enrichment results in a leftward shift in the Q-Q curve, corresponding to a larger fraction of SNPs with nominal −log 10 p-value greater than or equal to a given threshold. Conditional Q-Q plots are constructed by creating subsets of SNPs based on the significance of each SNP's association with a related phenotype, and computing Q-Q plots separately for each level of association (for further details, see references 21, 22). Conditional Q-Q plots of empirical quantiles of nominal −log 10(p) values were constructed for SNP association with SBP for all SNPs, and for subsets of SNPs determined by the nominal p-values of their association with each of the 12 related phenotypes (−log 10(p)≧0, −log 10(p)≧1, −2 log 10(p)≧2, and −log 10(p)≧3 corresponding to p≦1, p≦0.1, p≦0.01, and p≦0.001, respectively). The nominal p-values (−log 10(p)) are plotted on the y-axis, and the empirical quantiles (−log 10(q), where q=1−cdf(p)) are plotted on the x-axis. To assess polygenic effects, the conditional Q-Q plots were focused on SNPs with nominal −log 10(p)<7.3 (corresponding to p>5×10-8).

Conditional False Discovery Rate (FDR)

Enrichment seen in the conditional Q-Q plots can be directly interpreted in terms of False Discovery Rate (FDR)21,22 (equivalent to 1−True Discovery Rate (TDR)35). A conditional FDR method22,36,37 was applied, and TDR plots were constructed, as described earlier21,22.

Conditional Statistics—Test of Association with Systolic Blood Pressure

To improve detection of SNPs associated with SBP, SNPs were conditioned based on p-values in the related phenotype21.22. A conditional FDR value (denoted as FDRSBP|related-phenotype) was assigned for SBP to each SNP, for each related phenotype by interpolation, using a two-dimensional look-up table of conditional FDR values21,22 computed for each of the specific datasets used in the current study. All SNPs with FDRSBP|related-phenotype<0.01 (−log 10(FDRSBP|related-phenotype)>2) in SBP given association with any of the 12 related phenotypes are listed in Table 33 after ‘pruning’ (i.e., removing all SNPs with r2>0.2 based on 1000 Genomes Project linkage disequilibrium (LD) structure). A significance threshold of FDR<0.01 corresponds to 1 false positive per 100 reported associations. To illustrate the localization of the genetic markers associated with SBP given the related phenotype effect, a ‘Conditional FDR Manhattan plot’ was generated, plotting all SNPs within an LD block in relation to their chromosomal locations. The strongest signal in each LD block was identified by ranking all SNPs in increasing order, based on the conditional FDR value for SBP, and then removing SNPs in LD r2>0.2 with any higher ranked SNP. Thus, the selected locus was the most significantly associated with SBP in each LD block.

Results

Pleiotropic Enrichment—Polygenic Overlap.

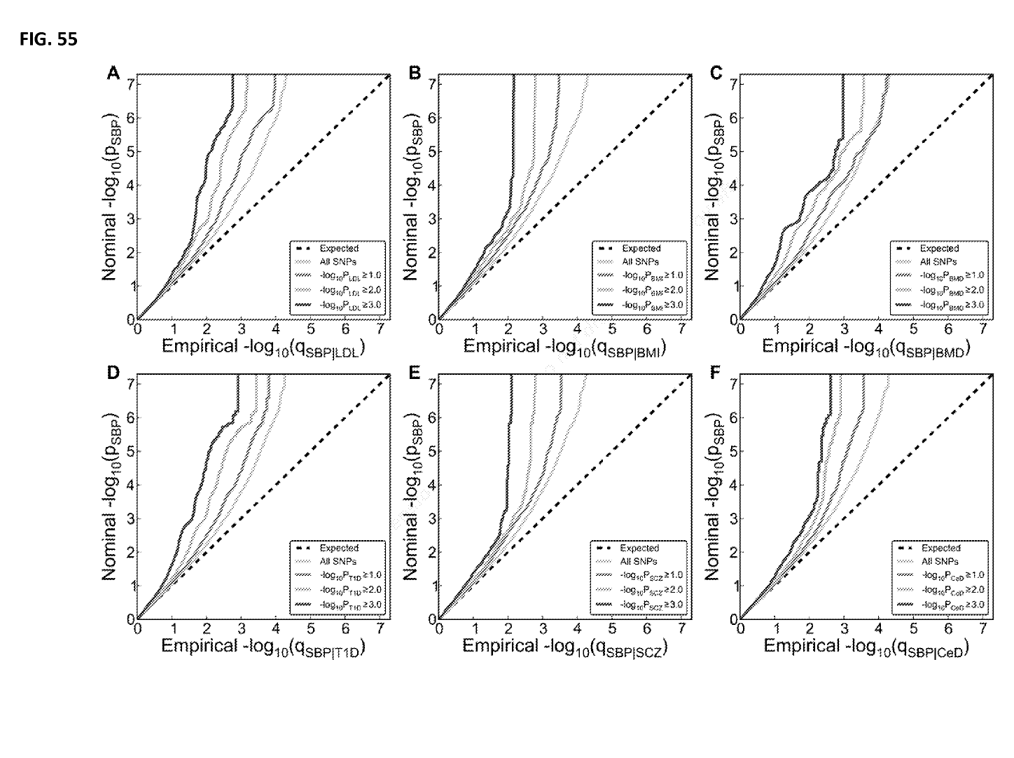

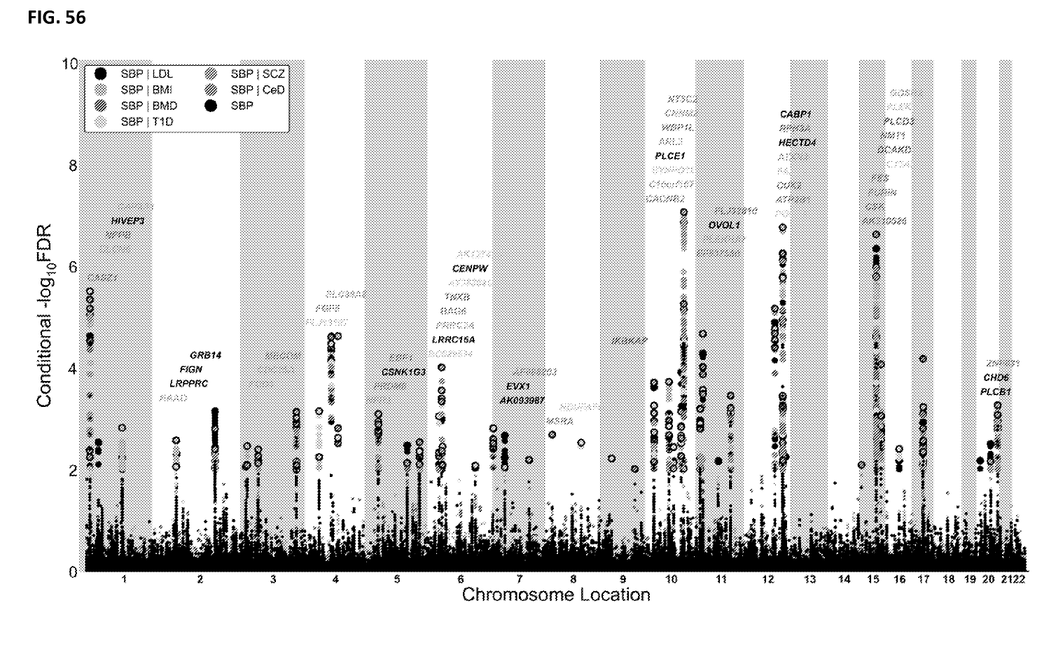

Conditional Q-Q plots for SBP conditioned on nominal p3 values of association with LDL, BMI, BMD, TID, SCZ, and CeD showed enrichment across different levels of significance (FIG. 55A-F). For LDL, the proportion of SNPs in the −log 10(pLDL)≧3 category reaching a given significance level (e.g., −log 10(pSBP)>6) was roughly 100 times greater than for −log 10(pLDL)≧0 category (all SNPs), indicating a very high level of enrichment (FIG. 55A). A similar level of enrichment was seen for BMI and SCZ (FIG. 55B,C); CeD, TID and BMD also showed a high level of enrichment (FIG. 55D-F). Weaker pleiotropic enrichment was seen for WHR with little or no evidence for enrichment in RA, HDL, TG, T2D, HT. The high level of polygenic pleiotropic enrichment in LDL, BMI, BMD, TID, SCZ, and CeD was demonstrated using “Enrichment Plots.”

Gene Loci Associated with SBP.

A “conditional FDR” Manhattan plot showed the 62 independent gene loci significantly associated with SBP based on conditional FDR<0.01 obtained from associated phenotypes. The 30 complex loci and 32 single gene loci (after pruning) were located on 16 chromosomes (Table 34). Only 11 of these loci would have been discovered using standard statistical methods (Bonferroni correction; bold values in the “SBP p-value” column, Table 34). Using the FDR method, 25 loci were identified (bold values in the “SBP-FDR” column, Table 34). The remaining 37 loci would not have been identified in the current sample without using the pleiotropy informed conditional FDR method. Of the 62 loci identified, 42 were novel; 20 were reported in the primary analysis of the current sample4. Many of these new loci are located in regions with borderline significant association with SBP in previous studies4. Of interest, several loci had multiple pleiotropic SNPs from several associated phenotypes, indicating overlapping genetic factors among these phenotypes. Follow-up Ingenuity Pathways Analysis (IPA) identifying the traits in the categories “Cardiovascular disease” or “Cardiovascular System Development and Function”, respectively, that may be affected by the gene heterogeneities in the vicinity of the indicated SBP associated genes were identified. A large proportion of SBP associated genes are functionally related.

TABLE 33
Table 1. Genome-Wide Association Studies Data
Used in the Current Study

| | | Number | |
|---|---|---|---|
| Disease/Trait | N | of SNPs | Reference |
| Syntolic blood pressure | 203 056 | 2382 073 | International |
| | | | Cannectfilm for Blood |
| | | | Pressure |
| | | | Genome-Wide |
| | | | Association Studies* |
| Low-density lipoprotein | 99 900 | 2508 375 | Teslovich et al²⁵ |
| High-density lipoprotein | 95 598 | 2508 370 | |
| Triglycerides | 96 568 | 2608 369 | |
| Height | 183 727 | 2398 527 | Lango Allen et al²⁹ |
| Body mass index | 123 865 | 2400 377 | Spelictes et al²⁷ |
| Waist/hip ratio | 77 167 | 2376 820 | Heid et al [symbol] |
| Type 2 diabetes mellitus | 22 044 | 2426 886 | Voight et al [symbol] |
| Type 1 diabetes mellitus | 16 559 | 841 622 | Barrett et al²¹ |
| Rheumatoid arthritis | 25 708 | 2560 000 | Stahl et al²⁷ |
| Bone mineral density | 32 961 | 2600 000 | Estrada et al²⁴ |
| Celiac disease | 15 283 | 528 969 | Dubuis et al [symbol] |
| Schizophrenia | 21 856 | 1171 056 | Schizophrenia |
| | | | Psychiatric |
| | | | Genome-Wide |
| | | | Association Study |
| | | | (GWAS) Consortium²⁰ |

For more details. see also http://www.genome./gos/gwastudies.
SNP indicates single nucleotide polymorphium. [symbol]
indicates data missing or illegible when filed

TABLE 34
Independent loci associated with SBP through Conditional FDR (<0.01) with associated phenotypes.

| | | | | | SBP | SBP | Min cond | Associated |
|---|---|---|---|---|---|---|---|---|
| Locus | SNP | Pos | Gene | chr | p-value | FDR | FDR | Phenotype |
| 1 | rs2748975 | 1886519 | KIAA1751 | 1 | 1.81E−06 | 0.01493 | 0.0095053 | WHR |
| 2 | rs880315 | 10796866 | CASZ1 | 1 | 1.44E−05 | 0.04983 | 0.0040514 | CeD |
| 3 | rs17367504 | 11862778 | MTHFR† | 1 | 9.86E−11 | 0.00003 | 0.0000013 | WHR |
| | rs2050265 | 11879699 | CLCN6 | 1 | 2.38E−10 | 0.00003 | 0.0000026 | WHR |
| 4 | rs6676300 | 11925300 | NPPB | 1 | 1.47E−05 | 0.04983 | 0.0054695 | CeD |
| 5 | rs783622 | 42366988 | HIVEP3 | 1 | 1.04E−05 | 0.03839 | 0.0028136 | LDL |
| 6 | rs12048528 | 113210534 | CAPZA1 | 1 | 3.84E−06 | 0.02209 | 0.0014541 | BMI |
| | rs2932538 | 113216543 | MOV10† | 1 | 1.78E−06 | 0.01493 | 0.0014684 | BMI |
| 7 | rs4332966 | 43083831 | HAAO | 2 | 1.58E−05 | 0.04983 | 0.0025790 | BMI |
| 8 | rs9309112 | 44169889 | LRPPRC | 2 | 1.56E−05 | 0.04983 | 0.0047478 | LDL |
| 9 | rs12619842 | 164945044 | FIGN | 2 | 1.01E−05 | 0.03839 | 0.0089999 | LDL |
| | rs16849397 | 165108248 | GRB14 | 2 | 4.76E−07 | 0.00665 | 0.0025354 | WHR |
| 10 | rs2594992 | 11360997 | ATG7 | 3 | 2.24E−06 | 0.01687 | 0.0076216 | WHR |
| 11 | rs6806067 | 14948702 | FGD5 | 3 | 2.23E−06 | 0.01493 | 0.0033240 | BMI |
| 12 | rs6797587 | 48197614 | CDC25A | 3 | 1.32E−06 | 0.01180 | 0.0043919 | BMI |
| 13 | rs223102 | 169100755 | MECOM† | 3 | 4.56E−08 | 0.00112 | 0.0006796 | WHR |
| 14 | rs9290369 | 169324783 | MECOM | 3 | 8.04E−07 | 0.00909 | 0.0066551 | WHR |
| 15 | rs10006384 | 38385187 | FLJ13197 | 4 | 2.71E−06 | 0.01687 | 0.0054382 | BMI |
| 16 | rs1458038 | 81164723 | FGF5† | 4 | 1.08E−09 | 0.00004 | 0.0000228 | WHR |
| 17 | rs13107325 | 103188709 | SLC39A8† | 4 | 1.55E−07 | 0.00271 | 0.0000229 | BMI |
| 18 | rs1173743 | 32775047 | NPR3 | 5 | 4.78E−07 | 0.00665 | 0.0007773 | BMI |
| | rs1173771 | 32815028 | C5orf23† | 5 | 8.44E−08 | 0.00162 | 0.0004338 | WHR |
| 19 | rs458158 | 122482181 | PRDM6 | 5 | 6.76E−06 | 0.02945 | 0.0071865 | SCZ |
| 20 | rs11750782 | 122976743 | CSNK1G3 | 5 | 6.75E−06 | 0.02945 | 0.0070289 | BMD |
| 21 | rs11953630 | 157845402 | EBF1† | 5 | 3.64E−07 | 0.00558 | 0.0029954 | WHR |
| 22 | rs199205 | 7736417 | BMP6 | 6 | 2.29E−06 | 0.01687 | 0.0076216 | WHR |
| 23 | rs9467445 | 25234884 | BC029534 | 6 | 2.20E−06 | 0.01493 | 0.0011956 | T1D |
| 24 | rs11754013 | 25370200 | LRRC16A | 6 | 1.32E−05 | 0.04368 | 0.0076472 | LDL |
| 25 | rs2736155 | 31605199 | PRRC2A | 6 | 1.41E−06 | 0.01180 | 0.0002670 | BMI |
| | | | (BAT2)† | | | | | |
| | rs805303 | 31616366 | BAG6(BAT3)† | 6 | 8.17E−07 | 0.00909 | 0.0000941 | SCZ |
| 26 | rs429150 | 32075563 | TNXB | 6 | 1.70E−05 | 0.04983 | 0.0090475 | LDL |
| 27 | rs394199 | 33553580 | GGNBP1 | 6 | 3.96E−05 | 0.08570 | 0.0034152 | T1D |
| | | | (AY383626) | | | | | |
| 28 | rs581484 | 126665180 | CENPW | 6 | 3.08E−06 | 0.01922 | 0.0089438 | LDL |
| | | | (C6orf173) | | | | | |
| 29 | rs853964 | 127029267 | AK127472 | 6 | 2.63E−06 | 0.01687 | 0.0076216 | WHR |
| 30 | rs2969070 | 2512545 | BC034268 | 7 | 2.64E−07 | 0.00386 | 0.0014814 | T1D |
| 31 | rs3735533 | 27245893 | HOTTIP | 7 | 1.37E−05 | 0.04368 | 0.0056631 | LDL |
| | | | (AK093987) | | | | | |
| 32 | rs7777128 | 27337113 | EVX1 | 7 | 6.04E−06 | 0.02945 | 0.0020776 | LDL |
| 33 | rs7787898 | 106409897 | AF086203 | 7 | 2.60E−06 | 0.01687 | 0.0062017 | SCZ |
| 34 | rs3088186 | 10226355 | MSRA | 8 | 1.97E−05 | 0.05707 | 0.0019924 | SCZ |
| 35 | rs4735337 | 95973465 | NDUFA6 | 8 | 3.54E−05 | 0.07505 | 0.0028564 | T1D |
| | | | (C8orf38) | | | | | |
| 36 | rs12006112 | 21042299 | PTPLAD2 | 9 | 5.02E−05 | 0.09719 | 0.0058735 | T1D |
| 37 | rs4978374 | 111646983 | IKBKAP | 9 | 9.87E−06 | 0.03839 | 0.0094345 | BMD |
| 38 | rs12570727 | 18425519 | CACNB2† | 10 | 4.07E−08 | 0.00093 | 0.0001882 | SCZ |
| 39 | rs12258967 | 18727959 | CACNB2 | 10 | 1.42E−07 | 0.00271 | 0.0015659 | WHR |
| 40 | rs4590817 | 63467553 | C10orf107† | 10 | 3.40E−08 | 0.00077 | 0.0001588 | WHR |
| 41 | rs12247028 | 75410052 | SYNPO2L | 10 | 1.59E−06 | 0.01328 | 0.0067916 | WHR |
| 42 | rs932764 | 95895940 | PLCE1† | 10 | 1.47E−07 | 0.00271 | 0.0001182 | LDL |
| 43 | rs10786156 | 96014622 | PLCE1 | 10 | 2.51E−06 | 0.01687 | 0.0020927 | BMI |
| 44 | rs10883766 | 104464763 | ARL3 | 10 | 1.91E−05 | 0.05707 | 0.0071447 | CeD |
| | rs284844 | 126665180 | WBP1L | 10 | 5.48E−09 | 0.00015 | 0.0000039 | BMI |
| | | | (C10orf26) | | | | | |
| | rs1926032 | 127029267 | CNNM2 | 10 | 2.77E−10 | 0.00003 | 0.0000001 | BMI |
| | rs11191548 | 2512545 | NT5C2† | 10 | 2.43E−10 | 0.00003 | 0.0000001 | SCZ |
| 45 | rs7129220 | 27245893 | EF537580† | 11 | 6.92E−08 | 0.00135 | 0.0006154 | SCZ |
| 46 | rs1580005 | 27337113 | EF537580 | 11 | 2.80E−06 | 0.01687 | 0.0057696 | LDL |
| 47 | rs381815 | 106409897 | PLEKHA7† | 11 | 1.25E−09 | 0.00005 | 0.0000205 | BMI |
| 48 | rs642803 | 10226355 | OVOL1 | 11 | 1.14E−05 | 0.04368 | 0.0065527 | LDL |
| 49 | rs633185 | 95973465 | FLJ32810† | 11 | 2.98E−08 | 0.00077 | 0.0004474 | WHR |
| 50 | rs11105328 | 21042299 | POC1B | 12 | 5.35E−10 | 0.00003 | 0.0000080 | SCZ |
| | | | (WDR51B) | | | | | |
| | rs2681472 | 111646983 | ATP2B1† | 12 | 5.14E−13 | 0.00003 | 0.0000062 | SCZ |
| 51 | rs7297186 | 18425519 | CUX2 | 12 | 1.88E−06 | 0.01493 | 0.0005328 | CeD |
| | rs3742004 | 18727959 | FAM109A | 12 | 6.39E−07 | 0.00783 | 0.0003417 | WHR |
| | rs653178 | 63467553 | ATXN2 | 12 | 4.58E−10 | 0.00003 | 0.0000002 | BMI |
| | rs1005902 | 75410052 | HECTD4 | 12 | 2.62E−06 | 0.01687 | 0.0005845 | LDL |
| | | | (C12orf51) | | | | | |
| | rs12580178 | 95895940 | RPH3A | 12 | 4.21E−06 | 0.02209 | 0.0007345 | LDL |
| 52 | rs7299238 | 96014622 | CABP1 | 12 | 6.25E−05 | 0.10892 | 0.0053975 | LDL |
| 53 | rs11070252 | 104464763 | GOLGA8T | 15 | 3.86E−06 | 0.02209 | 0.0078255 | CeD |
| | | | (AK310526) | | | | | |
| 54 | rs1378942 | 75077367 | CSK† | 15 | 1.63E−10 | 0.00003 | 0.0000002 | CeD |
| 55 | rs8032315 | 91418297 | FURIN | 15 | 1.83E−07 | 0.00323 | 0.0000828 | SCZ |
| | rs2521501 | 91437388 | FES† | 15 | 7.16E−08 | 0.00162 | 0.0011762 | WHR |
| 56 | rs11643718 | 56933519 | SLC12A3 | 16 | 3.30E−05 | 0.07505 | 0.0037698 | T1D |
| 57 | rs4793172 | 43131480 | DCAKD | 17 | 7.05E−07 | 0.00783 | 0.0040625 | SCZ |
| | rs2239923 | 43176804 | NMT1 | 17 | 3.97E−07 | 0.00558 | 0.0008079 | BMD |
| | rs12946454 | 43208121 | PLCD3 | 17 | 5.17E−08 | 0.00112 | 0.0000647 | BMD |
| 58 | rs11012 | | PLEKHM1 | 17 | 4.12E−05 | 0.08570 | 0.0034152 | T1D |
| 59 | rs17608766 | | GOSR2† | 17 | 4.59E−07 | 0.00665 | 0.0005684 | BMI |
| 60 | rs6055905 | | PLCB1 | 20 | 3.04E−05 | 0.07505 | 0.0064506 | LDL |
| 61 | rs6072403 | | CHD6 | 20 | 5.59E−06 | 0.02552 | 0.0058812 | LDL |
| 62 | rs6015450 | | ZNF831† | 20 | 5.63E−08 | 0.00135 | 0.0006154 | SCZ |

### REFERENCES

1. Kearney P M, Whelton M, Reynolds K, Muntner P, Whelton P K, He J. Global burden of hypertension: analysis of worldwide data. Lancet. 2005; 365:217-223.
2. Kotchen T A, Kotchen J M, Grim C E, George V, Kaldunski M L, Cowley A W, Hamet P, Chelius T H. Genetic determinants of hypertension: identification of candidate phenotypes. Hypertension. 2000; 36:7-13.
3. Levy D, DeStefano A L, Larson M G, O'Donnell C J, Lifton R P, Gavras H, Cupples L A, Myers R H. Evidence for a gene influencing blood pressure on chromosome 17. Genome scan linkage results for longitudinal blood pressure phenotypes in subjects from the Framingham heart study. Hypertension. 2000; 36:477-483.
4. International Consortium for Blood Pressure Genome-Wide Association Studies. Ehret G B, et al., Genetic variants in novel pathways influence blood pressure and cardiovascular disease risk. Nature. 2011; 478(7367):103-109.
5. Kurtz T W. Genome-wide association studies will unlock the genetic basis of hypertension: con side of the argument. Hypertension. 2010; 56:1021-1025.
6. Doris P A. The genetics of blood pressure and hypertension: the role of rare variation. Cardiovasc Ther. 2011; 29:37-45.
7. Yang J, Benyamin B, McEvoy B P, Gordon S, Henders A K, Nyholt D R, Madden P A, Heath A C, Martin N G, Montgomery G W, Goddard M E, Visscher P M. Common SNPs explain a large proportion of the heritability for human height. Nat Genet. 2010; 42:565-569.
8. Yang J, Manolio T A, Pasquale L R, Boerwinkle E, Caporaso N, Cunningham J M, de Andrade M, Feenstra B, Feingold E, Hayes M G, Hill W G, Landi M T, Alonso A, Lettre G, Lin P, Ling H, Lowe W, Mathias R A, Melbye M, Pugh E, Cornelis M C, Weir B S, Goddard M E, Visscher P M. Genome partitioning of genetic variation for complex traits using common SNPs. Nat Genet. 24 2011; 43:519-525.
9. Manolio T A, Collins F S, Cox N J, Goldstein D B, Hindorff L A, Hunter D J, McCarthy M I, Ramos E M, Cardon L R, Chakravarti A, Cho J H, Guttmacher A E, Kong A, Kruglyak L, Mardis E, Rotimi C N, Slatkin M, Valle D, Whittemore A S, Boehnke M, Clark A G, Eichler E E, Gibson G, Haines J L, Mackay T F C, McCarroll S A, Visscher P M. Finding the missing heritability of complex diseases. Nature. 2009; 461:747-753.
10. Wagner G P, Zhang J. The pleiotropic structure of the genotype-phenotype map: the evolvability of complex organisms. Nat Rev Genet. 2011; 12:204-213.
11. D'Agostino R B, Vasan R S, Pencina M J, Wolf P A, Cobain M, Massaro J M, Kannel W B. General cardiovascular risk profile for use in primary care: the Framingham Heart Study. Circulation. 10 2008; 117:743-753.
12. Conroy R M, Pyörälä K, Fitzgerald A P, Sans S, Menotti A, De Backer G, De Bacquer D, Ducimetiére P, Jousilahti P, Keil U, Njølstad I, Oganov R G, Thomsen T, Tunstall-Pedoe H, Tverdal A, Wedel H, Whincup P, Wilhelmsen L, Graham I M, SCORE project group. Estimation of ten-year risk of fatal cardiovascular disease in Europe: the SCORE project. Eur Heart J. 15 2003; 24:987-1003.
13. Libby P. Pathophysiology of Coronary Artery Disease. Circulation. 2005; 111:3481-3488.
14. Messerli F H, Williams B, Ritz E. Essential hypertension. Lancet. 2007; 370:591-603.
15. Eckel R H, Grundy S M, Zimmet P Z. The metabolic syndrome. Lancet. 2005; 365:1415-1428.
16. Rosner B, Prineas R J, Loggie J M, Daniels S R. Blood pressure nomograms for children and adolescents, by height, sex, and age, in the United States. J Pediatr. 1993; 123:871-886.
17. Caudarella R, Vescini F, Rizzoli E, Francucci C M. Salt intake, hypertension, and osteoporosis. J Endocrinol Invest. 2009; 32:15-20.
18. Birkenaes A B, Opjordsmoen S, Brunborg C, Engh J A, Jonsdottir H, Ringen P A, Simonsen C, Vaskinn A, Birkeland K I, Friis S, Sundet K, Andreassen O A. The level of cardiovascular risk factors in bipolar disorder equals that of schizophrenia: a comparative study. J Clin Psychiatry. 2007; 68:917-923.
19. Group T A S. Effects of Intensive Blood-Pressure Control in Type 2 Diabetes Mellitus. N Engl J Med. 2010; 362:1575-1585.
20. Panoulas V F, Metsios G S, Pace A V, John H, Treharne G J, Banks M J, Kitas G D. Hypertension in rheumatoid arthritis. Rheumatology. 2008; 47:1286-1298.
21. Andreassen O A, Thompson W K, Schork A J, Ripke S, Mattingsdal M, Kelsoe J R, Kendler K S, O'Donovan M C, Rujescu D, Werge T, Sklar P, Roddey J C, Chen C-H, McEvoy L, Desikan R S, Djurovic S, Dale A M. Improved detection of common variants associated with schizophrenia and bipolar disorder using pleiotropy-informed conditional false discovery rate. PLoS Genet. 2013; 9:e1003455.
22. Andreassen O A, Djurovic S, Thompson W K, Schork A J, Kendler K S, O'Donovan M C, Rujescu D, Werge T, van de Bunt M. Morris A P, McCarthy M I, Roddey J C, McEvoy L K, Desikan R S, Dale A M. Improved detection of common variants associated with schizophrenia by leveraging pleiotropy with cardiovascular-disease risk factors. Am J Hum Genet. 2013; 92:197-209.
23. Coffman T M. Under pressure: the search for the essential mechanisms of hypertension. Nat Med. 2011; 17:1402-1409.
24. Estrada K, et al., Genome-wide meta-analysis identifies bone mineral density loci and reveals 14 loci associated with risk of fracture. Nat Genet. 20 2012; 44: 491-501.
25 Teslovich T M, et al., Biological, clinical and population relevance of 95 loci for blood lipids. Nature. 2010; 466:707-713.
26. Voight B F, et al., MAGIC investigators; GIANT Consortium. Twelve type 2 diabetes susceptibility loci identified through large-scale association analysis. Nat Genet. 2010; 42:579-589.
27. Speliotes E K, et al., Association analyses of 249,796 individuals reveal 18 new loci associated with body mass index. Nat Genet. 2010; 42:937-948.
28. Heid I M, et al., Meta-analysis identifies 13 new loci associated with waist-hip ratio and reveals sexual dimorphism in the genetic basis of fat distribution. Nat Genet. 2011; 43:1164-1164.
29. Lango Allen H, et al., Hundreds of variants clustered in genomic loci and biological pathways affect human height. Nature. 2010; 467:832-838.
30. Schizophrenia Psychiatric Genome-Wide Association Study (GWAS) Consortium. Genome wide association study identifies five new schizophrenia loci. Nat Genet. 2011; 43:969-976.
31. Barrett J C, Clayton D G, Concannon P, Akolkar B, Cooper J D, Erlich H A, Julier C, Morahan G, 17 Nerup J, Nierras C, Plagnol V, Pociot F, Schuilenburg H, Smyth D J, Stevens H, Todd J A, Walker N M, Rich S S, Type 1 Diabetes Genetics Consortium. Genome-wide association study and meta-analysis find that over 40 loci affect risk of type 1 diabetes. Nat Genet. 2009; 41:703-707.
32. Stahl E A, et al., Genome-wide association study meta-analysis identifies seven new rheumatoid arthritis risk loci. Nat Genet. 2010; 42:508-514.
33. Franke A, et al., Genome-wide meta analysis increases to 71 the number of confirmed Crohn's disease susceptibility loci. Nat Genet. 2010; 42:1118-1125.
34. Dubois P C A, et al., Multiple common variants for celiac disease influencing immune gene expression. Nat Genet. 2010; 42:295-302.
35. Benjamini Y, Hochberg Y. Controlling the False Discovery Rate: A Practical and Powerful Approach to Multiple Testing. J R Stat Soc Ser B Slat Methodol. 1995; 57:289-300.
36. Sun L. Craiu R V, Paterson A D, Bull S B. Stratified false discovery control for large-scale hypothesis testing with application to genome-wide association studies. Genet Epidemiol. 2006; 30:519-530.
37. Yoo Y J, Pinnaduwage D, Waggott D, Bull S B, Sun L. Genome-wide association analyses of North American Rheumatoid Arthritis Consortium and Framingham Heart Study data utilizing genome-wide linkage results. BMC Proceedings. 2009; 3 Suppl 7:S103.
38. Schork A J, Thompson W K, Pham P, Torkamani A, Roddey J C, Sullivan P F, Kelsoe J R, O'Donovan M C, Furberg H, Schork N J, Andreassen O A, Dale A M. All SNPs Are Not Created Equal: Genome-Wide Association Studies Reveal a Consistent Pattern of Enrichment among Functionally Annotated SNPs. PLoS Genet. 2013; 9:e1003449.
39. Reppe S, Refvem H, Gautvik V T, Olstad O K, Høvring P I, Reinholt F P, Holden M, Frigessi A, Jemtland R, Gautvik K M. Eight genes are highly associated with BMD variation in postmenopausal Caucasian women. Bone. 2010; 46:604-612.
40. Dokos C, Savopoulos C, Hatzitolios A. Reconsider hypertension phenotypes and osteoporosis. J Clin Hypertens (Greenwich). 2011; 13:E1-2.
41. Sivakumaran S, Agakov F, Theodoratou E, Prendergast J G, Zgaga L, Manolio T, Rudan I, McKeigue P, Wilson J F, Campbell H. Abundant pleiotropy in human complex diseases and traits. Am J Hum Genet. 2011; 89:607-618.
42. Qiao S-W, Sollid L M, Blumberg R S. Antigen presentation in celiac disease. Curr Opin Immunol. 2009; 21:111-117.
43. Andreassen O A, Thompson W K, Dale A M. Boosting the power of schizophrenia genetics by leveraging new statistical tools. Schizophr Bull. 2014 In Press

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the medical sciences are intended to be within the scope of the following claims.

1. A computer implemented process of identifying gene variants associated with a specific trait or disorder, comprising:
a) inputting gene variant information selected from the group consisting of SNP (single-nucleotide polymorphism) genotype, copy number variant (CNV) information, gene deletion information, gene inversion information, gene duplication information, splice variant information, haplotype information and combinations thereof for a plurality of gene variants selected from the group consisting of SNPs (single-nucleotide polymorphisms), copy number variant (CNV), gene deletions, gene inversions, gene duplications, splice variants, and haplotypes associated with said specific trait or disorder;
b) assigning one or more enrichment factors for each of said plurality of gene variants wherein said one or more enrichment factors are selected from the group consisting of assignment to one or more annotation categories, statistical association with one or more phenotypes, and heterozygosity of the gene variant; and
c) combining one or more said enrichment factors within a linear or non-linear regression model to predict relative effect size or probability of association of said gene variants with specific trait or disorder.

2. The process of claim 1, wherein said gene variants are single nucleotide polymorphisms (SNP).

3. The process of claim 1, further comprising providing an enrichment score for said enrichment factors by conditional distribution analysis.

4. (canceled)

5. The process of claim 1, wherein said identifying comprises listing identified gene variants in a priority order based on probability of association with said specific trait or disorder.

6. The process of claim 1, wherein said assigning further comprises using linkage disequilibrium (LD) to assign each of said gene variants to a functional category.

7. The process of claim 1, further comprising performing a condition distribution analysis for each of said gene variants to provide a true discovery rate and/or a false discovery rate for each of said gene variants.

8. The process of claim 1, wherein said polymorphism information is obtained from at least 2 subjects.

9. The process of claim 1, wherein said polymorphism information comprises at least 1000 gene variants.

10. The process of claim 1, wherein said polymorphism information comprises at least 5000 gene variants.

11. The process of claim 1, wherein said polymorphism information comprises at least 10000 gene variants.

12. The process of claim 2, wherein said SNPs are intergenic SNPs.

13. The process of claim 3, wherein said enrichment scores are plotted as Q-Q plots.

14. The process of claim 13, wherein said Q-Q plots identify pleiotropic enrichment for said genetic variants.

15. The process of claim 7, wherein said false discovery rate for a specific gene variant is defined as the nominal p-value divided by the empirical quantile.

16. The process of claim 15, wherein gene variants with false discovery rates less than a prescribed threshold are defined as associated with said condition.

17. The process of claim 7, further comprising the step of plotting false discovery rates within a LD block in relation of their chromosomal location.

18. The process of claim 1, wherein said condition is selected from the group consisting of a disease, a trait, a response to a particular therapeutic agent, and a prognosis.

19. The process of claim 1, wherein said gene variants have specific minor allele frequencies.

20. The process of claim 1, wherein said gene variants are depleted for true effects.

21-27. (canceled)

28. A method, comprising:
a) identifying a plurality of gene variants from a subject associated with a given specific trait or disorder condition using the process of claim 1; and
b) characterizing one or more specific traits or disorders in said subject based on said plurality of gene variants.

29-46. (canceled)

47. The process of claim 1, wherein the enrichment factor can be weighted by a function of the linkage equilibrium (LD) of the observed said gene variant with underlying potential causal variants.
